(19) United States
(12) Patent Application Publication
(10) Pub. No.: US 2005/0283410 A1
(43) Pub. Date: Dec. 22, 2005

(54) Automated configuration catalog

(75) Inventor: Theresa M. Gosko, Austin, TX (US)

Correspondence Address: HAMILTON & TERRILE, LLP, P.O. BOX 203518, AUSTIN, TX, 78720, US

(73) Assignee: Dell Products L.P.

(21) Appl. No.: 11/111,666

(22) Filed: Apr. 21, 2005

Related U.S. Application Data
(63) Continuation of application No. 09/593,112, filed on Jun. 13, 2000, now abandoned.

(51) Int. Cl. G06F 17/60

(52) U.S. Cl. 705/27

(57) ABSTRACT

A system and method for automating manufacturing processes integrates customer-created orders into the manufacturing process. A method allows a manufacturer to automate a catalog process. The method includes creating a catalog of configurable products including at least one of non-commodity products and services and presenting a data file via a communication medium to a purchaser. The purchaser may include a customer, a third party acting on behalf of the customer and a supplier. The data file allows the purchaser to configure the products independent of a third party provided configuration tool by including manipulable parameters that enable configuration of non-commodity product or service. For example, the manipulable parameters may include upgrades, downgrades and swapping of components. Further, the data file is configured to be incorporated into a procurement system, the data file providing a catalog of configurable components.

### CROSS-REFERENCE TO RELATED APPLICATIONS

This application relates to application Ser. No. ______ (attorney docket number M-8809 US), filed on even date herewith, entitled “Data Structure for use in an Automatic Order Entry System” and naming Theresa M. Gosko, Joyce Sham, Reynaldo Ortega, Joy Fang and Emil Harsa, as inventors, the application being incorporated herein by reference in its entirety.

This application relates to application Ser. No. _______ (attorney docket number M-8810 US), filed on even date herewith, entitled “A System and Method for an Automated Inventory Process” and naming naming Theresa M. Gosko, Joyce Sham, Reynaldo Ortega, Joy Fang and Emil Harsa, as inventors, the application being incorporated herein by reference in its entirety.

This application relates to application Ser. No. ______ (attorney docket number M-9083 US), filed on even date herewith, entitled “Data Structure for use in an Automatic Order Entry System” and naming Theresa M. Gosko, as inventor, the application being incorporated herein by reference in its entirety.

This application relates to application Ser. No. ______ (attorney docket number M-9084 US), filed on even date herewith, entitled “Translator for use in an Automatic Order Entry System” and naming Theresa M. Gosko, as inventor, the application being incorporated herein by reference in its entirety.

This application relates to application Ser. No. ______ (attorney docket number M-9085 US), filed on even date herewith, entitled “A Customer-Hosted Automated Configuration Catalog” naming Theresa M. Gosko, as inventor, the application being incorporated herein by reference in its entirety.

This application relates to application Ser. No. ______ (attorney docket number M-9086 US), filed on even date herewith, entitled “A Translation System for Configuration Data” and naming Theresa M. Gosko, and Joy Fang, as inventors, the application being incorporated herein by reference in its entirety.

### BACKGROUND OF THE INVENTION

1. Field of the Invention

The present invention relates to an automated order and manufacturing process, and more particularly, to a process for integrating customer business processes with manufacturing processes.

2. Description of the Related Art

Electronic commerce, or e-commerce includes the transfer of orders or other sales communications, credit information, electronic “funds”, and digital products. Electronic commerce provides speed and convenience to many types of commercial activities. Interest in electronic commerce has heightened with the advent of widely accessible communication systems such as the Internet. Other types of electronic commerce include direct telephone line connections, interactive cable or television services, facsimile services, local and wide area network communications and the like. Electronic data communications technologies, particularly the Internet, have greatly enhanced marketing and retail opportunities and activities.

Electronic commerce has not been fully realized. There is a need to incorporate electronic communications technologies to synchronize customer interactions with businesses. More specifically, electronic commerce capabilities need to be expanded to synchronize business relationships with customers. For example, present electronic commerce businesses do not provide customers with the capability of configuring non-commodity items such as services and configuration options within their own systems. More particularly, present electronic commerce business must rely on third party configuration software to configure such non-commodity and commodity products. Additionally, electronic commerce presently fails to provide cohesive, integrated manufacturing processes that synchronize business documents and data that automate customer relationships.

### SUMMARY OF THE INVENTION

Accordingly, the present invention provides a system and method for automating manufacturing processes to integrate customer-created orders into the manufacturing process, including extending configuration data for providing the capability of configuring non-commodity products and services to customers.

A method according to an embodiment is for a manufacturer to automate a catalog process. The method includes creating a catalog of configurable products including at least one of non-commodity products and services and presenting a data file via a communication medium to a purchaser. The purchaser may include a customer, a third party acting on behalf of the customer and a supplier. The data file allows the purchaser to configure the products independent of a third party provided configuration tool by including manipulable parameters that enable configuration of non-commodity product or service. For example, the manipulable parameters may include upgrades, downgrades and swapping of components. Further, the data file is configured to be incorporated into a procurement system, the data file providing a catalog of configurable components.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram of a computer system in accordance with an embodiment of the invention.

FIG. 2 is a block diagram of a computer server network including a communication medium in accordance with an embodiment of the invention.

FIG. 3A is a block diagram of an automated order entry process in accordance with several embodiments of the invention.

FIG. 3B is a block diagram of an automated order entry process from a customer perspective in accordance with several embodiments of the invention

FIG. 4A is a block diagram of a catalog process of a manufacturer in accordance with an embodiment of the invention.

FIGS. 4A-1A through 4A-1E illustrates a single flow diagram illustrating catalog acknowledgment module 405 shown in FIG. 4A.

FIGS. 4A-2A through 4A-D is a single flow diagram illustrating status update module 406 shown in FIG. 4A.

FIG. 4B is a block diagram of a catalog process of a manufacturer including server applications in accordance with an embodiment of the invention.

FIG. 5 is a flow diagram of software modules for a catalog process showing a graphical user interface of a manufacturer in accordance with an embodiment of the invention.

FIG. 5-3 is a logic flow diagram for the software module “Catalog Maintenance” shown in FIG. 5.

FIG. 5-4 is a logic flow diagram for the software module “Customer Email Addresses” shown in FIG. 5.

FIG. 5-5 is a logic flow diagram for the software module “Catalog Transport” shown in FIG. 5.

FIGS. 5-6A through FIG. 5-6G are logic flow diagrams for the software modules “Quote List” and “Create Catalog” shown in FIG. 5.

FIGS. 5-6AA through FIG. 5-6AH-8 are logic flow diagrams for the software modules for creating reports via the graphical user interface in accordance with module 506 a shown in FIG. 5.

FIGS. 5-7A through FIG. 5-7C are logic flow diagrams for the software module “Quote Header Editor” shown in FIG. 5.

FIG. 5-8A through FIG. 5-8K are logic flow diagrams for the software module “Add Quote” shown in FIG. 5.

FIG. 5-9 is a logic flow diagram for the software module “Catalog file history” shown as module 509 in FIG. 5.

FIGS. 5-10A through FIG. 5-610B are logic flow diagrams for the software module “Catalog Compare” shown in FIG. 5.

FIGS. 5-11A through FIGS. 5-11G are logic flow diagrams for the software module “SKU Detail” and “Add Customer Solution” shown in FIG. 5

FIGS. 5-12 is a logic flow diagram for the software module “Quote Detail” shown in FIG. 5.

FIGS. 5-13 is a flow diagram for module “Quote Status” 513 shown in FIG. 5.

FIG. 5-15A through FIG. 5-15E are logic flow diagrams for the software modules “Quote Replace” and “Quote Copy” shown in FIG. 5.

FIG. 5-17A through FIG. 5-17C are logic flow diagrams for the software module “Catalog Extract” and the software module “Catalog Compare” shown in FIG. 5

FIG. 5-18 is a logic flow diagram for the software module “Legend Detail” shown in FIG. 5.

FIG. 5-19A and 5-19B are logic flow diagrams for the software module “Add Customer Kit” shown in FIG. 5.

FIG. 5-21 is a logic flow diagram for the software module “Delete Customer Kit” shown in FIG. 5.

FIG. 5-22A and 5-22B are logic flow diagrams for the software module “Delete Custom Solution” shown in FIG. 5.

FIG. 6 is a block diagram illustrating a method for a translation process in accordance with an embodiment of the present invention.

FIGS. 6A through 6BB are logic flow diagrams for a translation process in accordance with an embodiment of the invention.

FIGS. 7A and 7B show a block diagram of an inventory process.

FIG. 8 is block diagram for a graphical user interface showing software modules of an inventory process.

FIG. 9 is a logic flow diagram for a “Stocking Maintenance” software module shown in FIG. 8.

FIGS. 10, 10-1A, 10-1B, and 10-2 are logic flow diagrams for a “Quote List” software module shown in FIG. 8.

FIG. 10-3 is a logic flow diagram for the “Stocking Order Header” software module shown in FIG. 8.

FIGS. 10-4 and 10-5 represents a logic flow diagram for the “Stocking Order Detail List” software module shown in FIG. 8.

FIGS. 10-6A and 10-6B are logic flow diagrams for the “Stocking Order Detail Change” software module shown in FIG. 8.

FIG. 10-7 is a logic flow diagram for the “Stocking Order Inventory” software module shown in FIG. 8.

FIG. 10-8 is a logic flow diagram for the “Stocking Order Available Inventory” software module shown in FIG. 8.

FIGS. 11-11A through 11-11D show a logic flow diagram for a batch program “Stocking Order Router” shown in FIG. 7A.

FIG. 12 is a logic flow diagram of a batch program for providing a stocking order status update.

FIG. 13 is a block diagram illustrating a method in accordance with an inventory process in accordance with an embodiment of the invention.

FIG. 14 is a block diagram illustrating a method in accordance with an embodiment of the invention.

FIG. 14A, 14B, and 14C illustrate block diagrams of an order process in accordance with an embodiment of the invention.

FIG. 15A through 15S is a logic flow diagram for Order Processor 14A-15 shown in FIG. 14A.

FIG. 16 is a block diagram of a method for translating data between disparate platforms in accordance with an embodiment of the invention.

FIG. 17-1 through 17-24 a logic flow diagram for OMS server 1240 in accordance with an order process and method for translating data is shown.

FIG. 18A through 18H is a logic flow diagram of a batch program for providing order acknowledgments in accordance with an embodiment of the present invention.

FIGS. 19A through 19K show a logic flow diagram for a batch program for an automated order change process in accordance with an embodiment of the invention.

FIG. 20A through 20F is a logic flow diagram for a batch program for an automated order change/cancel acknowledgment.

FIGS. 21A through 21C is a logic flow diagram for a batch program for order tracking and asset tagging in accordance with an embodiment of the invention.

FIGS. 22A through 22F is a logic flow diagram for a server program for order tracking in accordance with an embodiment of the invention.

FIG. 23 is a logic flow diagram of a graphical user interface for an order process in accordance with an embodiment of the invention.

FIG. 23-3A through 23-3D represent a logic flow diagram for an Order Files module in FIG. 23.

FIG. 23-4A and 23-4B are logic flow diagrams illustrating the ShippingCharge module in FIG. 23.

FIG. 23-5A and 23-5B are logic flow diagrams illustrating the Email List module in FIG. 23.

FIG. 23-6A through 23-6C are logic flow diagrams illustrating the Advance Shipment Notice module in FIG. 23.

FIG. 23-7 is a logic flow diagram illustrating the Order Maintenance module in FIG. 23.

FIG. 23-8A through 23-8H are logic flow diagrams illustrating the Tax Exempt Customer module in FIG. 23.

FIG. 23-9A through 23-9E are logic flow diagrams illustrating the Manual Order Entry module in FIG. 23.

FIG. 23-10A and 23-10B are logic flow diagrams illustrating Order Summary module in FIG. 23.

FIG. 23-11A through 23-11J are logic flow diagrams illustrating the View Pending Order module in FIG. 23.

FIG. 23-12 is a logic flow diagram illustrating the Non-Working Day module in FIG. 23.

FIG. 23-13 is logic flow diagram illustrating the Order Transport in FIG. 23.

FIG. 23-15A and 23-15B are logic flow diagrams illustrating the Order Information module in FIG. 23.

FIG. 23-17A through 17C are logic flow diagrams illustrating the Order Detail Information module in FIG. 23.

FIG. 23-18 is a logic flow diagram illustrating the Order Change/Cancel Information module in FIG. 23.

FIG. 23-19A, 23-19B, 23-20, 23-21, 23-22, 23-23 and 23-24 are logic flow diagrams illustrating the Reports module in FIG. 23.

The use of the same reference symbols in different drawings indicates similar or identical items.

### DETAILED DESCRIPTION

In the following description, for the purposes of explanation, numerous specific details are set forth in order to provide a thorough understanding of the present invention. It will be apparent, however, to a person of ordinary skill in the art that the present invention may be practiced without these specific details. In other instances, well-known structures and devices are shown in block diagram form in order to avoid unnecessarily obscuring the present invention.

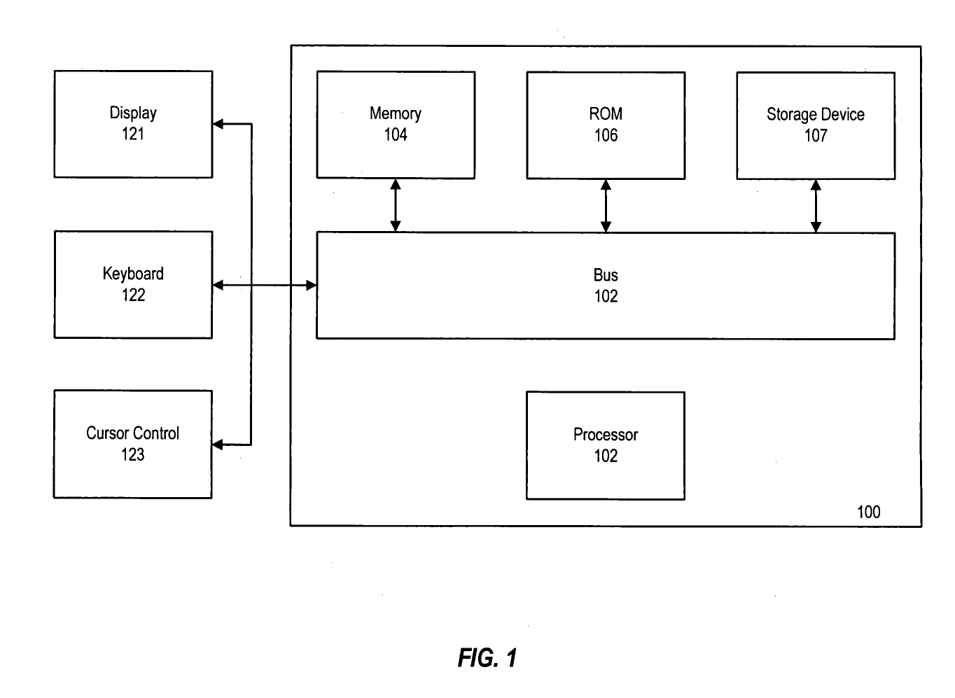

FIG. 1 illustrates a block diagram of a computer system 100 upon which an embodiment of the present invention may be implemented. Computer system 100 includes a bus 101 or other communication mechanism for communicating information, and a processor 102 coupled to bus 101 for processing information. Computer system 100 further comprises a memory dynamic storage 104 coupled to bus 101 for storing information and instructions to be executed by processor 102. Computer system 100 also includes a read only memory (ROM) and/or other static storage device 106 coupled to bus 101 for storing static information and instructions for processor 102. A data storage device 107, such as a magnetic disk or optical disk, is coupled to bus 101 for storing information and instructions.

Computer system 100 may also be coupled via bus 101 to a display device 121, such as a cathode ray tube (CRT), for displaying information to a computer user. Optionally, computer system 100 operates as a computer server or as a computer system coupled to a computer server. An input device 122, including alphanumeric and other keys, is typically coupled to bus 101 for communicating information and command selections to processor 102. Another type of user input device is cursor control 123, such as a mouse, a trackball, or cursor direction keys for communicating direction information and command selections to processor 102 and for controlling cursor movement on display 121.

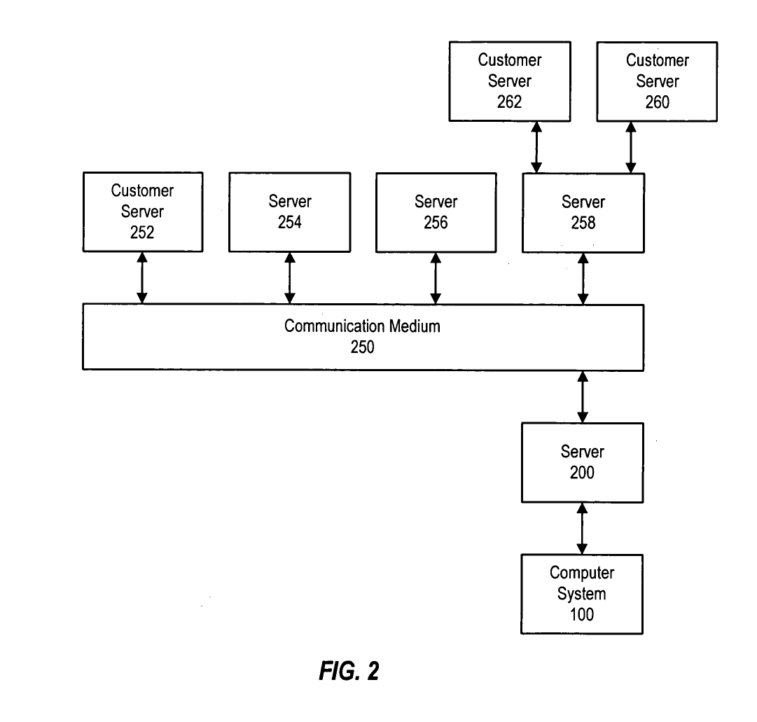

Referring now to FIG. 2, computer system 100 is shown coupled to communication medium 250, which may be a multi-point network, a point-to-point communications link, etc. any of type of circuit-style network link capable of transferring data. Communication medium 250 may be an X0.25 circuit, a physical type of line, such as a T1 or E1 line, or an electronic industry association (EIA) 232 (RS-232) serial line. In addition, communication medium 250 may utilize a fiber optic cable, twisted pair conductors, coaxial cable, or a wireless communication system, such as a microwave communication system. Coupled to communication medium 250 is database server 200, which, according to an embodiment of the present invention, provides data across communication medium 250 to a plurality of servers, shown as servers 252, 254, 256 and 258. In an embodiment of the invention, servers 252, 254, 256 and 258 each represent servers of a customer or a third party in communication with customers via communication medium 250. For example, server 258 is shown further coupled to customer server 260 and customer server 262.

Overview

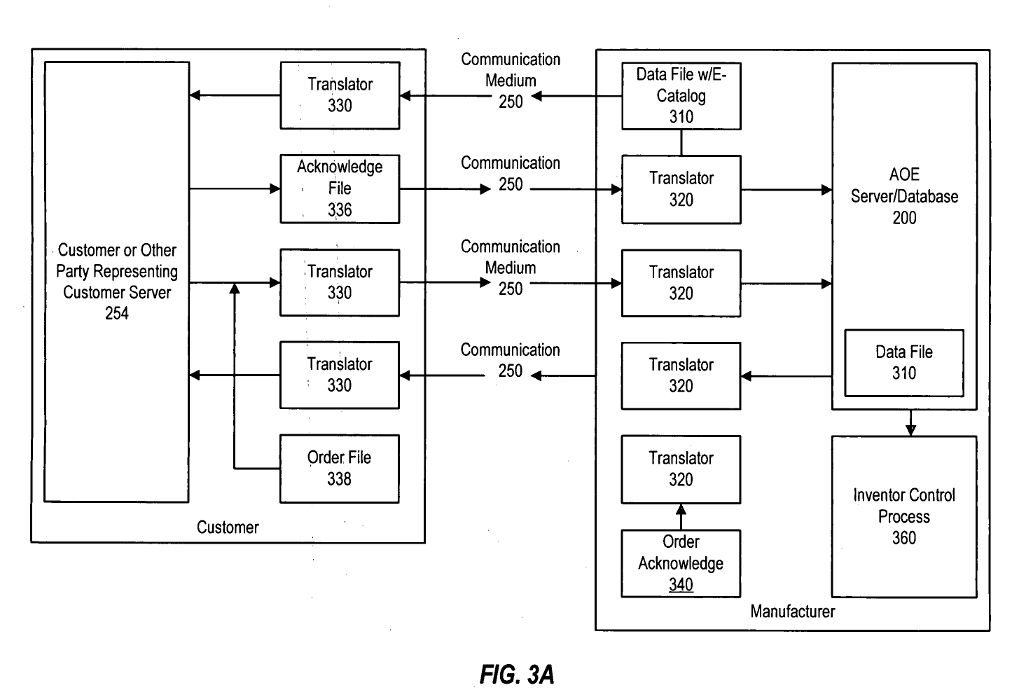

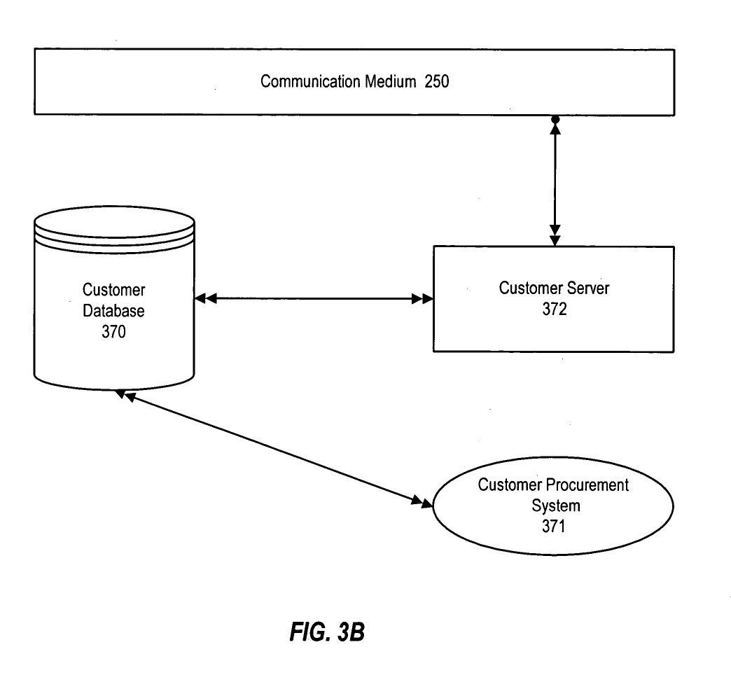

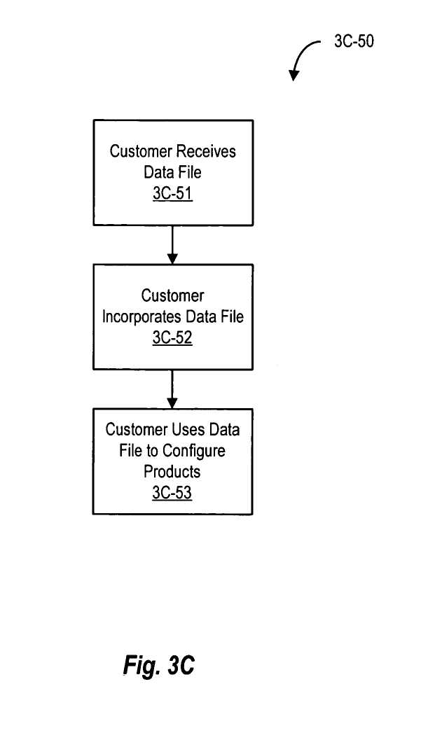

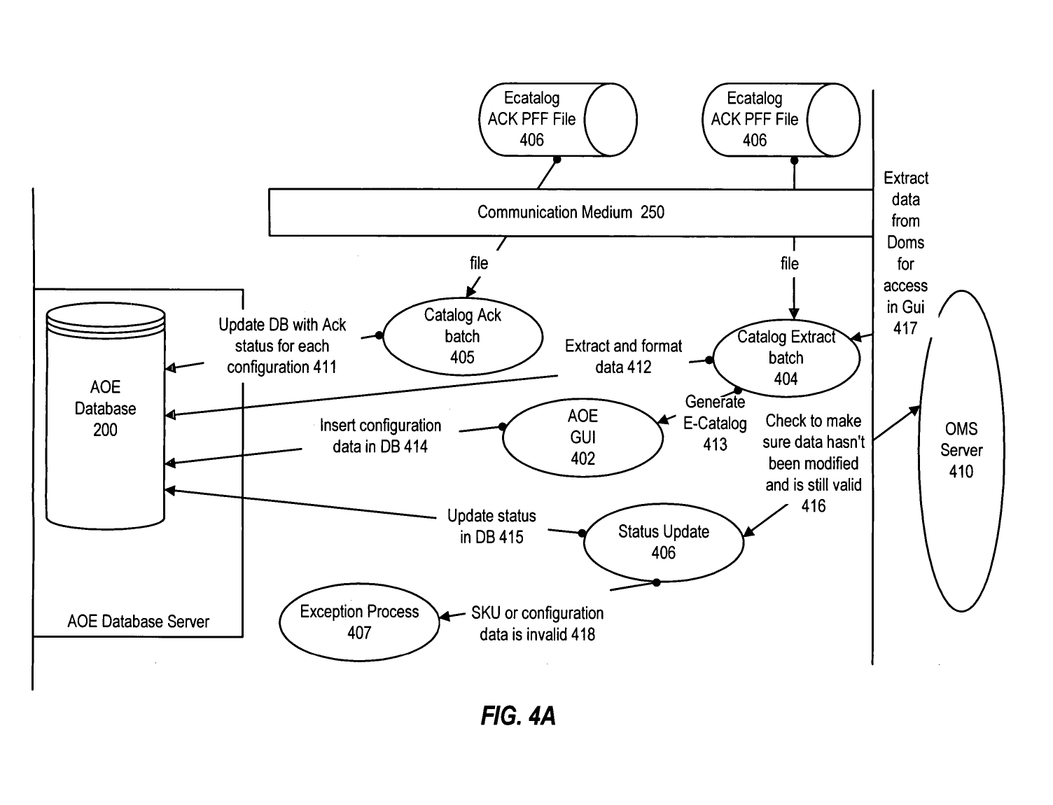

The present invention is related to the use of computer systems and servers to facilitate and automate a manufacturing process, the process, hereinafter referred to as an Automated Order Entry (AoE) process, is outlined in FIG. 3. Referring to FIG. 3, the manufacturing process is shown including communication with customers via the communication medium 250 and server 200. The AoE process first includes creation of a data file 310 for transport via the communication medium 250. The data file 310 includes an electronic catalog suited for one or more customers. The catalog allows customers to host the data and configure both commodity and non-commodity products and services, as explained in further detail below. Hereinafter, the term “customer” or “customer hosted” includes third parties acting on behalf of a customer, supplier or manufacturer and hosting on behalf of the customer, supplier or manufacturer.

FIG. 3A shows a data file 310 including an electronic catalog transmitted from server 200 to a customer server 254. The data file is in a structured data format which is one of a proprietary format, EDI (Electronic Data Interchange) format, an SGML (Structured General Markup Language), such as XML (eXtensible Markup Language) or HTML (HyperText Markup Language), or another format familiar to persons of ordinary skill in the art. Data file 310 is in an industry supported communication protocol. For example, the data optionally may be configured to be transferred via a “value added network type protocol,” or be configured for a direct connection with a customer via a T1 line, such as a direct “pipe” line, or be configured for a TCP/IP protocol. The data file 310 is optionally first translated in translator 320 to an industry standard format, such as Electronic Data Interchange (EDI), or, if not translated, transmitted in a proprietary format to customer server 254. The customer server receives data file 310 and acknowledges each configurable component in the data file 310 using acknowledgement file 336.

The AoE process continues on the customer server 254, wherein the data file enables the customer to host data file 310 and create orders, including internal purchase orders and files for transport to the manufacturer server 200. The customer transmits the order file 338 via communication medium 250 to manufacturer server 200. The order file 338 is optionally translated via translator 330 to an industry standard format prior to transmitting the order file 338 via the communication medium 250. The manufacturer receives either a proprietary file format or an industry standard format order file 338. If the order file 338 is in an industry standard format, the order file is first translated in translator 320. The manufacturer acknowledges the order file 338, process the order file 338, thereby validating the order via order acknowledgement file 340. Acknowledgement file 340 is transmitted via communication medium 250 to customer server 254, and is optionally translated into an industry standard format in translator 320, and translated into a proprietary file format by the customer in translator 330.

The AoE process further includes an inventory control process by which appropriate data feeds inventory control process 360. In one embodiment, the catalog acknowledgement file 336, indicates whether the data file including the electronic catalog 310 was ‘accepted’ by the customer. If accepted, the data file 310 is made available by AoE server 200 within the AoE process to the inventory control process 360 to ensure appropriate inventory levels for products included in the electronic catalog that fall within a predetermined category of products. In another embodiment, the acknowledgement file 336 is not required to begin the inventory control process. For example, customers that lack the capability to send acknowledgment files. Such customers optionally may acknowledge and verify data files by other methods, such as a telephone call. Accordingly, in another embodiment, the inventory control process begins upon creation of the catalog or at other appropriate junctions within the manufacturing process. For example, certain catalogs include products that can be “bundled” as pre-built components, and other catalogs include products that are non-commodity type configurable products. Yet other catalogs include a mixture of both types of products. Each of these types of catalogs may be made available to the inventory control process.

Catalog Process

According to one embodiment, the invention provides an automated electronic catalog and catalog process in a structured data format. As shown in FIG. 3A, the invention includes providing data file 310 via the communication medium 250 to a customer's server 252.

Referring now to FIG. 3B an example of customer database 400 is shown, including procurement system 420, coupled to server 430. Customer server 430 is shown coupled to communication medium 250. The customer's server 430 receives the data file 310, which optionally includes data, application data, and business rules. In one embodiment, data file 310 includes software or code for programming a software system to accommodate the data within the data file 310. Data file 310, in one embodiment, includes catalog data and business rules for manipulating the catalog data. In an exemplary embodiment, the business rules are in a structured data format and provide rules for manipulating the data include functional rules as well as configuration rules for integrating the catalog data into a procurement system or other system.

After a customer receives the data file 310, the customer uploads or imports the data into a procurement system 440. In one embodiment, the procurement system 440 includes a database running procurement system software. In another embodiment, customer runs asset management software in lieu of a procurement system. The structured data format in one embodiment provides an outer layer to the procurement system software 440.

According to one embodiment, the structured data includes catalog data that allows a user of the customer server 430 to configure and price configurations of products. Such products optionally include configurable computer systems, prebuilt or “bundled” computer systems, and non-commodity (i.e. custom) products such as services. The data includes manipulable parameters that contribute to the configuration of a product or service. For example, a computer system can be configured using the data by providing parameters allowing upgrades and downgrades of computer components. A hard drive can be upgraded, a monitor can be downgraded, and additional computer components can be added. According to one embodiment, the data provides safeguards to ensure valid configurations of non-commodity products. For example, the data permits swapping of components, allowing a customer to choose one swap for each component. Non-commodity products can be configured to be included with a product.

For example, according to an embodiment, a customer receives the structured data file and any associated software program from a manufacturer or a party associated with a manufacturer or provider of products. The customer optionally receives data specifically designed for the customer with pricing of configurable components according to predetermined contractual agreements. The customer incorporates the data file into an existing procurement system using the data application and/or the structured data file with associated rules.

The data file is a catalog of configurable products, services and commodity products. The data file further includes factory-installed components, hereinafter referred to as a “legend.” The data file also includes non-factory-installed componenets, hereinafter referred to as “customer kits;” and subsystem configurations within a system configuration hereinafter referred to as a “solution.” For each component, whether factory installed, non-factory installed or customer kit, or solution, the data includes the associated Stock Keeping Units (SKUs), including a third parties or a manufacturer generated SKUs and pricing.

Upon receiving the data file, the customer acknowledges receipt of the data file, and acknowledges each parameter of the configurable products included in the catalog. The acknowledgment procedure ensures proper pricing and SKU numbers and the like. The data file includes parameters providing dates for which other parameters, such as pricing, are valid. Accordingly, for customers having a relationship with a manufacturer or other party representing a manufacturer, the parameters may be updated at regular intervals. Moreover, because the structured data file provides for acknowledgment of individual configurable parameters, updates are optionally provided only for the individual configurable parameters.

According to one embodiment, customers receive an “action code” that indicates the actions to take for each configuration within the catalog data file. An example of an action code includes three codes. In the example, the first action code is “A,” which stands for an “Add” of a product. The second action code is a “D,” which stands for a “discontinue” of a product. The third action code is an “R,” which stands for a “replace” of a product. In the embodiment, an A and/or a D is used for a product transition catalog, and an R is used for a price refresh catalog.

A product transition would use an “A” to denote a new product using the effective date provided in the catalog. The “D” is used to denote that a product needs to be discontinued and when it needs to be discontinued. For example, if a manufacturer or supplier adds a product with an effective date as of Monday, and a discontinues a second configuration and has a discontinue date is as of two weeks later, the catalog data file allows customers to make a product requisition for both products before the discontinue date. Further, customers can self-determine if orders already placed will trigger a rejection of the order due to a discontinue. Customers with advance notice can therefore take corrective action to change the order, if necessary, place a rush on the discontinued products, or other appropriate corrective action.

According to an embodiment, an “R” is used for the price refresh of products and configurations. For example, when the configurations are the same from one time period to the next but the price has changed. Another instance for which a replace action is appropriate occurs if a different code or SKU applies to a configuration component or product.

The R triggers certain configurations that will be replaced. This allows a customer to automatically, by software or other appropriate method, determine which configurations will require refresh/replacement in their own system, allowing them to update their orders in a customer procurement system prior to delivery without manual interaction. Customers therefore benefit from cost reductions without re-ordering.

Additionally, each catalog received by a customer includes effective dates for commodity and non-commodity products. Therefore, a system can be automatically triggered to respond to an effective date that can be different for each configuration within the catalog. The data therefore enables the customers system to automatically respond to the effective dates and take appropriate measures to order within those dates. According to one embodiment, the customer system including the data file uses the effective dates to trigger automatic display of products within their procurement systems.

Also within the catalog file, for each configuration and component, the data file provides the relationship of each component to each other and other components. The type of relationships for each component includes a core component which is hereinafter referred to as a “configuration” component, a optional component, a parent component, a child component, or an orphan component. The data includes starting points and options that can be tacked on to as an add or an upgrade or a downgrade of a component, which is referred to as a swap out of the original component.

For example a monitor can be a part of an original configuration “starting point” An upgrade of the monitor to a larger monitor would be denoted as an upgrade from the starting point configuration, thereby swapping out the original monitor with a different monitor.

The core configuration includes commodity and non-commodity default services, customer specific integration components such as customer specific software and menus, images, customer asset tag labels, security cables, and the like. The core configuration optionally includes one to three year service plans for the configuration. The core configuration furthermore includes a chassis, a processor, a memory module, keyboard, monitor, hard drive, OS, mouse.

Additionally, a customer specific catalog includes non-commodity optional components that are pre-chosen according to business rules for that customer, contractual agreements as to which configurations are agreed to prior to generating the catalog. For example, customer corporate standards for purchasing a computer may be predefined to include a limited set of configurations. The catalog would follow those standards by including only those configurations in the limited set. Optionally, a customer can request a catalog that is an omnibus catalog, including every component for each configuration.

Furthermore, the catalog data provides the ability for a customer to create a table of components that demonstrates the relationships between and among the components. All the possible components are defined.

By following the business rules given in the data file, the customer has the ability to configure a product without requiring a “validator” or “configurator” which is typically provided by a third party. For example, FORD provides customers with the ability to configure a new car with options but only by enlisting the use of a third party configurator software package. This creates inefficiencies and extra expense overcome by embodiments of the present invention.

Referring now to FIG. 3D, a method 3D-50 in accordance with an embodiment is shown in a block diagram. The method begins with block 3D-51 with a customer receiving a data file. The data file optionally includes application data and structured data. Block 3D-52 continues the method with a customer incorporating the electronic data file into procurement system 440. Block 3D-53 continues the method with the customer using the data file to configure products, optionally including non-commodity products such as services and the like. For example, the configurable products include products like computer systems and related components, wherein the data file is a catalog of components that allow the customer to host the catalog and configure products. The customer's ability to host the catalog and configure products enables the customer's procurement system to generate purchase orders that use the same data as that used by the manufacturer or the party representing one or more manufacturers. Thus, according to an embodiment of the invention, the data file provides codes to be shared by the procurement system of the customer as well as the manufacturer or a third party invoicing system.

According to one embodiment, the structured data is specifically designed on a customer by customer basis. Accordingly, configuration data, including pricing and parameter configurations are predetermined according to business relationships with a given customer.

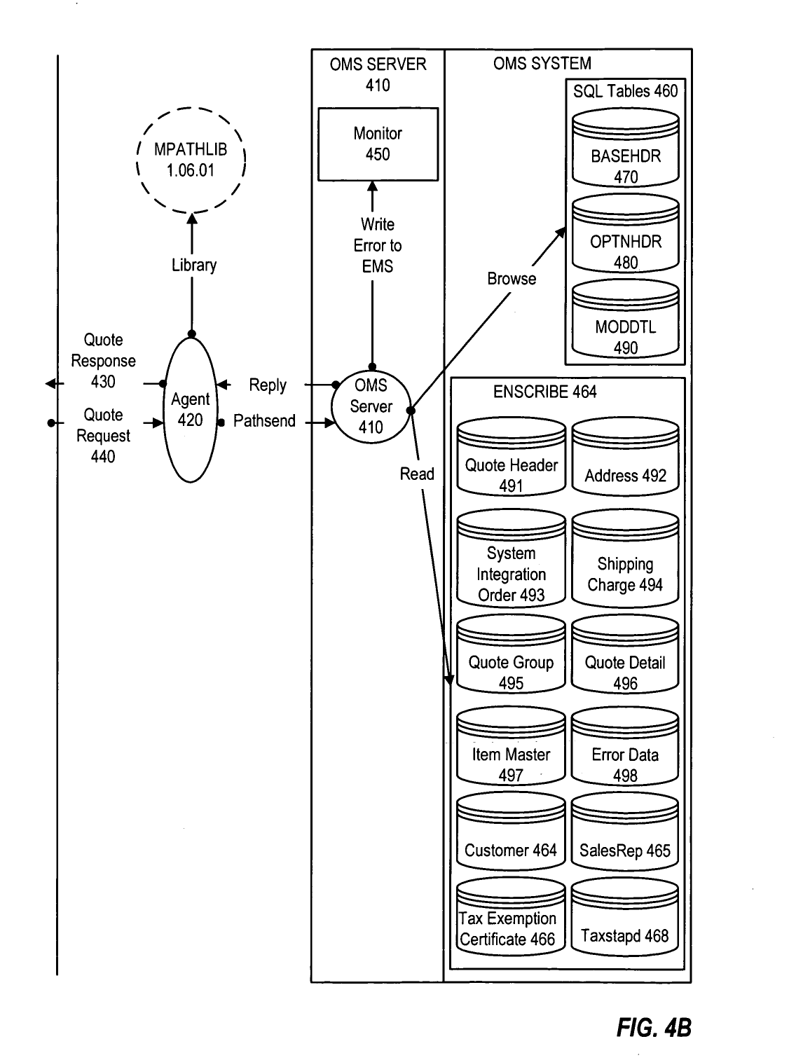

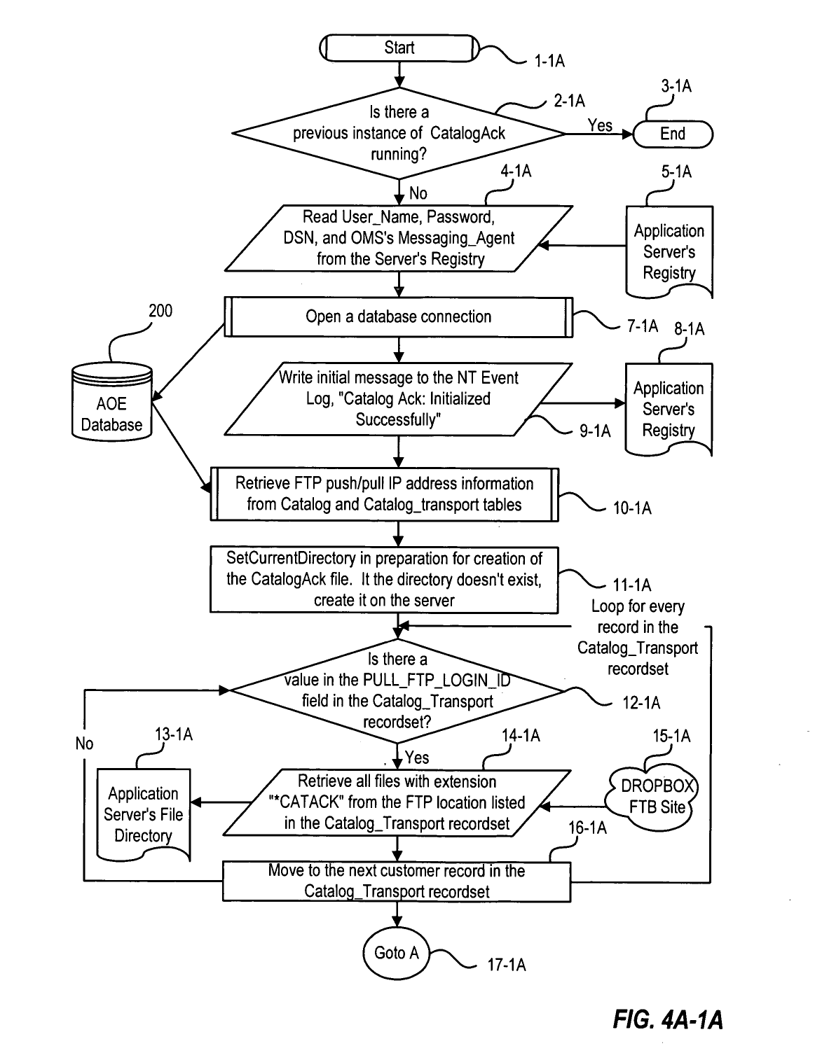

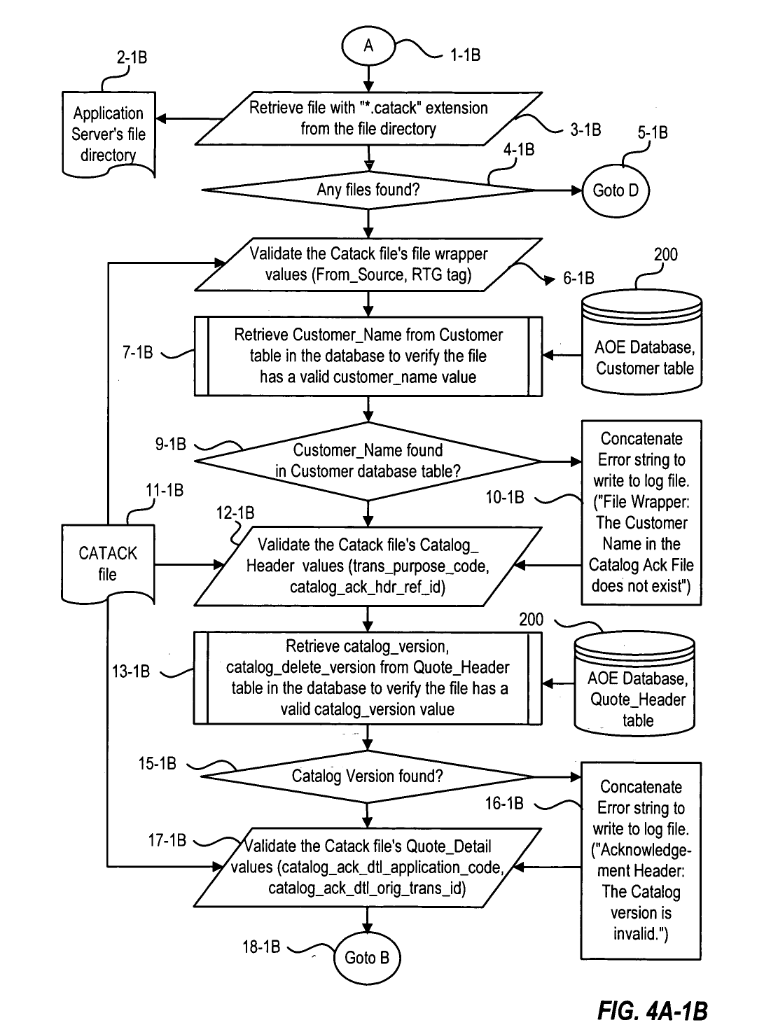

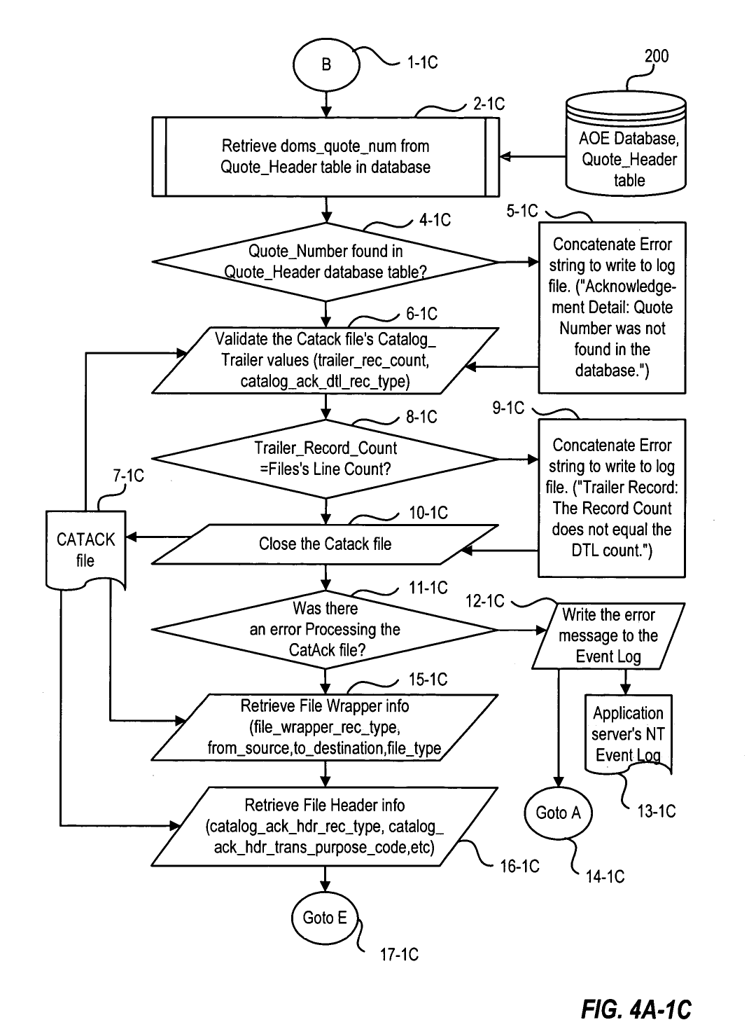

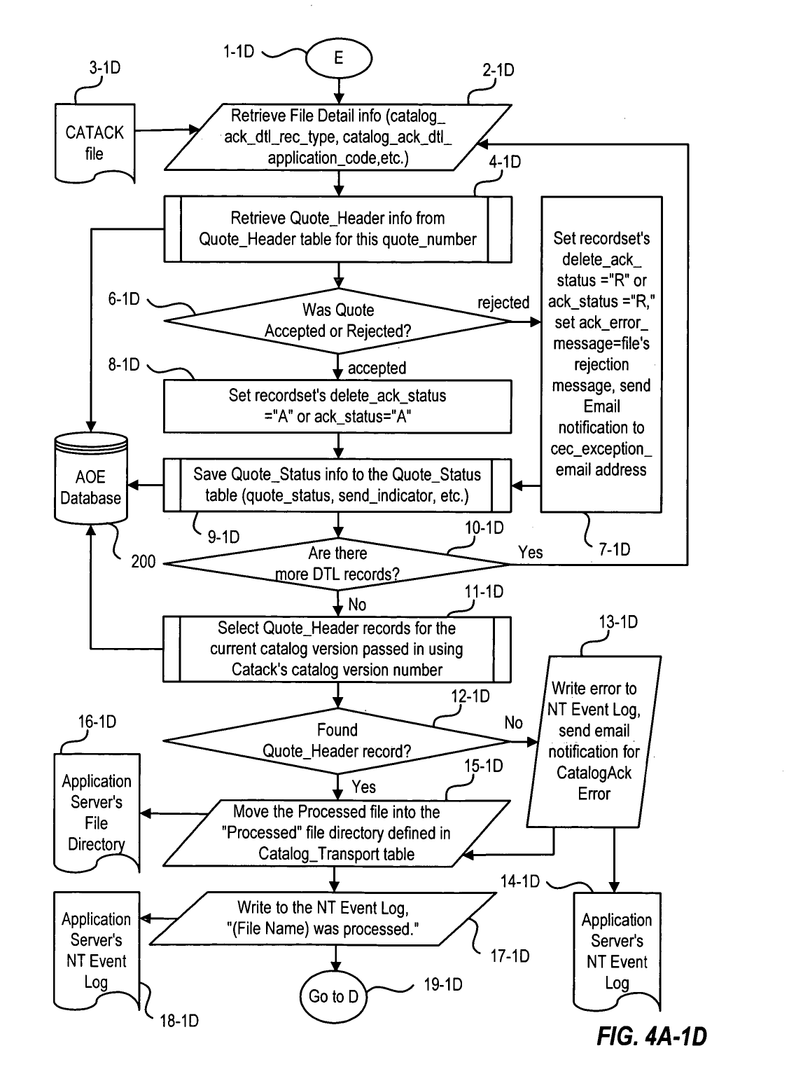

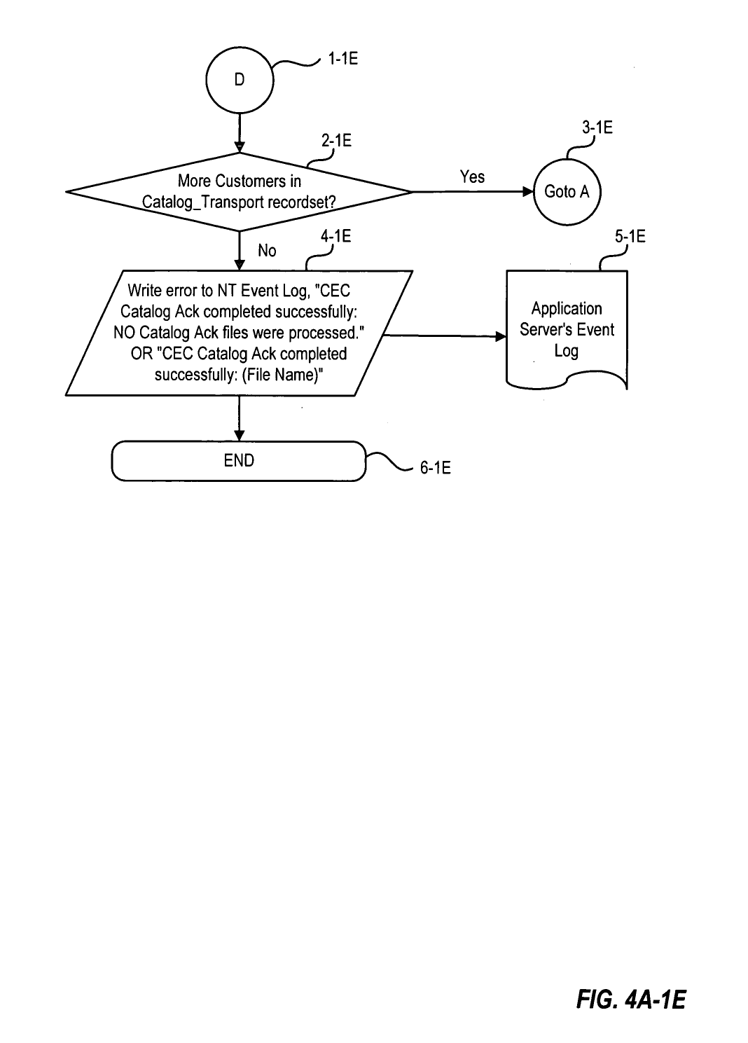

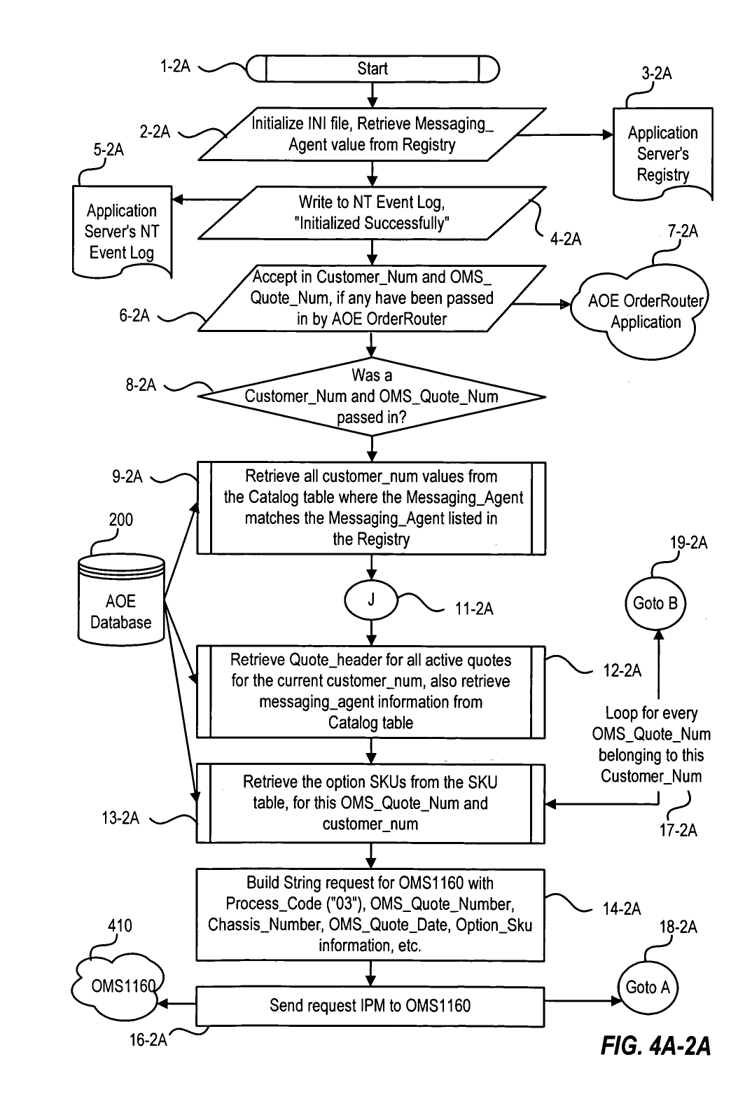

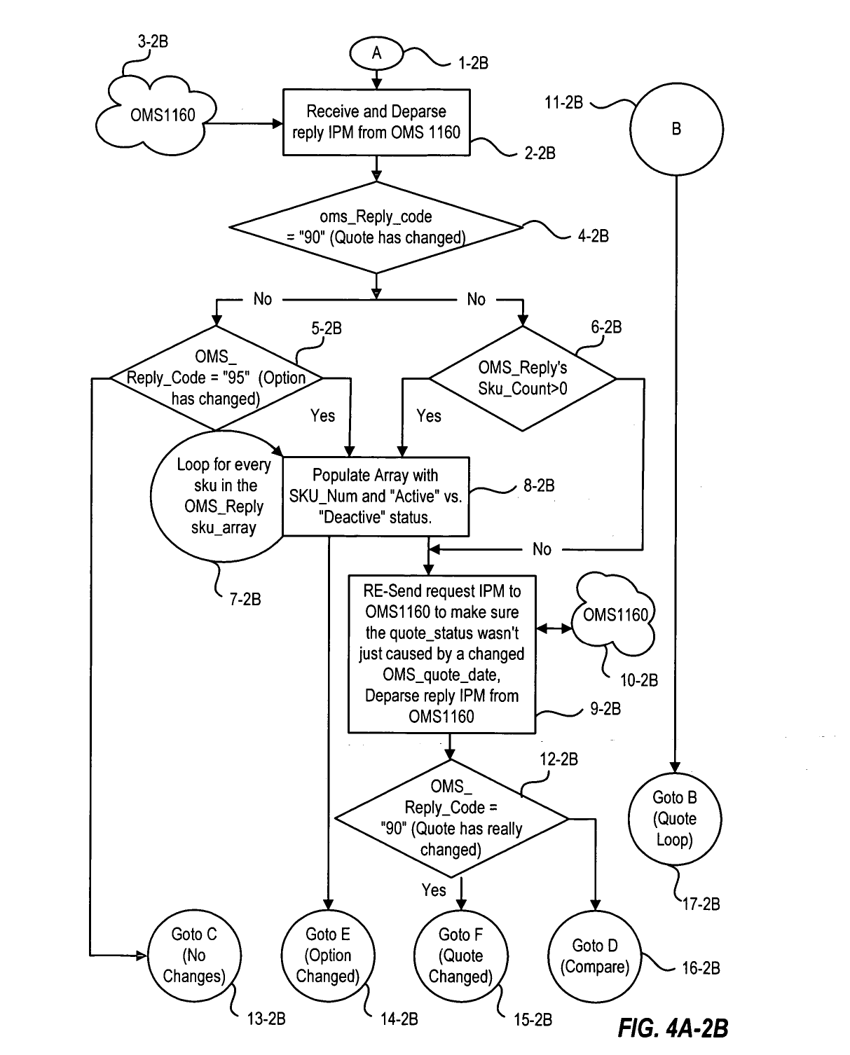

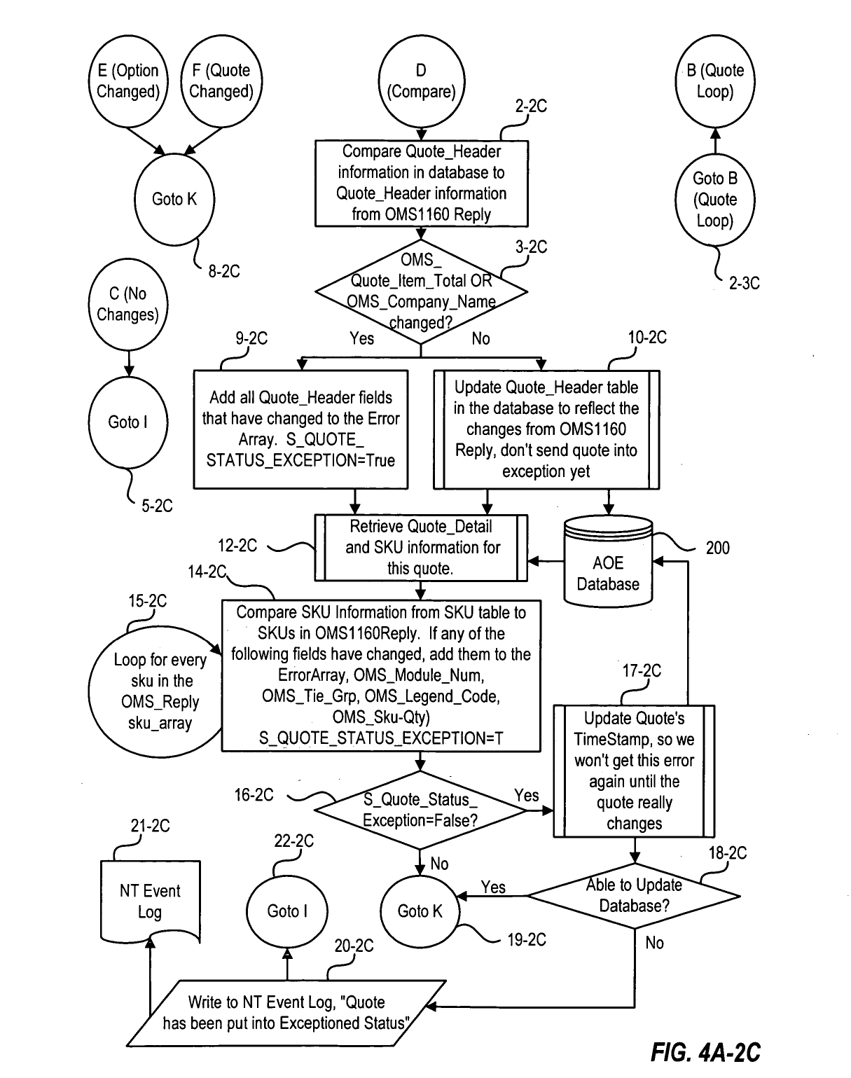

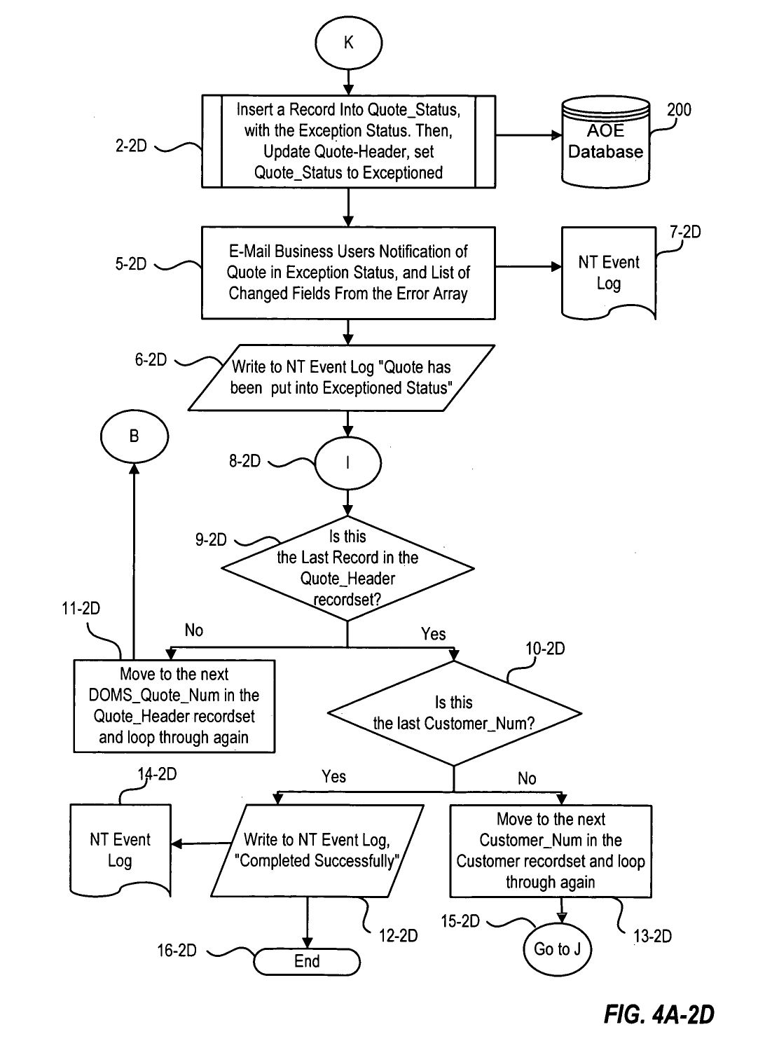

Referring to FIGS. 4A and 4B, an overview of a catalog process from the manufacturer perspective is represented in block diagram form. The process begins with a computer user accessing a software application program for the AoE process using a graphical user interface (GUI) 402. The AoE GUI 402 enables the user to prepare a catalog for export to a customer in an efficient manner. However, one of ordinary skill in the art appreciates that a GUI is only one implementation of a software application for preparing a catalog. The AoE GUI or other client application allows a user to access other databases to extract configuration information and insert the extracted data into a dedicated AoE database 200. For example, in one embodiment, AoE GUI 402 allows an application to extract data from an Order Management System (OMS) server 410 via process 417. The application then inserts the configuration data into AoE database 200 via process 414. The AoE GUI allows the computer user, once the data is extracted, to modify the data by adding the additional factory-installed component, customer kit components, solutions, necessary to complete the catalog. Then, in process 412, allows a user to extract and format the data stored in AoE database 200 into a catalog extract batch file 404. Process 413 provides that the user generate the catalog and provide the catalog data extracted to the user via the AoE GUI 402. In creating the catalog, the data includes packaged components that in advance prevent a customer from incompatible components or products that can't be manufactured. For example, a chassis with a limited number of slots for memory can never be configured to hold more than physically possible.

FIG. 4A provides other processes related to the catalog process beyond preparation of the catalog. For example, after the catalog is created and before the application sends the data file 310 including the catalog to a customer, the application checks all components in the configuration data for accuracy in step 406 and updates the status in AoE database 200 in step 415. Accordingly, the application accesses the OMS server 410 via step 416 to verify that data has not changed once sent out in a catalog to a customer, is still valid and updates the status in the AoE database 200 in step 415. An exception process 407 applies if SKU or configuration data is invalid 418.

Other processes shown in FIG. 4A include a catalog acknowledgment batch file 405, which runs after a customer acknowledges a catalog sent by the manufacturer by the acceptance or non-acceptance of each configuration or component sent in the catalog, both commodity and non-commodity. A customer forwards the data in a file 406 and transmits the data via communication medium 250. The data is in a predefined format, such as a proprietary file format (PFF), an EDI format or a web-based format such as XML. If the customer has accepted the configuration data within a catalog file, then batch program 405 automatically updates the quote status to “ACCEPTED”. If the configuration or component has NOT been accepted, then this program will update the status to “REJECTED”. According to one embodiment, a computer user is notified if a configuration or component is put into a “REJECTED” status by an electronic email message. According to an embodiment, each rejected configuration is accompanied by an error message identifying the error and explaining the reason for the rejection. A computer user receiving the error message will act accordingly to take corrective action. Further, according to an embodiment, the batch program 405 is scheduled to run on a regular basis, for example, a typical basis includes seven days a week, twice a day.

The catalog acknowledgement batch program is shown more specifically in FIGS. 4A-1A, 4A-1B, 4A-1C, 4A-1D, and 4A-1E. The batch program 405 includes steps 1-1A through step 6-1E. In one embodiment, the flow logic included in the steps is implemented in an NT batch program and written in Visual Basic. Alternatively, the batch program could be written in a C or C++ program. The batch program updates AoE database 200 with the status of a previously sent catalog.

Referring to FIG. 4A-IA, the catalog batch program 405 operates to open a database connection with the AoE database 200 in steps 7-1A and 7-1A, and retrieves information from an FTP transport medium in step 10-1A, and 14-1A, which optionally is another type of transport medium, such as TCP/IP or other appropriate medium. More particularly, referring to steps 12-1A through 16-1A, a retrieval is accomplished with a loop that retrieves each file with an appropriate extension identifying the file as a catalog acknowledgement file. This loop retrieves any acknowledgments received from one or more customers.

Referring to FIG. 4A-1B, the steps shown include validation steps 6-1B through 18-1B, which validate the catalog acknowledgment files, including customer name, and whether a catalog version is valid. FIG. 4A-1C shows steps that further include validation of the catalog acknowledgement file, including step 6-1C, which validates the total number of records in the file using the trailer record.

FIG. 4A-1D illustrates the retrieval of data from within a catalog acknowledgment file 3-1D, including checking whether configurations within a prior catalog sent to a customer were accepted or rejected in step 6-1D. FIG. 4A-1E illustrates the logging of results from the flow logic steps, ending with step 6-1E after writing events in step 4-1E.

Referring back to FIG. 4A, status update 406 further includes a batch program depicted in flow logic diagrams FIG. 4A-2A, FIG. 4A-2B, FIG. 4A-2C, and 4A-2D. The status update batch program is optionally an NT batch program written in Visual Basic, or in C, such as C++ and runs when a predetermined schedule dictates. The batch status update program 406 ensures that quote header and detail data stored in the AoE database 200 matches data stored in a second database, such as OMS server 410. The flow logic diagrams shown in the FIGS. 4A-2A through 4A-2D include retrieving customer values from the AoE database 200, active configurations for the customer, including option SKUs for configurable data in step 12-2A, and building a string in step 14-2A. The batch program 406 then receives a reply from the OMS server 410 in step 2-2B, and the data is deparse. If the data in the OMS server does not match, a reply code “90 ” indicates that the configuration sent to a customer has changed in step 4-2B. Similarly, if an option for a configurable product changed in the OMS server, a different reply code “95 ” is received. FIG. 4A-2C provides multiple paths within the batch program 406 for different events. For example, SKU information is compared with a SKU table to SKUs in the OMS server to detect changes in step 14-2C. If changes are detected in the OMS server 410, the updates are made to the AoE database 200 if the updates relate to header data. If the updates relate to configuration data, the process produces an “exception status” for the configuration. If updates are not possible in step 18-2C, an event log is written in step 20-2C. Conversely, events completed are also written in step 12-2D.

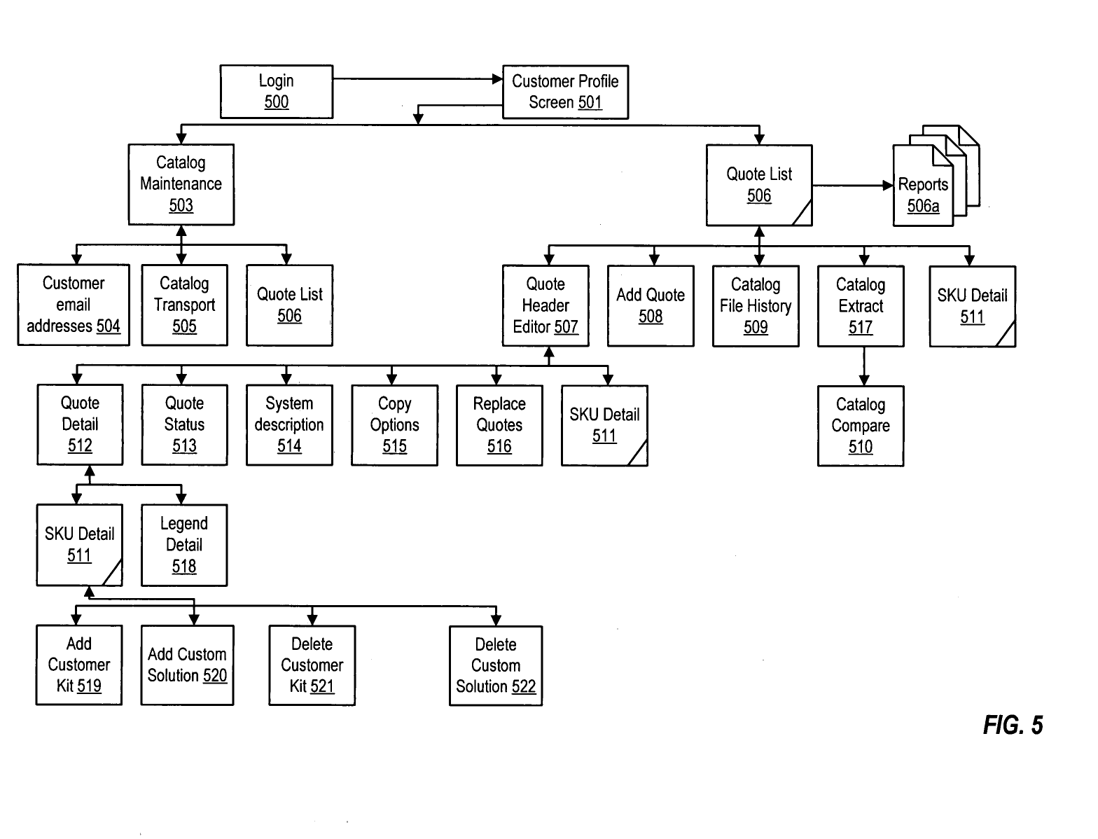

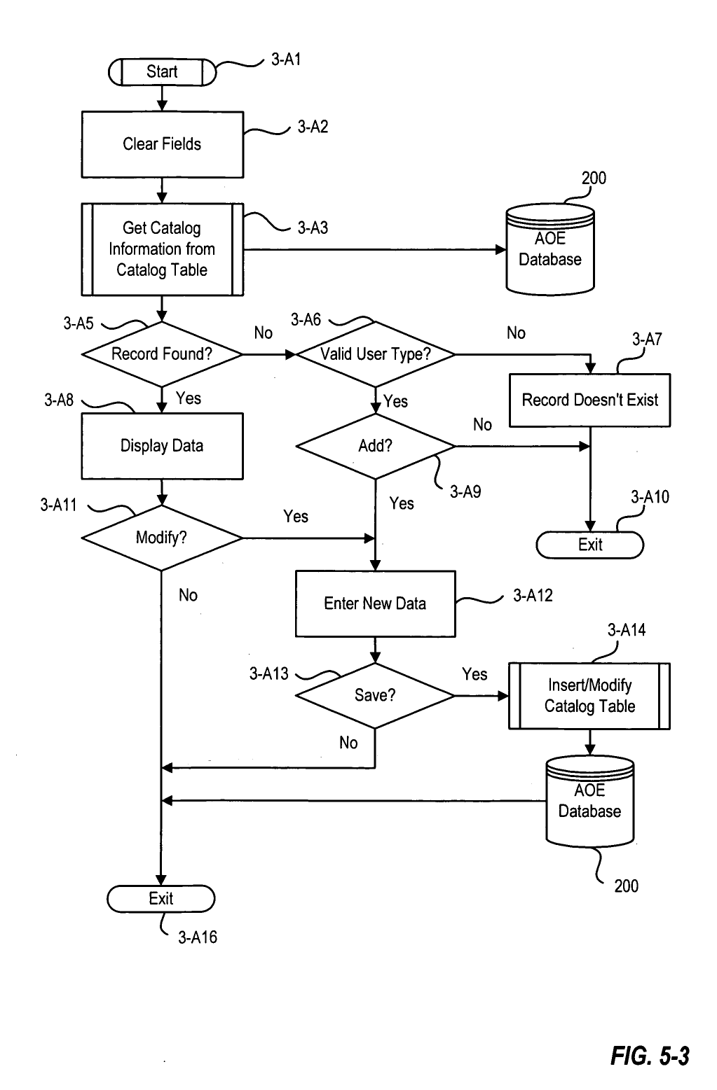

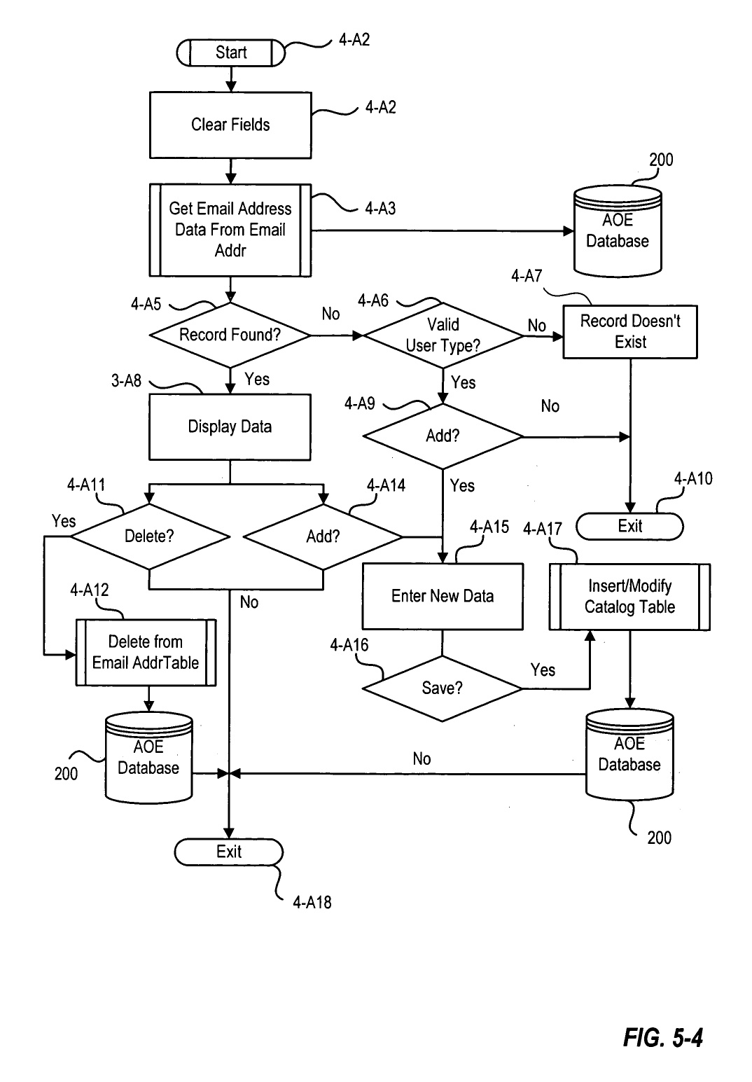

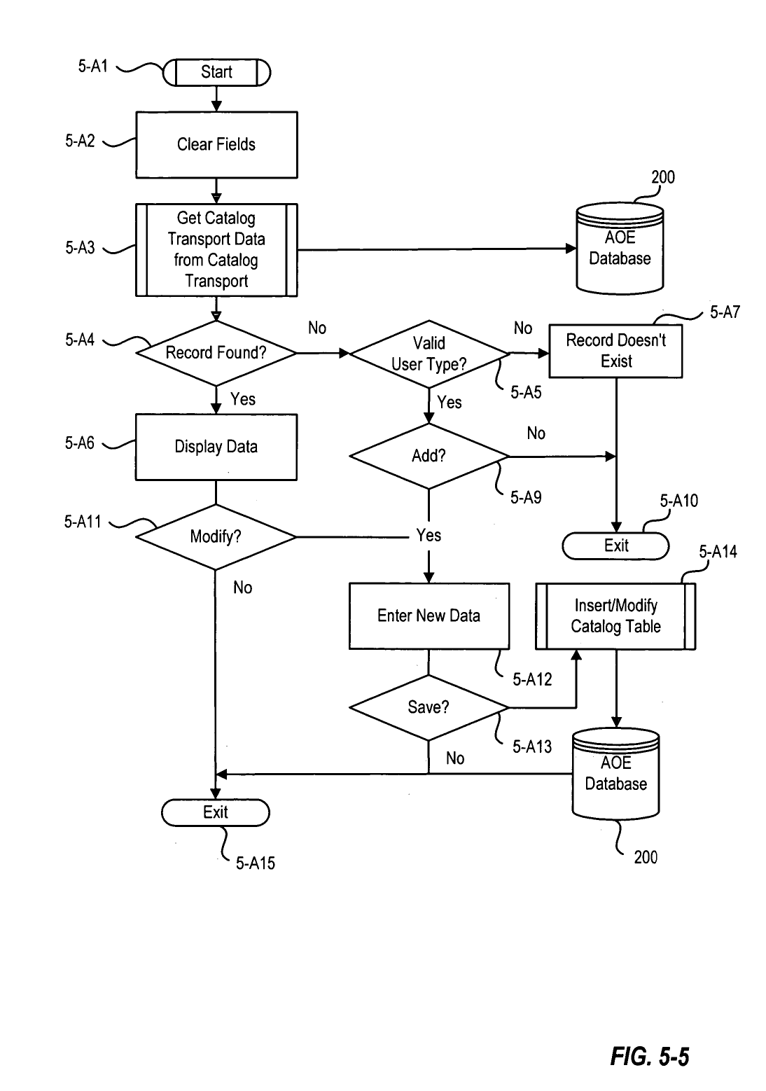

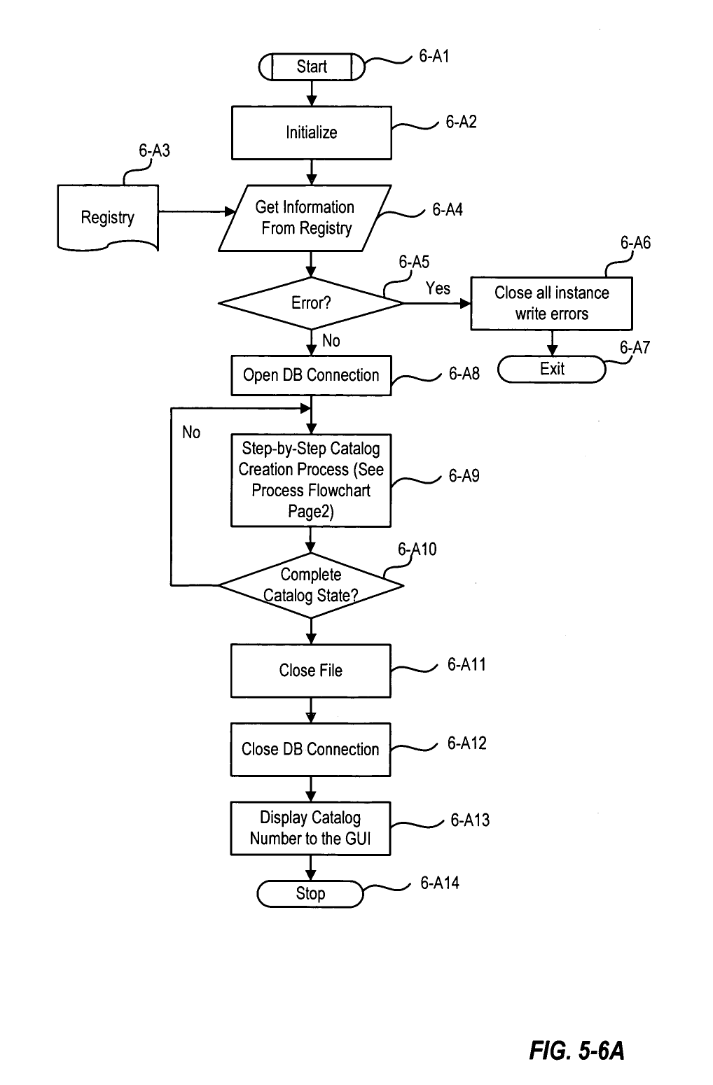

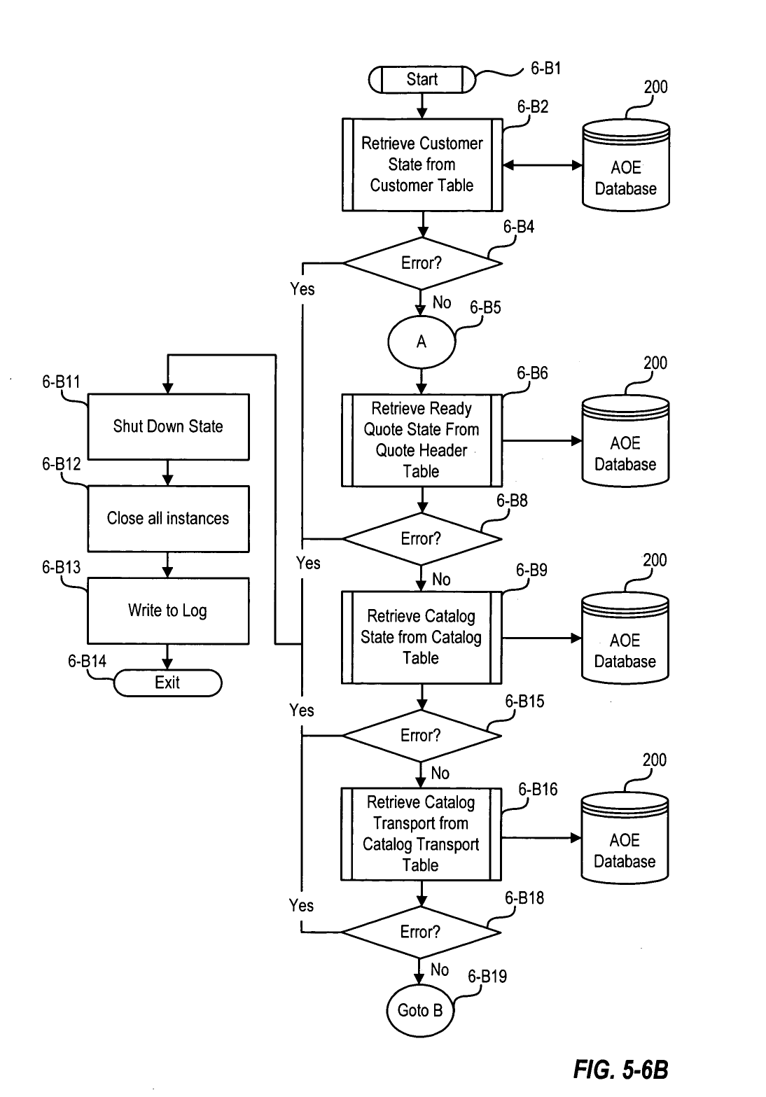

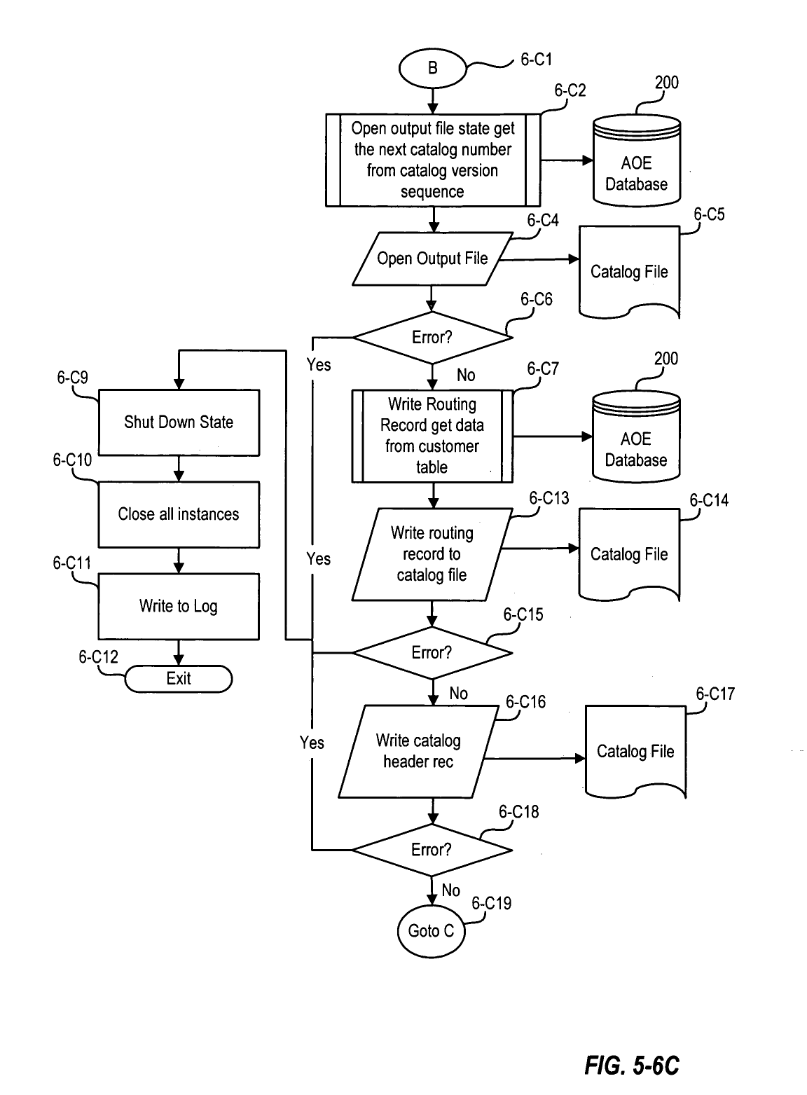

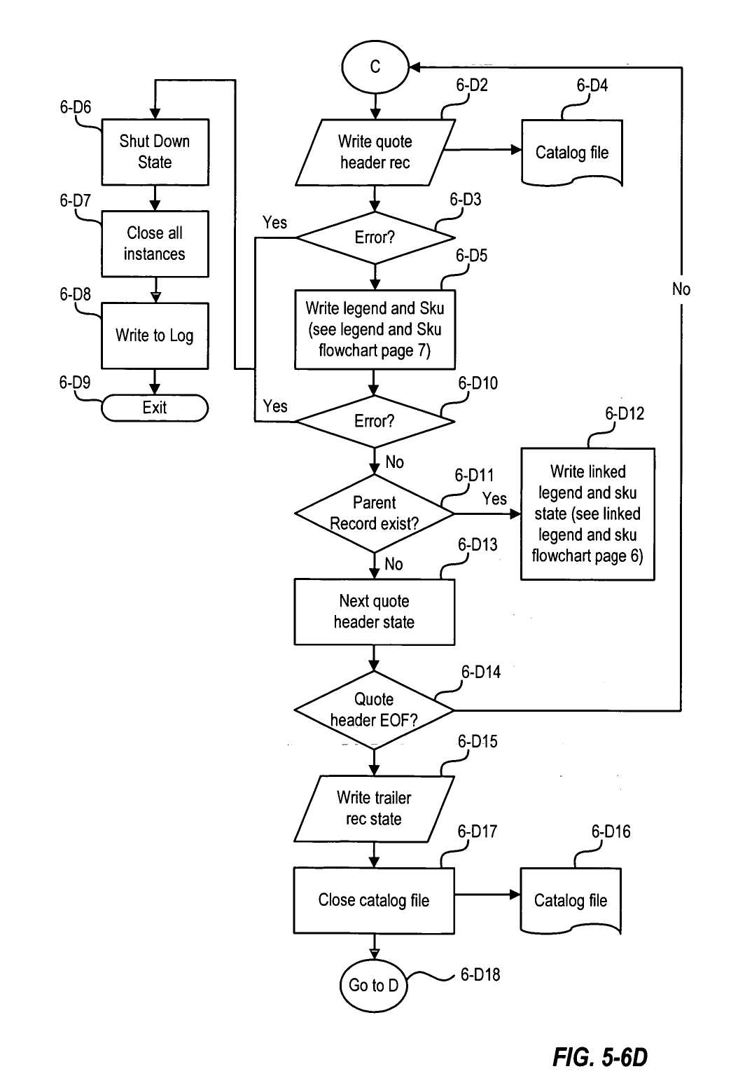

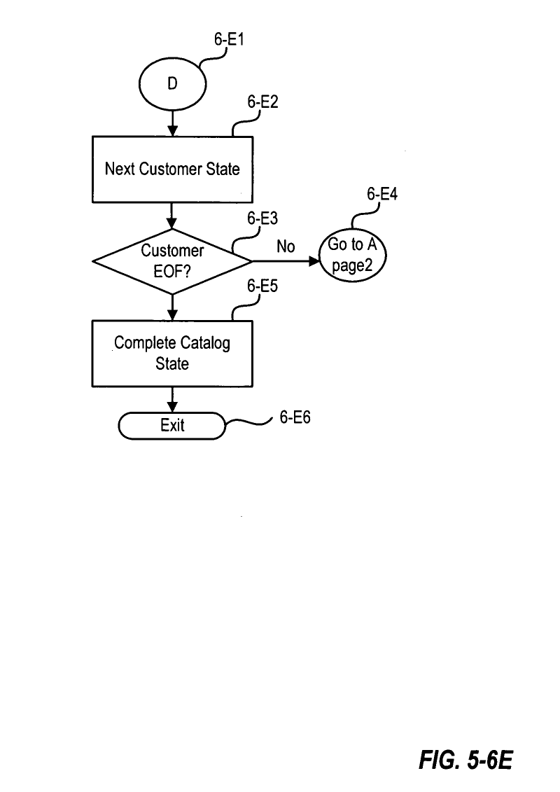

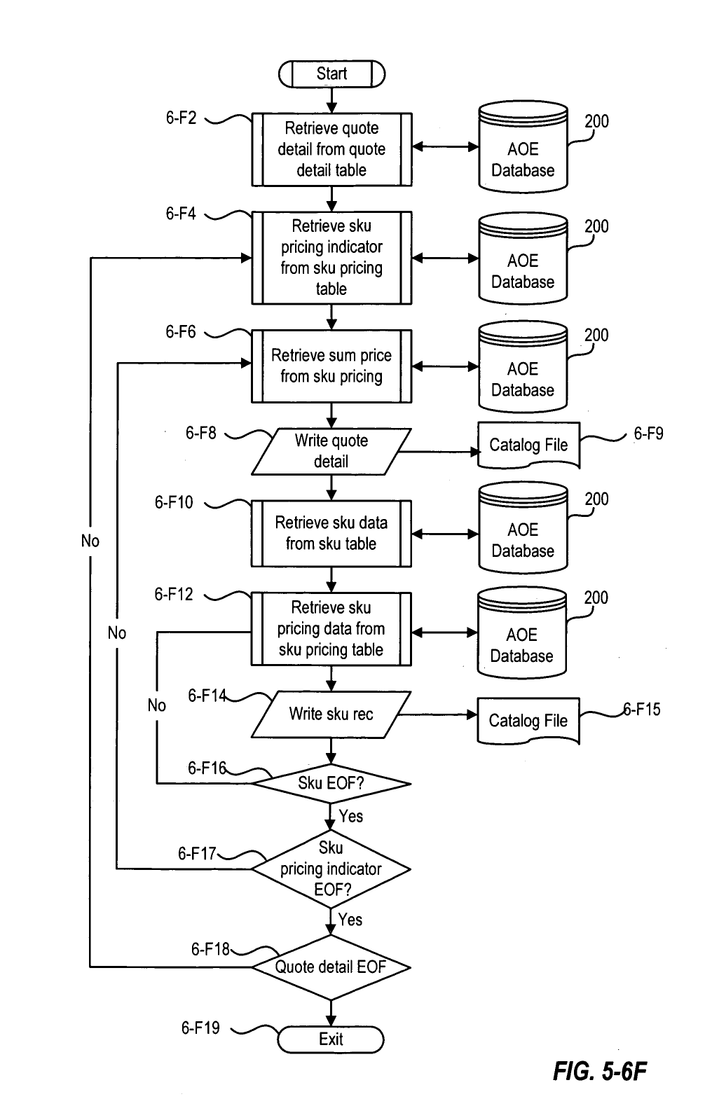

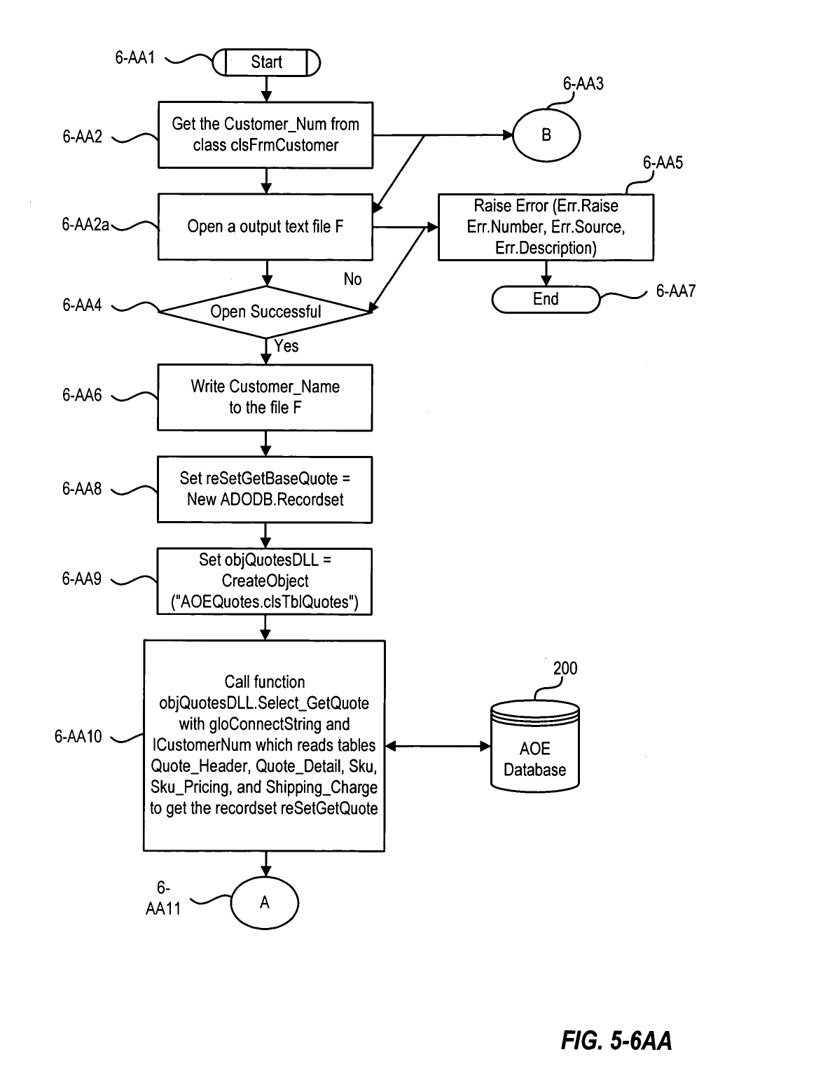

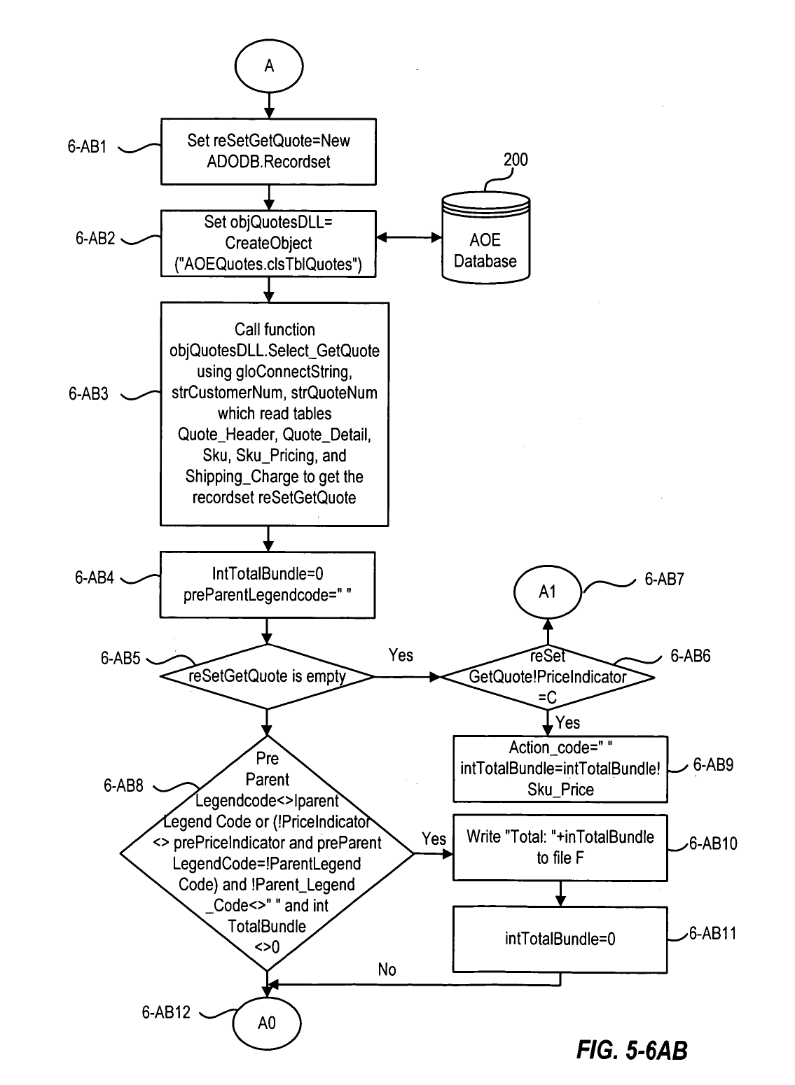

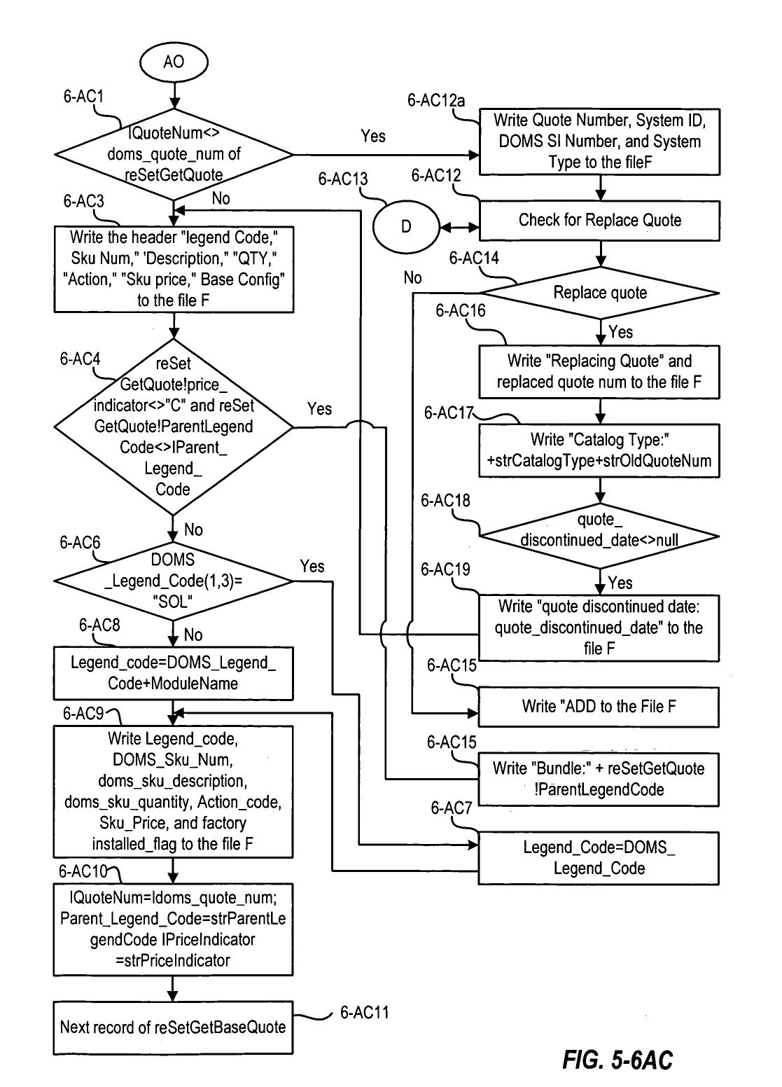

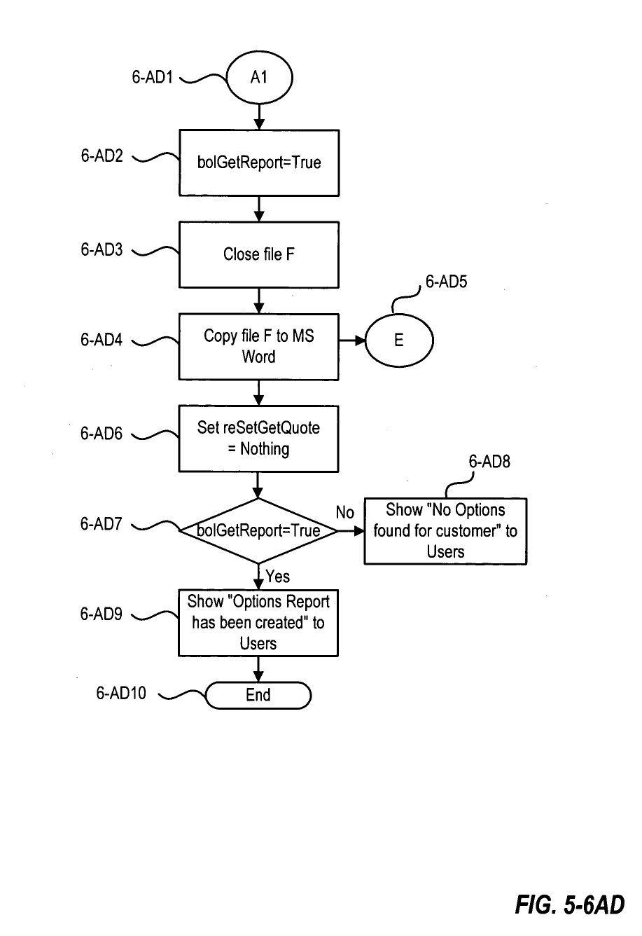

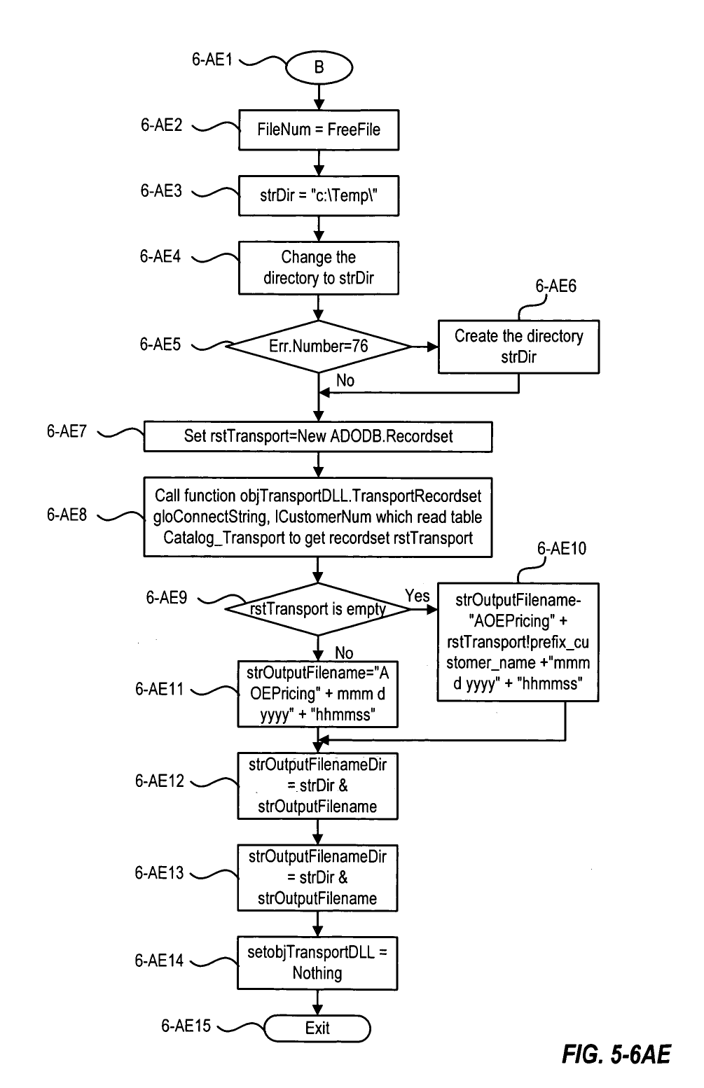

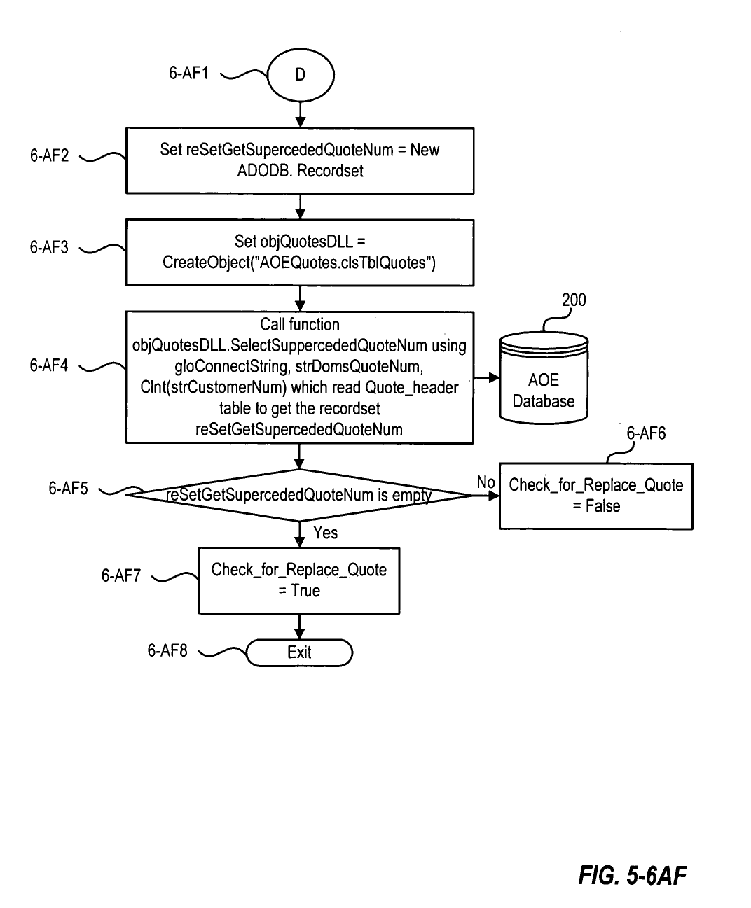

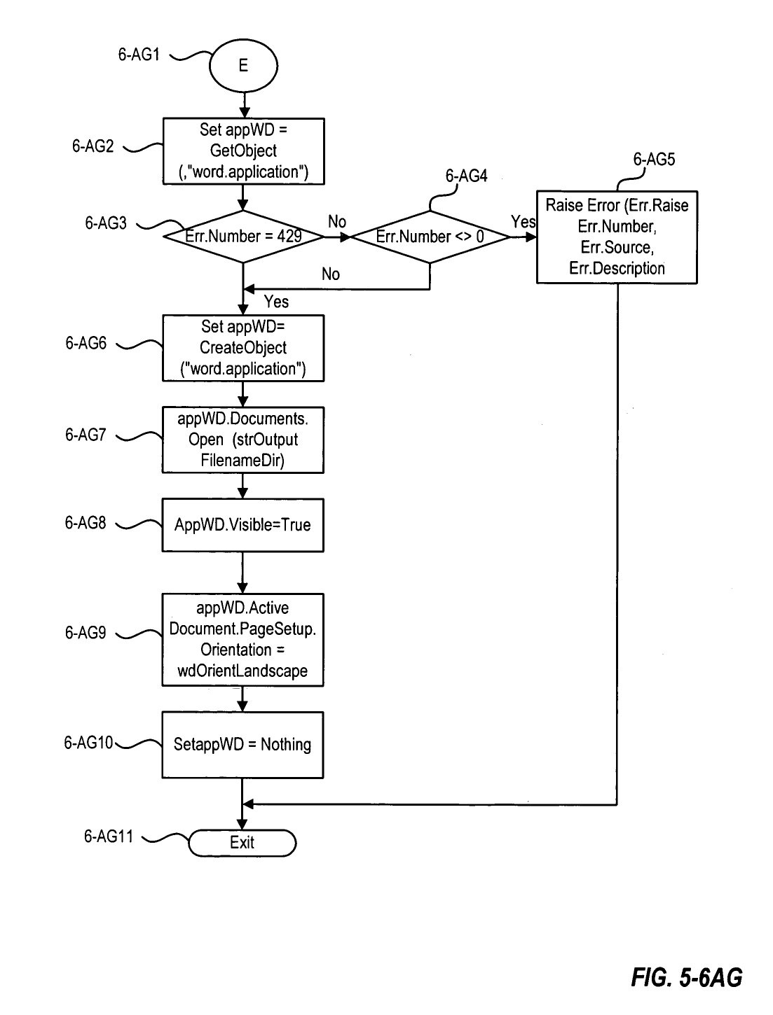

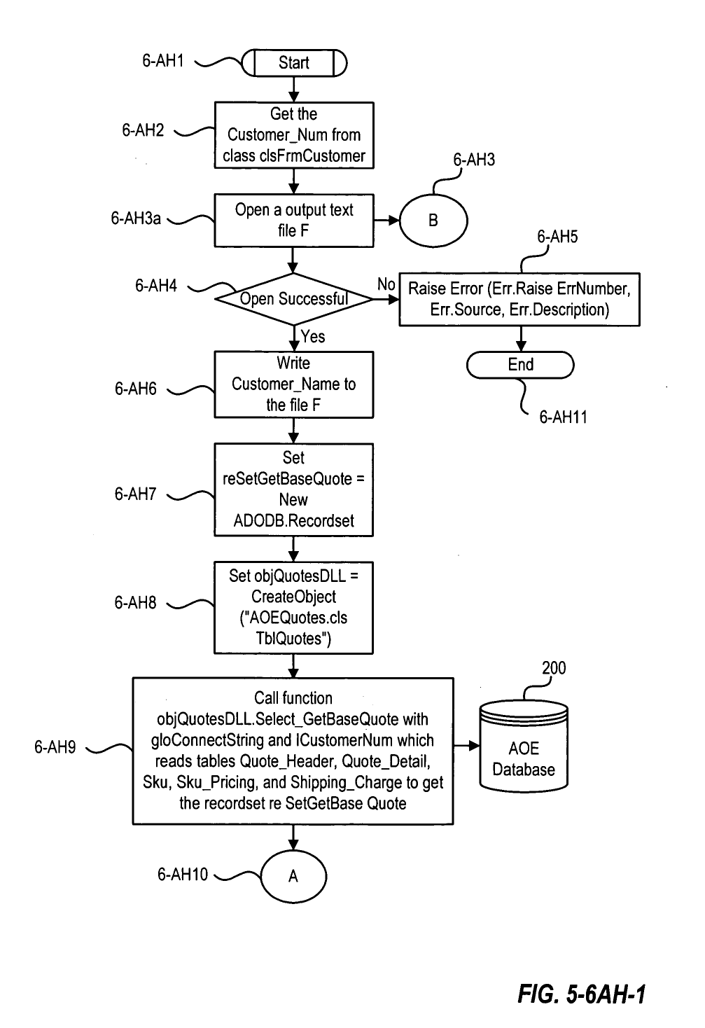

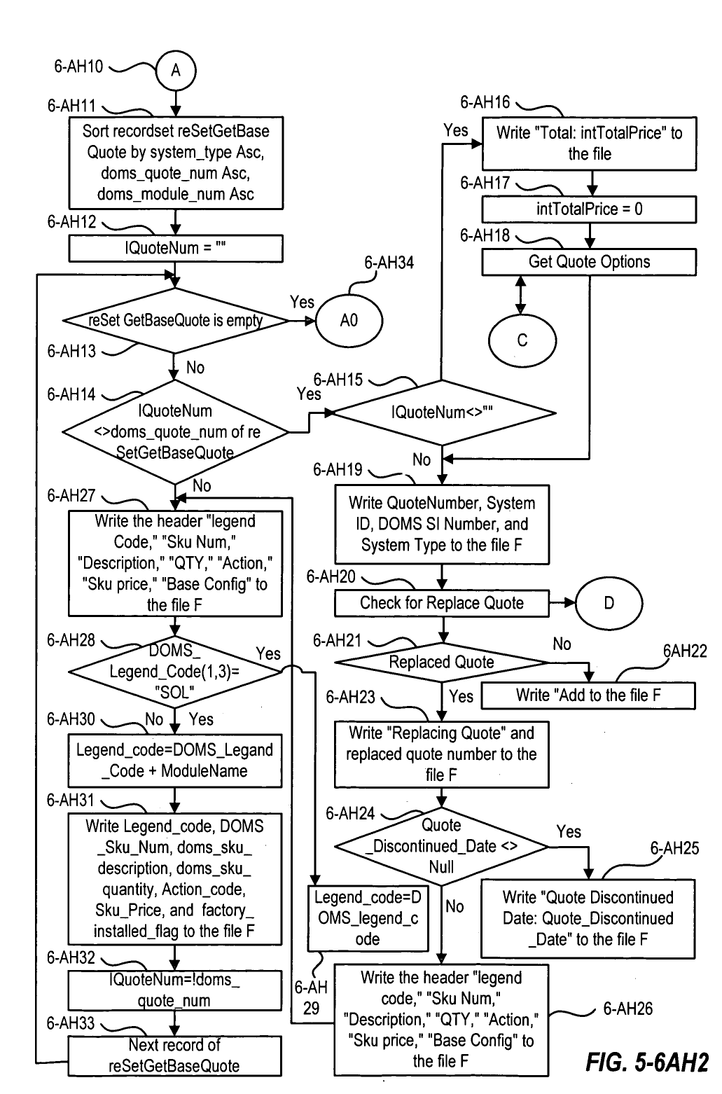

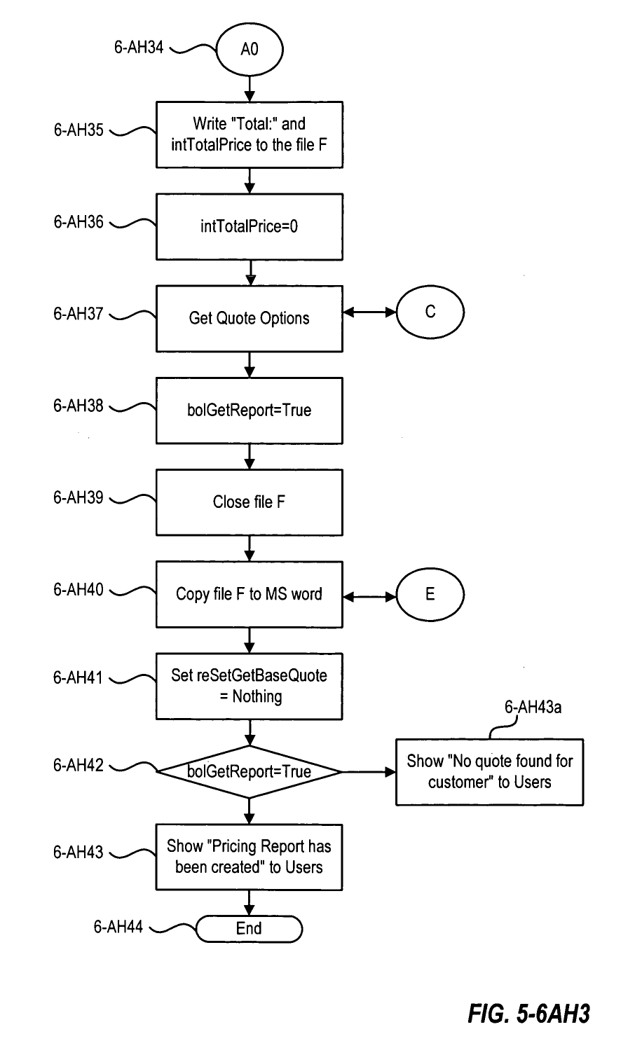

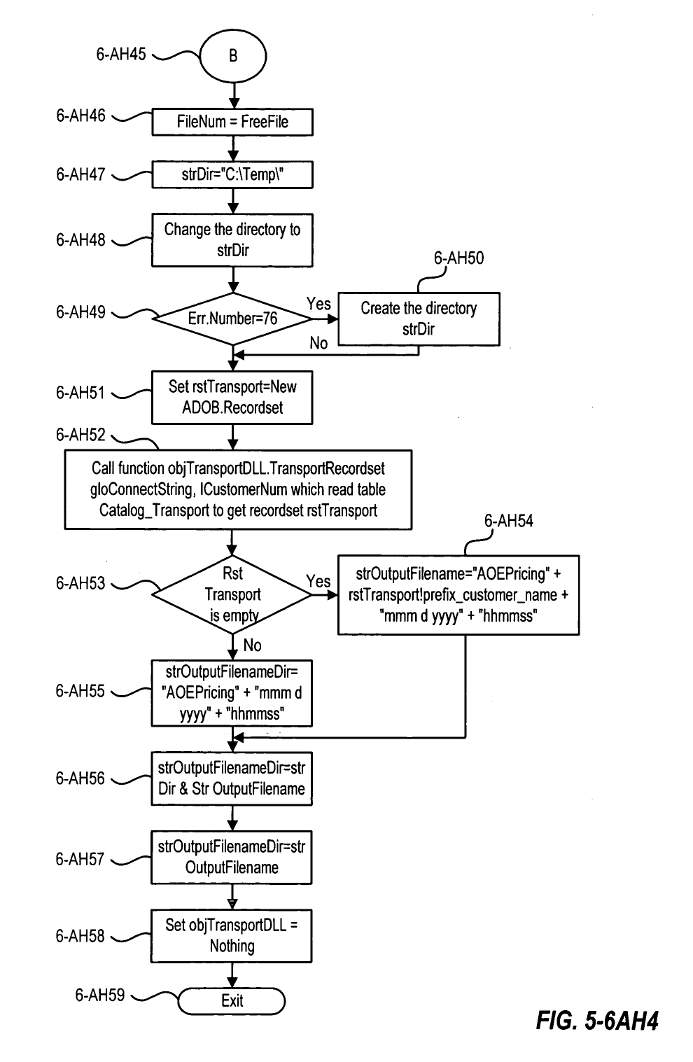

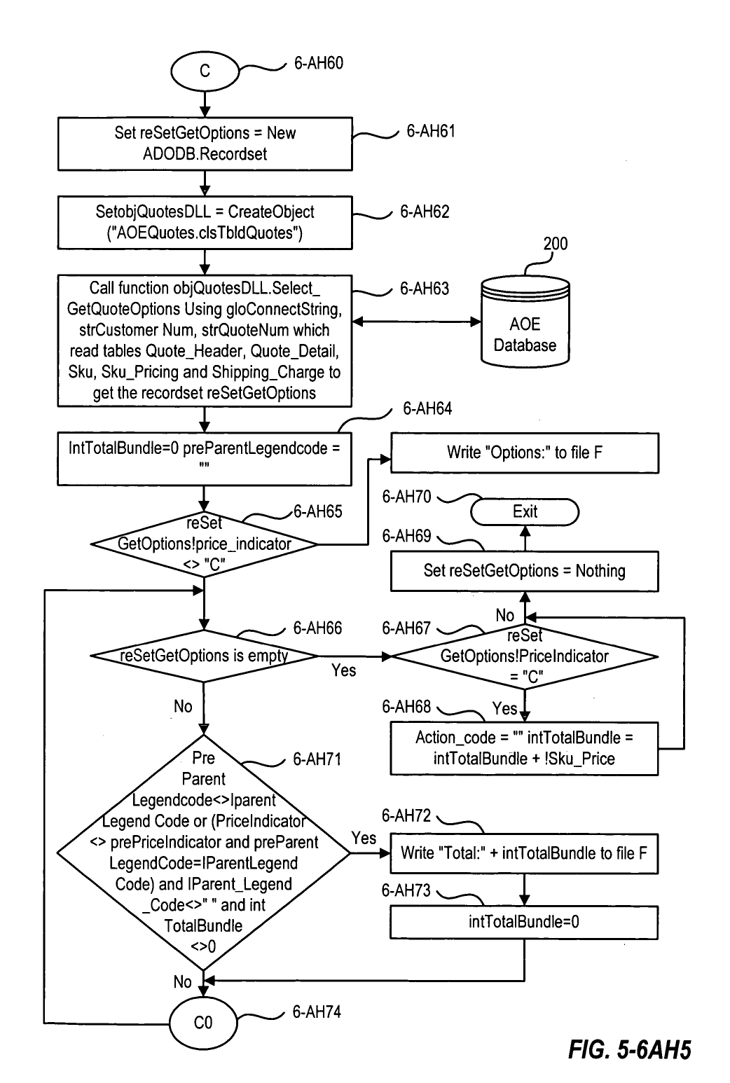

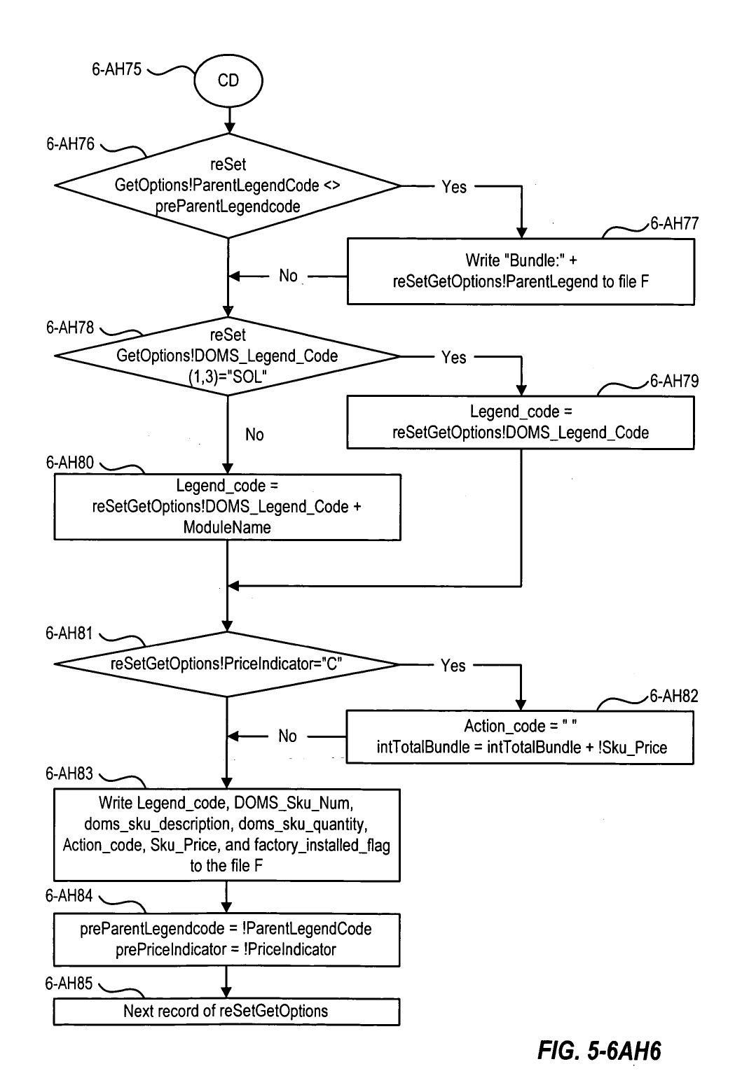

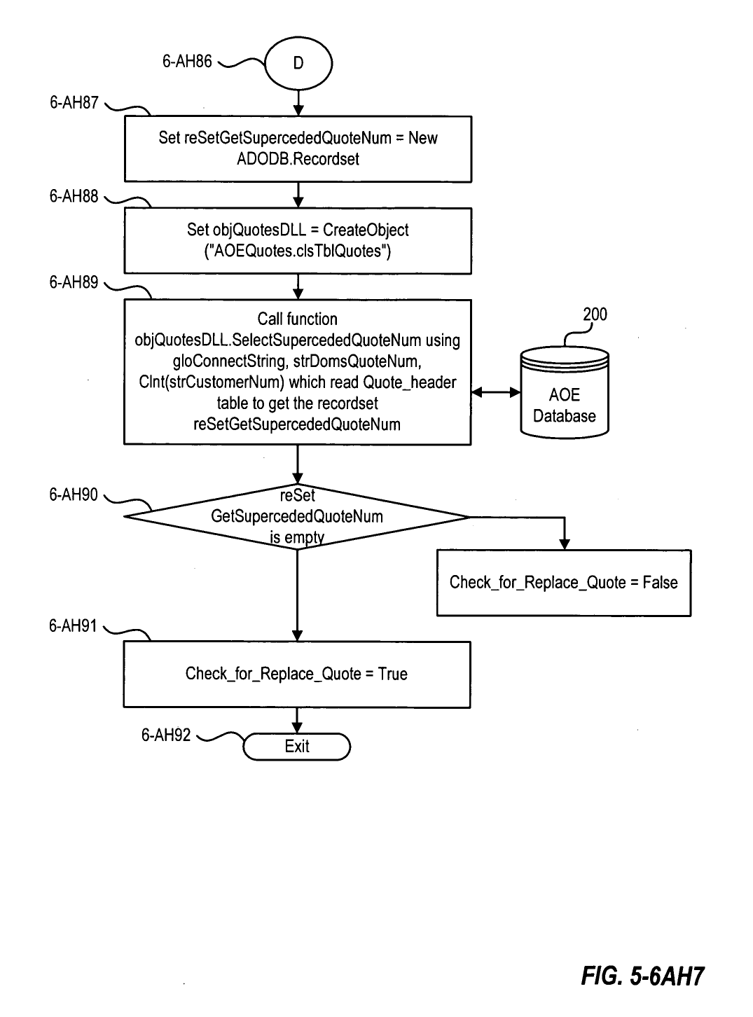

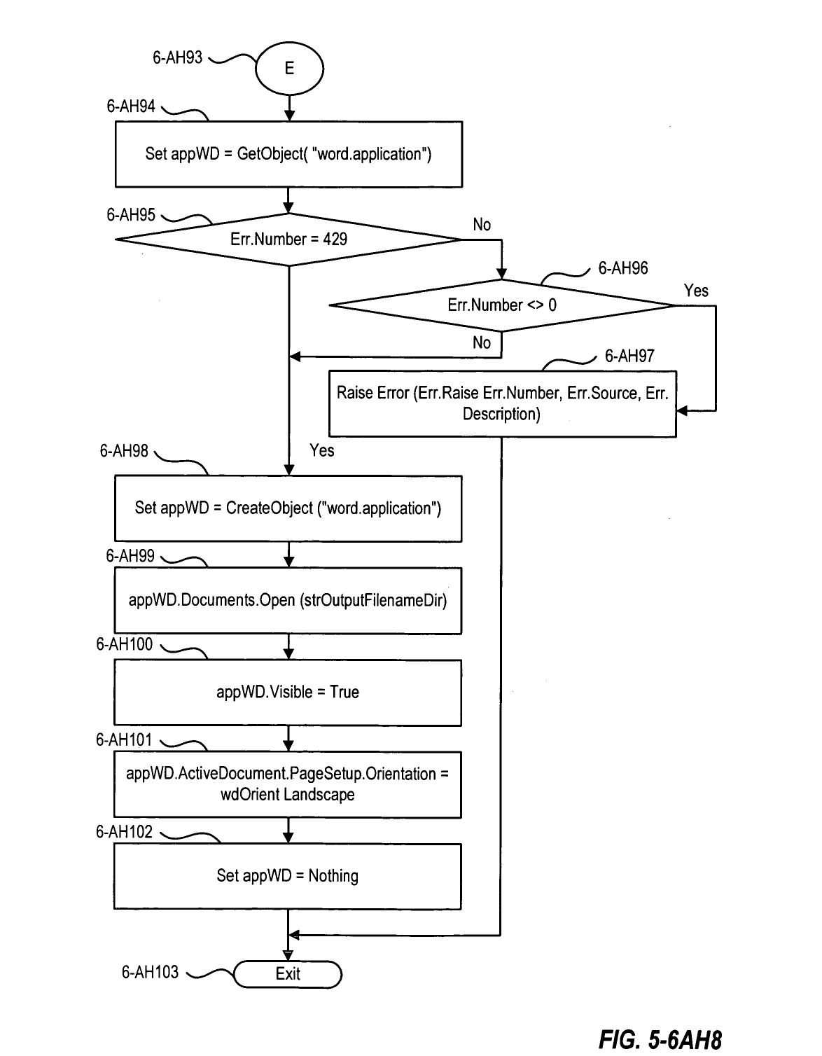

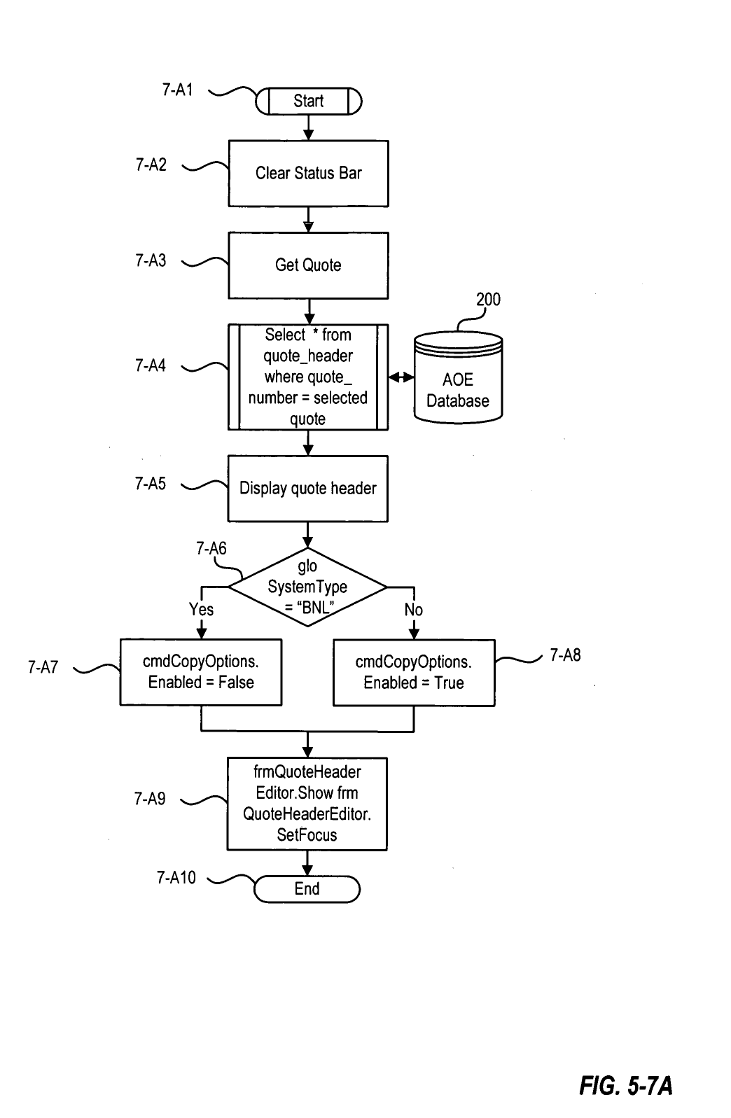

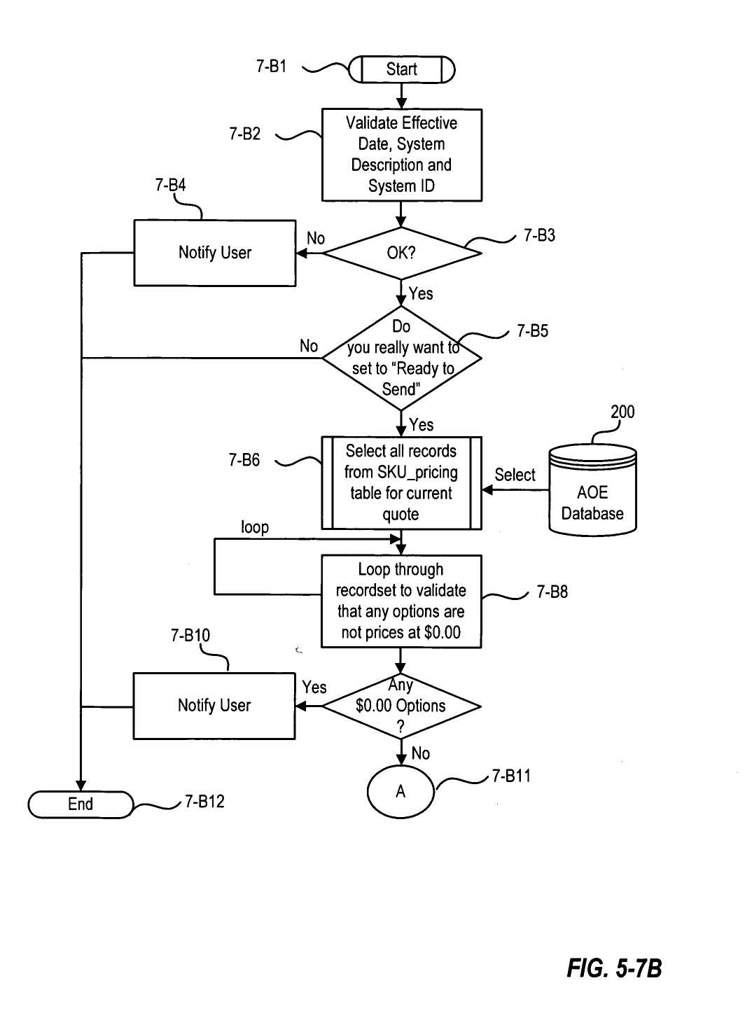

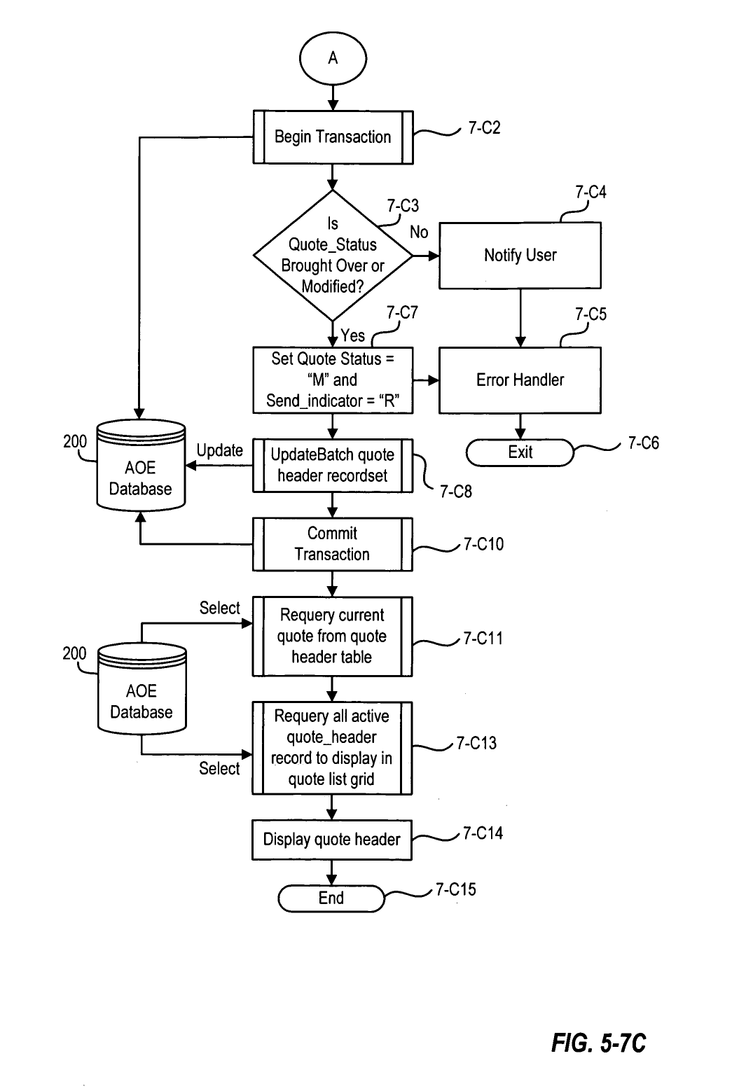

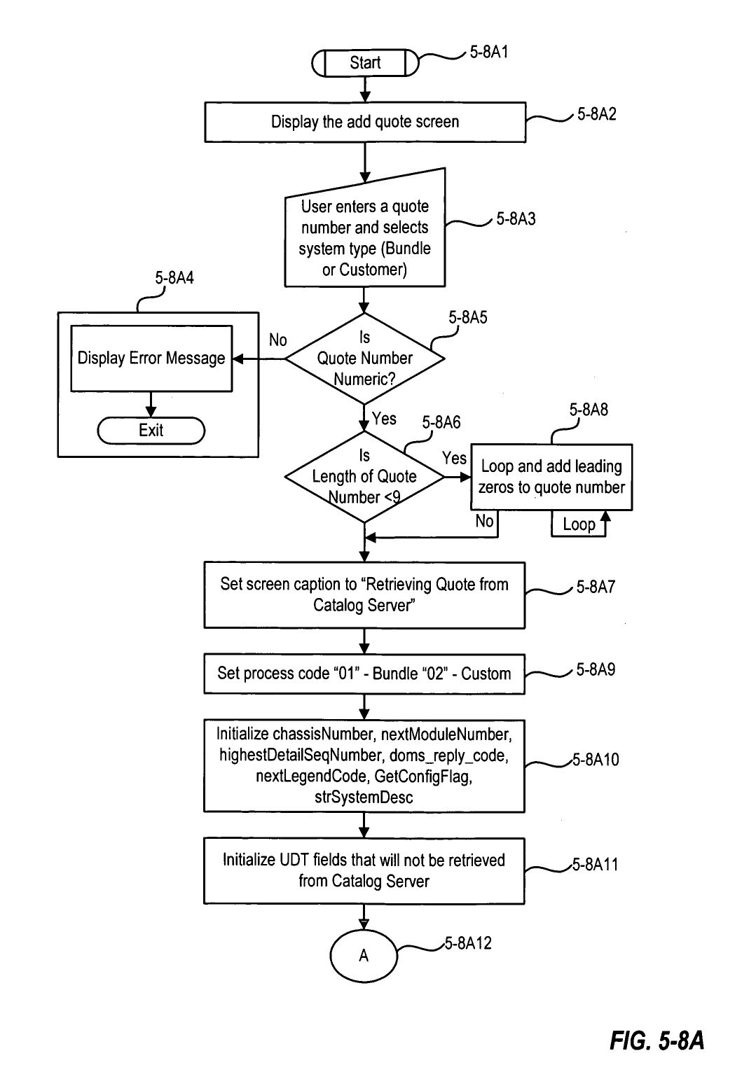

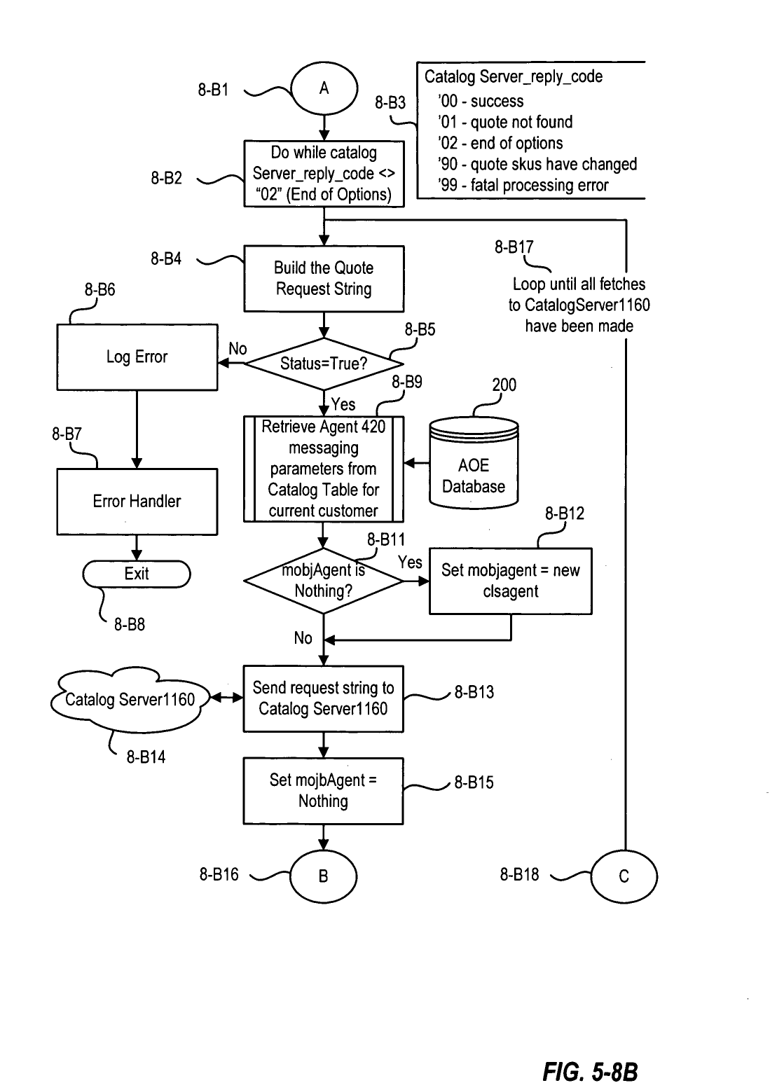

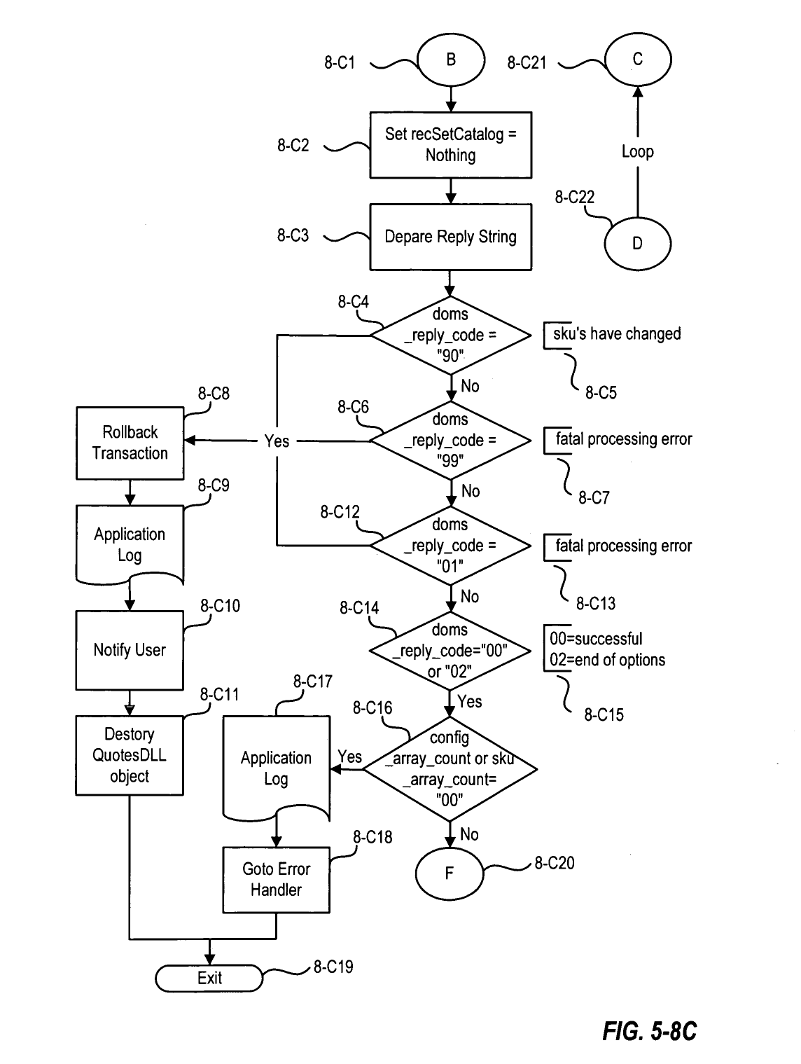

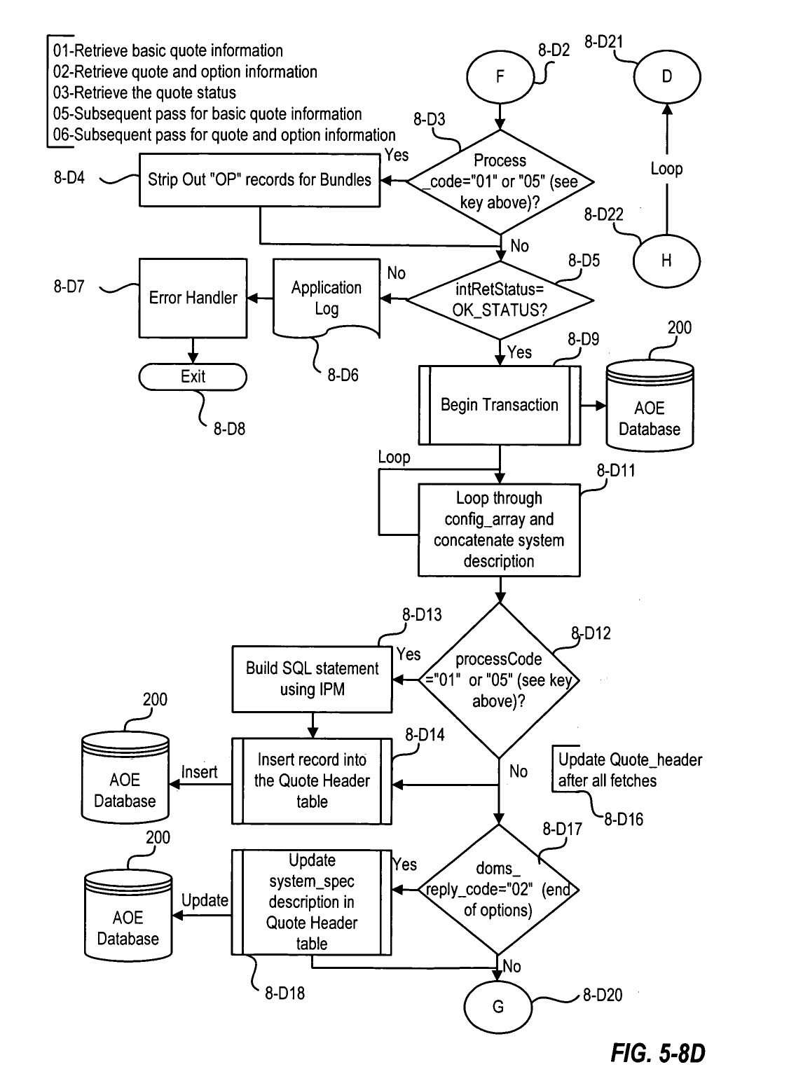

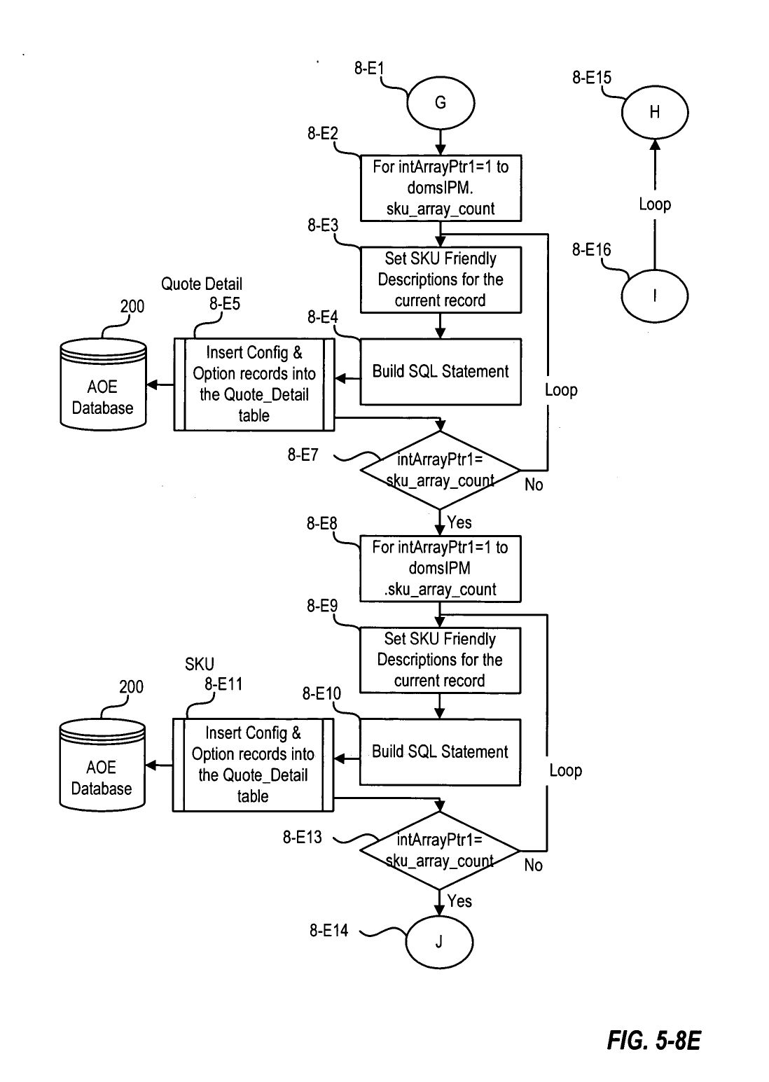

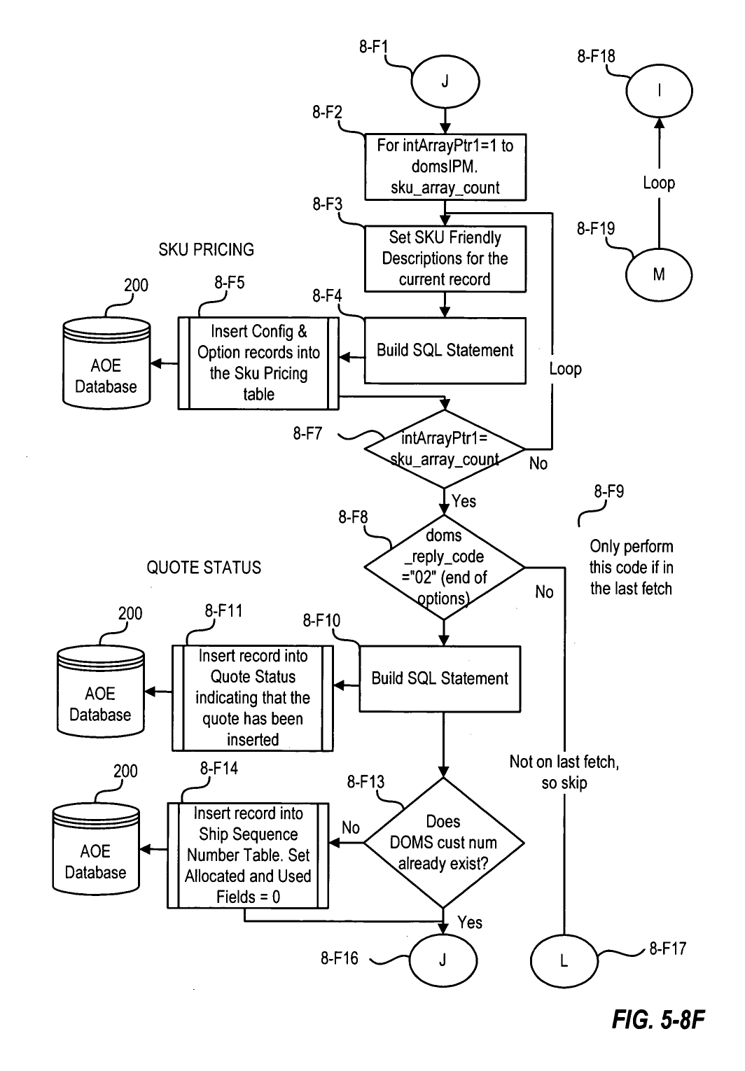

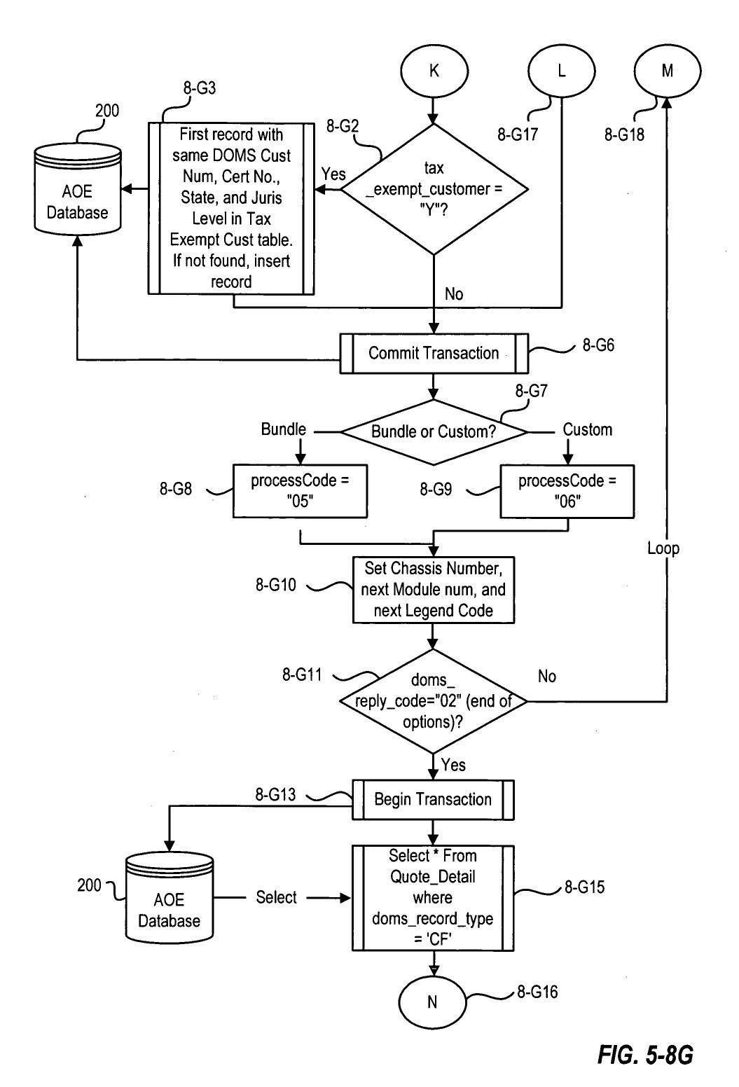

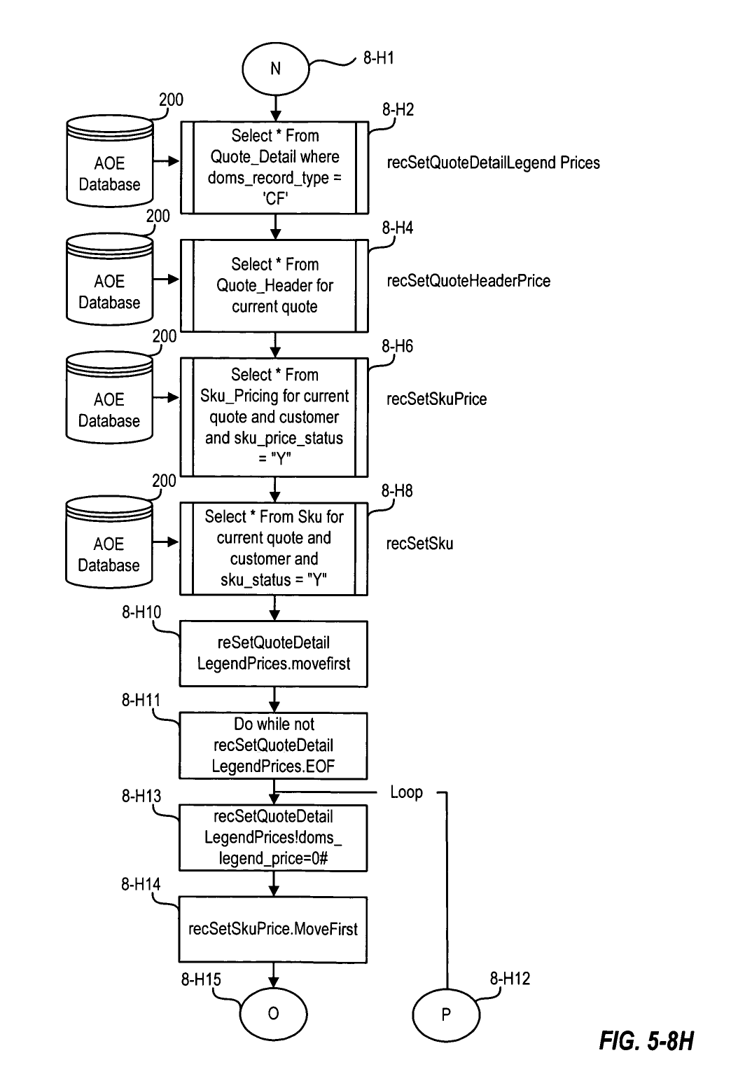

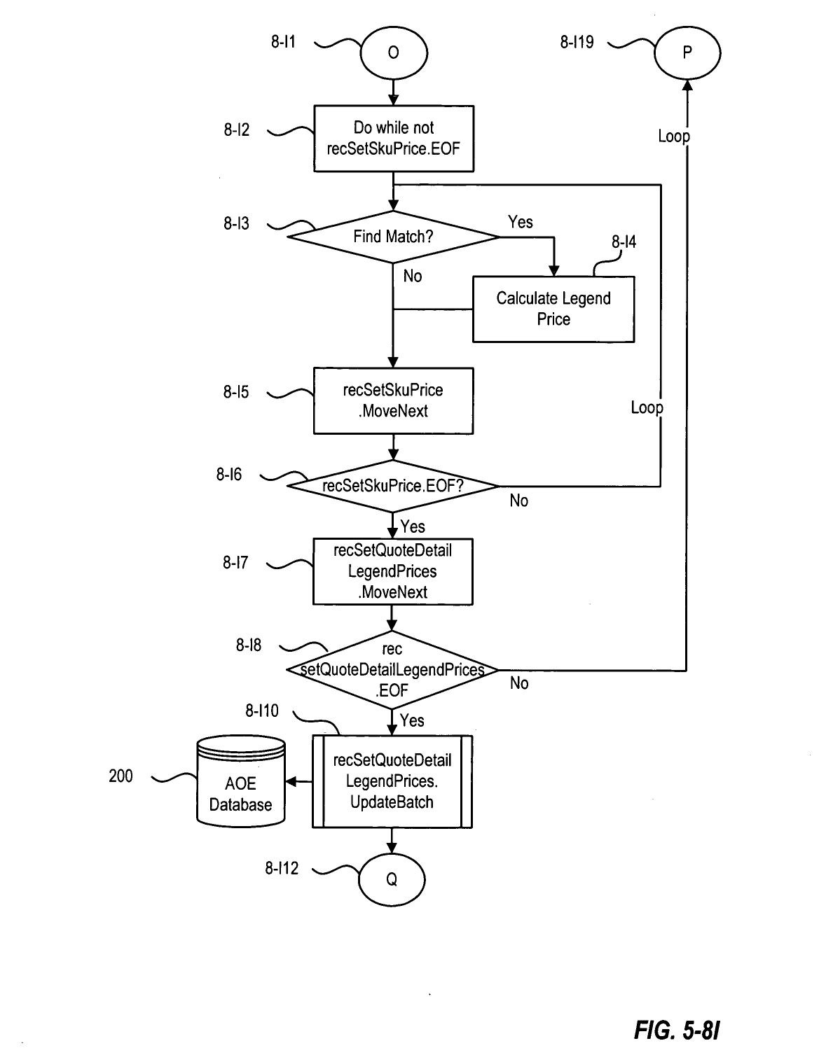

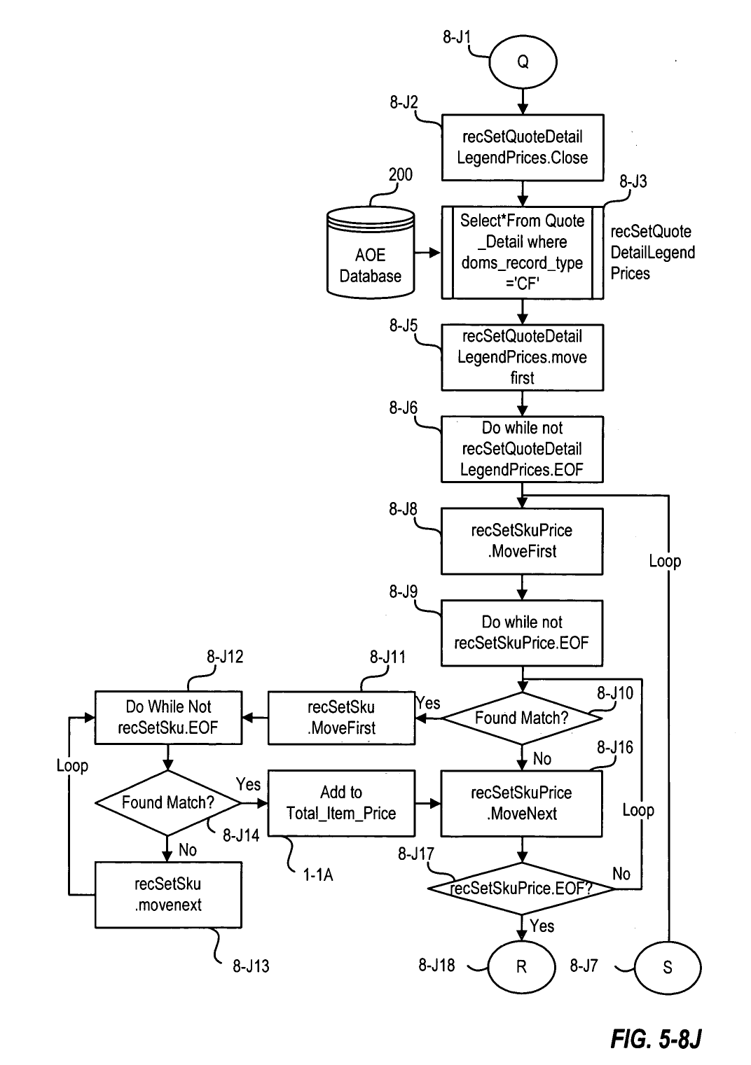

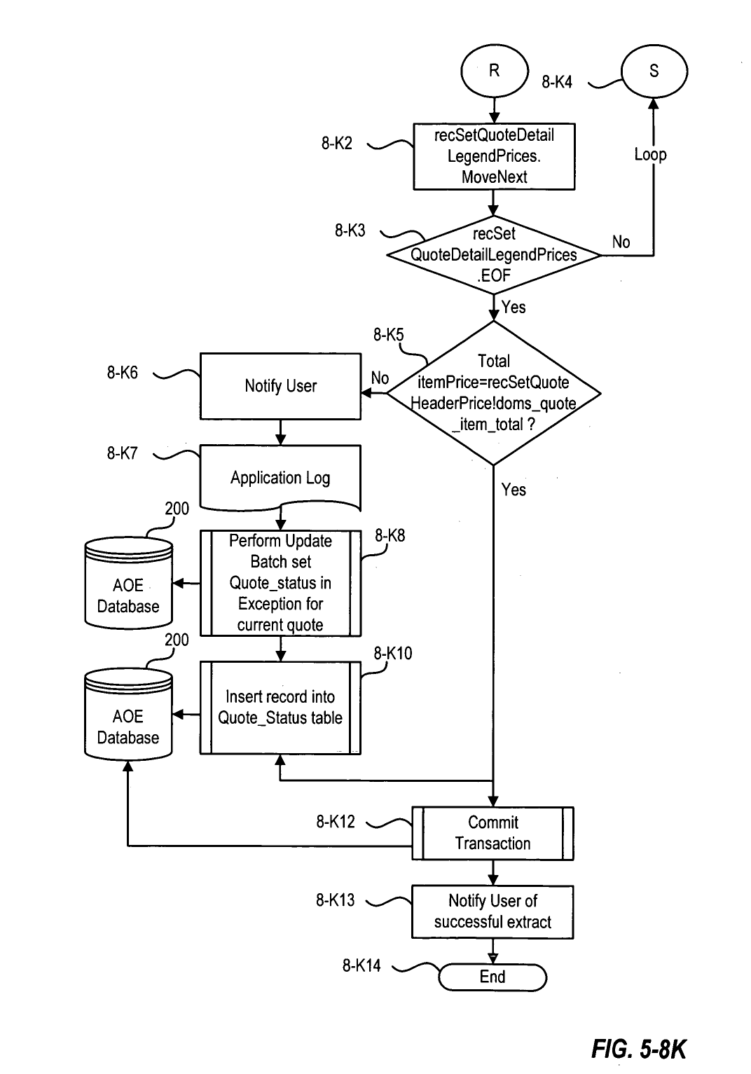

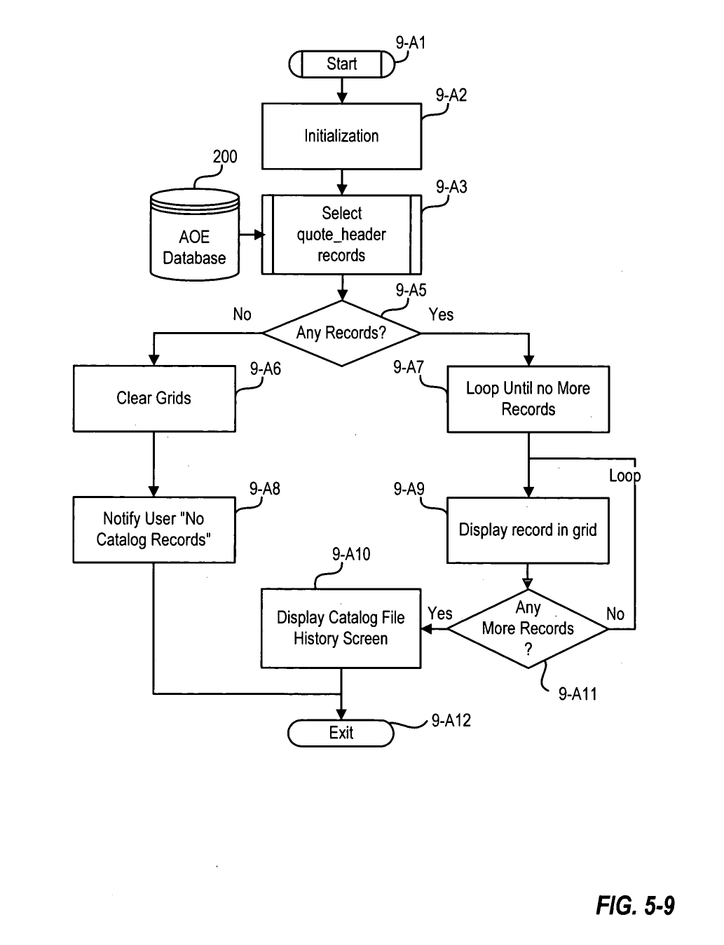

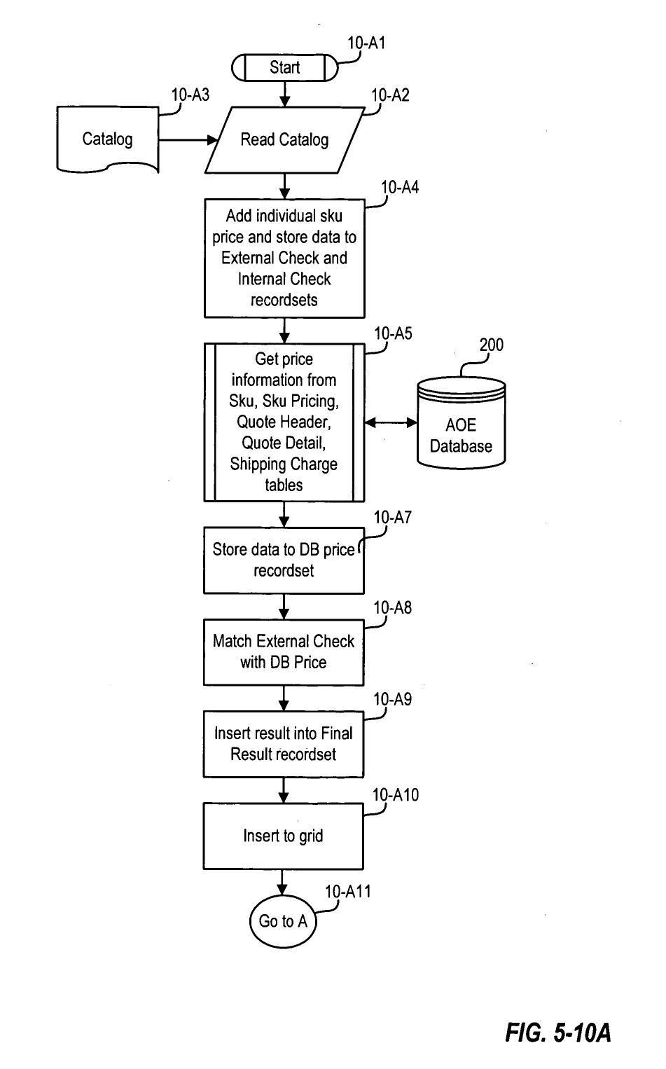

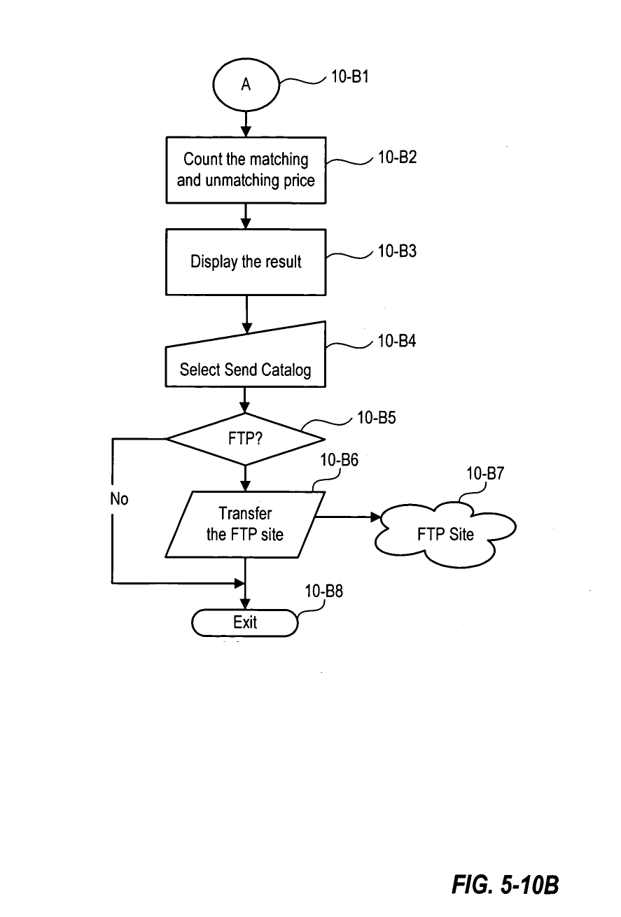

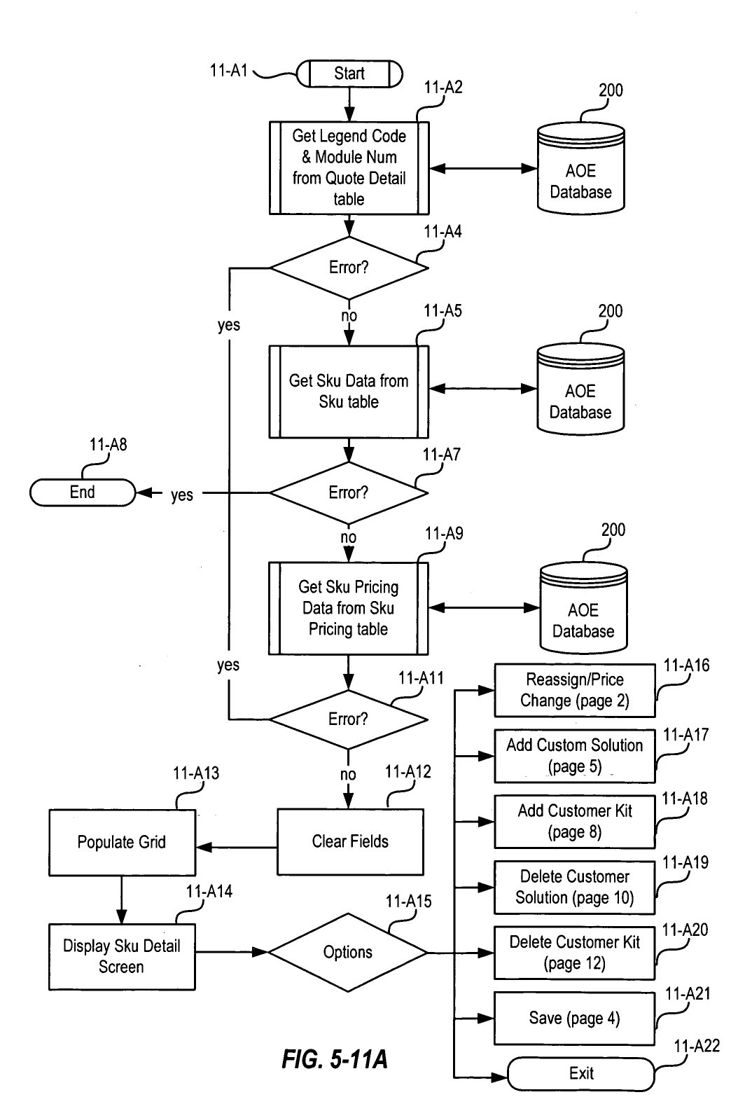

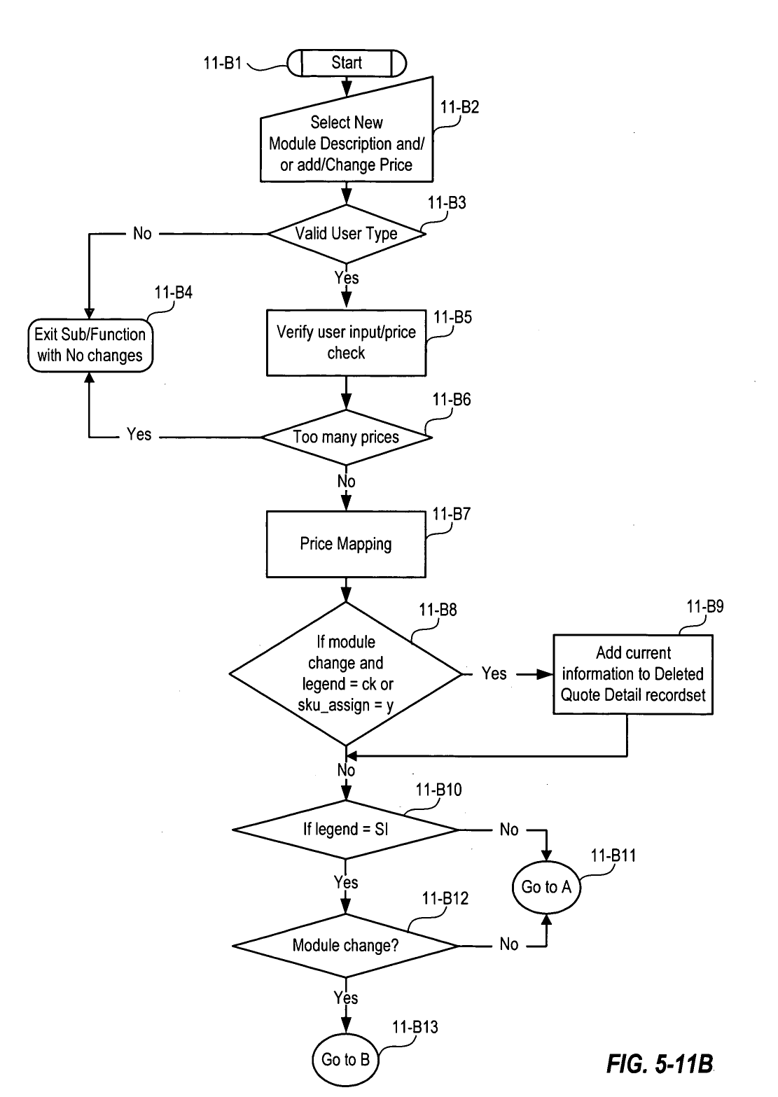

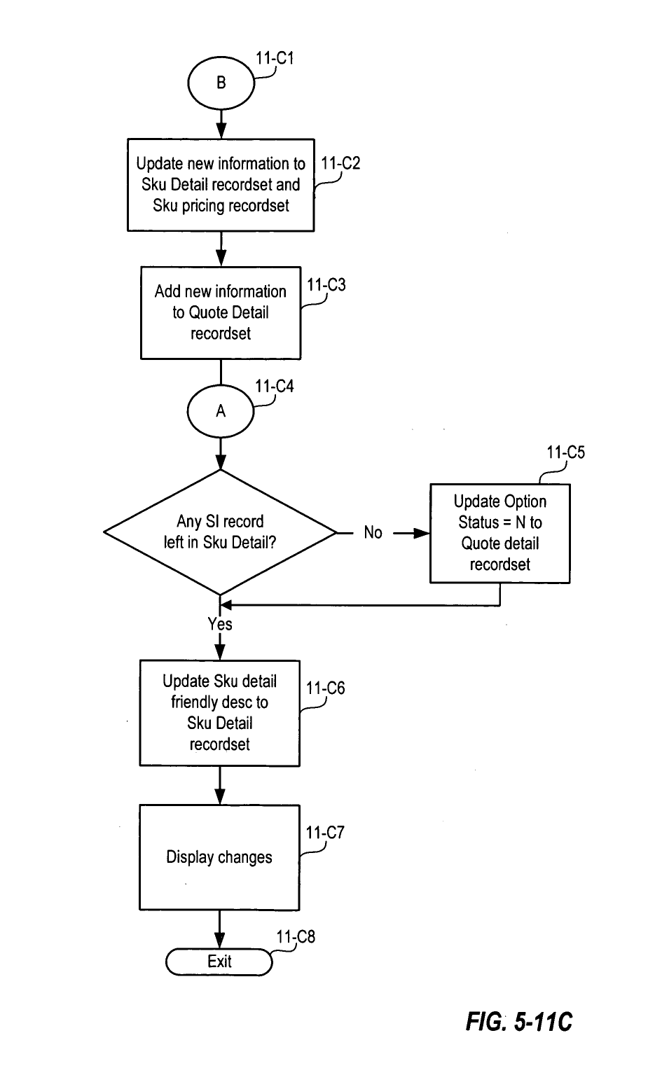

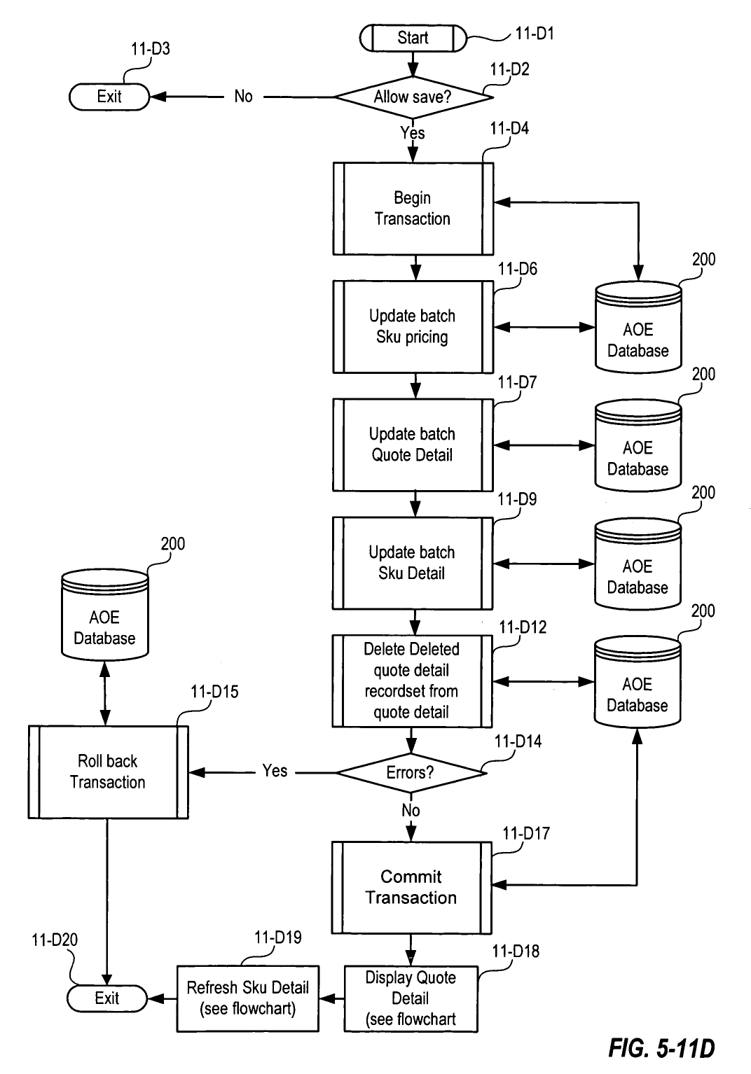

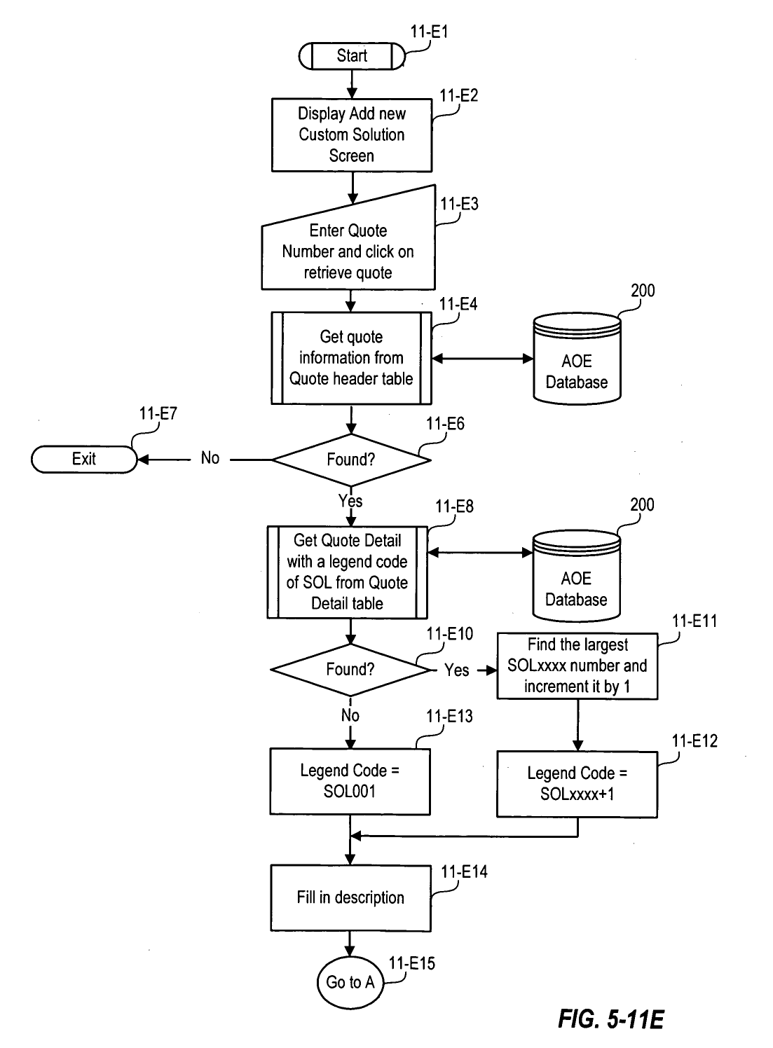

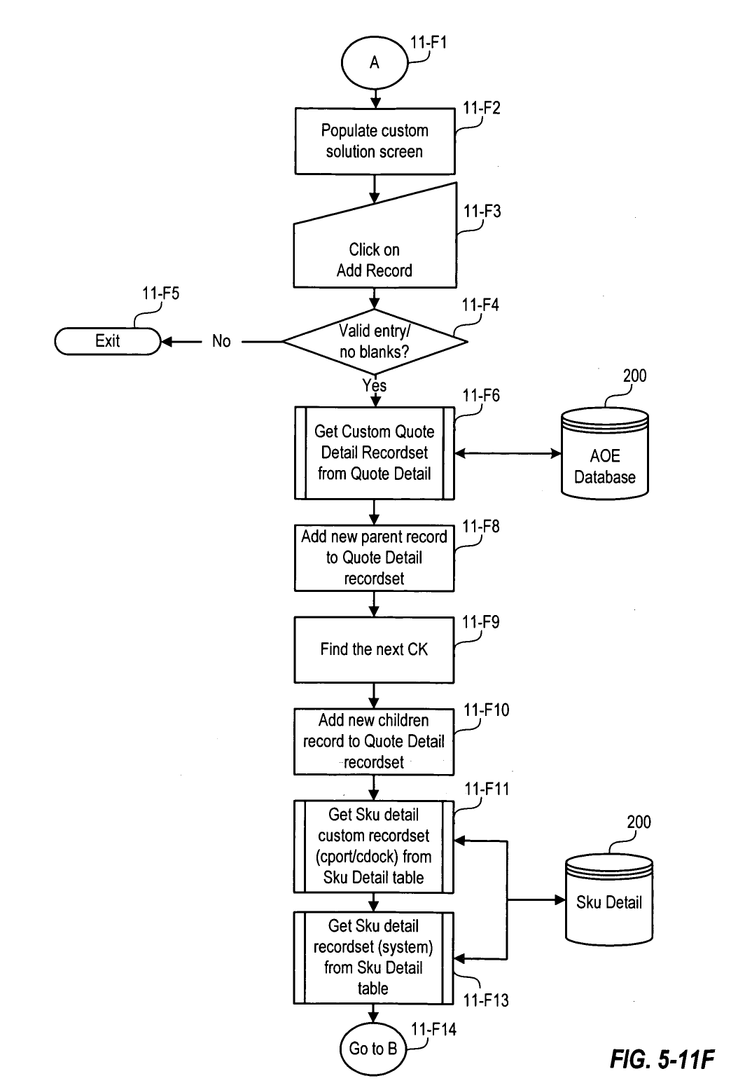

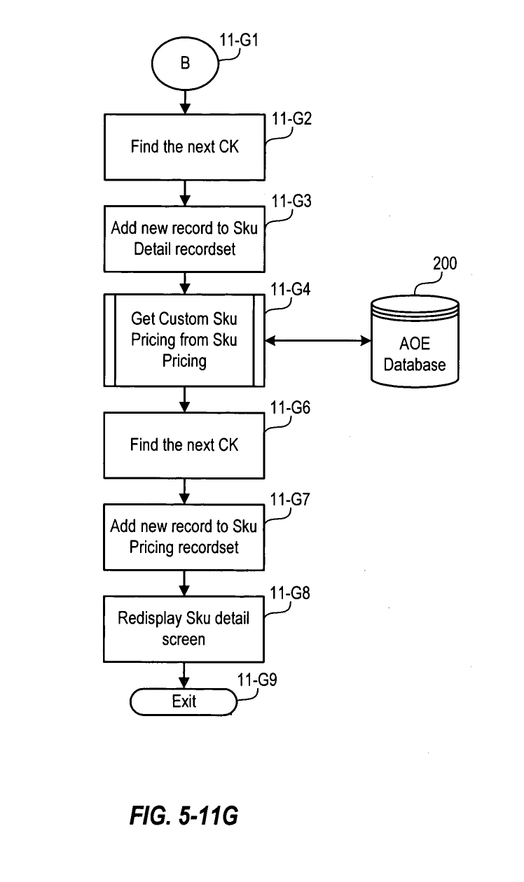

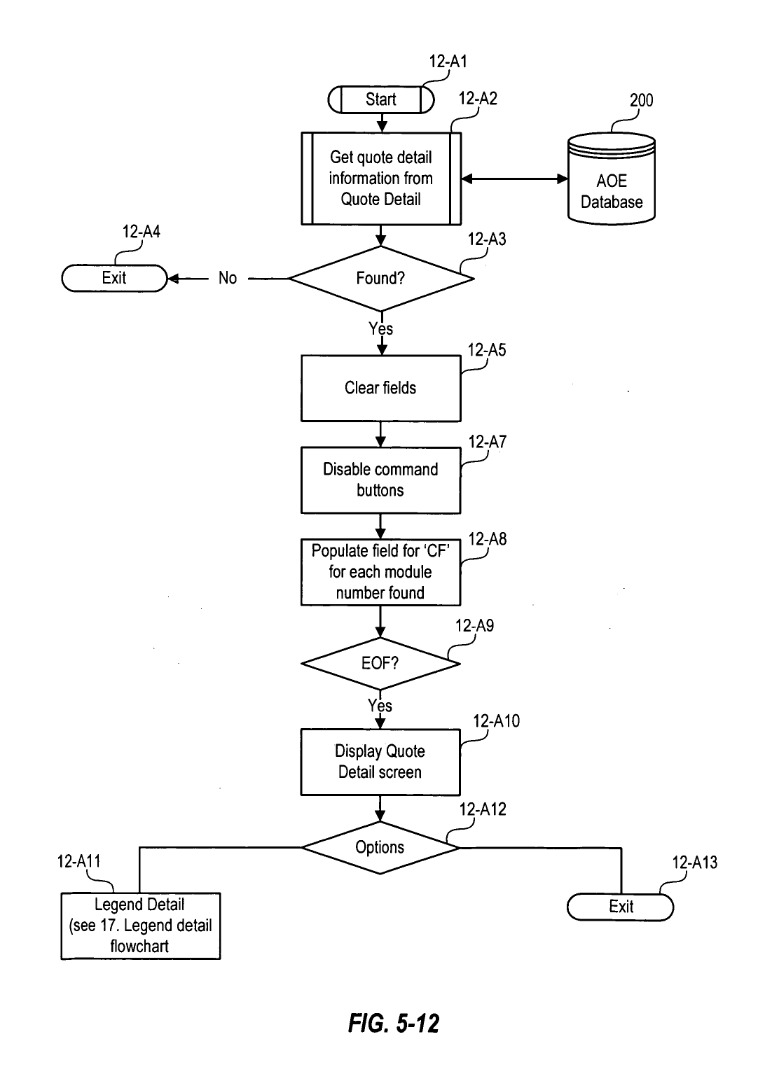

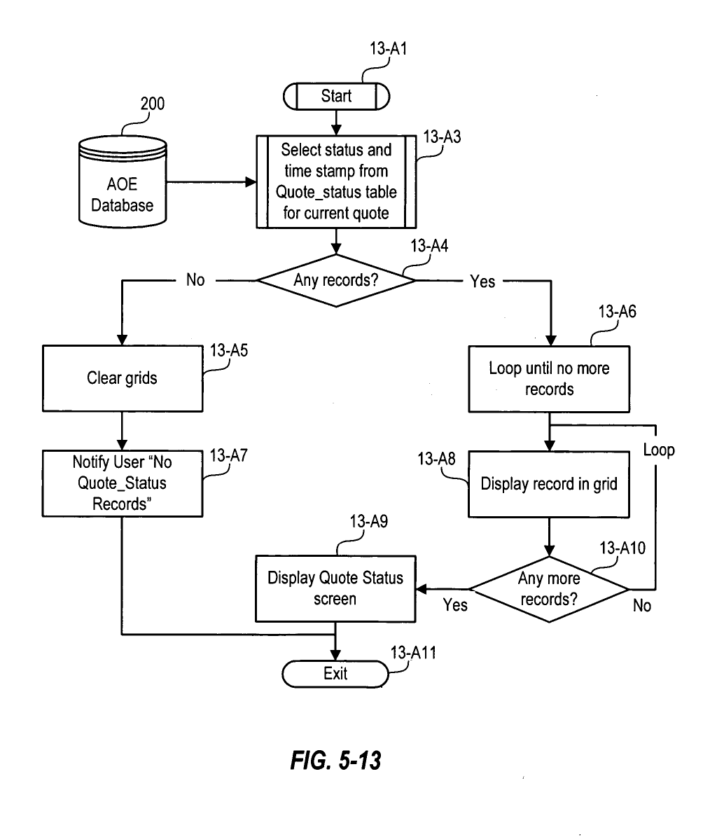

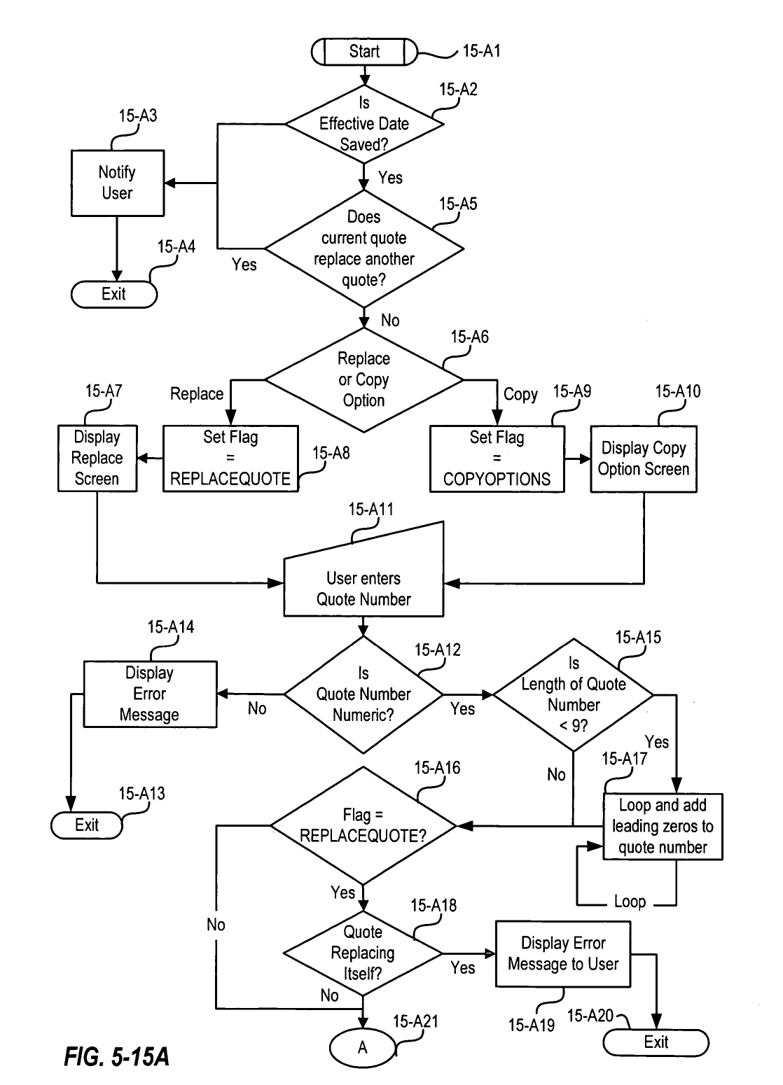

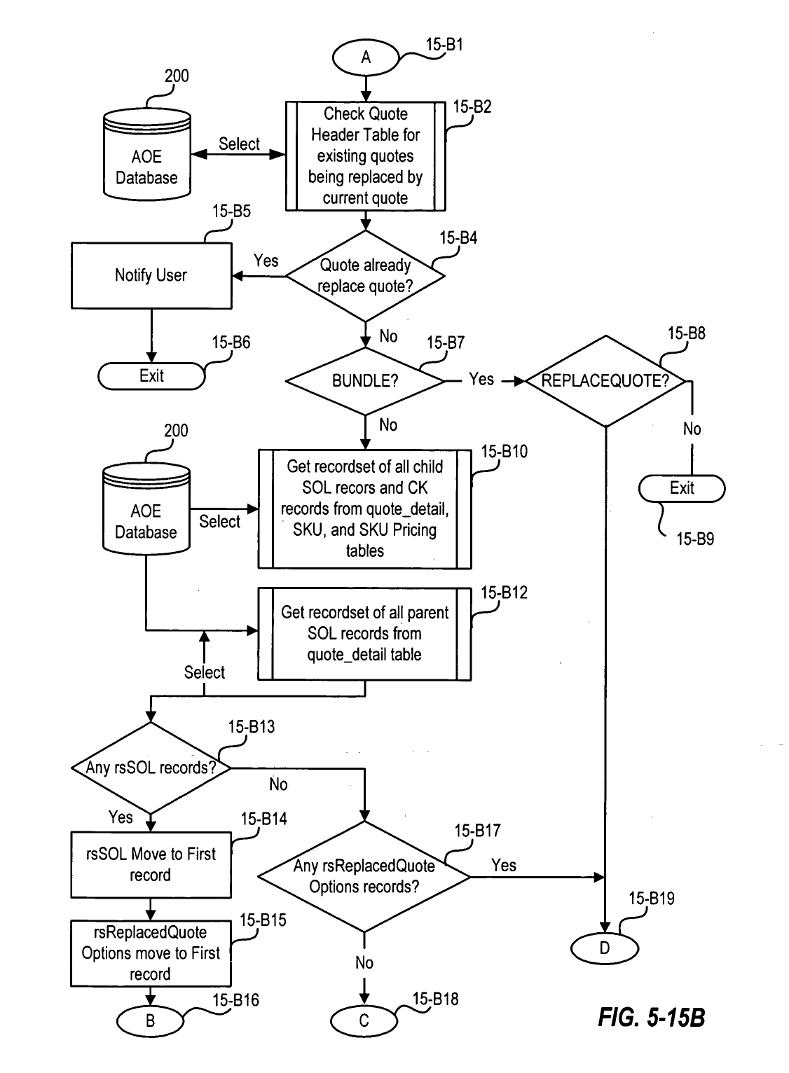

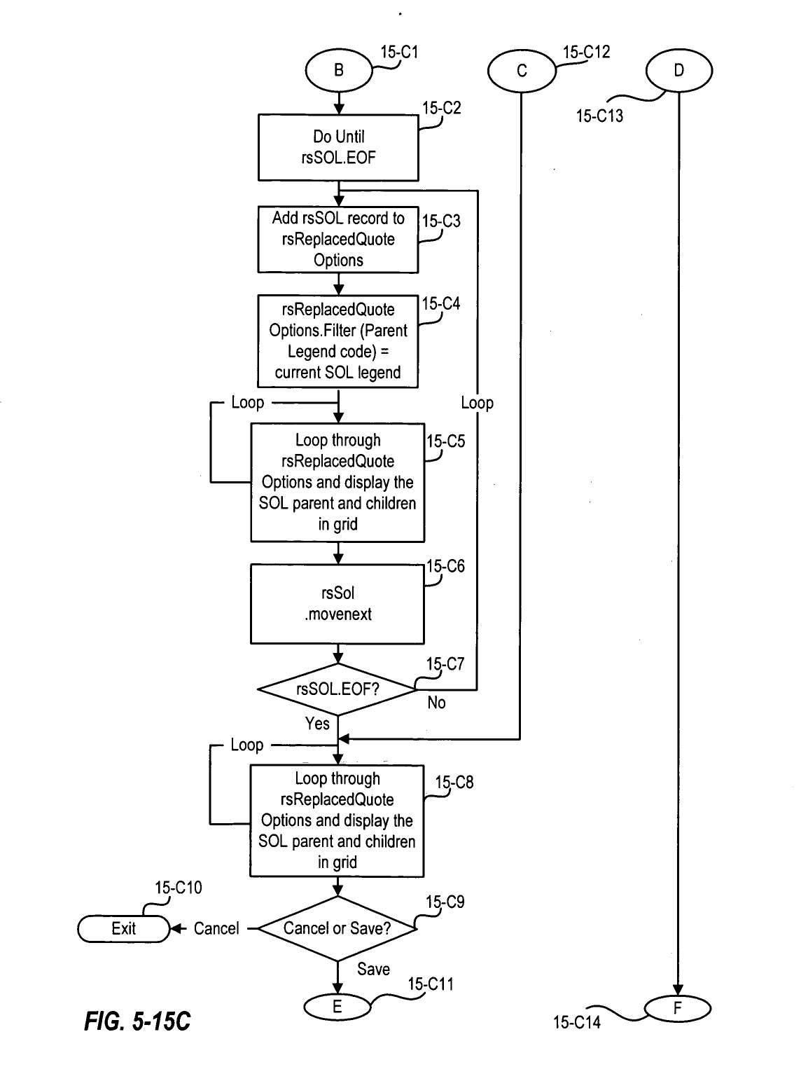

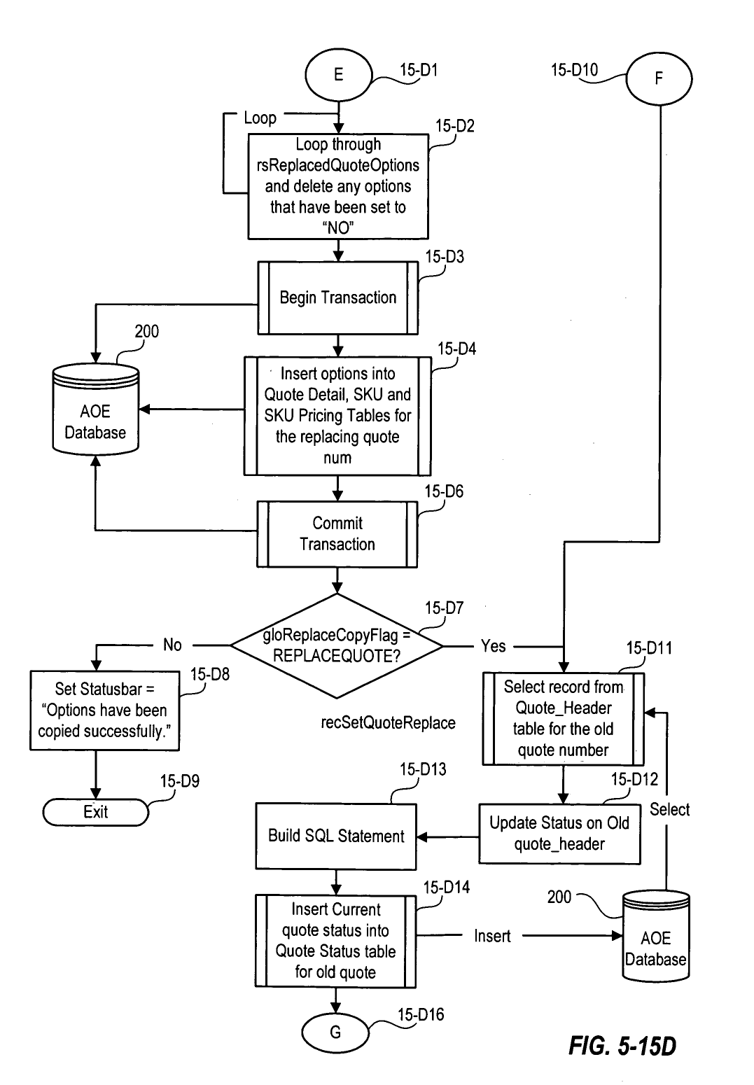

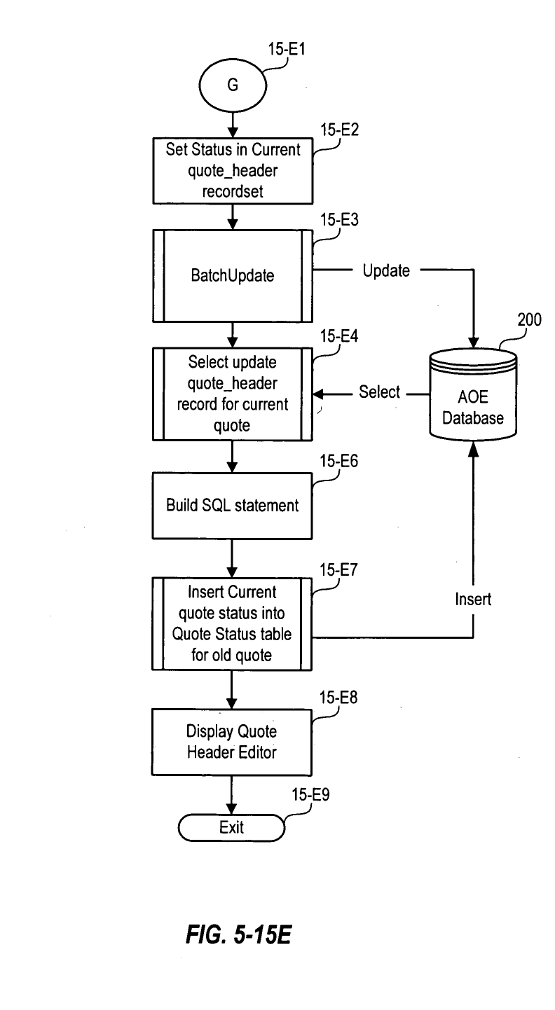

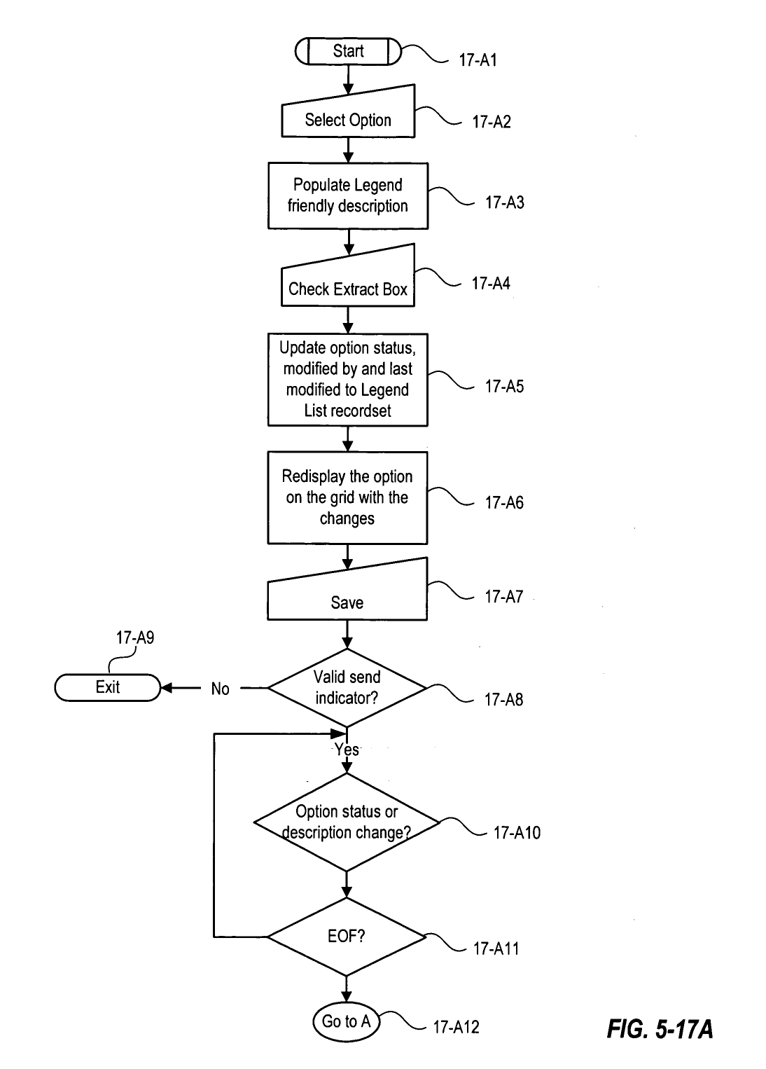

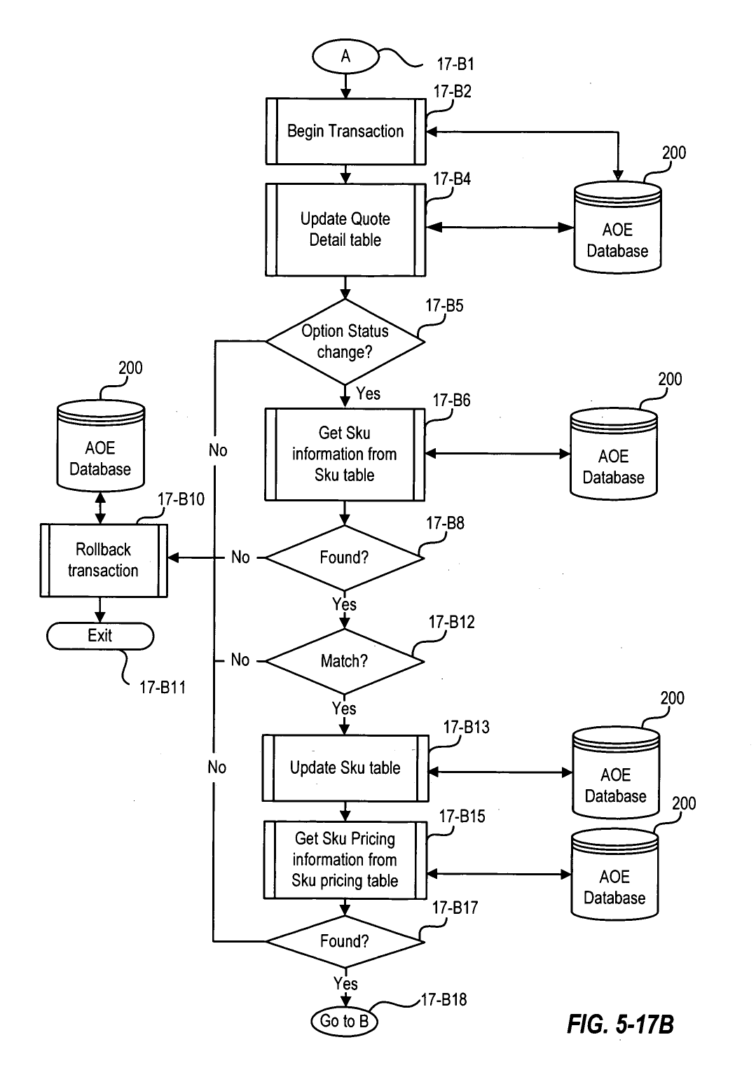

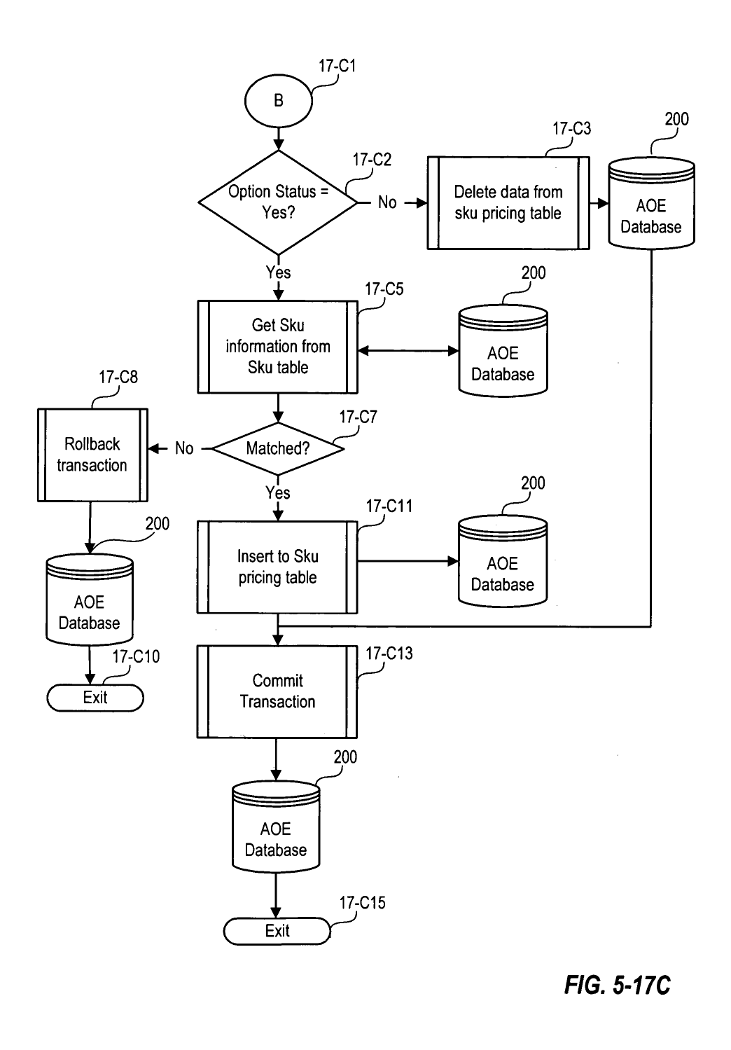

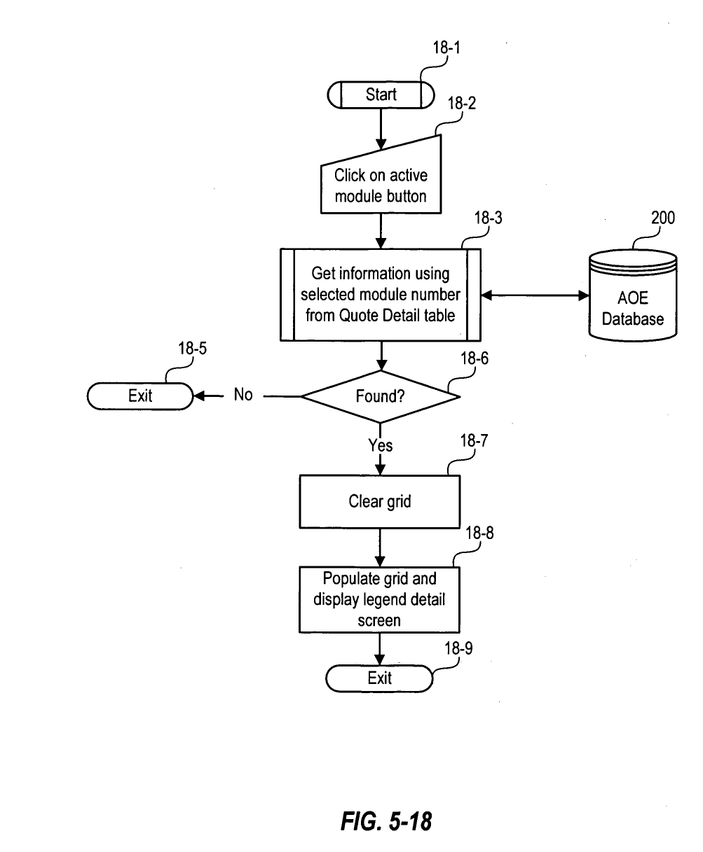

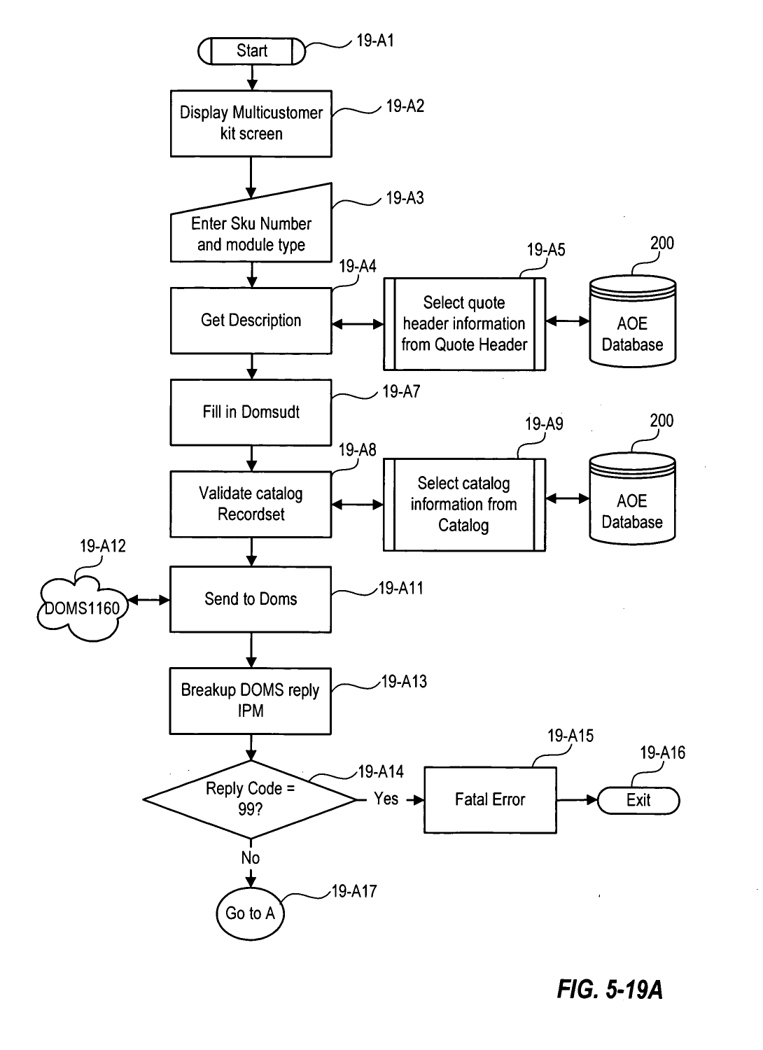

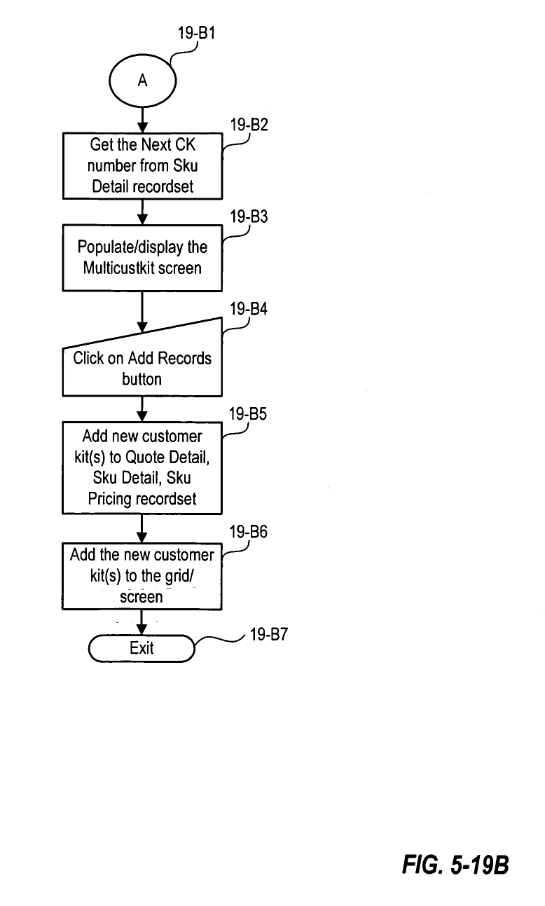

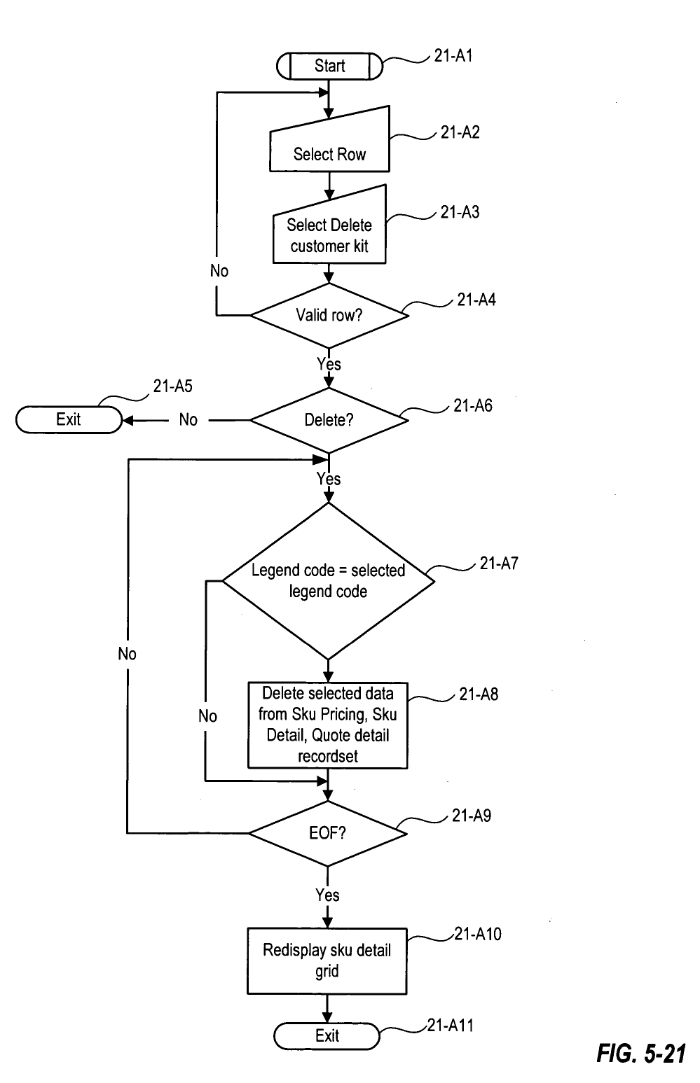

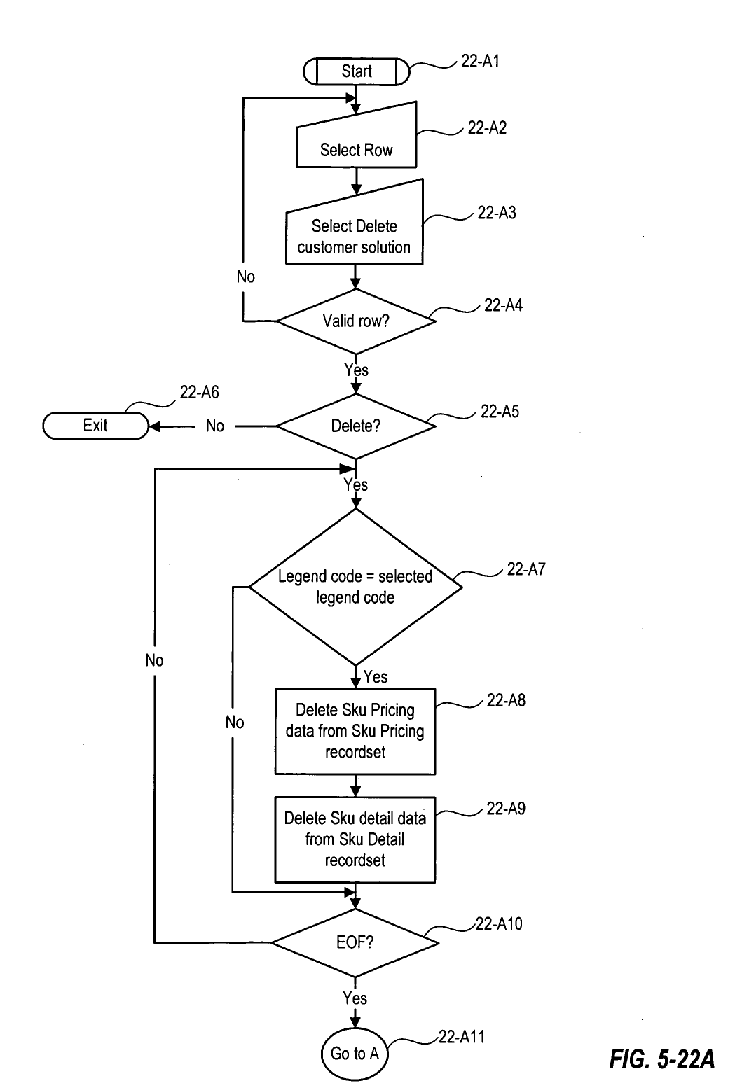

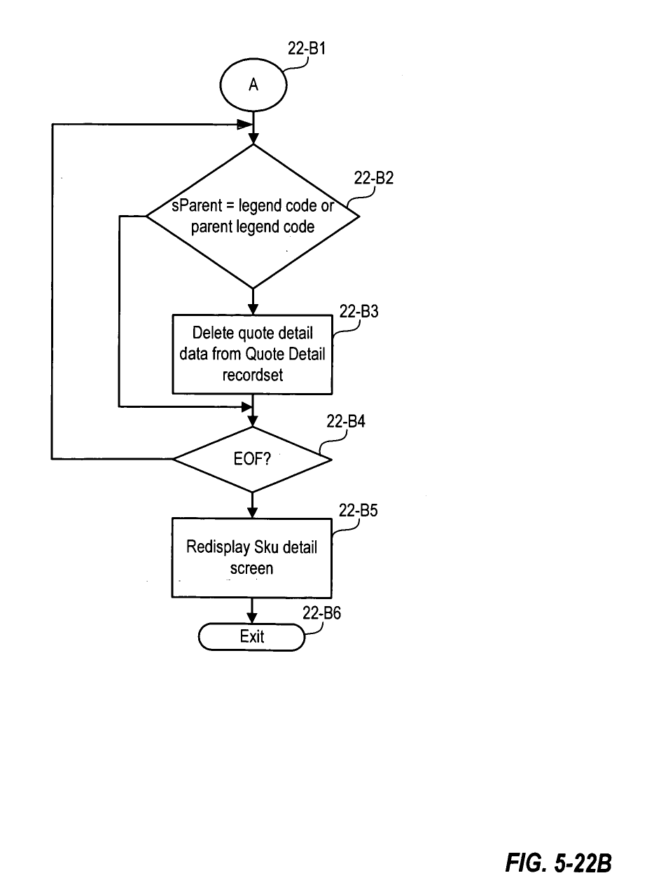

Referring now to FIG. 5, a flow diagram illustrates the processes included in. extracting data from the non-Windows the catalog process using GUI 402, shown in FIG. 4A. The processes are implemented in software modules in a Windows environment, such as a Windows-NT environment. In one embodiment, the processes are implemented using object-oriented programming in Visual Basic. In other embodiments, the processes are implemented using C programming or other object-oriented programming milieu.

The flow diagram of FIG. 5 represents the modules of software code that support the AoE GUI 402. More particularly, FIG. 5 shows login module 500, which relates to a login procedure module for users. Module 500 is followed by customer profile screen 501. Module 501 provides for a user to limit the catalog process to identified customers. Optionally, a user can create a catalog for one or more customers, or create a generic catalog, depending on the purpose served. The flow diagram next splits, enabling a user to choose catalog maintenance functionality 503 or a quote list functionality 506.

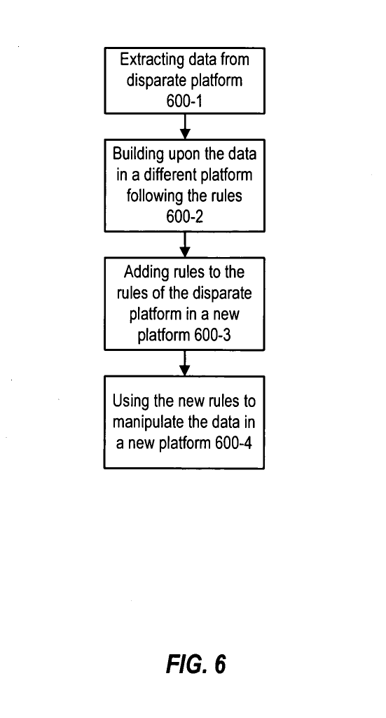

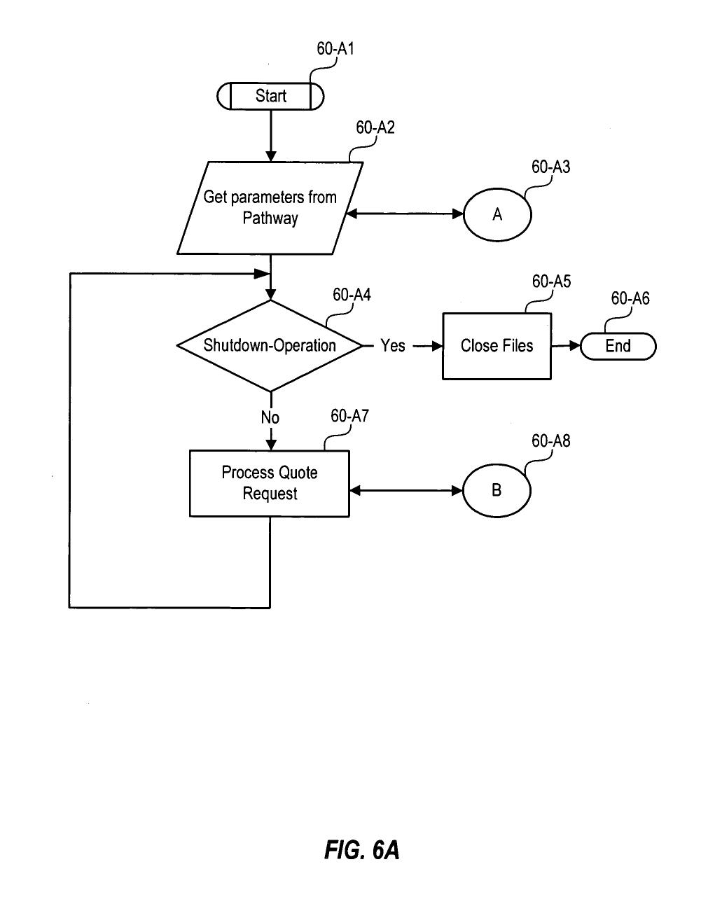

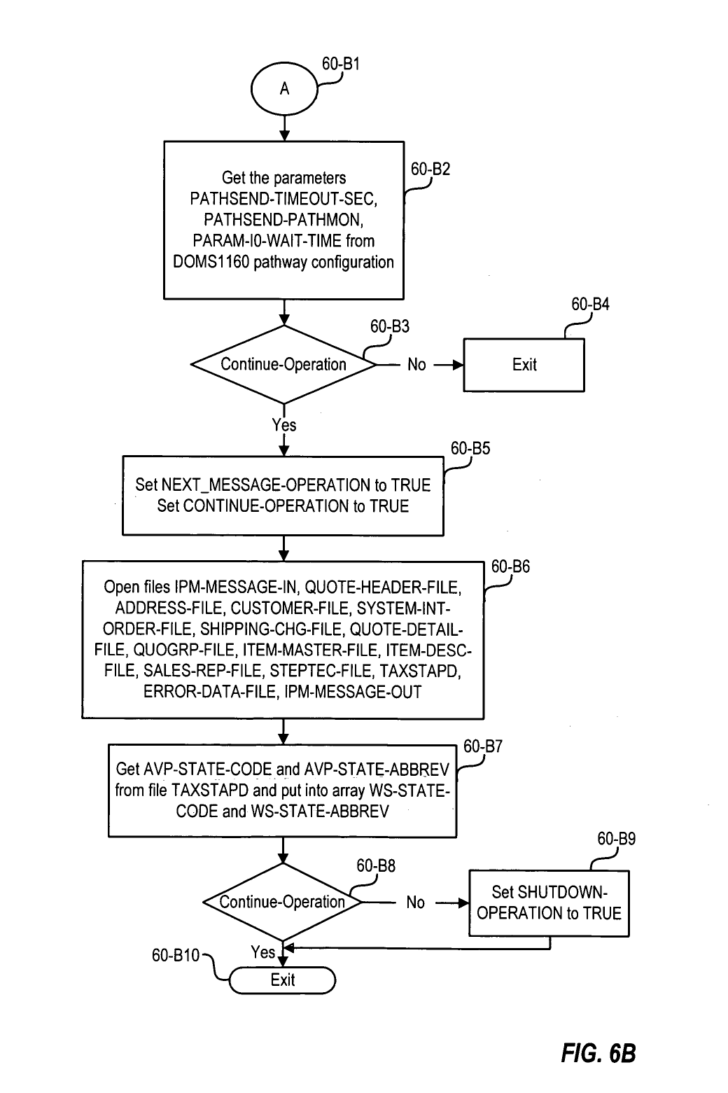

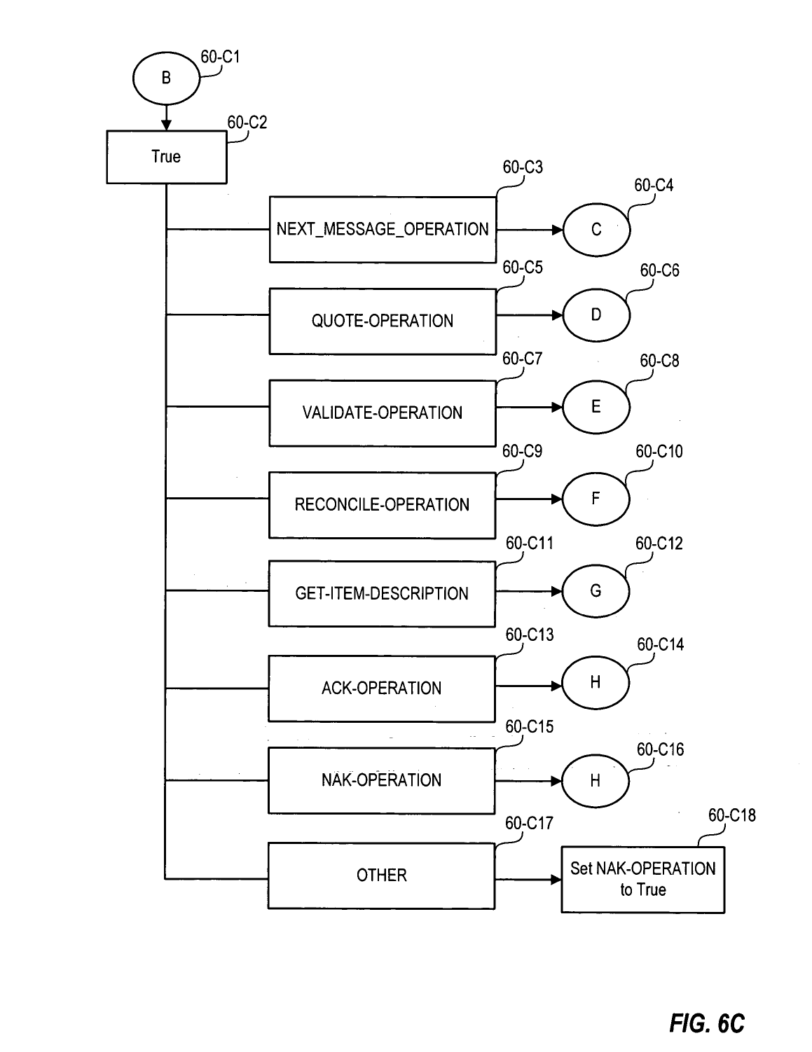

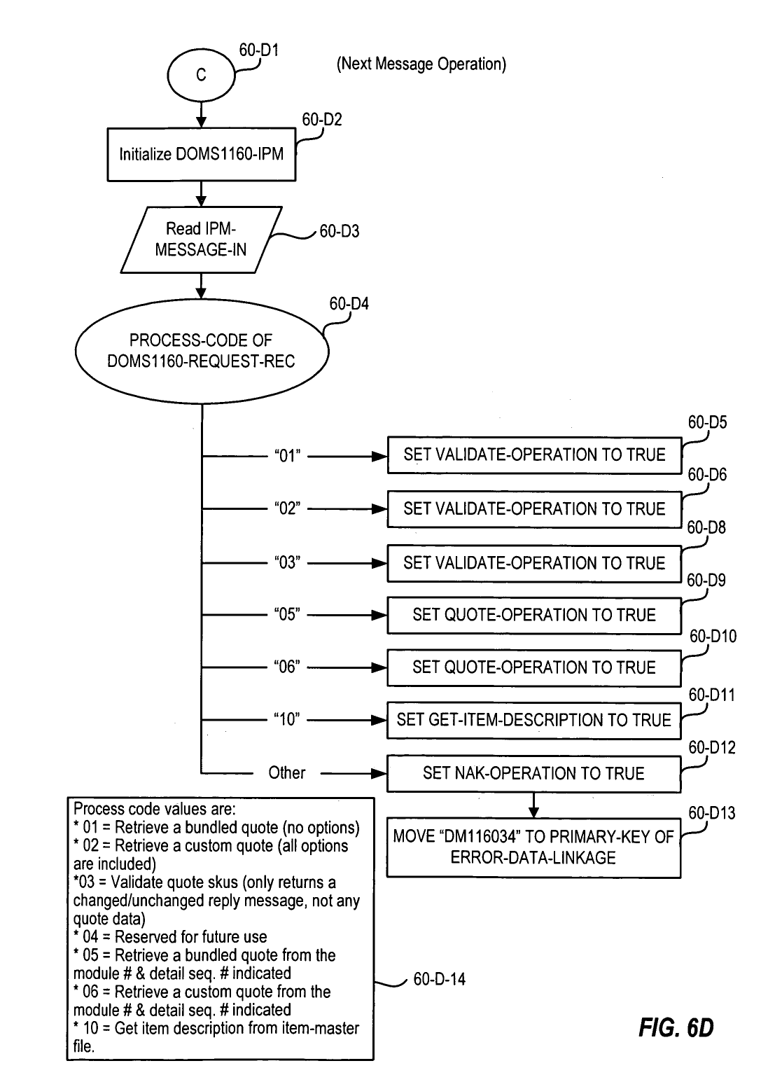

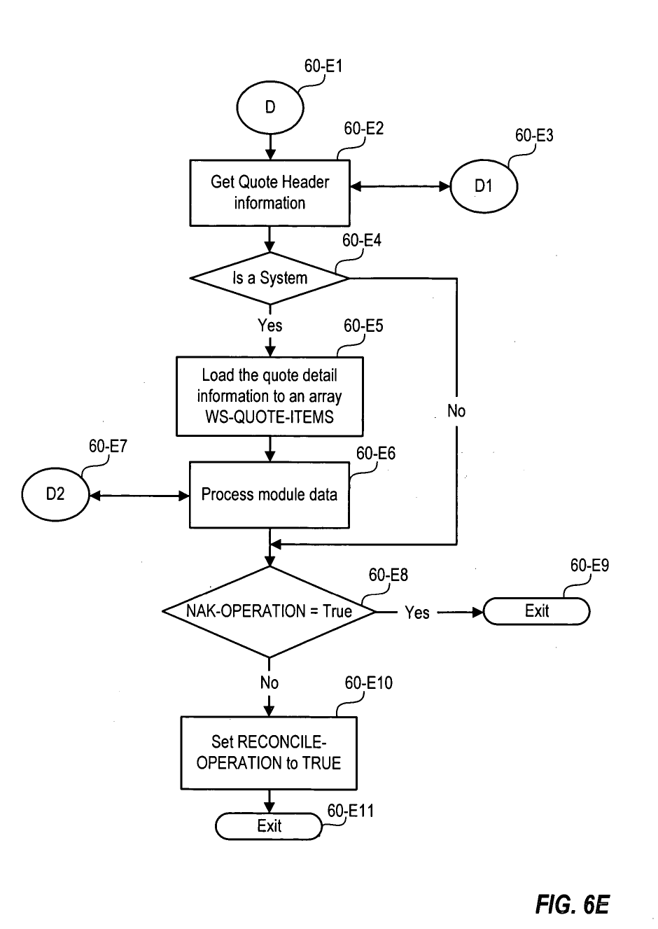

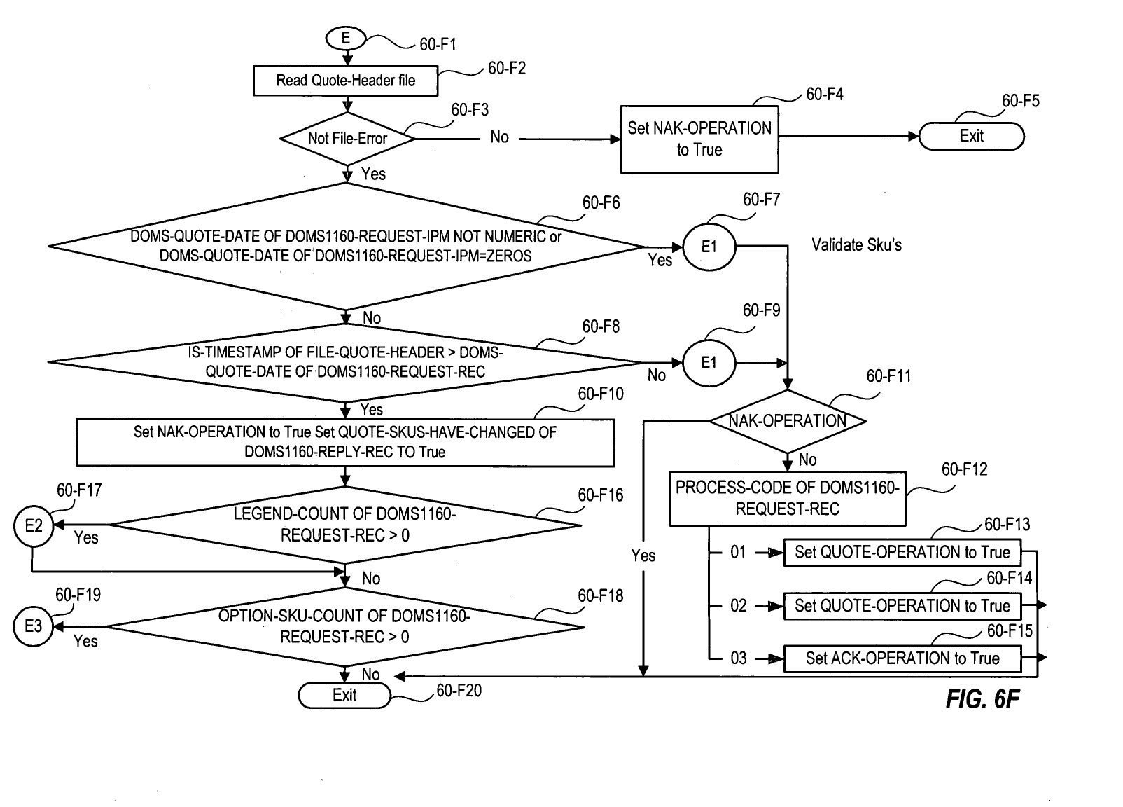

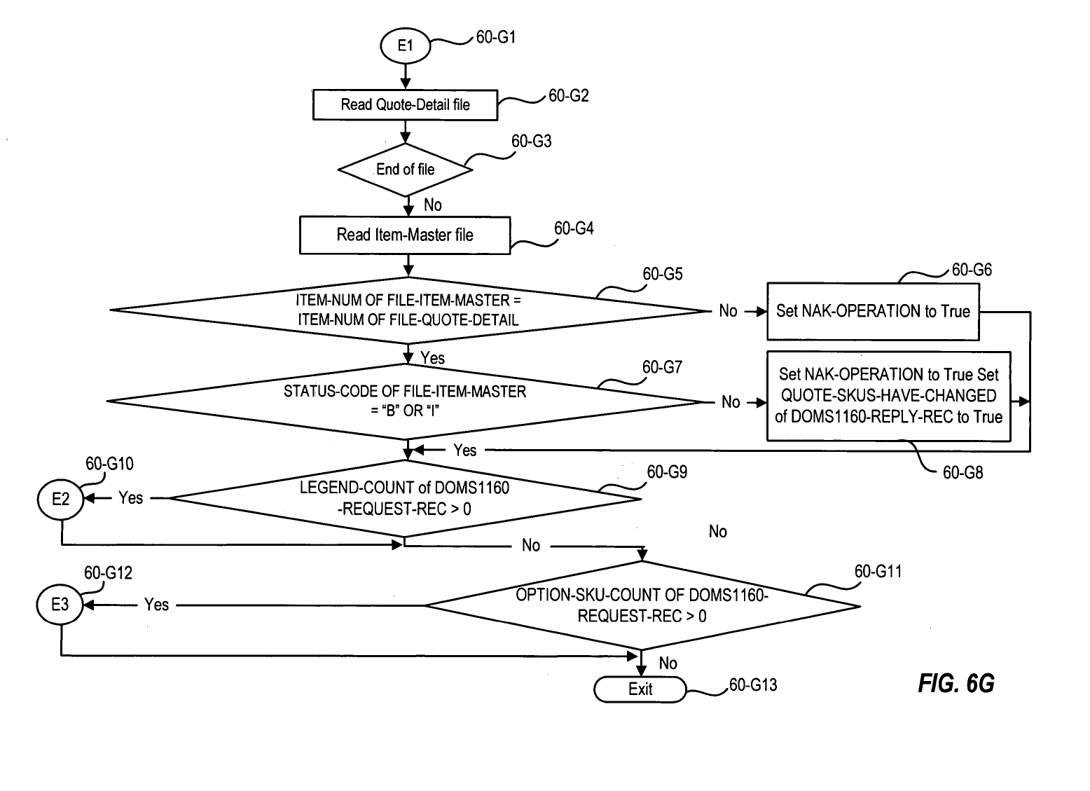

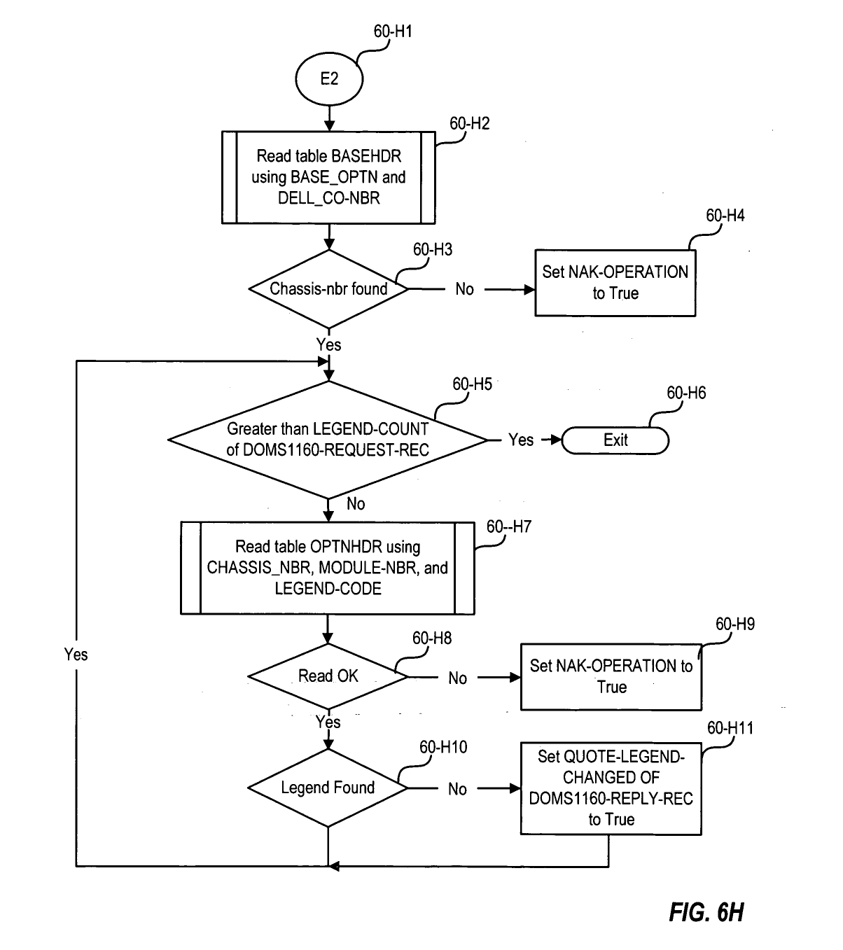

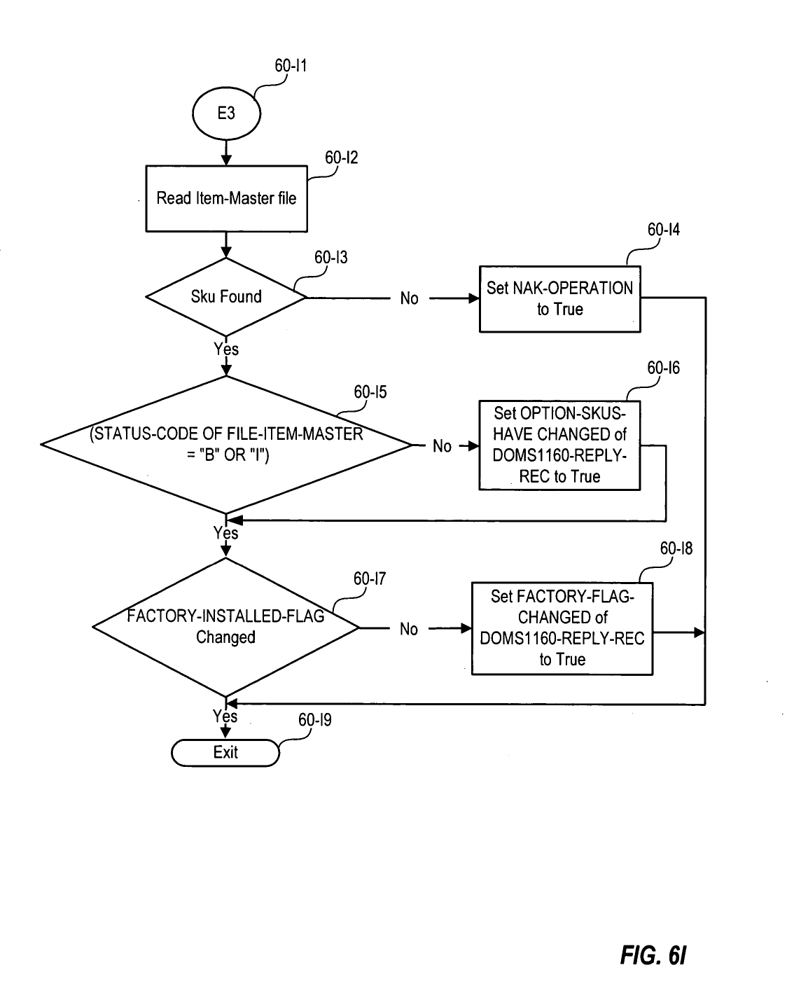

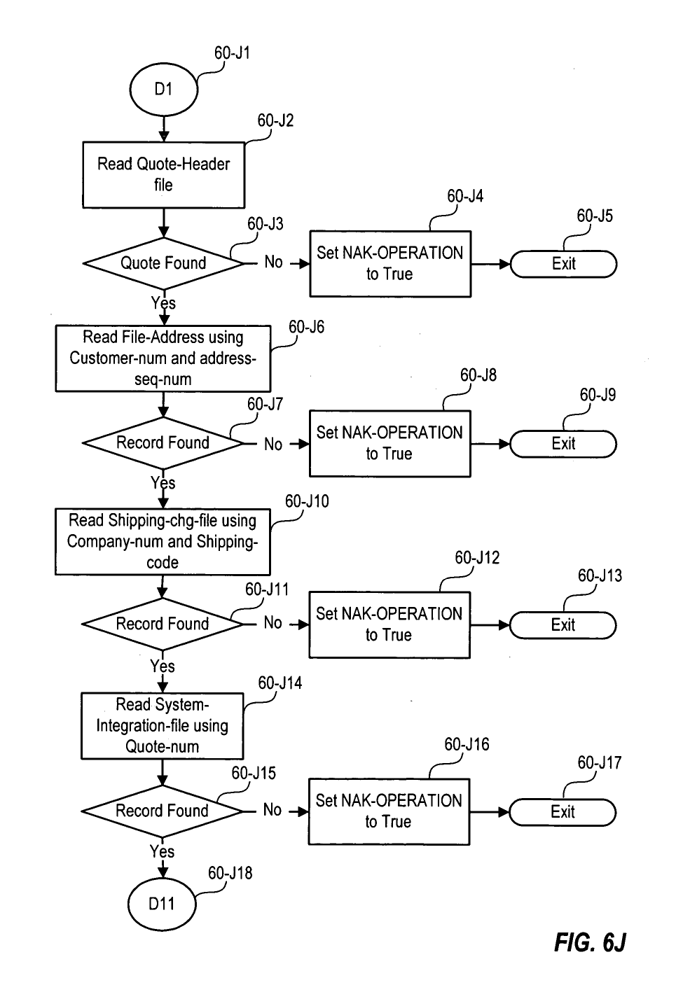

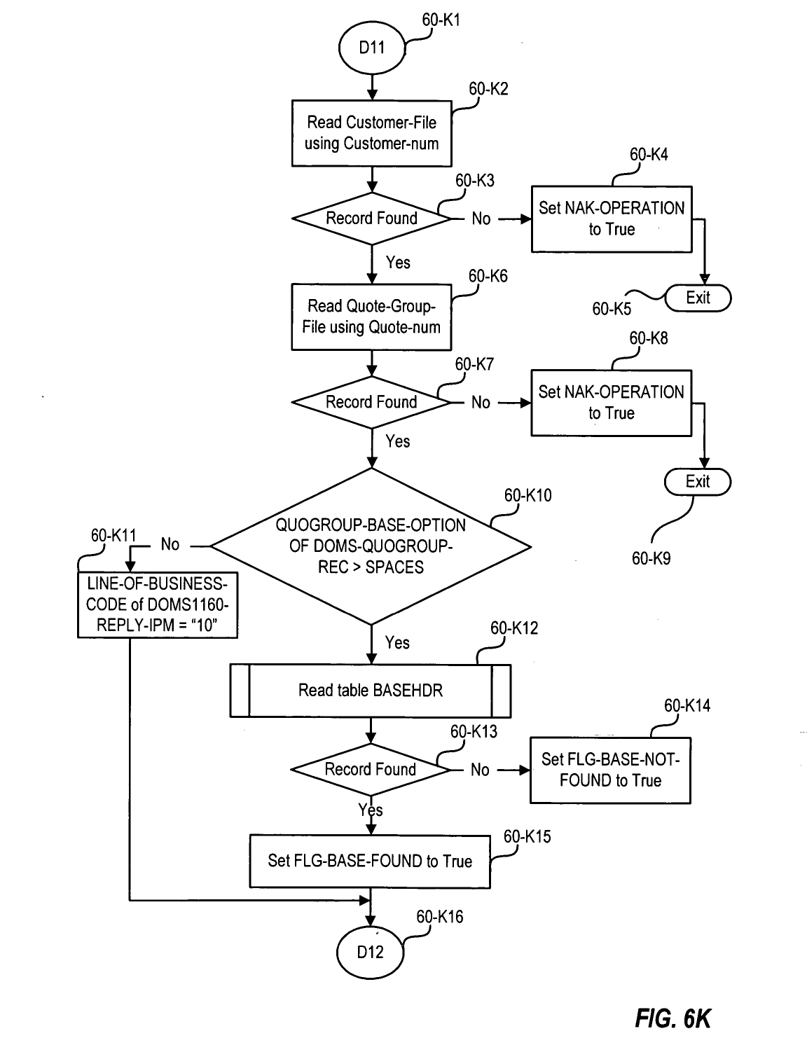

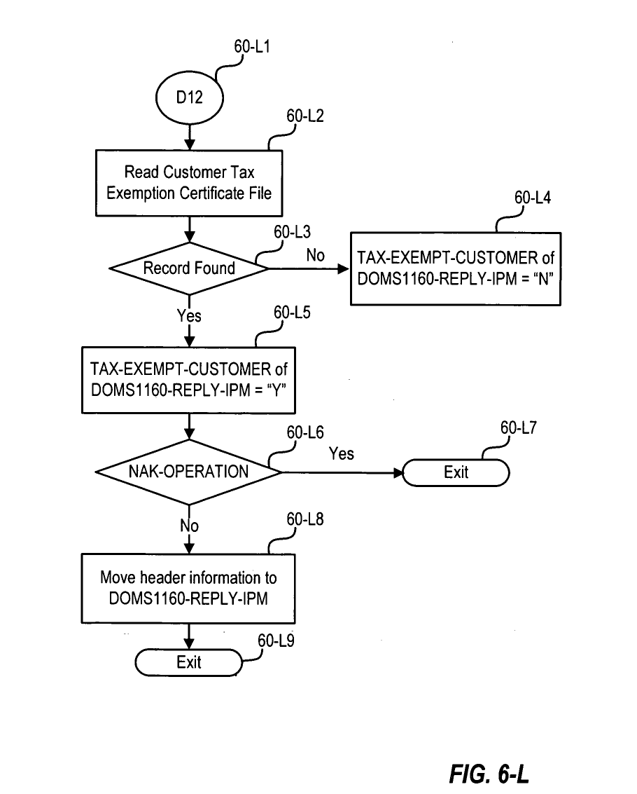

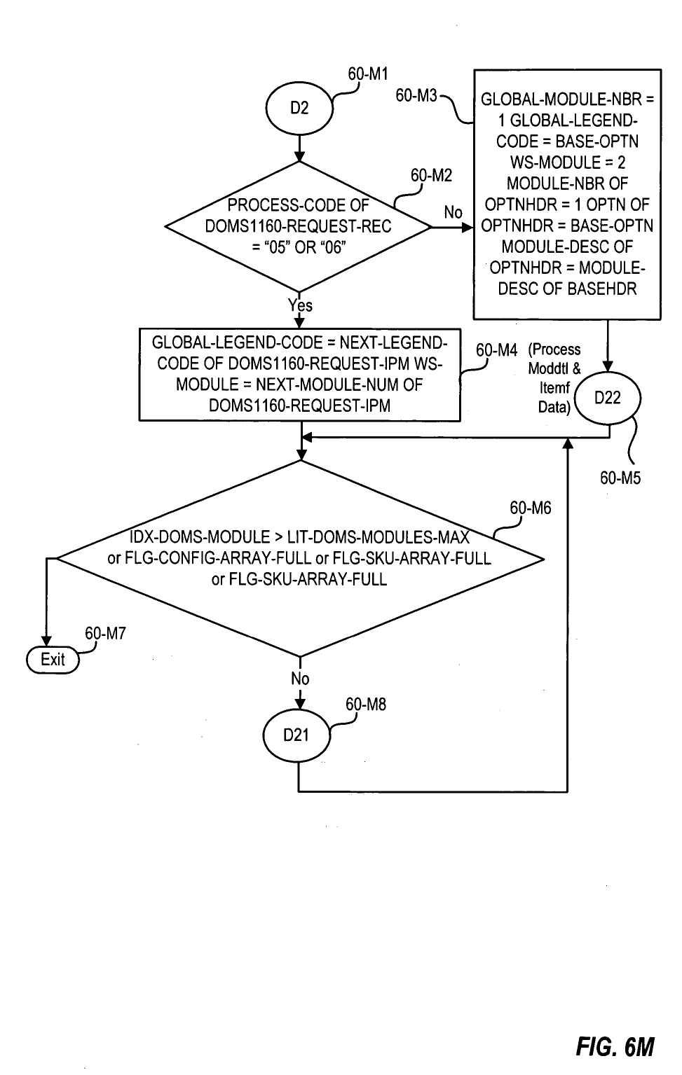

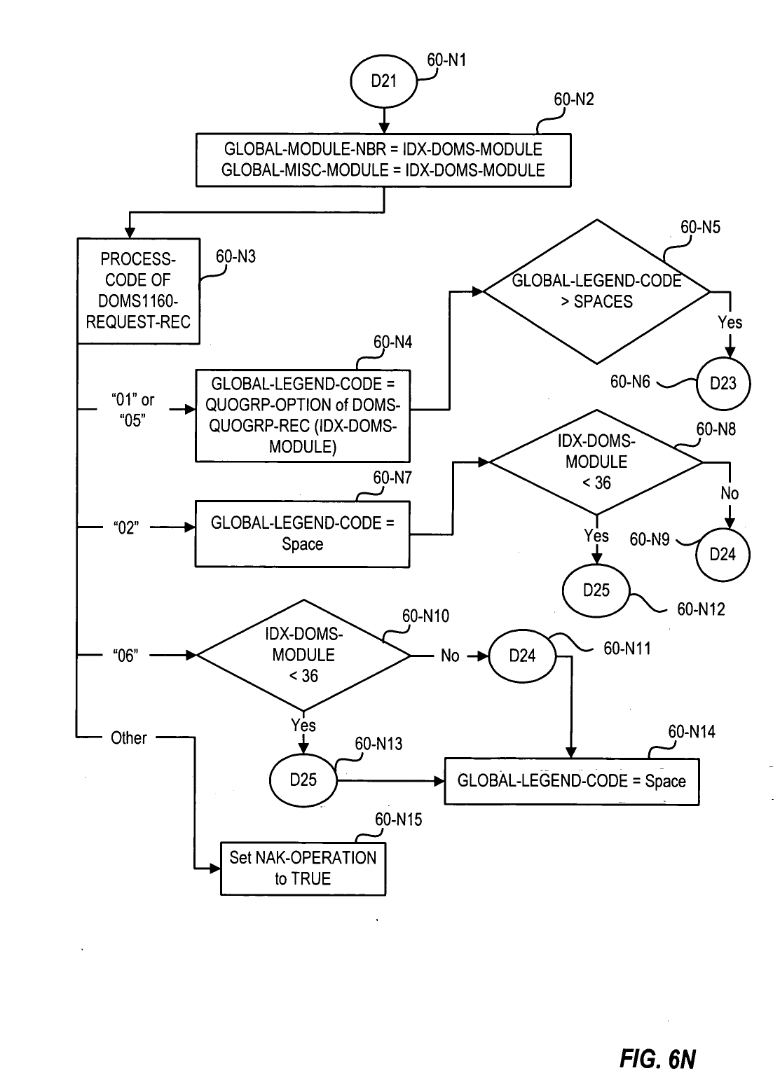

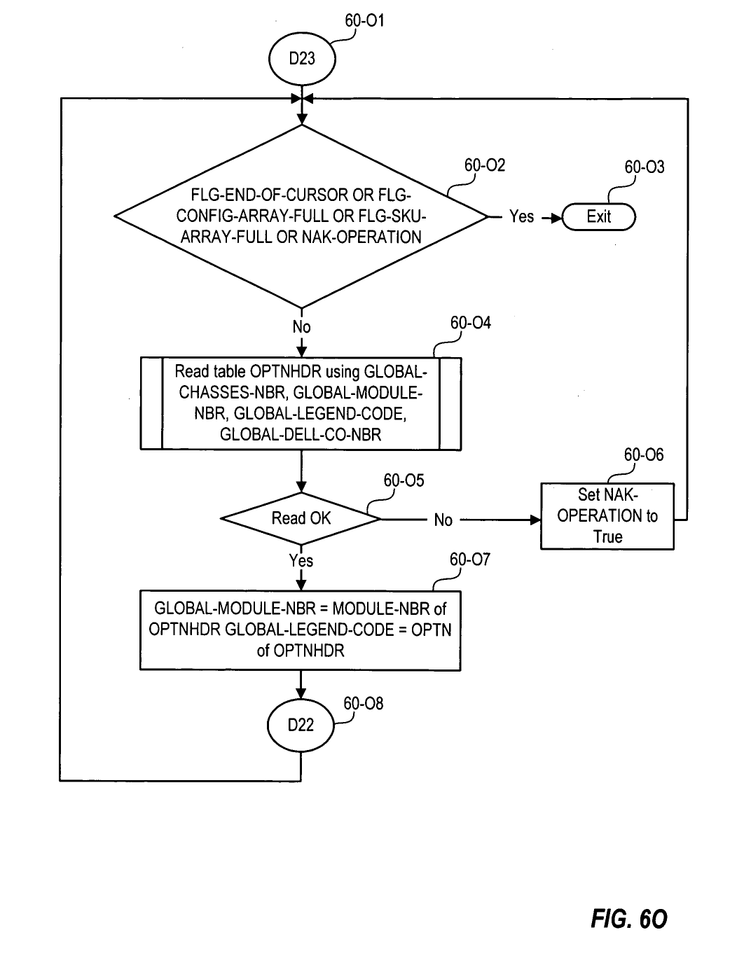

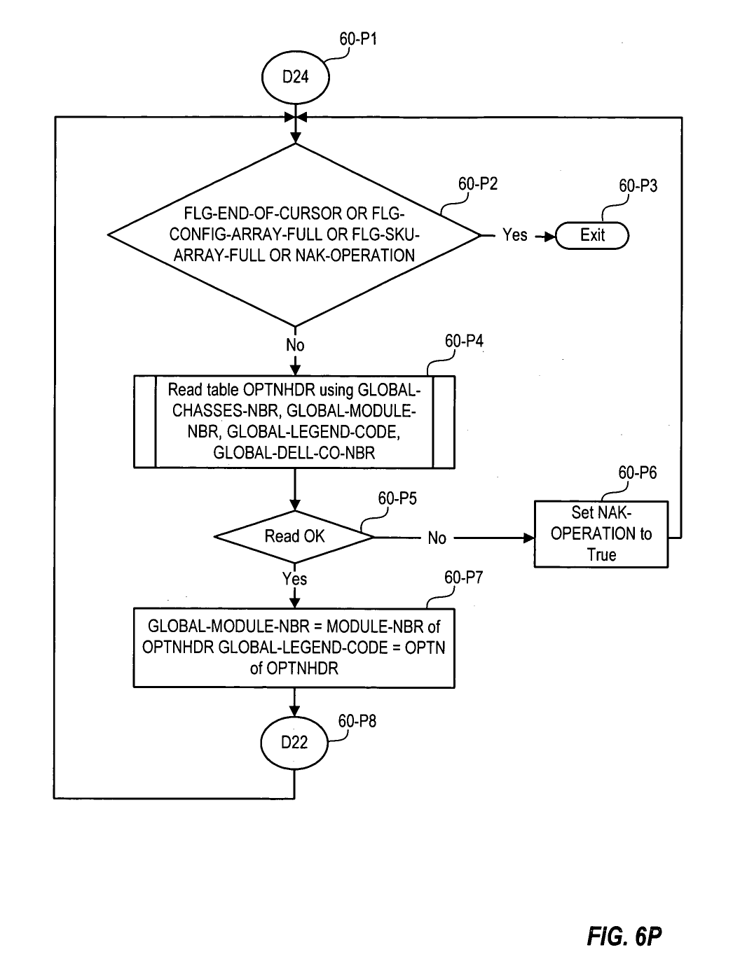

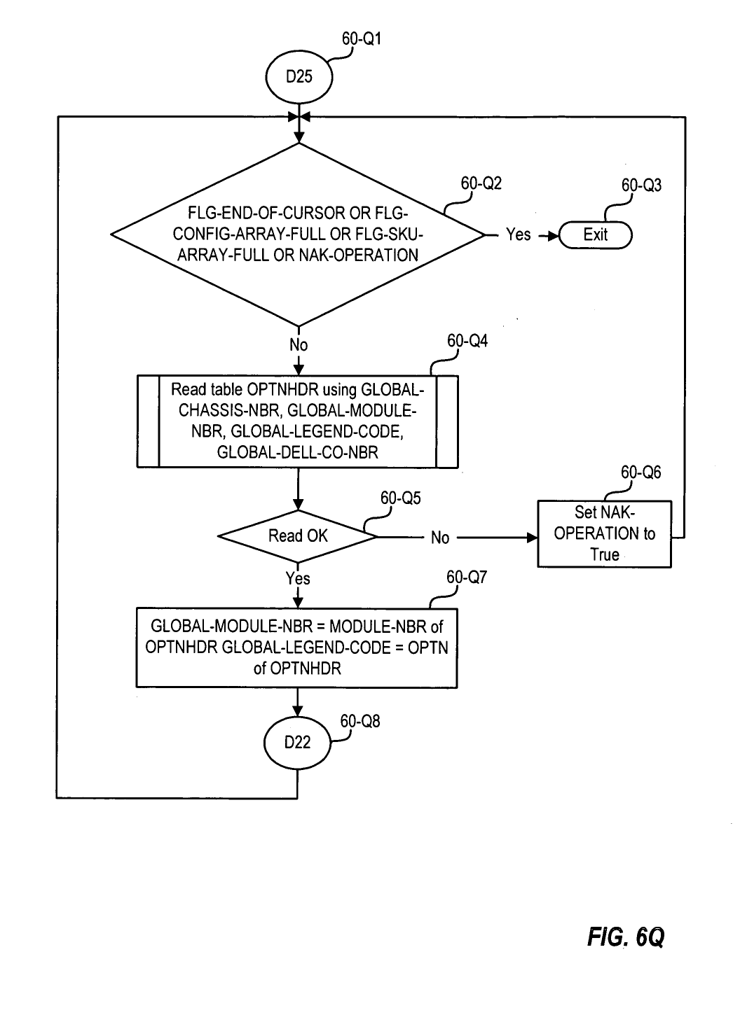

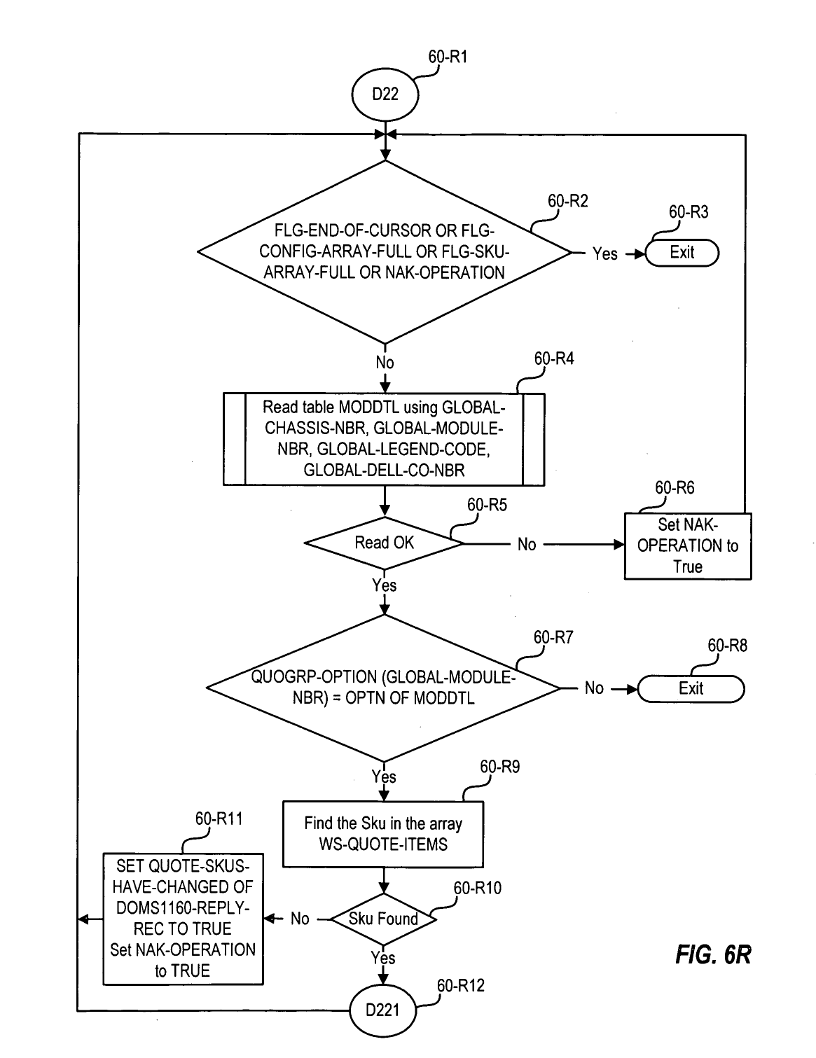

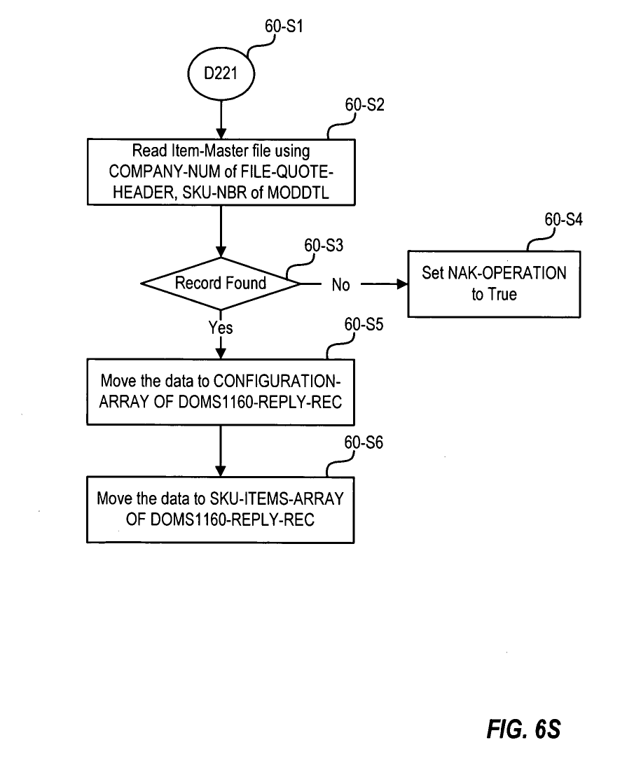

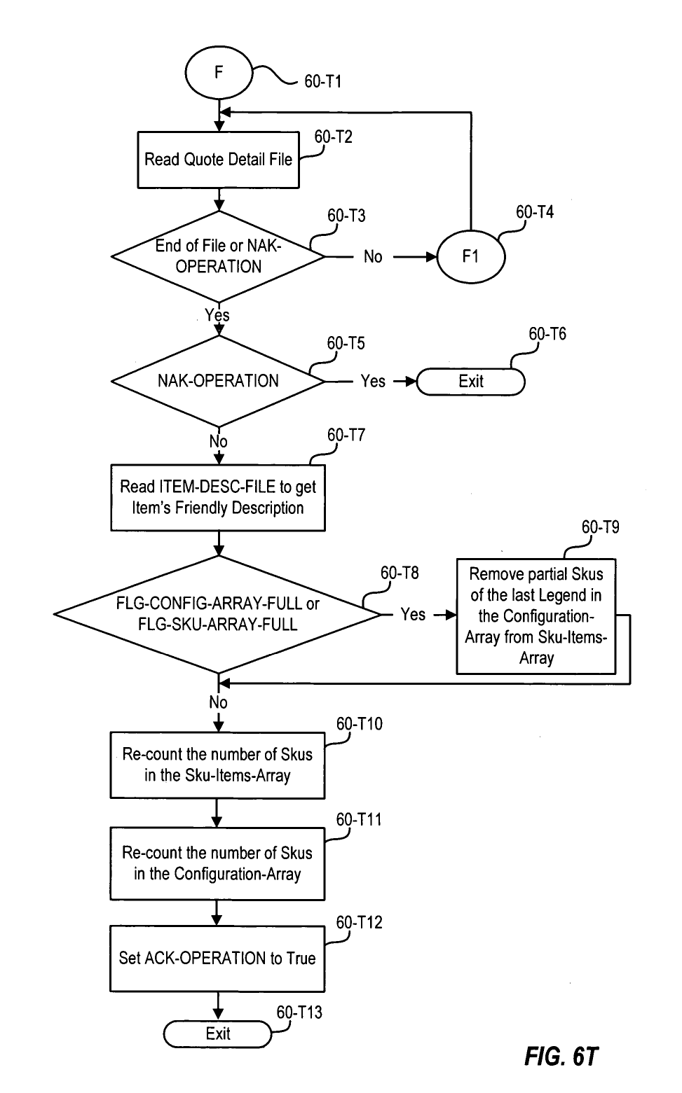

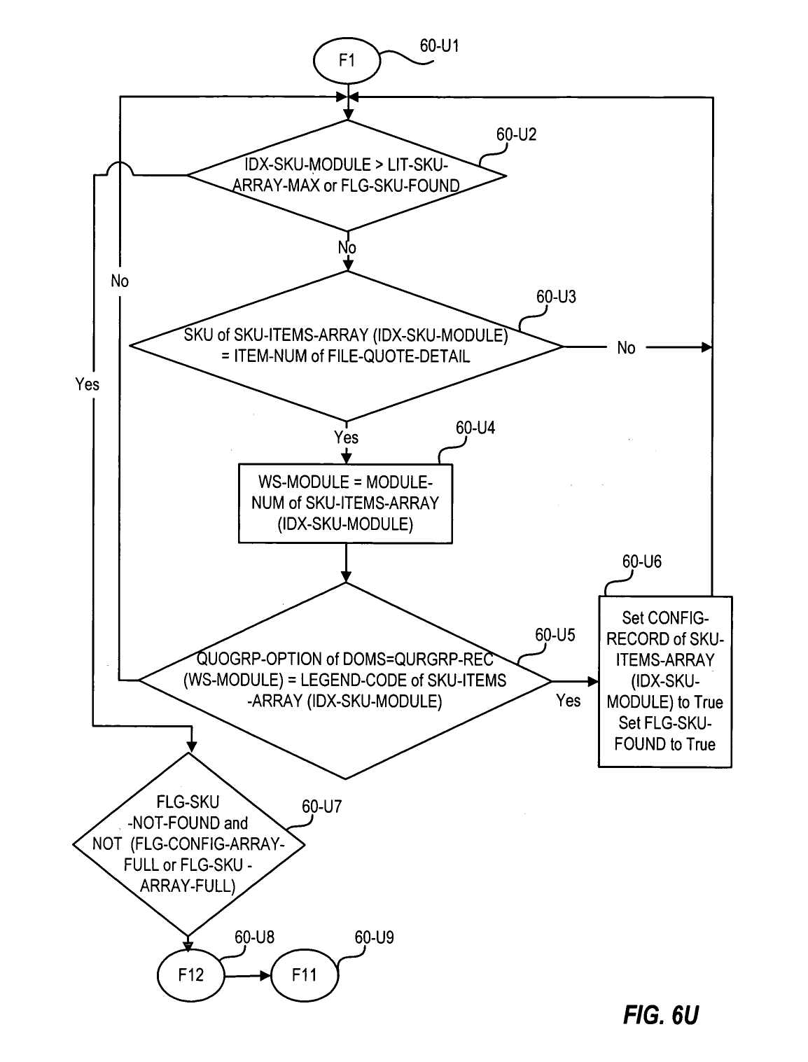

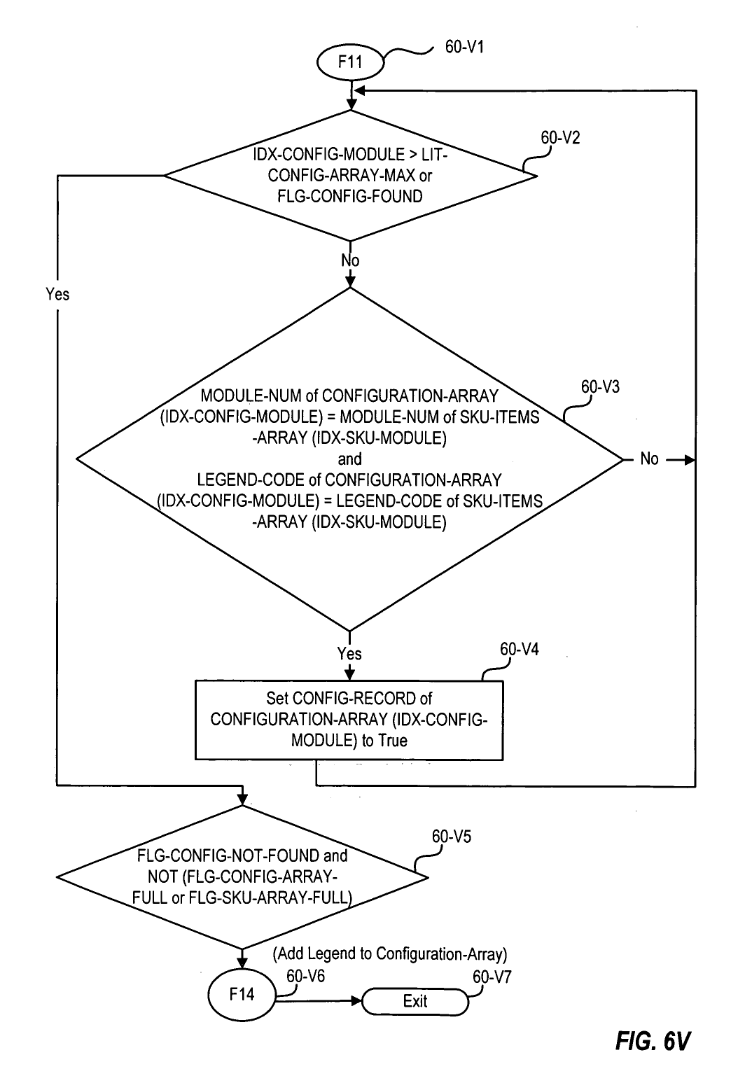

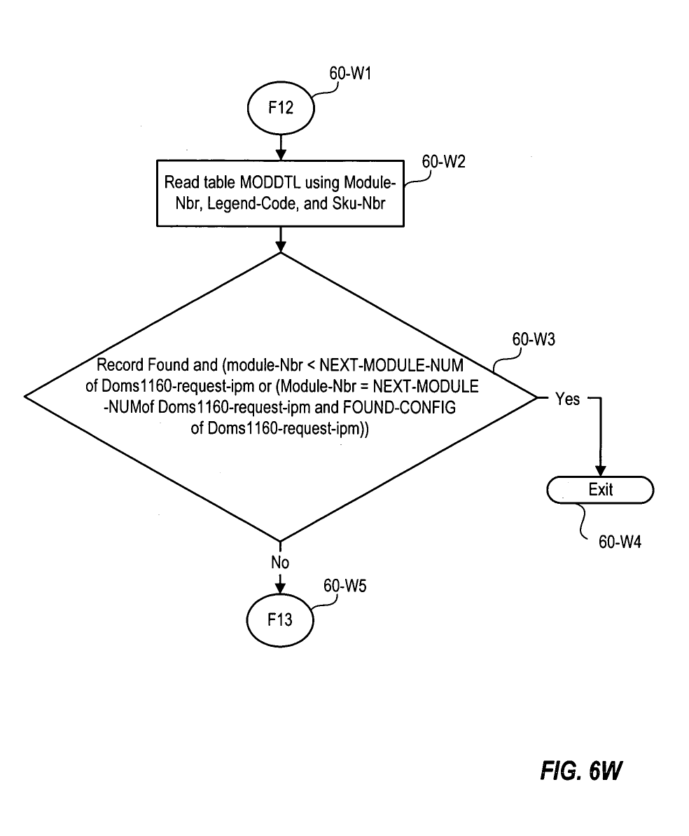

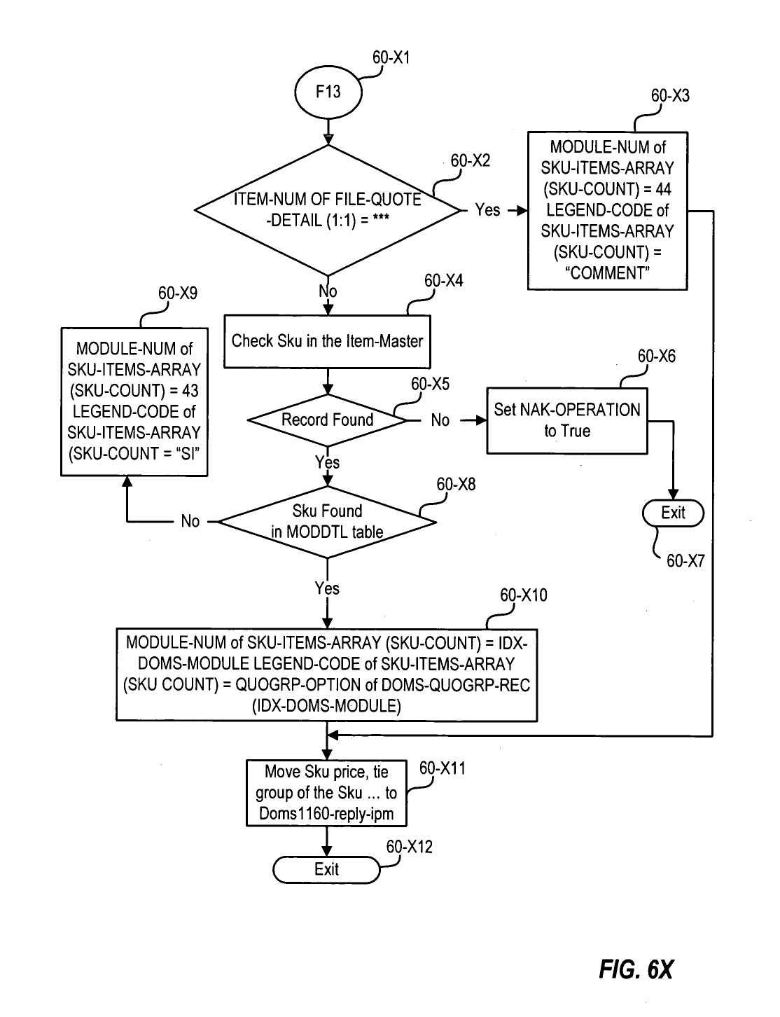

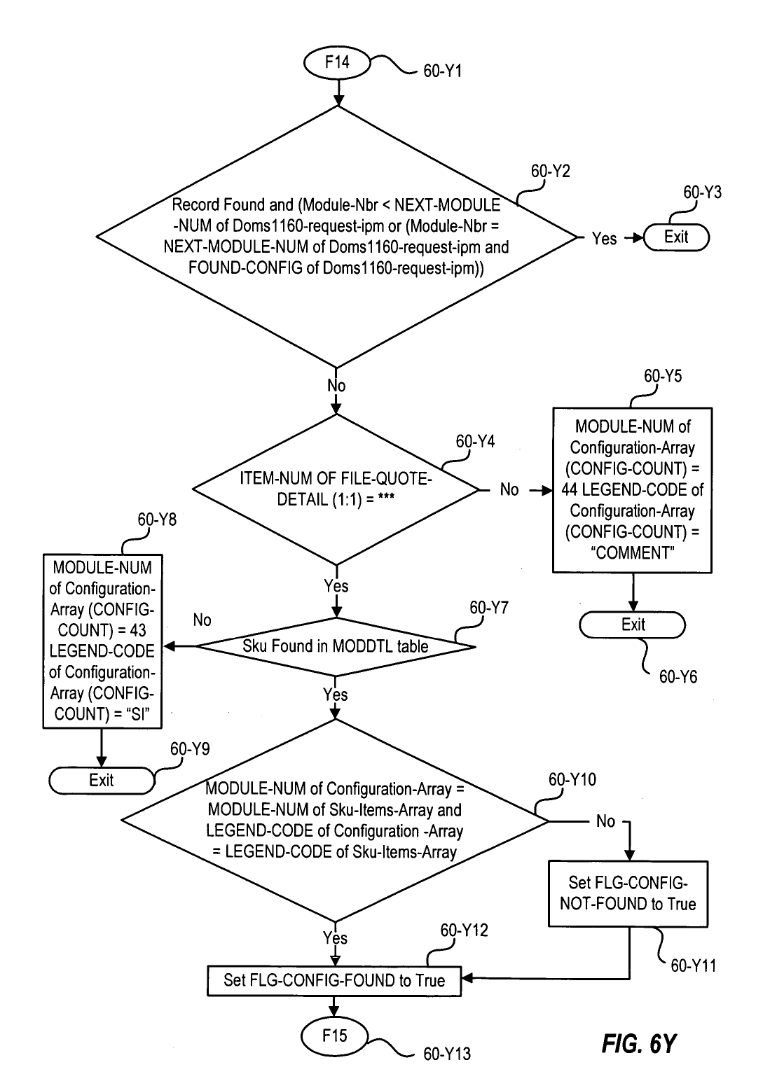

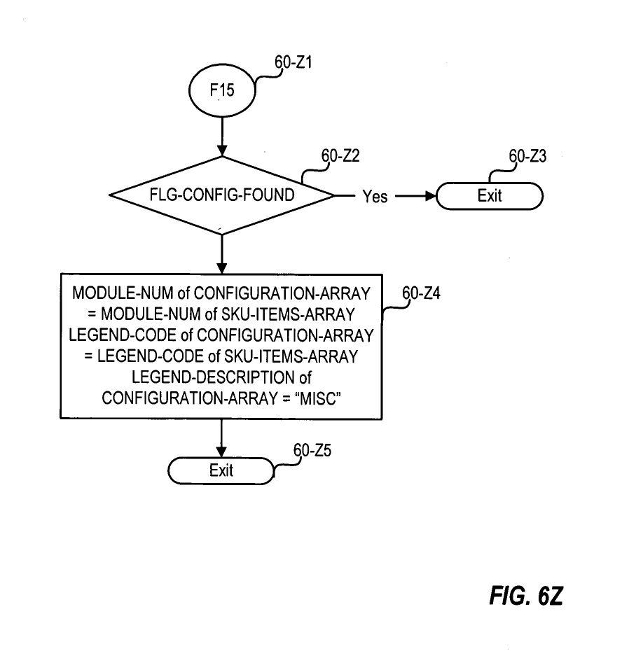

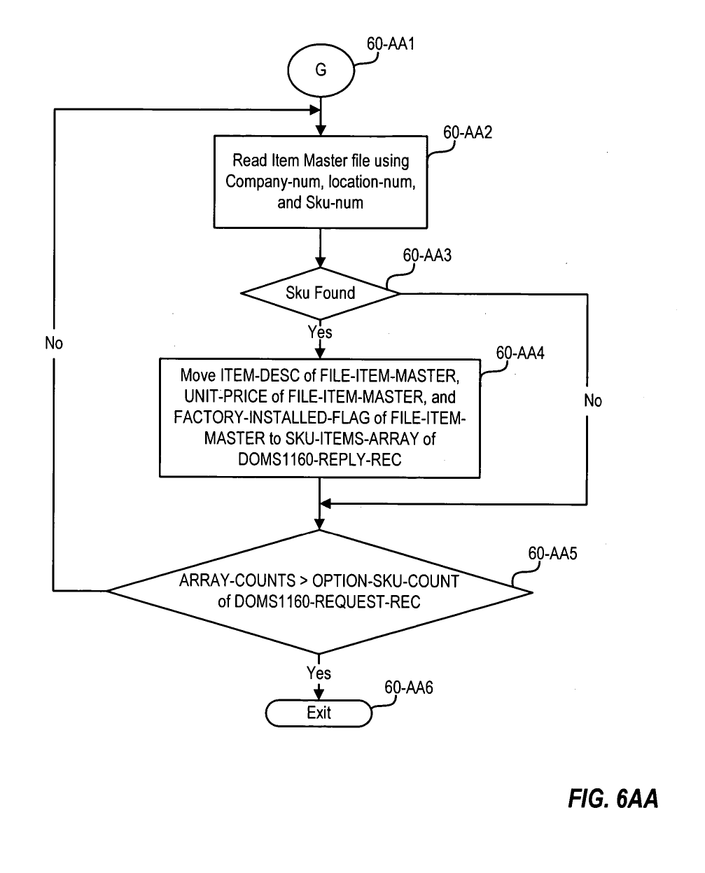

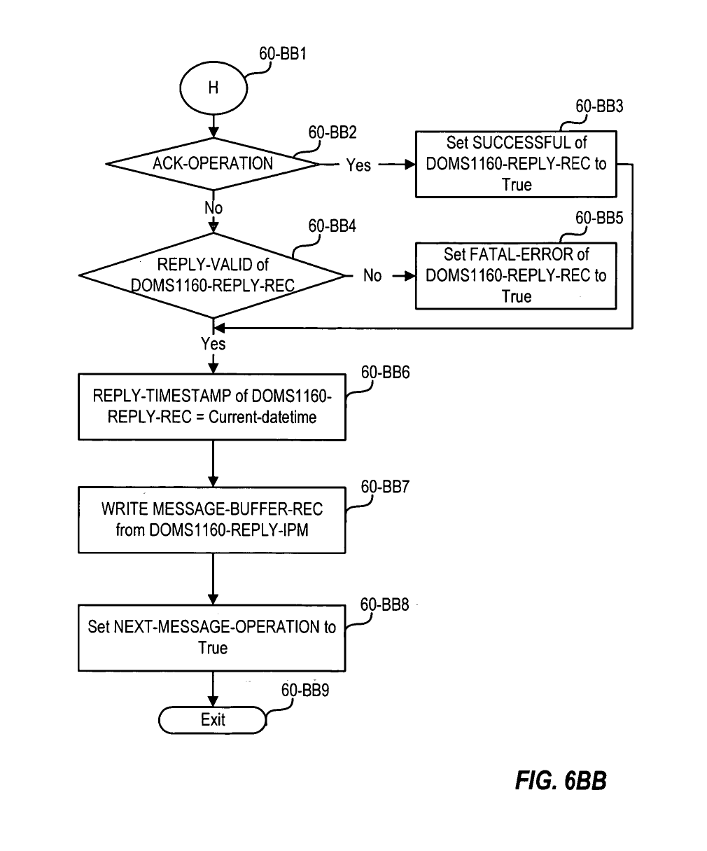

Software module 506a “reports” relates to software that generates at least two reports in human readable format. The reports are shown in detail in FIGS. 5-6AA through 5-6AH-8 inclusive. The reports are human readable reports for the commodity and non-commodity products offered in the catalog. The catalog file is machine readable and provides for a computer user to see actual data prior to sending the catalog file to a customer.

The catalog maintenance functionality module 503 enables three different modules, including customer email addresses module 504, catalog transport module 505, and quote list module 506, which is a shared functionality. The quote list module 506 enables a user to access five additional functionalities, including, a quote header editor module 507, extract data module 508, catalog file history module 509, catalog compare module 510 and SKU detail module 511. If a user chooses quote header editor module 517, the user access six different functionalities including, including quote detail module 512, quote status module 513, system description module 514, copy options module 515, replace quote module 516 and SKU detail module 511. SKU detail module is a shared module. A user choosing quote detail module 512 enables access to SKU detail module 511 and legend detail module 517. SKU detail module 511 further enables add customer kit module 518 and add custom solution module 519. The add customer kit module 518 enables delete customer kit 520. The add custom solution module 519 enables delete custom solution module 521.

Each of the modules described above in module 500 to 521 are explained in further detail through the flow charts shown in FIGS. 5-3, 5-4, 5-5, FIGS. 5-6A through 5-6G, FIGS. 5-7A through 5-7C, FIGS. 5-8A through 5-8K, FIG. 5-9, FIG. 5-10A through 5-10B, FIGS. 5-11A through 5-11G, FIG. 5-12, FIG. 5-13, FIG. 5-15A through 5-15E, FIGS. 5-17A through 5-17C, FIG. 5-18, FIG. 5-19A and 5-19B, FIG. 5-21, FIG. 5-22A and 5-22B. More particularly, the figures show flow logic diagrams that include the programming code used to create and maintain the catalog process. The figure numbers relate to the module thereby represented. For example, module 508 is depicted in the flow diagrams in FIGS. 5-8a through 5-8k. Likewise, the module 507 is depicted in flow diagram FIG. 5-7a. Module 517 is depicted in the flow diagrams of FIGS. 5-17a through 5-17e.

FIG. 5-3 relates to the module shown in FIG. 5, catalog maintenance 503. As shown in FIG. 5-3, the logic flow diagram includes steps 3A1 through 3A16. The flow diagram retrieves catalog data from the AoE database 200 and displays the data on the GUI. The values included on the screen for the maintenance of the catalog include contact names of computer users of the manufacturer, customer contact names, catalog types, currency types, exchange rates, and appropriate data related to business interactions. A computer user within the GUI can alter data stored in the AoE database 200 as needed. In one embodiment, the ability to alter data depends on appropriate permissions.

Referring now to FIG. 5-4, a flow diagram illustrates the logic for module 504 shown in FIG. 5. The logic provides lists of email addresses of those who receive notification of catalog changes or discrepancies. The email addresses are shared by different AoE server programs that automatically and manually notify computer users. The ability to add and delete email addresses may optionally be dependent on user permission levels.

Referring now to FIG. 5-5a flow diagram, including blocks, 5A1 through 5A16 illustrates the catalog transport module 505. The module lists the data used to transmit and receive catalog and catalog acknowledgment files in block 5A8. The data from the AoE database 200 that is used by the extract process and the acknowledgment process discussed above are retrieved in block 5A3. The data listed in block 5A8 includes customer prefix name, transport type, and file format.

FIGS. 5-6A through 5-6G illustrate a flow diagram for creating a catalog using the quote list functionality of module 506. The flow diagram enables a computer user to create a catalog file and post the file to a designated site for transmission to a customer. The catalog creation process is shown in block 6A9 and in fuller detail in FIG. 6-6B. As shown in FIG. 5-6B, blocks 6B1 through 6B19, data stored in the AoE database 200 is retrieved in turn. FIG. 5-6C illustrates further accesses to AoE database 200 in block 6C2 and 6C7. Blocks 6C4, 6C13 and 6C17 provide for opening an output catalog file 6C5 and adding to that file data including customer data in block 6C7, routing data in block 6C13 and header data in block 6C16.

Further data is written into the catalog file as shown in FIG. 5-6D. More specifically, blocks 6D1 through 6D18 illustrate a flow diagram for completing the catalog file. FIG. 5-6E illustrates the final completion blocks for the catalog file in blocks 6E1 through 6E6. One of the more detailed blocks relates to writing legend and SKU details in the catalog file. FIG. 5-6F illustrates the flow logic for retrieving the SKU and legend and SKU details. Blocks 6F1 through 6F19 illustrate the flow logic for retrieving pricing, quote details and SKU data. The flow logic continues retrieving and writing quote detail in blocks 6G1 through 6G19 in FIG. 5-6G.

Referring to FIGS. 5-6AA through FIG. 5-6G, flow diagrams illustrate a method for providing an options report. More particularly, the flow diagram shows a configuration reporting functionality accessible through the Quote List module 506 shown in FIG. 5 of the AoE GUI 402. This report is in a human readable and tab delimited format that lists option only information for a configuration in an effective catalog. The report includes the following data elements: option code, SKU Number, SKU pricing, action codes for an upgrade, downgrade, and add. If the configuration is replacing another configuration, the relationship with the new configuration is given. A system type code represents whether a system is commodity or non-commodity. Further codes include system description, effective date of the configuration, discontinued date of the configuration, component type, SKU description, and pricing.

Another report, a pricing report, is generated according to flow diagrams in FIG. 5-6AH-1 through 5-6AH-8, including blocks 6-AH1 through 6-AH103 inclusive. flow diagrams illustrate a method for providing a complete report of a configuration including options included as part of the configuration. More particularly, the flow diagram shows a configuration reporting functionality accessible through the Quote List module 506 shown in FIG. 5 of the AoE GUI 402. This report is in a human readable and tab delimited format that lists a complete configuration and any options included as part of the configuration The report includes the following data elements: option code, SKU Number, SKU pricing, action codes for an upgrade, downgrade, and add. If the configuration is replacing another configuration, the relationship with the new configuration is given. A system type code represents whether a system is commodity or non-commodity. Further codes include system description, effective date of the configuration, discontinued date of the configuration, component type, SKU description, and pricing. Unlike the options report, the pricing report gives complete line item detail for options as well as core components.

Referring to FIG. 5 in combination with FIGS. 5-7A, 5-7B and 5-7C, a flow diagram for block 507 is shown in fuller detail. The logic shown resides in the AoE user interface GUI 402 and gives users the ability to view and update Quote Header information on a configuration by configuration basis. The logic displays both catalog server 410 quote header information (such as quote total, system integration number, and line of business code) as well as quote header information that was entered through AoE database 200, (such as system description, effective date, discontinued date, and system type). According to one embodiment, a user must have the appropriate permissions level to modify the data displayed according to the logic of flow diagram 507. The data includes configuration total data, system integration data and line of business data. Blocks 7A1 through 7A11 illustrates the primary flow diagram for the logic, including retrievals from AoE database 200.

Referring to FIG. 5-7B, a “ready to send” flow logic is illustrated in blocks 7B1 through 7B12, the functionality allows a computer user to set a configuration into the status for another function for extracting the catalog file for pick up and add to a next version of a catalog file. The process shown in FIG. 5-7B includes checks of required fields, such as description, checks of prices and checks of the current configuration status to validate each field. Referring to FIG. 5-7C, the process continues in blocks 7C1 through 7C15. At block 7C10, the updates are committed after the validation process.

Referring now to FIGS. 5-8A through 5-8K, flow diagrams depict the logic that allows the GUI 402 user to extract data in the form of a “quote” from the non-Windows database and catalog server and store the data in the AoE database 200. A quote includes all configuration data required in a catalog being constructed by a user.

FIG. 5-8A includes blocks 8A1 through block 8A12 inclusive. The logic in the form of flow diagrams begins with start block 8A1 and continues with the user displaying the “add quote screen” 8A2. From there, the logic flow includes providing for a user to indicate whether data to be retrieved is a “bundle” or “custom” product. For example, if a product is a non-commodity type product requiring configuration, the product would be identified as a custom product in blocks 8A3 and 8A9. The logic further includes error handling block 8A4, and initialization of parameters block 8Af10. FIG. 5-8B includes block 8B11 through block 8B20 inclusive. As shown, the FIG. 5-8B is a loop that retrieves each parameter required for a given configuration. The loop continues until each parameter is extracted from catalog server 410. The flow diagram logic loop continues until FIG. 5-8G, wherein the determination of the loop depends on whether each option for a configuration has been received. More specifically, FIG. 5-8C, including blocks 8C1 through 8C22, loops through strings, unconcatenating strings, determining whether SKUs and other data have changed in a database. The process of looping through strings continues in FIG. 5-8D in blocks 8D2 through 8D5. If the status is identified as “OK” in block 8D5, block 8D9 begins a process of looping through arrays to concatenate a system description in block 8D11. The process continues in FIG. 5-8E with blocks 8E1 through 8E16. More particularly, blocks 8E3 through 8E8 provide for inserting configuration and option records into the AoE database 8E6, and blocks 8E9 though 8E14 provide for inserting SKU data into the AoE database 8E12. FIG. 5-8F continues the process in blocks 8F1 through 8F19, including inserting SKU pricing in blocks 8F2 through 8F8 into AoE database 8F6. Blocks 8F10 through 8F17 provide for inserting quote status and other data into the AoE database in blocks 8F12 and 8F15. The process continues in FIG. 5-8G with blocks 8G1 through 8G16, wherein data inserted into the AoE database in block 8G4 includes customer number, certification number, state and jurisdiction data and other data for those customers that are tax exempt. Block 8G7 provides for determining whether a product for the catalog is a bundled product or a custom configuration product. For those products that a bundled, an inventory process described below applies to pre-build certain products. A custom product relates to those products that are non-commodity products that are configured after the catalog is distributed to a customer. Those products that are non-commodity products and those that are bundled are given chassis numbers, module number and a legend code in block 8G10. FIG. 5-8H includes blocks 8H1 through 8H15, continuing with the process of preparing a configuration for a catalog file for a customer. FIG. 5-81 and 5-8J, including blocks 811 through 8112 and blocks 8J1 through 8J18, respectively, include finding matches for SKU pricing in blocks 813 and 8J10. FIG. 5-8K includes blocks 8K1 through 8K14 completes the loop of determining configuration details and prices, including inserting records into a quote status table in AoE database 200 in block 8K10 and notifying a computer user of a successful extraction of data in block 8K13.

Referring back to FIG. 5, module 509, catalog file history is shown in flow logic diagram in FIG. 5-9. FIG. 5-9 includes blocks 9A1 through 9A12. The logic flow diagram functions to give a computer user a historical view in block 9A10 of every catalog sent to a particular customer. The module lists every catalog sent for a customer by looping in block 9A7 and its catalog version number, send date, catalog data and acknowledgment date, as applicable. The module further lists each quote number included in each catalog, a quote status, and acknowledgment status.

FIGS. 5-10A and 5-10B, including blocks 10A1 through 10A11 and blocks 10B1 through 11B8 respectively, provide the flow diagrams for module 510 shown in FIG. 5. More particularly, the flow diagrams ensure that SKUs and prices match with data stored in the AoE database 200. FIG. 5-10B provides for further matching as well as transferring the catalog in block 10B6 to an FTP site for a customer. Although the block relates to an FTP site, other embodiments include posting the catalog on a web site or transmitting the data via other communication media, such as a Ti line or wireless communication network as described for communication medium 250 in FIG. 2.

FIG. 5-11A through FIG. 5-11D provide flow logic diagrams for module 511 shown in FIG. 5. The figures provide SKU detail data on a configuration by configuration basis to a computer user. The module displays all available configuration and option parts for a configuration, along with its price, parent solution designation, legend code, module number and SKU description. FIG. 5-11A includes block 11A1 through 11A22, including retrieval of price data from a SKU pricing table in AoE database 11A10 in blocks 11A9. FIG. 5-11B illustrates flow logic diagrams for SKU reassignment and pricing changes, enabling computer users to update SKU module numbers and prices in blocks 11B1 through 11B13. The process continues in FIG. 5-11C in blocks 11C1 through 111C8. FIG. 5-11D, shows blocks 11D1 through 11D20, wherein updates of SKU pricing, quote details, SKU details and quote details are saved in the AoE database 200.

FIG. 5-11E provides blocks 1E1 through 1E15, showing the logic flow for module 520 shown in FIG. 5. The flow logic enables a computer user to add custom solutions to a configuration. The logic displays all available configurations that can be added as a solution for another configuration. Custom solutions include non-commodity solutions for a product. More particularly, FIG. 5-11E, FIG. 5-11IF and 5-11G represent one flow logic diagram in blocks 11E1 through 11G9. FIG. 5-11E includes the portion of the diagram that retrieves configuration detail from a table in the AoE database 200 and fills in a description in block 11E14. FIG. 5-11F includes the portion of the diagram that retrieves custom configuration details from AoE database 200 in block 11F6, adds “parent” records in block 11F8, adds children records in block 1F10 and SKU details of a customer recordset from a SKU detail table in blocks 11F11 through 11F13. FIG. 5-11G includes adding new records to the SKU detail recordset in block 11G3 and retrieving custom SKU pricing from the AoE database 200 in block 11G4, continuing through block 11G9.

Referring to FIG. 5-12, the module “QuoteDetail” 512 shown in FIG. 5 is shown in flow logic diagram in blocks 12A1 through 12A13. The logic allows a computer user to view and update configuration detail data on a configuration by configuration basis in blocks 12A2 and 12A10, displaying available OMS component modules for a configuration and defaulted legend code values for each of the OMS component modules.

FIG. 5-13 provides a flow diagram for module “Quote Status” 513 shown in FIG. 5. More particularly, the module allows a computer user to view configuration status data on a configuration by configuration basis, looping through records in blocks 13A4 through 13A10 after retrieving appropriate data from the AoE database 200 in block 13A3.

FIGS. 5-15A through 5-15E provide one flow logic diagram for options 515 and 516 shown in FIG. 5. More particularly, the diagram provides a computer user with the ability to create a configuration replace/supercede relationship between two configurations from different catalogs as part of a price refresh agreement. The functionality further allows a computer user to copy selected options from one non-commodity configuration to another and save time when configuring quotes. Prices for the configurations can be adjusted when pulling options. More particularly, FIG. 5-15A provides for setting up the ability to refresh, by ensuring appropriate nomenclature in blocks 15A1 through 15A21, continuing in FIG. 5-15B, wherein the logic determines whether or not a product is bundled in block 15B7, if not, further steps are taken to get a recordset of parent and child SOL records and other data in block 15B10 and block 15B12, and moving SOL record to first records in blocks 15B14 and 15B15. The logic diagram continues in FIG. 5-15C blocks 15C1 through 15C14 wherein the records are displayed in the AOE GUI 402 grid for a solution.

FIG. 5-15D continues the logic diagram including inserting options into quote detail, SKU and SKU pricing tables for replacing configuration in the AoE database 200. The actual replacement of records occurs in blocks 15D7 through 15D16 wherein the records for the new configuration are inserted by using SQL statements in block 15D13 continuing with inserting the current quote status into quote status table for an old configuration in block 15D14, continuing in FIG. 5-15E with updating of the AoE database 200 in block 15E3, inserting the current quote status into the quote status table in block 15E7.

Referring now to FIG. 5-17A through 5-17C, a flow diagram for module 517, “Legend Detail” shown in FIG. 5 is illustrated. The flow diagram includes blocks 17A1 through 17C 15. As shown in the diagram, the logic allows a computer user to enable all options offered in a configuration to be delivered to a customer in a catalog file. A configuration is extracted into the AoE database 200 from the OMS server. Those configuration component records that are available to order are “turned on” in option records, allowing a customer to upgrade, downgrade or add a configurable component for a product. As shown in FIG. 5-17B, the data includes SKU data from a SKU table from AoE database 200, updating the SKU table if an option status was changed in a validation check in block 17B5. A similar validation check is performed in FIG. 5-17C, blocks 17C2 through 17C14.

FIG. 5-18 provides a flow diagram for a module 518 shown in FIG. 5. The flow diagram illustrates how legend code data in the OMS database is displayed, and activated by selecting the legend code to activate module by module as shown in blocks 18A2 through 18A4.

FIG. 5-19A and 5-19B illustrate a flow diagram for module 519 in FIG. 5, “Add Customer Kit.” As shown, blocks 19A1 through 19B7 enable a computer user to add SKUS from an OMS database into an existing configuration in the AoE database 200. For example, a computer user enters a SKU number and module type in block 19A3, retrieves a description from AoE database 200, requests data from the OMS server in block 19A11, flowing through data in block 19B2, and adding data to configurations in blocks 19B4 through 19B6.

FIG. 5-21 is a flow diagram illustrating the ability to delete a customer kit module 521 shown in FIG. 5. The blocks 21A1 through 21A11 include looping through a customer kit data in blocks 21A7 through 21A9 to remove data related to SKU and pricing and other data.

FIG. 5-22A and 5-22B include blocks 22A1 through 22B6. The flow diagrams illustrate the steps for the module 522 shown in FIG. 5, “Delete Custom Solution.” FIG. 5-22B includes looping through a record set to remove parent legend code and quote details until the end of the file.

Catalog Process Translation

According to one embodiment of the invention, a translation process is part of the manufacturing process. More particularly, in many manufacturing environments, databases in use for a number of years require integration into modern databases. For example, a non-Windows environment database, such as a UNIX system or other system requires particular software and/or hardware to communicate seamlessly with a Windows environment database. In many business environments, the ability to store data in an environment that is robust yet not as easily accessible is desired to maintain important data. Such environments may include legacy environments. However, it is desirable to have access to the robust environment from a user-friendly environment such as the world wide web or from an NT environment. More particularly, according to one embodiment, a configuration translation process includes extracting data from a platform with rules for the data and loading the data into another disparate platform.

Referring to FIG. 6 a method for translating data between disparate platforms is provided. As shown, FIG. 6 includes blocks 600-1 through 600-4. In one embodiment, the data is in a legacy type platform with rules associated with the data. The process begins with extracting data from a disparate platform in block 600-1. The process continues in block 600-2 with allowing a disparate platform to build on the data with those rules. In block 600-3 the process includes adding additional rules for data manipulation, thereby, block 600-4, allowing a software application incompatible with the original platform to manipulate the data.

Referring back to FIG. 4B, one embodiment of the manufacturing process depicts how configuration data is extracted seamlessly from a non-Windows environment database into a Window environment. FIG. 4B shows a non-Windows database, such as a UNIX or LINUX or other legacy server OMS server 410 . The process interacts with OMS server 410 from a Windows environment or other user-friendly environment via an agent 420. As shown, quote requests 430 are received by agent 420 which responds with response 440. Agent 420 includes a library shown as MPATHLIB, which assists in the seamless interaction with the OMS server 410.

As discussed above, OMS server 410 interacts with SQL tables 460 and ENSCRIBE files 462. As shown, SQL tables 760 includes browseable files including BASEHDR 470, OPTNHDR 480, and MODDTL 490. ENSCRIBE files include readable files including Quote Header 491, Address 492, System Integration Order 493, Shipping Charge 494, Quote Group 495, Quote Detail 496, Item Master 497, Customer 464, SalesReg 465, Tax Exemption Certificate 466, Error Data 498 and Taxstpd 468.

According to the translation process, the interface between the Windows environment and the non-Windows environment allows changes to be completed in the non-Windows database from the Windows environment.

Referring now to FIG. 6A through FIG. 6BB, flow diagrams illustrate a translation process for retrieving data related to configuration of products from a database. More particularly, in one embodiment the flow diagrams are written in Cobol as a server program that operates on a mainframe type computer system, and operates within the Order Management System (OMS) discussed above. Accordingly, the flow diagrams discussed below provide a method of interacting with such an environment.

In one embodiment, the software is located in a legacy environment, wherein the ability to talk between a user-friendly environment and the legacy environment is accomplished through software acting as a “pipe” between the environments. One such “piping” software is NetWeave™.

The program accesses non-commodity, and commodity information, and extracts data out of a platform for use in a Windows platform, for example an NT environment. The program allows a computer user operating the AoE GUI discussed above in FIG. 4A to access data in the mainframe platform and store the data in an NT database or other database for further manipulation. The information extracted includes a plurality of data useful to a manufacturing business, including quote number and all valid components including the relationship of all components to each other (optional, or mandatory), component descriptions, component pricing, SKU numbers, SKU pricing, SKU descriptions, customer number, sales rep number, company number, ship by date, shipping code, manufacturing facility, line item total, shipping total, sales tax total and order total. The program also rechecks to ensure that a Quote, SKUs and all components as the configuration was written, is valid at the point and time of the data extraction, and configurable within the Order Management System. If valid, the data is then extracted as requested. If not, corrective action can be taken to address the specific issue.

Another feature shown in the flow diagrams is that the program is used by a Windows environment batch program, shown as “Status Update” discussed above with reference to FIG. 4A-1B which is used to recheck configuration data after the data is extracted from the robust legacy platform. The recheck accomplishes two things. First, recheck verifies that a quote in the Order Management System has not been modified. Second, the recheck verifies that quote data is still synchronized with the data in the AoE database 200, or another environment for storing data. The process of rechecking a quote includes rechecking each SKU in the Quote configuration to ensure that all SKU's are still active. If a SKU has been found to be deactivated, then an exception process is executed and corrective action is taken.

More specifically, referring to FIG. 6A, the program process beings with requests for single quotes or entire SKU sets for a base product, such as a “chassis” for a computer system in blocks 60-A1 through 60-A8. In FIG. 6B, the program gets parameters in block 60-B2 and initializes variables in steps 60-B5 through 60-B8. FIG. 6C provides the portion of the program that processes a request, including pulling a next message in block 60C3, or “quote” request operation on block 60C3, the quote operation in block 60C5, the validate operation in 60C9, the reconcile operation in block 60C9, the get item description in block 60C11, the acknowledgement operation in block 60C13, the NAK operation in block 6015 and other miscellaneous operations in block 6017. Each of the operations refers to a letter from “C” to “H” wherein the flow diagrams perform different operations and return.

FIG. 6D provides the flow diagram for the next message operation, including initialization of the OMS server in block 60-D2 and setting of operations in blocks 60-D5 through 60-D13. FIG. 6E provides that portion of the flow diagram related to retrieving requested quote and related legends and SKUs in blocks 60-E1 through 60-E11. FIG. 6F, FIG. 6G, FIG. 6H, and FIG. 61 provide that portion of the flow diagram that reads through each quote detail in block 60-F2 and checks each SKU in an item master file in blocks 60-F6 through 60-19. FIG. 6J, FIG. 6K and FIG. 6L provide that portion of the flow diagram related to populating a quote header with data from the legacy environment in blocks 60-J1 through 60-L9.

FIG. 6M, FIG. 6N, FIG. 60, FIG. 6P and FIG. 6Q each provide that portion of the flow diagram that reads files and tables in a legacy environment, and populates quote detail data. The flow diagrams further include controls of processing of configuration and SKU arrays based on whether a computer user is beginning with a new transaction or continuing a previous transaction. The flow diagrams include blocks 60-M1 through 60-Q8. FIG. 6R and FIG. 6S provide that portion of the flow diagram related to fetching and locating SKU numbers and filling configuration arrays in blocks 60-R1 through 60-S6. FIG. 6T and provides a flow diagrams for reading through quote details and looping through a SKU array to locate a match to a file record with a SKU record. The reply received from the legacy environment overwrites the file record in blocks 60-T1 through 60-T13. FIG. 6U and 6V provides for reading through a quote detail file and matching SKU data in a reply SKU array in blocks 60-U1 through 60-U9 and blocks 60-V1 through 60-V8. FIG. 6W and FIG. 6Z provide diagrams for the reconcile operation in blocks 60-W1 through 60-Z5.

FIG. 6AA provides a flow diagram for reading an item in a master file, and sending back item price, and item description data, as well as data related to whether the item is a factory installed item in blocks 6-AA1 through 60-AA6. FIG. 6BB provides a flow diagram for sending the OMS reply with the data to a buffer in blocks 60-BB1 through 60-BB9. Once the data is in the buffer, the data is stored in the AoE database 200. The final figure of the flow diagram, FIG. 6BB returns to the calling flow diagram illustrated in FIG. 6C.

Inventory Process

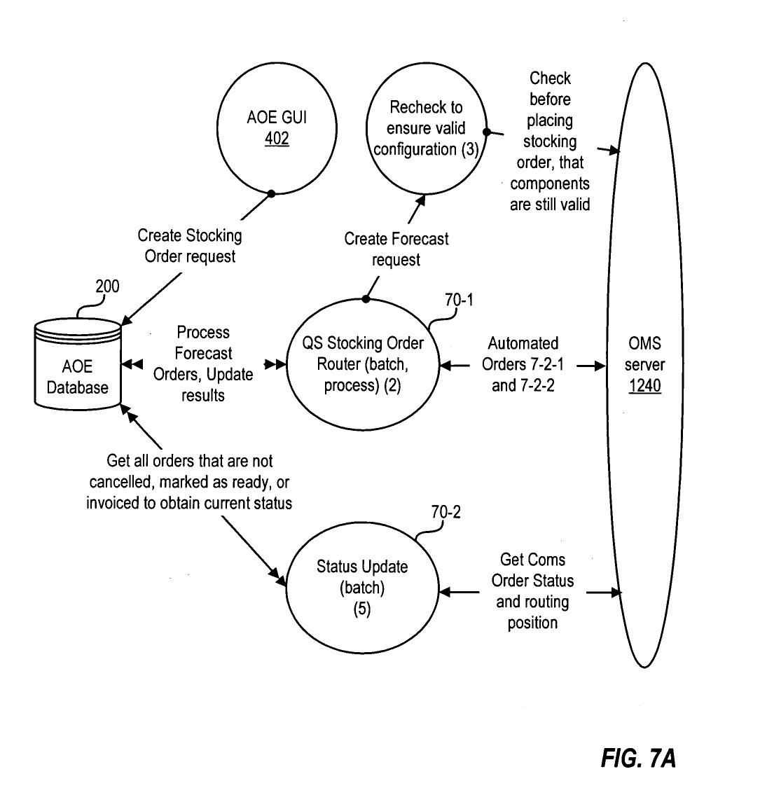

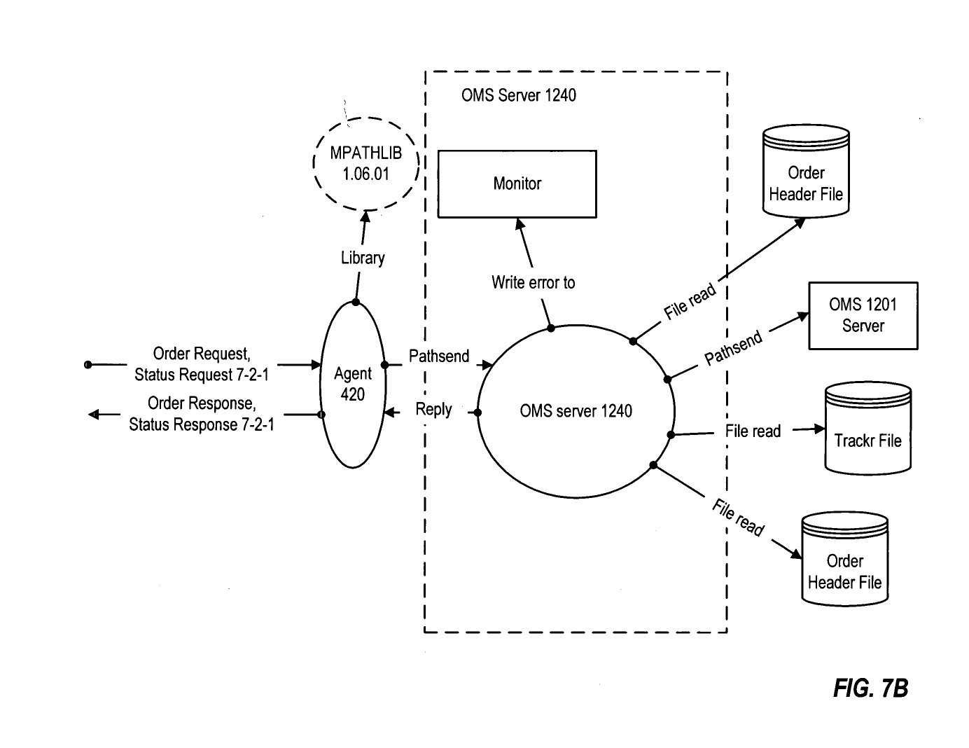

Referring back to FIG. 3, inventory control process 360 is more specifically shown in FIGS. 7 through FIG. 13-14. FIG. 7. shows a block diagram of the process flow for the inventory control process. More specifically, FIG. 7A and FIG. 7B show the process of interacting with a database and an order management system OMS server 1240 via AoE GUI 402 to automate inventory processes.

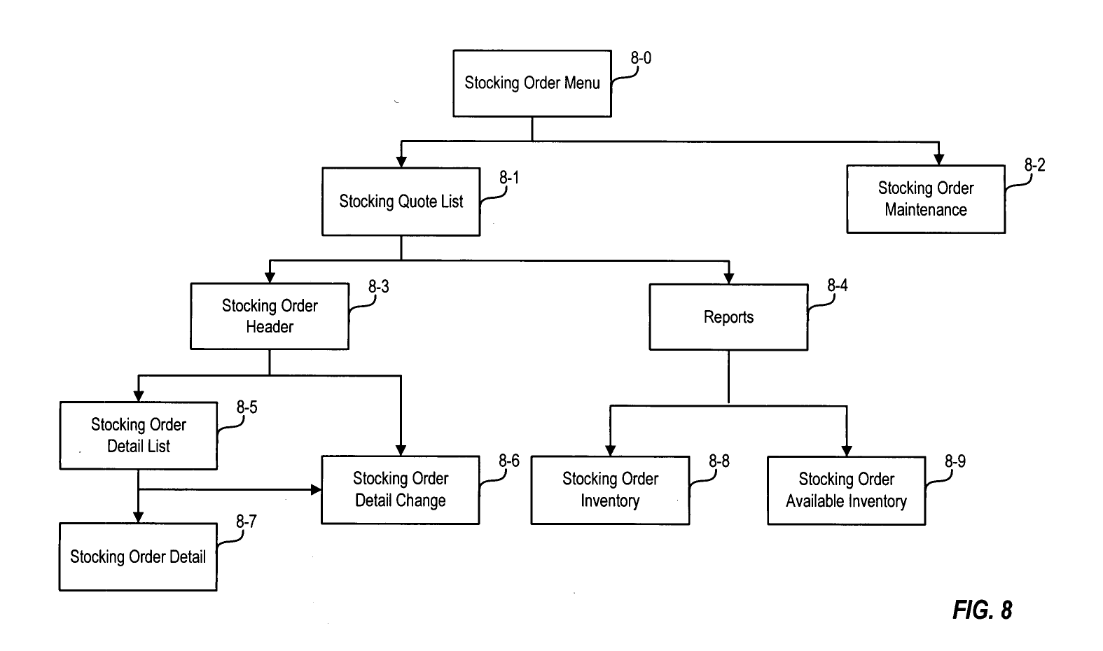

Referring to FIG. 7B, in one embodiment the OMS server 1240 is a Cobol program that runs on a mainframe type computer within the OMS system. There are portions of this program developed to generate non-commodity, or commodity stocking inventory orders in the mainframe. Another portion of the program returns the order information from a non-Windows environment to a Windows environment. A Windows batch program communications with OMS serverl 240 via AoE GUI 402. Data returned is stored in the AoE database 200. The information sent to OMS server 1240 is a Quote number and all order parameters from the Stocking Order Maintenance module 8-2 shown in FIG. 8. This information is necessary to generate an order in the OMS system. OMS server 1240 receives the request 7-2-1 and processes the request by generating the requested number of orders for the requested configuration and responds with the data in 7-2-2.

Another feature of this batch program is that it is used by a Windows-type program, called Order Status 7-5 shown in FIG. 7, which is used to find the order status and routing position for each order once the order has been generated in the OMS system and downloaded to the shop floor system. This information is returned to the AoE database 200 and the status of each order is updated to show the current OMS system status and the current shop floor routing position. The order status and routing position determine if the order has been manufactured and is ready inventory. The exact time and date of when an order is considered complete, and is ready as inventory, is necessary to allow for a FIFO release of inventory at a later time. As discussed earlier in relation to FIG. 6A etc., the ability to “pipe” used to communicate between two disparate systems is accomplished through piping software such as NetWeave™.

Inventory GUI 7-1 represents a subset of AoE GUI 402 shown in FIG. 4A. The Inventory GUI 7-1 allows a computer user to enter a specific quantity of inventory to pre-build for each of the inventory configuration identifiers active in the catalog. The inventory GUI 7-1 also displays the inventory status, which informs the computer users and the stocking order router 7-2 where in the stage in the build process each piece of inventory currently resides. The inventory GUI includes a customer profile that allows computer users to edit the order parameters identified in the profile used when the inventory is built. The parameters include “Direct_Ship customer” for customers for whom products are shipped directly to an end user, “Router_Position” for determining when product is available in inventory, etc. The inventory GUI screens also allow the computer users to run reports based off of available inventory per configuration identifiers or ordered/used inventory per configuration identifiers. The inventory control process is the precursor to receiving customer's purchase order requests, so that there is an available pool of inventory for configurations that must contractually ship in a specific time period that one that is less than a normal lead time.

Referring back to FIG. 7, stocking order router 7-2 is a batch program that sends stocking order requests into the Order Management System via the OMS application, OMS inventory server. When placing the orders for inventory, the stocking order router program uses the quantity of stocking orders requested by the computer user. The program 7-2 uses order parameters for certain fields, such as ShipByDate, when placing orders for inventory. Therefore, when an actual customer requested purchase order is received by the manufacturer, another process in the manufacturing process executes an order change on the piece of inventory applying its actual ShipByDate, shipping information, and the like.

Also included in the stocking order router 7-2 is a subroutine that rechecks to ensure valid configurations 7-3 prior to the stocking orders being placed in the stocking order router 7-2.

Status update program 7-5 is a batch program that receives the latest inventory status for each order created by the AoE inventory GUI 7-1 from the OMS inventory server 7-4 and placing the status data in the AoE database 200. The program also retrieves the date and timestamp of each status. These status values and timestamps help the various AoE programs and business users keep track of where any piece of pre-built inventory is located during the manufacturing process.

Referring now to FIG. 8, the inventory GUI 7-1 shown in FIG. 7 is shown in further detail. As shown in FIG. 8, the inventory GUI 7-1 includes a stocking order menu 8-0 that allows a computer user to access, with appropriate security, the stocking quote list 8-1 and the stocking order maintenance 8-2. The stocking order maintenance 8-2 includes the parameters used to build orders. The stocking quote list 8-1 is a visual display of the configurations that a computer user is permitted to pre-build inventory. Within the stocking quote list 8-1, the computer user enters a quantity of the chosen configuration for pre-building. As the computer user submits data, stocking order router 7-2 instantiates the programs necessary to support the computer users requests. Stocking order header 8-3 shows the display of all requests for each configuration previously requested by a computer user, indicating whether the requests have been processed. The stocking order detail list 8-5 provides all orders totaling the original request, displaying order specifics for each order. Stocking order detail list module 8-5 enables a computer user to access the individual order detail information for each line item created in the stocking order list in module stocking order detail 8-7. Stocking order header 8-3 further allows a computer user to manually update the status of a stocking order in stocking order detail change 8-6, if necessary.

Referring back to stocking quote list 8-1, a computer user also can access reports 8-4. The reports accessible include stocking order inventory reports 8-8 and stocking order available inventory reports 8-9.

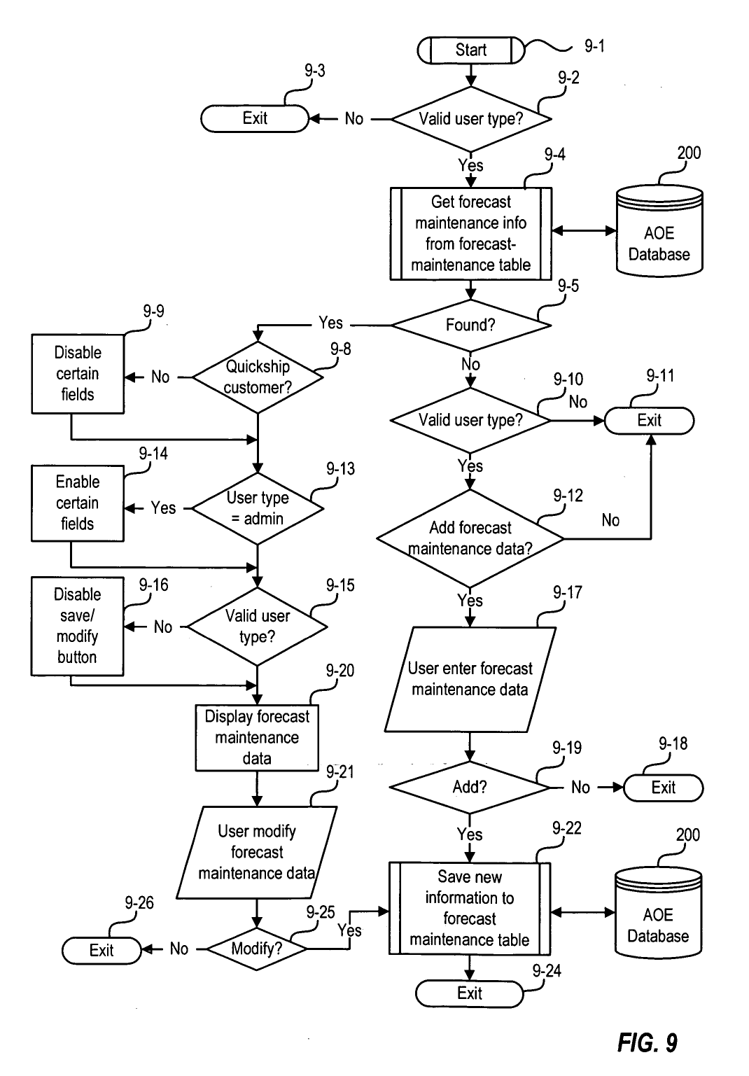

Referring now to FIG. 9, stocking order maintenance module 8-2 is shown in flow logic diagram format. FIG. 9 includes blocks 9-1 through 9-26 which accomplish the ability for the GUI to allow a computer user to view and update the customer parameters needed to create pre-built inventory stock for each customer. This module displays default values for payment type, payment code, ship to sequence number, max ship to sequence number, contract address, routing position, shipping code, and ship by date. The module also contains the contact information for the manufacturer and the customer, and the OMS routing information to determine to which a non-Windows environment inventory requests are sent. If the user has the correct level of permissions, they will be able to update information in the maintenance module. As shown, blocks 9-12 through 9-22 manipulate forecast maintenance data on a per customer basis which allows for dynamic access by application programs. Accordingly, the programs discussed herein continue to process independent of the data value.

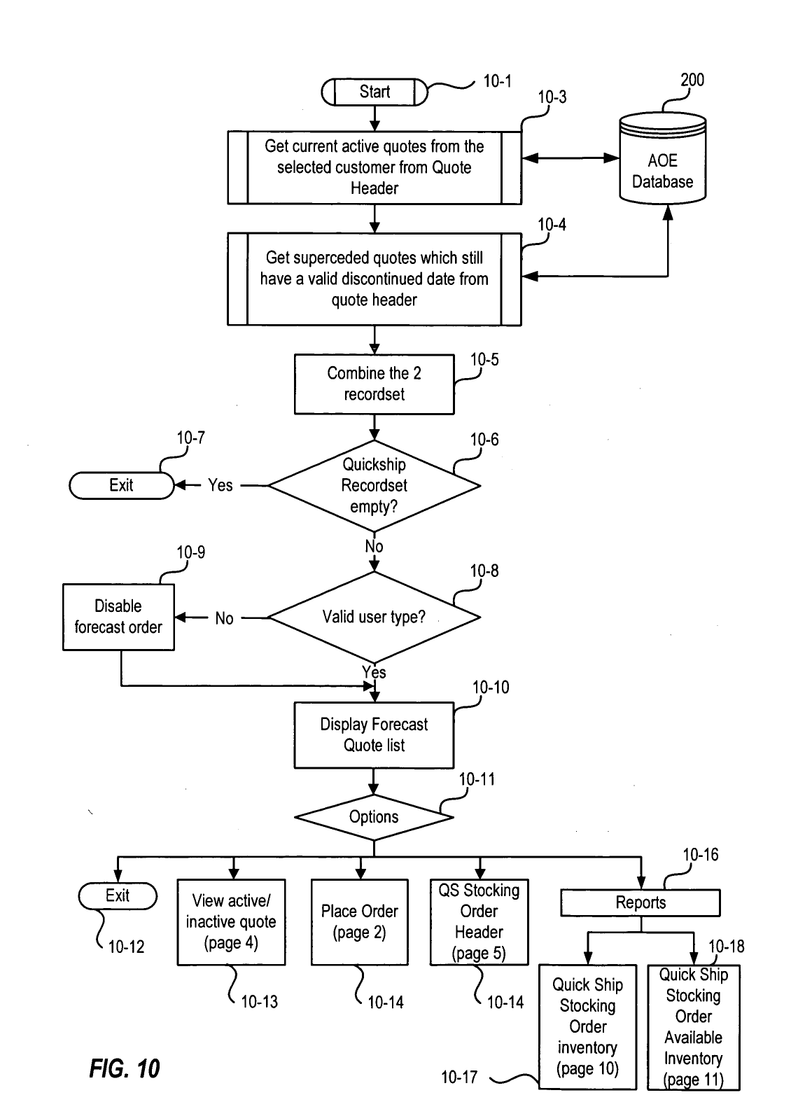

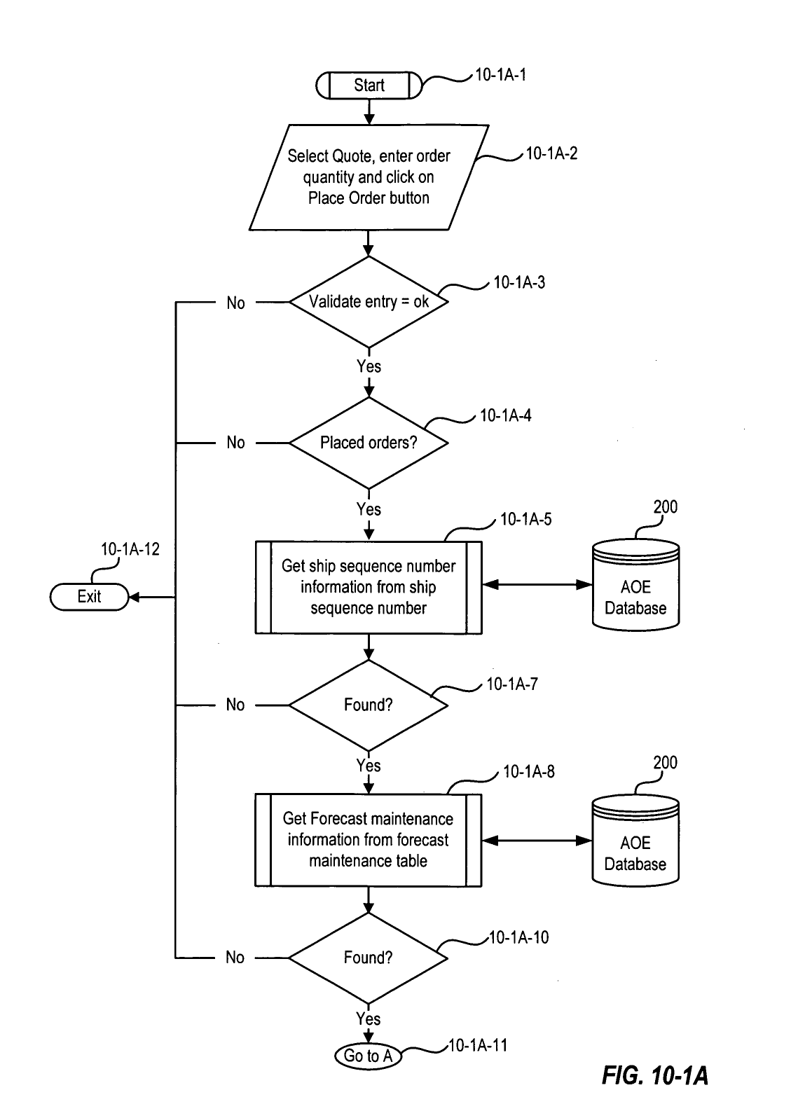

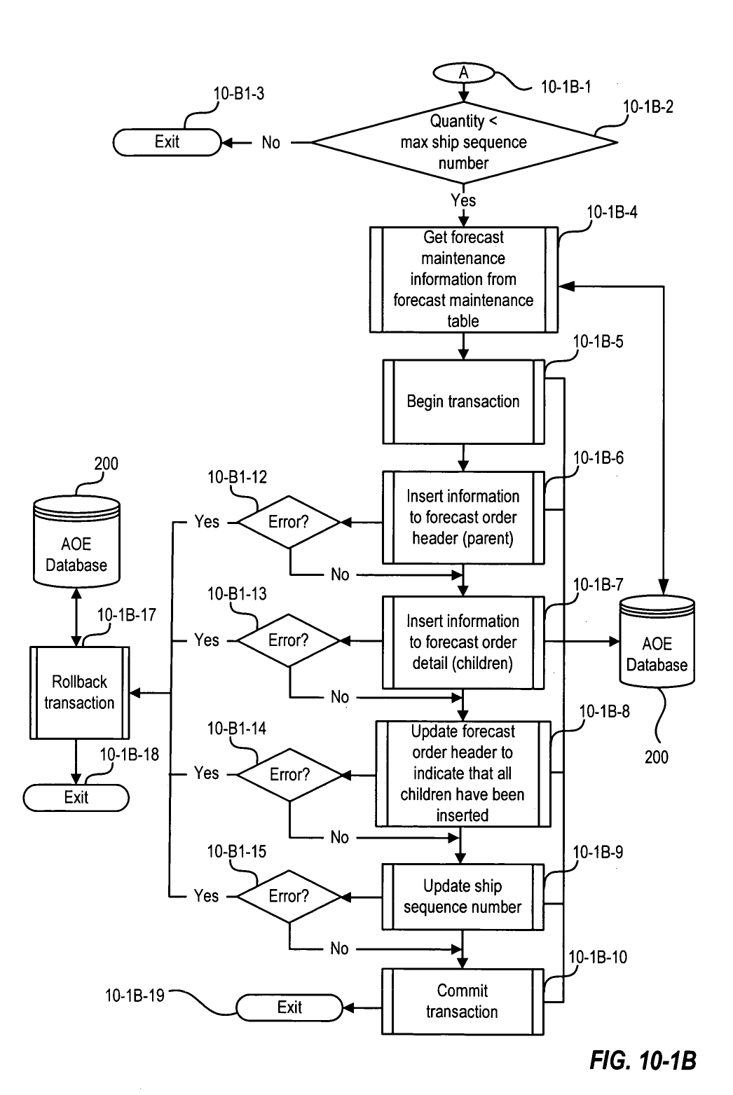

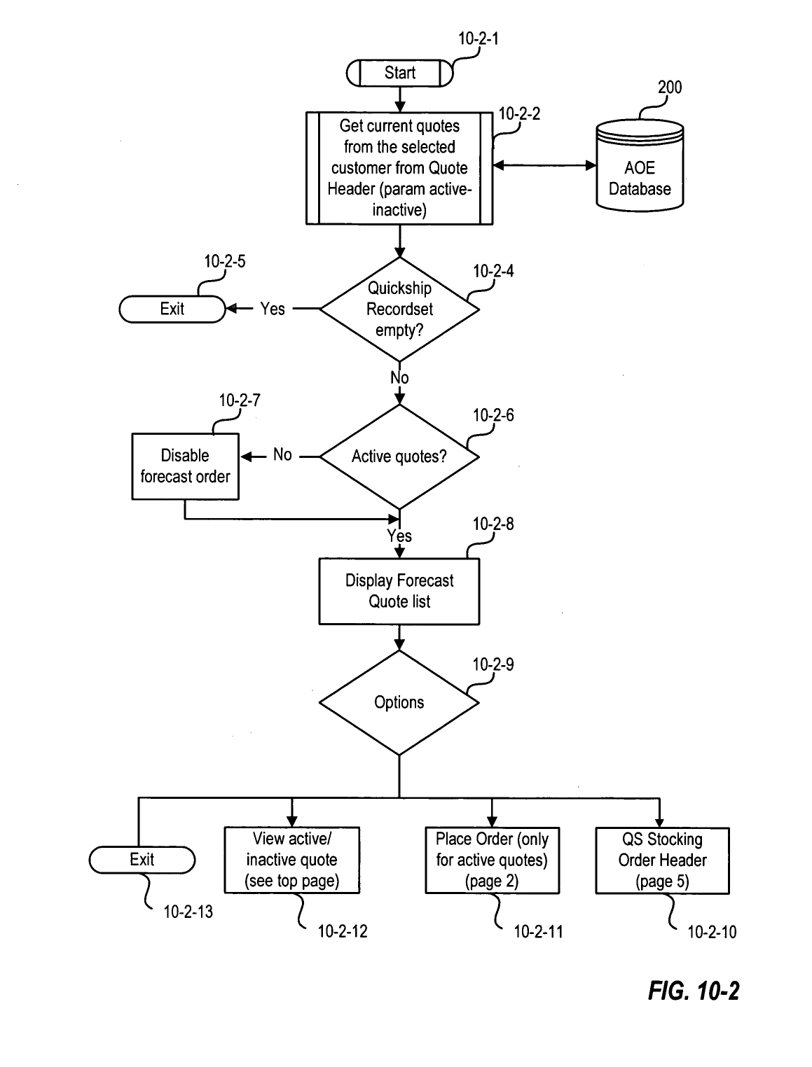

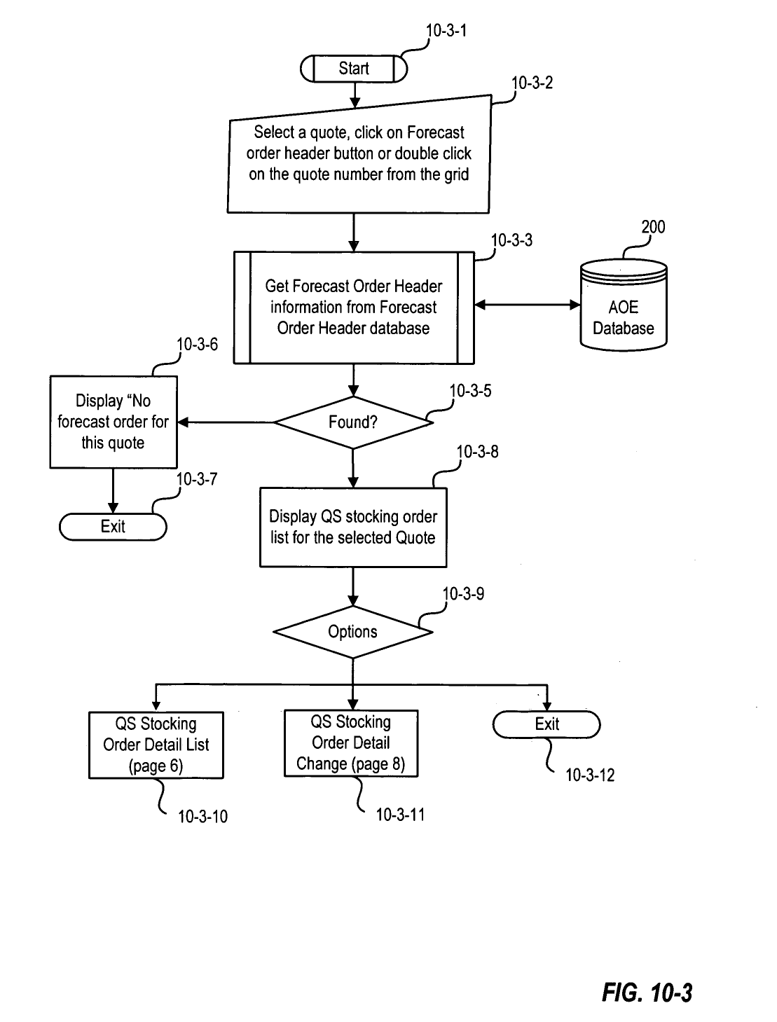

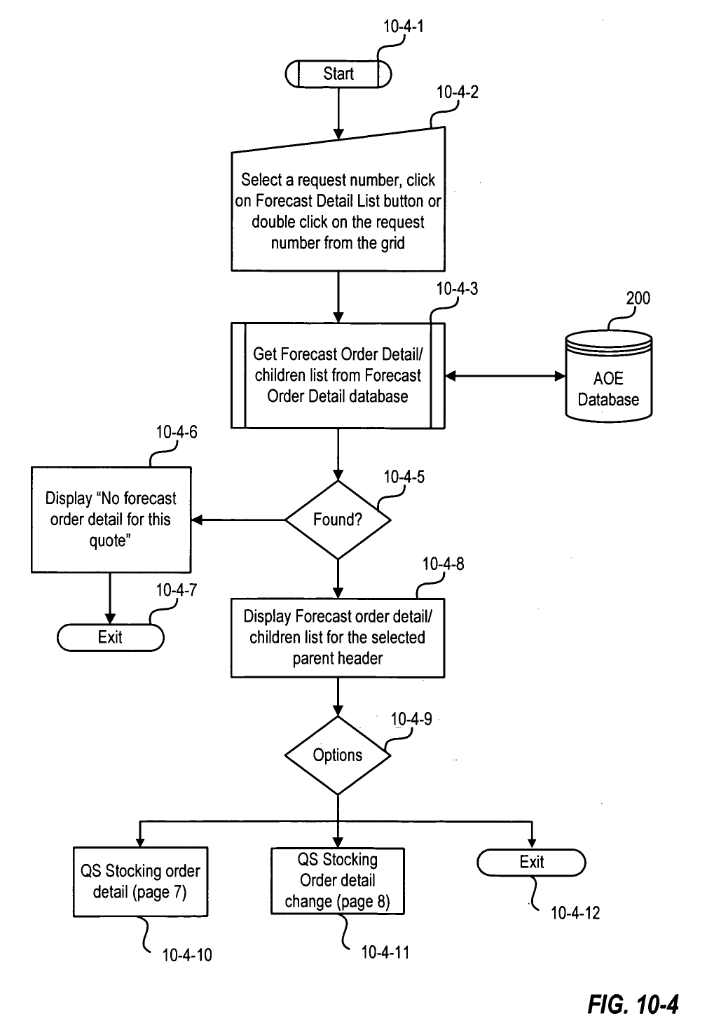

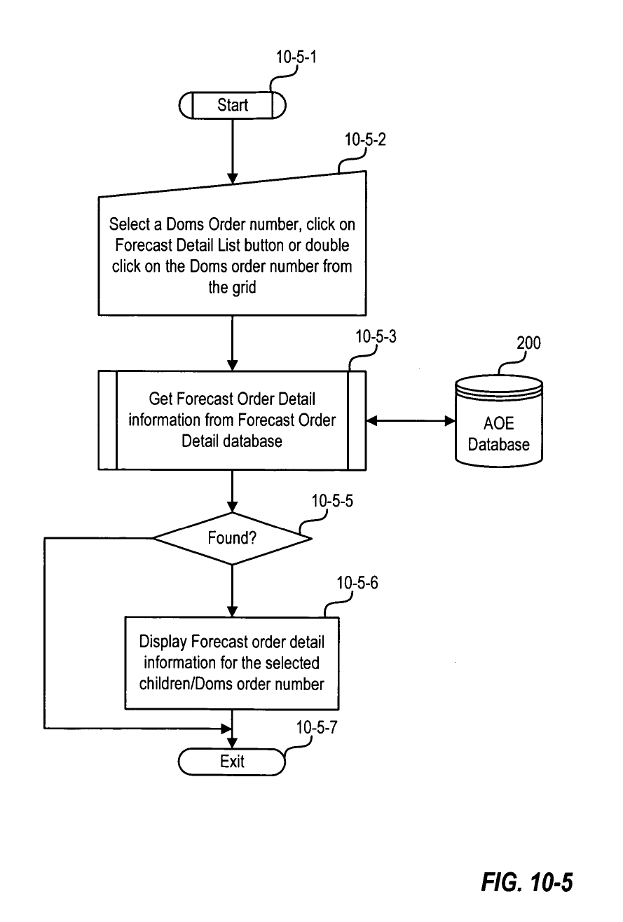

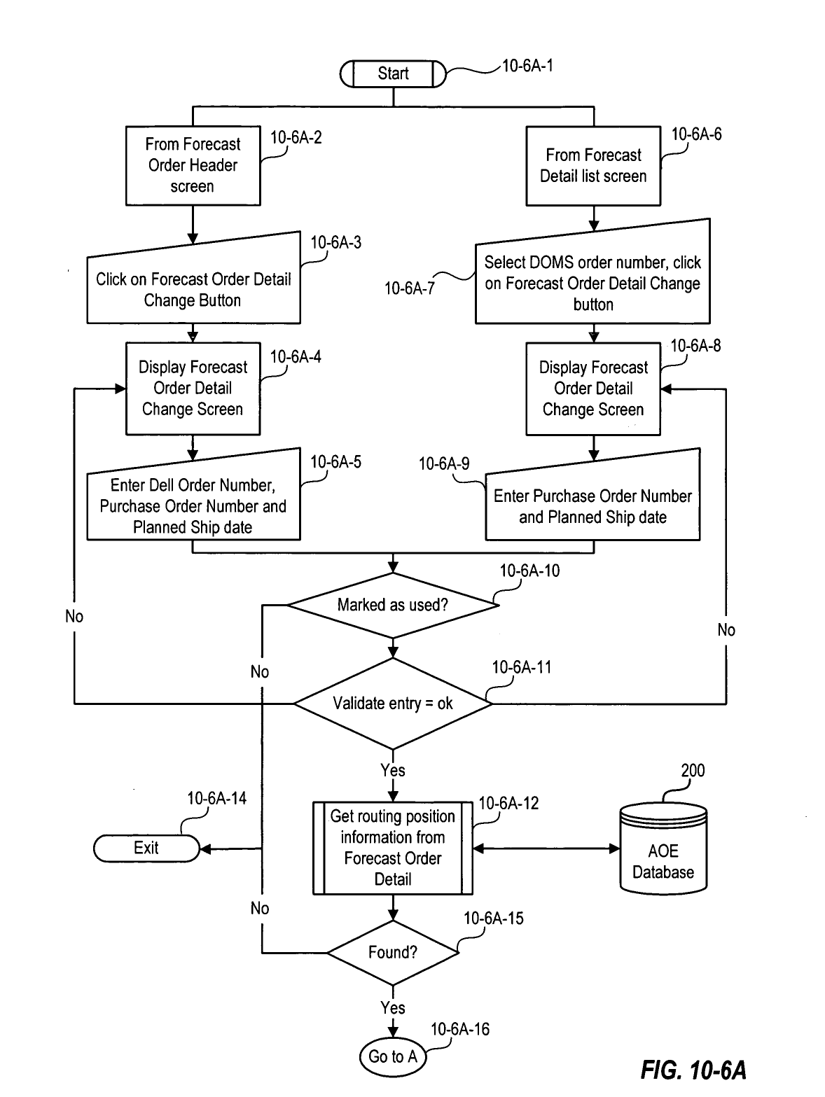

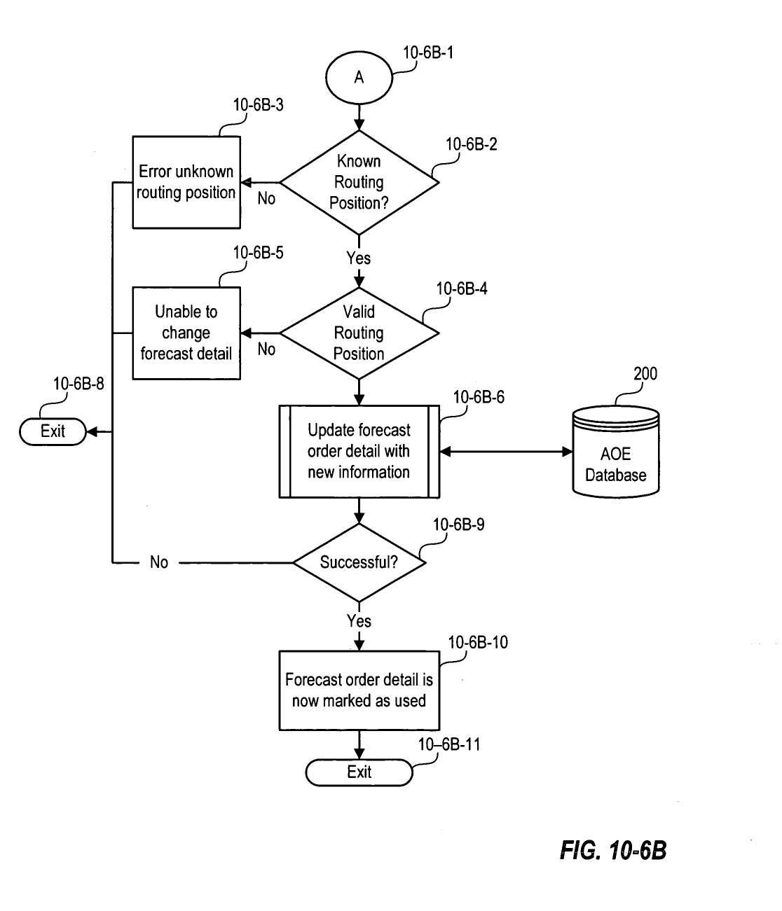

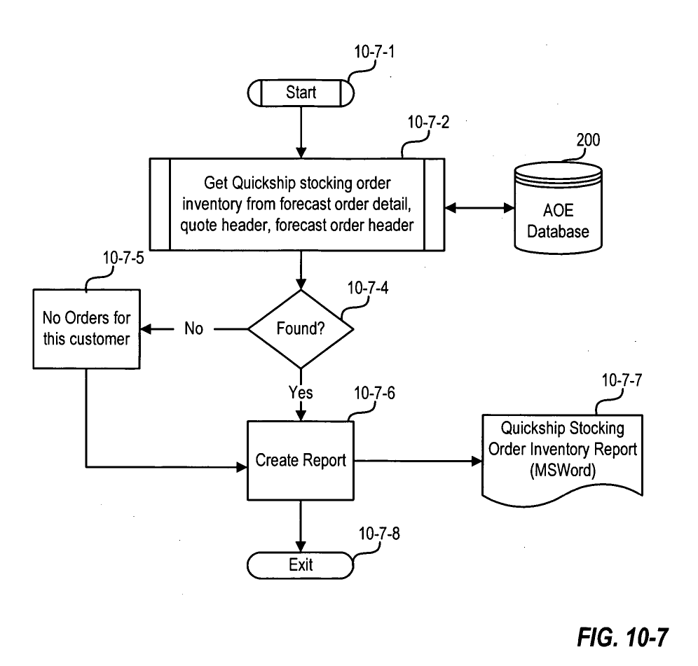

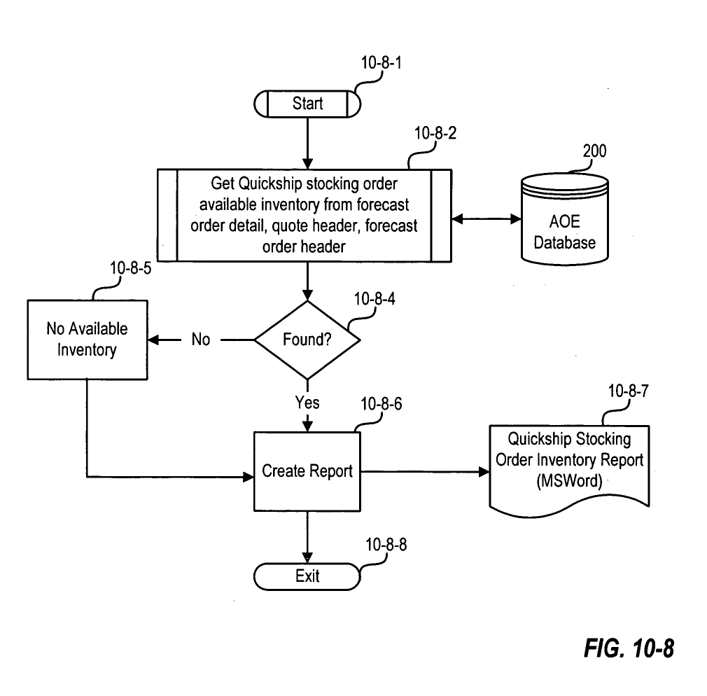

Referring to FIG. 10, the stocking quote list 8-1 shown in FIG. 8 is shown in a flow logic diagram. FIG. 10 includes blocks 10-1 through 10-18. As shown, the logic allows a computer user to display configurations that have been bundled for a customer that are available in block 10-3, validate those configurations in block 10-4, and if the user has appropriate permissions, place an order for the manufacturer to build stock in blocks 10-10 through 10-18. The order for building stock depends on the stocking quote list 10-10 displayed to a user. The forecast enables a user to place a stocking order based on configurations previously given to a customer, or prior buying habits of the customer, or prior catalogs sent to the customer. The inventory GUI 7-1 shown on FIG. 7 enables the user when placing a stocking order to view the items listed as blocks 10-12 through 10-18. The reports 10-16 include quick ship stocking order, inventor 10-17, as well as quick ship stocking order available inventory 10-18. The user refers to those reports when placing an order at block 10-14.

Referring to FIG. 10-1A, the inventory GUI allows the user with correct permissions to place a request to build stocking orders for a “bundled” product. The. flow diagram shown in FIG. 10-1A includes blocks 10-1A-1 through 10-1A-11. As shown, the user selects a configuration, enters an order quantity and places that order inBlock 10-1A-2. After placing orders, the user receives the updated allocated ship to sequence number from AoE Database 200.

Referring to FIG. 10-1B, the flow diagram continues with the placement of the stocking order. As shown, FIG. 10-1B includes blocks 10-1B-1 through 10-1B-19. As shown, the ordering of stock includes updating of forecast data and blocks 10-1B-6 through 10-1B-8.

Referring to FIG. 10-2, a flow diagram is illustrated demonstrating the quote list 8-1 shown in FIG. 8. FIG. 10-2 includes blocks 10-2-1 through 10-2-13. The functionality shown in the flow diagram allows a user to view active an inactive bundled product configurations. The flow diagram shows that the user can access quote numbers, system descriptions, status, effective dates, and the like, for configurations that are either active or inactive based on status. As shown, the flow diagram begins at block 10-2-1 and continues with the user retrieving configurations from AoE Database 200. If any active configurations are present at block 10-2-6, stocking quote lists are displayed at block 10-2-8. For those configurations that are active, the flow diagram permits the user to place orders at block 10-2-11.

Referring now to FIG. 10-3, the stocking order header block 8-3 as shown in FIG. 8 is shown in flow diagram form. FIG. 10-3 includes blocks 10-3-1 through block 10-3-12. The flow diagram illustrates how the inventory GUI 7-1 allows a computer user to view stocking order information that had been previously placed. The flow diagram shows in block 10-3-8 that stocking orders are displayed for particularly displayed configurations and details of the stocking order are displayed at block 10-3-10. Any changes are displayed at block 10-3-11.

Referring to FIG. 10-4, the stocking order detail 8-5 shown in FIG. 8 is shown in flow diagram form. FIG. 10-4 includes blocks 10-4-1 through 10-4-12. The flow diagram illustrates how a computer user views order details for stocking orders as shown, the order status, routing position and various states are shown in blocks 10-4-3 through 10-4-8.

Referring to FIG. 10-5, the stocking order detail 8-7 shown in FIG. 8 is shown in further detail. FIG. 10-5 includes blocks 10-5-1 through 10-5-7. The stocking order detail flow diagram shows how a computer user is able to view complete order detail data for individual stocking orders on an order number basis. Details listed include, ship to, sequence numbers, payment types, payment codes, subtotals, sales tax, shipping, order total, ship by dates, shipping instructions, and the like. The computer user selects a record from a screen shown in blocks 10-5-2 through 10-5-6.

Referring to FIG. 10-6A, the stocking order detail change shown in FIG. 8 item 8-6 is shown in further detail. FIG. 10-6A includes blocks 10-6A-1 through 10-6A-16. The flow diagram illustrates how a computer user can change the status of a piece of bundled inventory. This functionality shown in FIG. 10-6A and continuing to FIG. 10-6B, allows a piece of inventory that was built by a automatic order entry for a purchase order request that was received outside the system. For example, if a user has the correct permission level, a piece of inventory is marked as “used” and can be assigned to a purchase order number so that the ordering process will not reuse this piece of inventory. As shown in the figure, block 10-6A-10 asks whether the product was marked as “used”. If so, the entry is validated at block 10-6A-11 and routing position data from the forecast order is retrieved from the AoE Database 200 at block 10-6A-12.

The flow logic diagram continues with FIG. 10-6B in blocks 10-6B-1 through 10-6B-11, wherein the routing positions and new information is placed in the AoE Database 200. If successful, the forecast order detail is marked as “used” at block 10-6B-10.

Referring to FIG. 10-7, the stocking order inventory report shown as block 8-8 in FIG. 8 is shown in further detail. The function shown in FIG. 10-7 includes blocks 10-7-1 through 10-7-8. The function illustrated allows a computer user to run a report at block 10-7-6. The report is created by the inventory GUI 7-1 and written as a document on the computer users computer system. Information on the report includes order number, inventory status, routing status and relevant dates to the order. The report also includes a count of total orders for a particular configuration and a count of orders that have been used for each configuration, as well as a count of orders that are ready for use for each configuration. The report is generated by pulling stocking order inventory from stocking order detail header information, configuration information and forecast information from AoE Database 200.

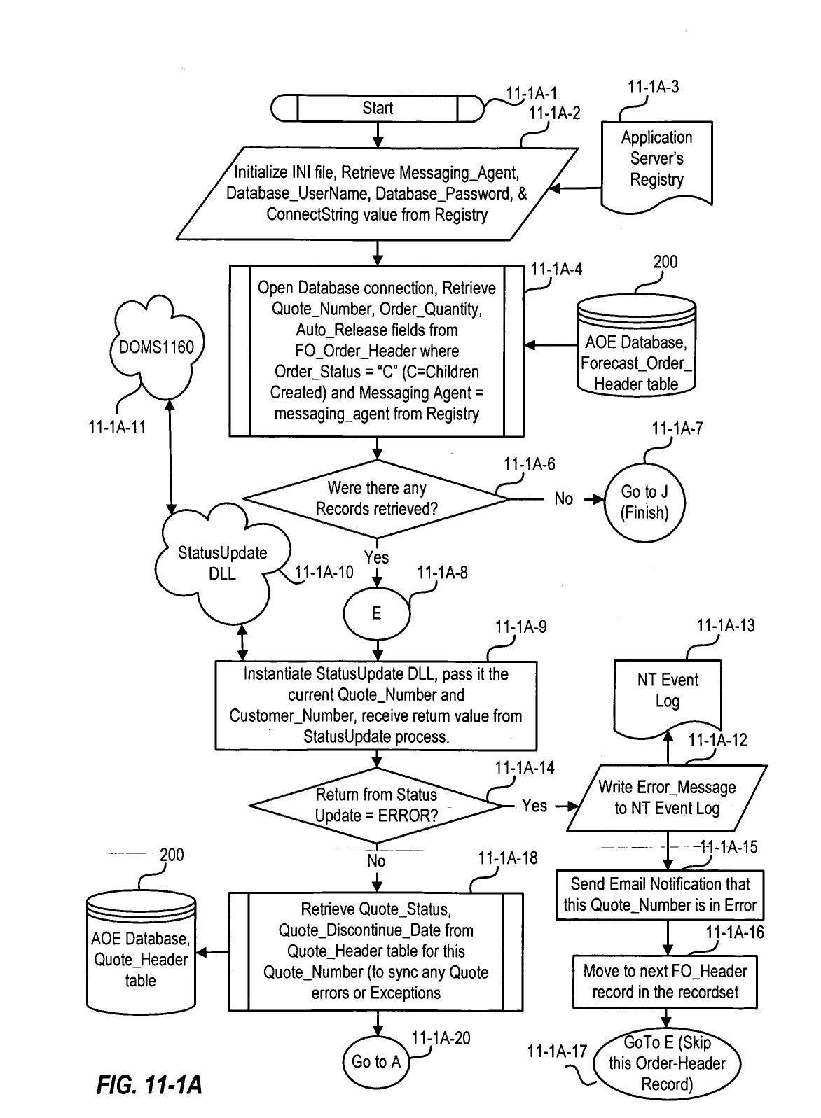

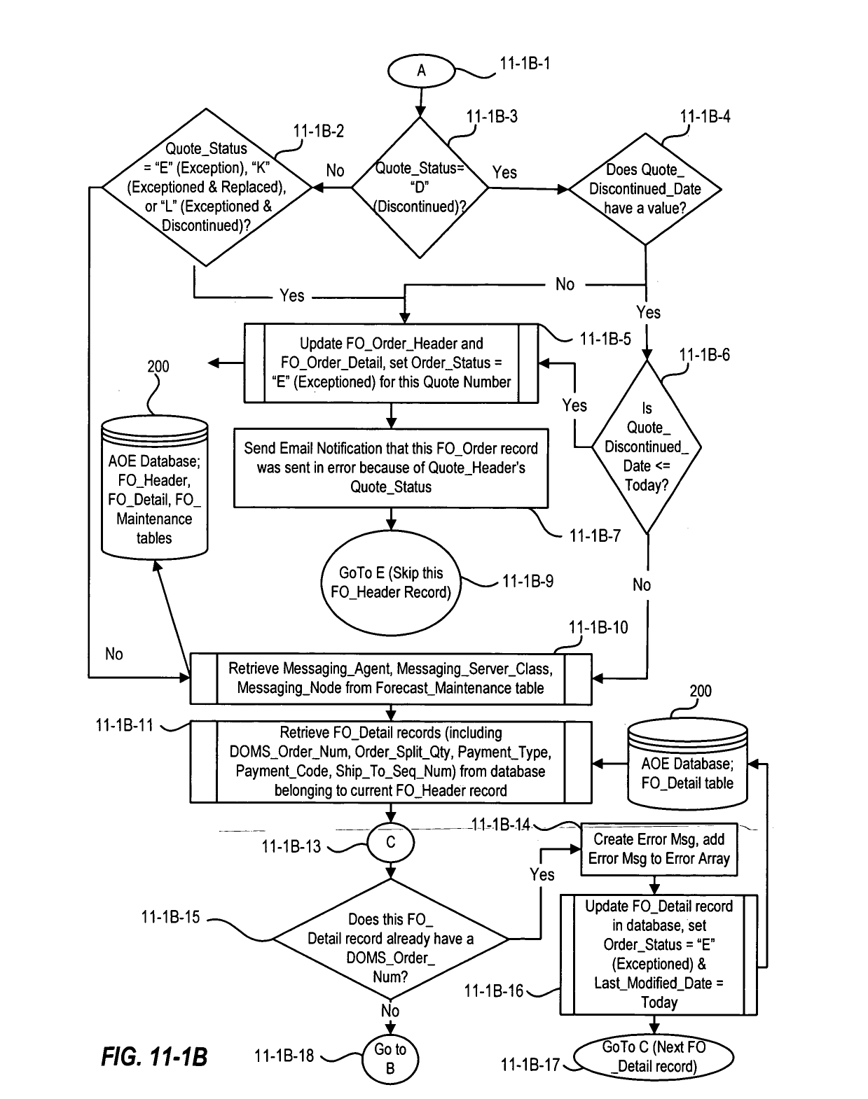

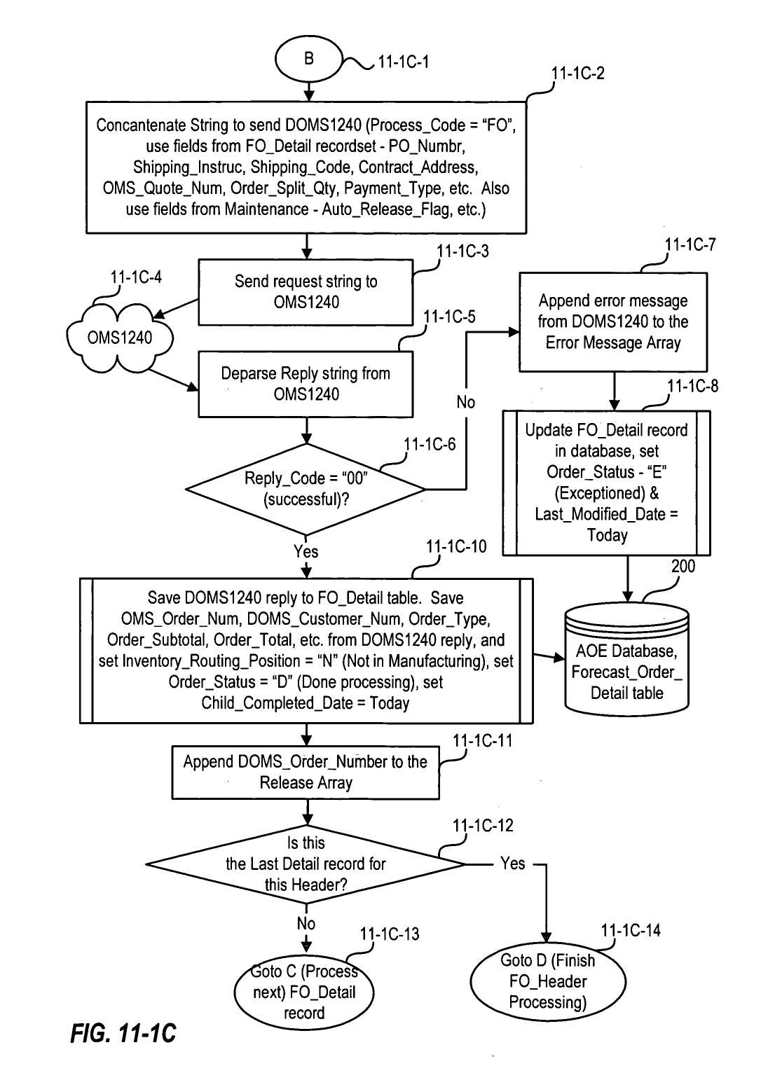

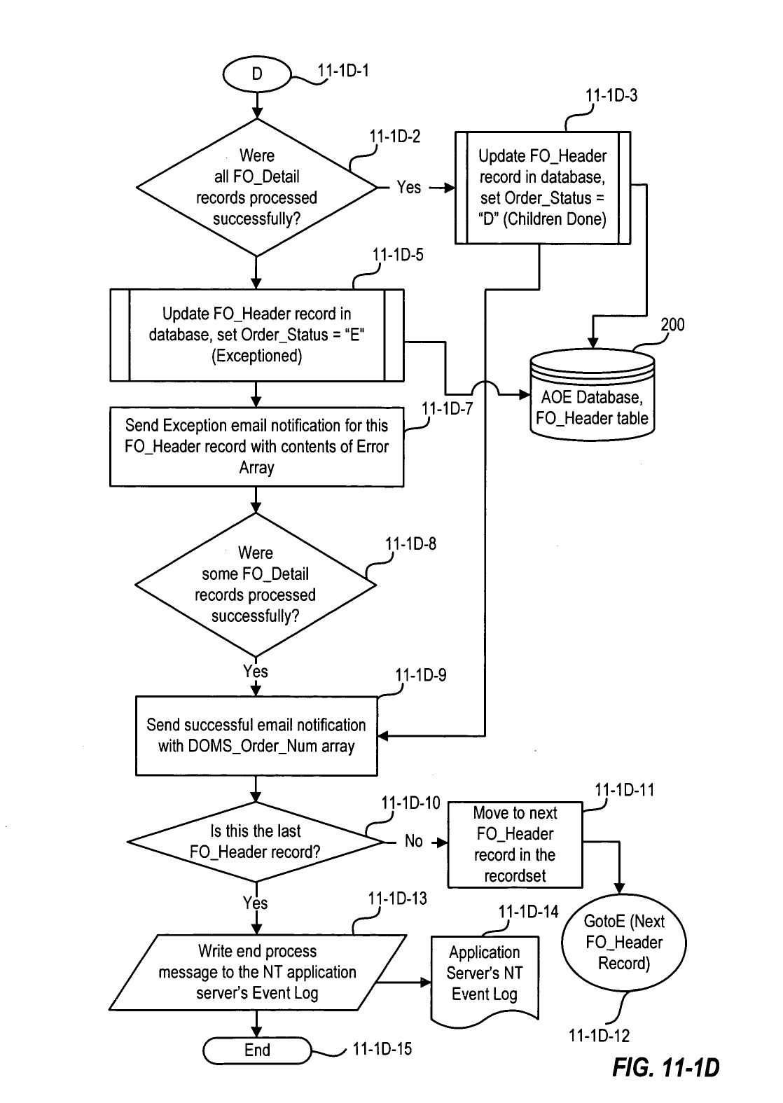

Referring now to FIG. 11-1A, an order router flow diagram is shown. The order router is shown in block diagram form in FIG. 7A, block 70-1. The order router 70-1 includes FIGS. 11-1A through 11-1D. The blocks included in the flow diagrams are 11-1A-1 through 11-1D-15, inclusive. The functionality of the flow diagrams as illustrated, operates after a computer user places a request for “bundled” stocking orders. The program shown in flow diagram form, is in “one embodiment” and a Windows NT batch application, optionally written in visual basic, or another appropriate software language for batch programs. The program places order requests for stocking inventory into the Order Management System (OMS). After a computer user places a request for a quantity of stocking orders the request is transported to a database. The batch program order router, picks up open requests from the database for stocking orders, checks the configuration status using an update program, and places the orders using the stocking order parameters from the customer profile. The batch program then emails the list of order numbers thereby created to appropriate email subscribers. The batch program is optionally scheduled to run at various times daily.

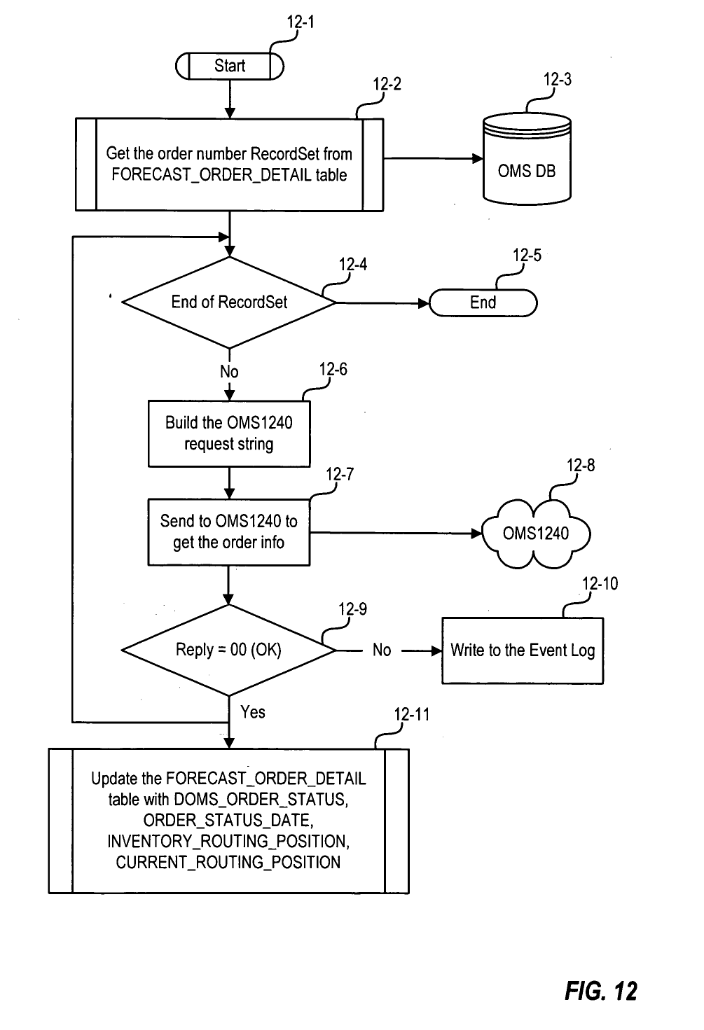

Referring now to FIG. 12, a flow diagram shows a batch application for providing a stocking order status update. As shown, the application includes blocks 12-1 through 12-11. The functionality includes checking the status of all stocking orders that reside in a stocking order database 200. The application makes a request to an OMS program shown as OMS 1240 in block 12-6. The reply “00 “12-9 indicates that information requested was properly returned. The information is used to update status of the stocking order, including order status, order status date, inventory routing position, and the like. The update is provided to AoE database 200. The status update further includes a shop floor status, which denotes where in the manufacturing process the system is located. Once the system is built on the shop floor, the system is placed on an onsite inventory warehouse. The status is updated to show that the system has been manufactured and is complete in inventory with the exact date and time of when that happened. In another embodiment, a batch application, for example, the order processor discussed in further detail herein, later uses the date and time to apply a FIFO release of the inventory.

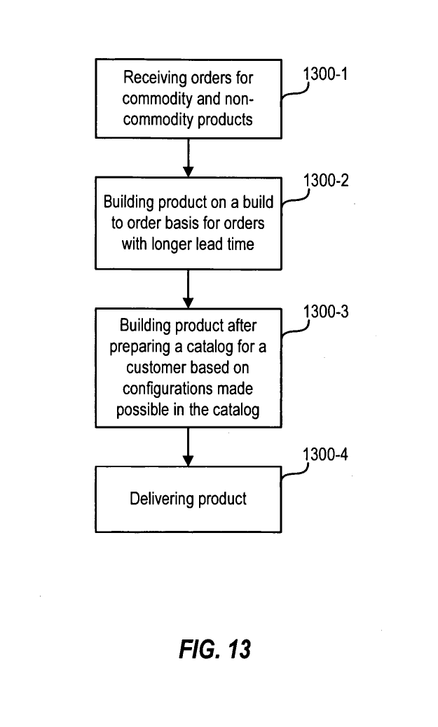

Referring to FIG. 13, a block diagram illustrates an embodiment of a method for the inventor process described above. FIG. 13 includes blocks 1300-1 through 1300-4. As shown block 1300-1 provides for receiving orders for commodity and non-commodity products. For example a manufacturer may receive orders for bundled products wherein the configuration of the product has been determined prior to receiving orders therefore. In contrast, a manufacturer may receive orders for non-commodity type products wherein the exact configuration of the product is unkown by the manufacturer until the order is received from a customer. Block 1300-2 provides for building product on a build to order basis for orders with longer lead times than other orders. For example, an order for a bundled product with a lead time of one month would be built from the order and not use inventory to fill the order. Thus, inventory is used only for products with shorter lead times. Advantageously, the use of inventory for short lead times only results in a smaller inventory and a quasi-build to order inventory process.

Block 1300-3 provides for building product after preparing a catalog for a customer based on possible configurations in the catalog. More particularly, in an embodiment, customers order based on a catalog written specifically for the customer or for a group of customers with similar requirements. Thus, the manufacturer knows what configurations are possible to be ordered from a particular customer. Furthermore, for customers with limited configurations or with a prior history of ordering particular configurations, the manufacturer has an option of preparing inventory based on the catalog sent to the customer and based on the effective dates of configurations in the catalog. The method completes in block 1300-4 wherein the manufacturer delivers product to the customer. The method allows for shorter lead times and small inventory in a quasi-build to order process.

Order Process

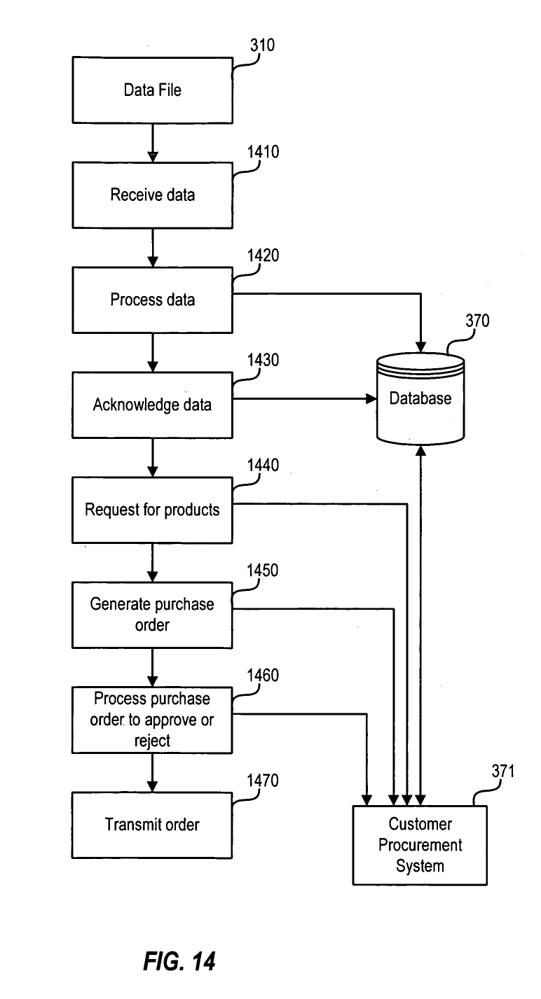

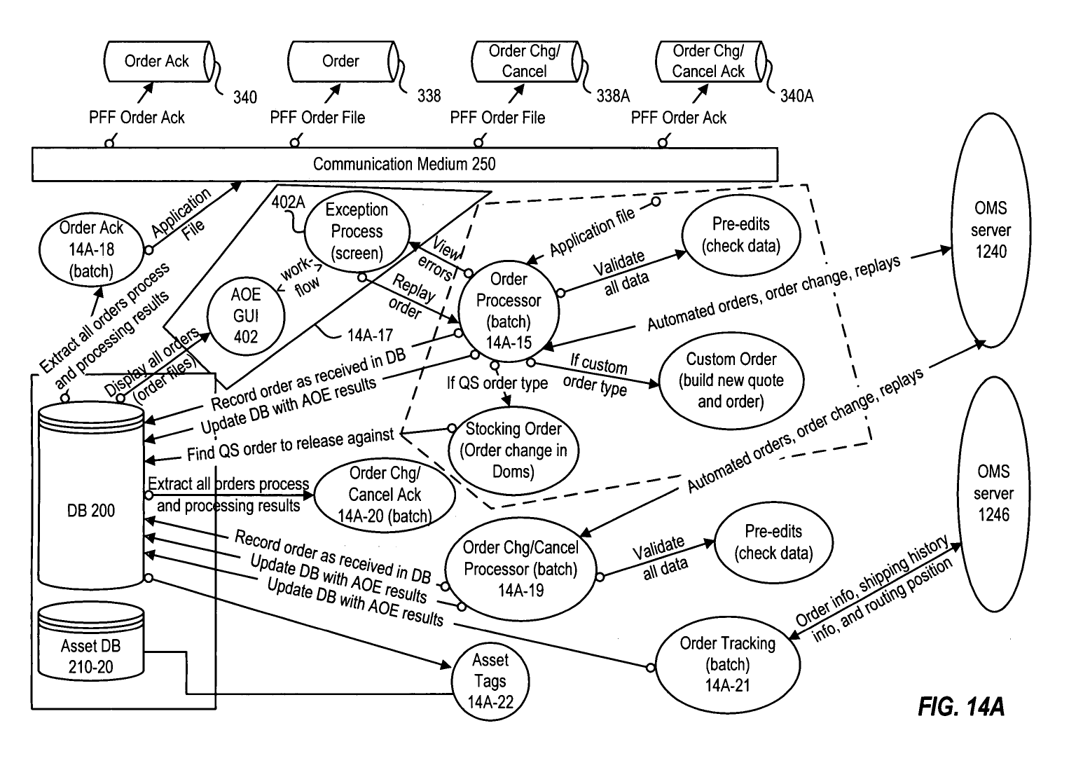

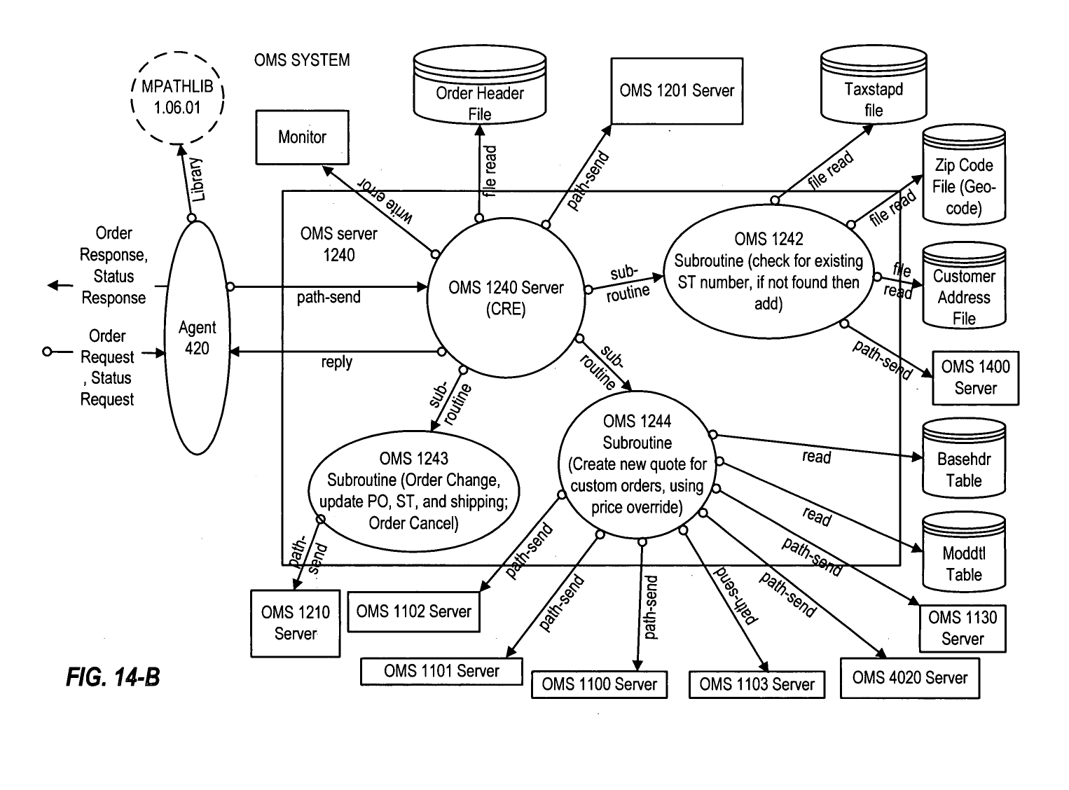

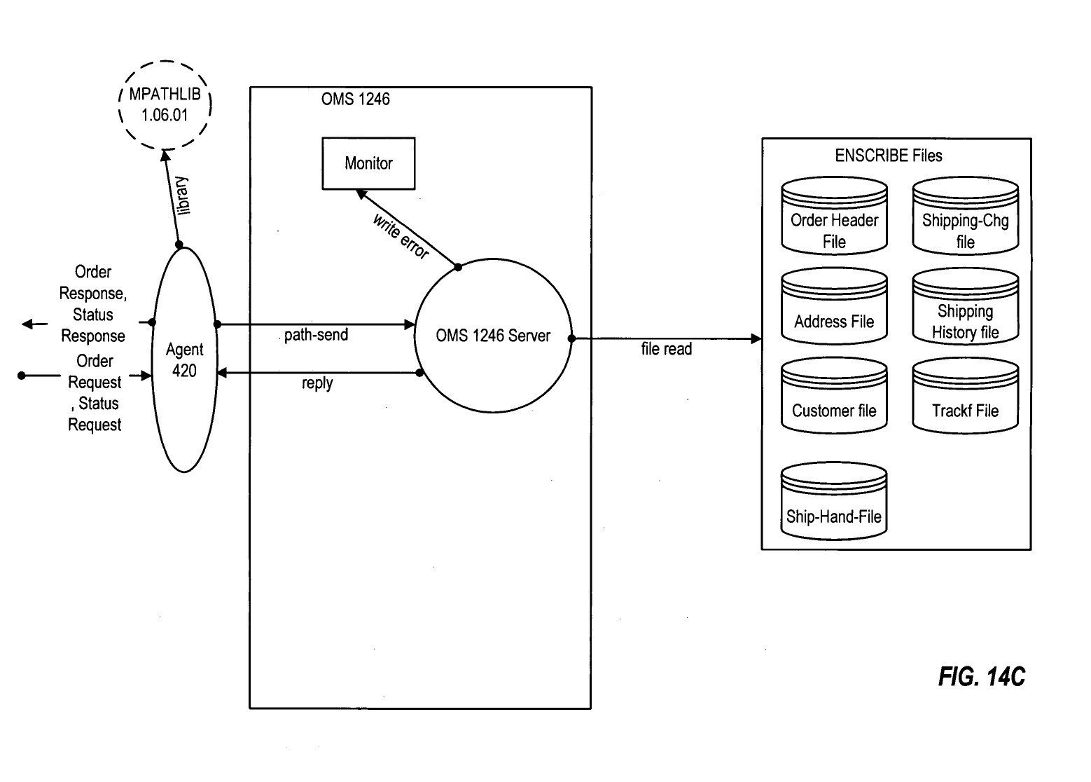

Referring now to FIG. 14 in combination with FIG. 3B, after customer receives a data file 310, incorporates the data file 310 into a procurement system 371 and acknowledges the data as accurate or not in an acknowledgement file 336. The data file 310 enables the customer to generate an order file 338. FIG. 14 provides a flow diagram of an order process for the customer. Block 1410 provides for the customer to receive data file 310. In block 1420, the customer processes the data file 310 into their database 370 shown in FIG. 3B. Block 1430 provides for the customer to acknowledge acceptance or rejection of each commodity and non-commodity product back to the manufacture or other party in acknowledgment 336 shown in FIG. 3B.

The process continues with the customer having a request for a commodity or a non-commodity product using the customer procurement 371 shown in FIG. 3B in block 1440. After determining the appropriate products required to be ordered, the procurement system 371 in block 1450 generates a purchase order in the form of an order file 338. In an embodiment, block 1460 provides for a customer specific approval process for approving the purchase order generated in block 1450. After the purchase order is approved, block 1470 provides that the order file 338 shown in FIG. 3B is communicated to the manufacturer or a party representing the manufacturer via communication medium 250.

More particularly, the customer generates a specification in the form of a request for commodity and/or non-commodity products using the data provided in the data file 310. The customer's procurement system 371 automatically generates a purchase order or a purchase request for non-commodity or commodity products with a correct price using the data from data file 310. In one embodiment, the data file supports an interactive application for access to the data as loaded in the customer's procurement system 371. The data is transmitted to the manufacturer or a party representing a manufacturer in the form of an order file 338. The data included in the order file 338 includes parameters included in the data file 310 received by the customer as well as additional parameters included by the customers in accordance with the business rules covering acceptable orders.

Referring to FIGS. 14A through 14C, a block diagram of the AOE system for the order process and order cancellation and change process is shown.

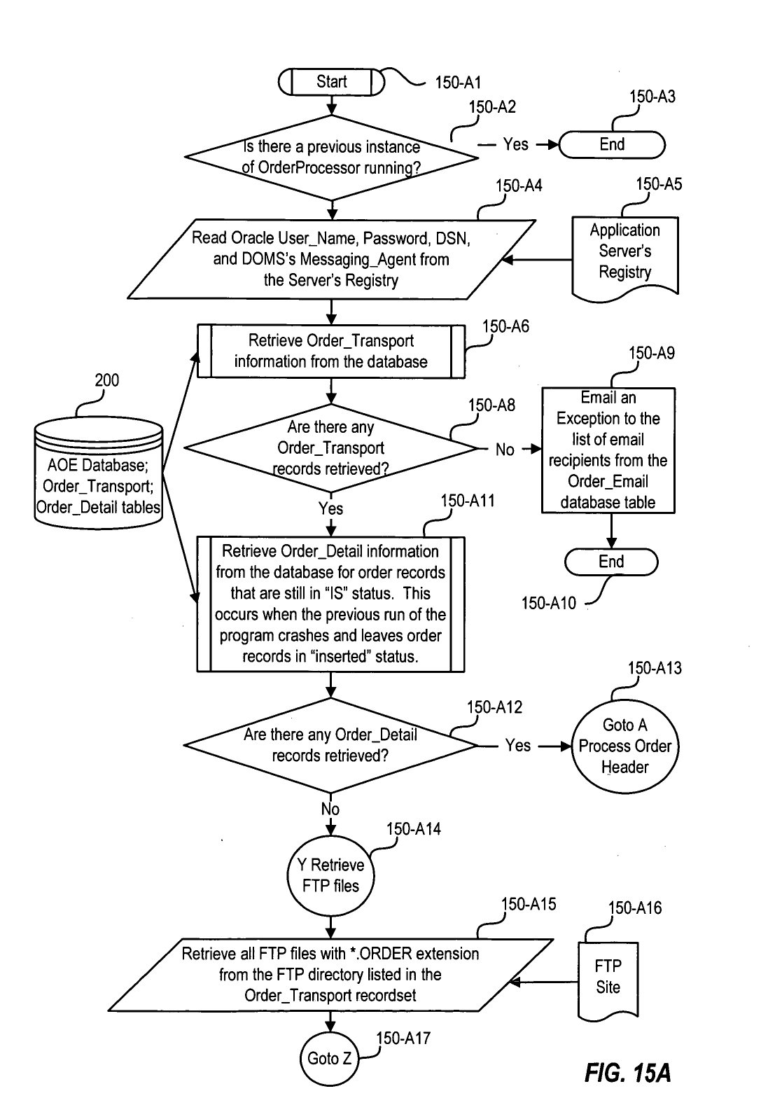

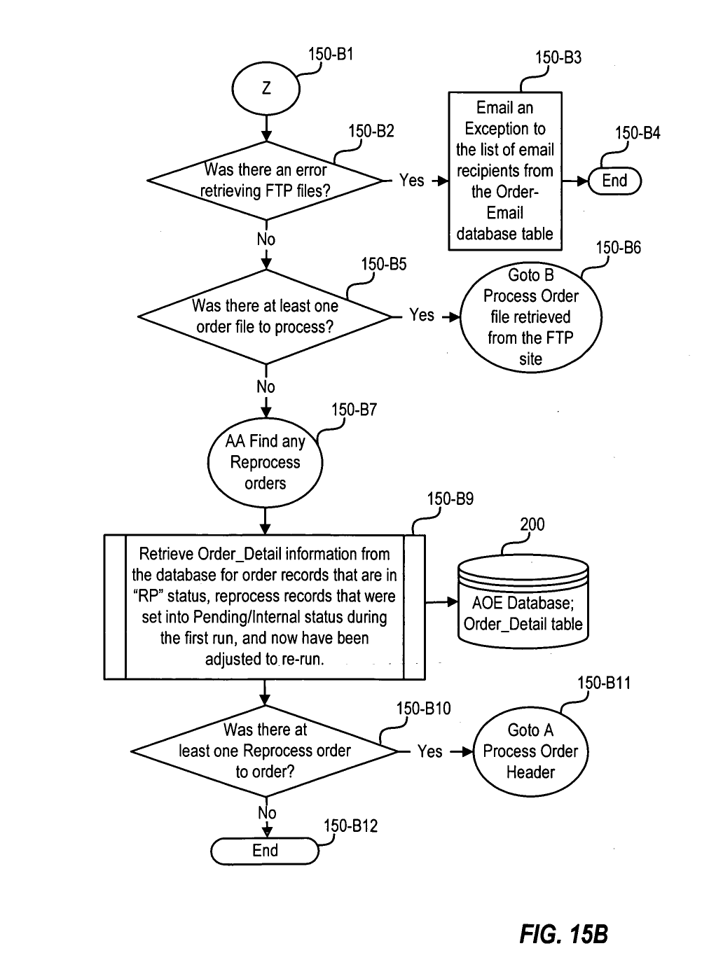

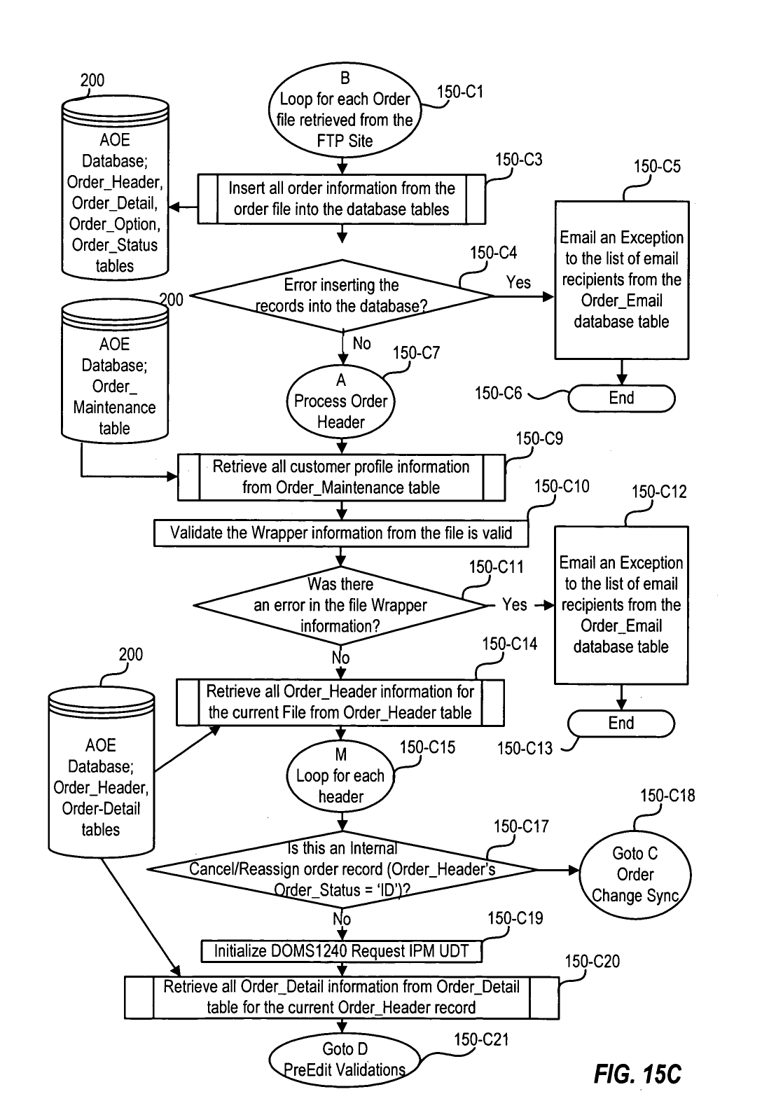

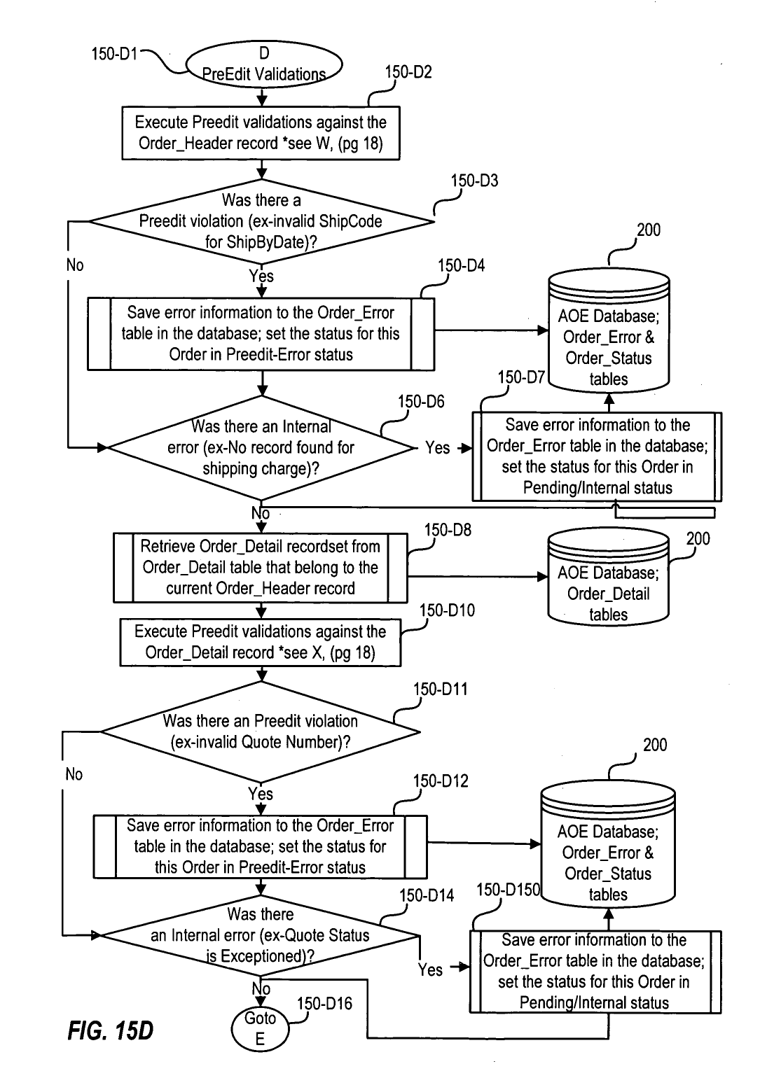

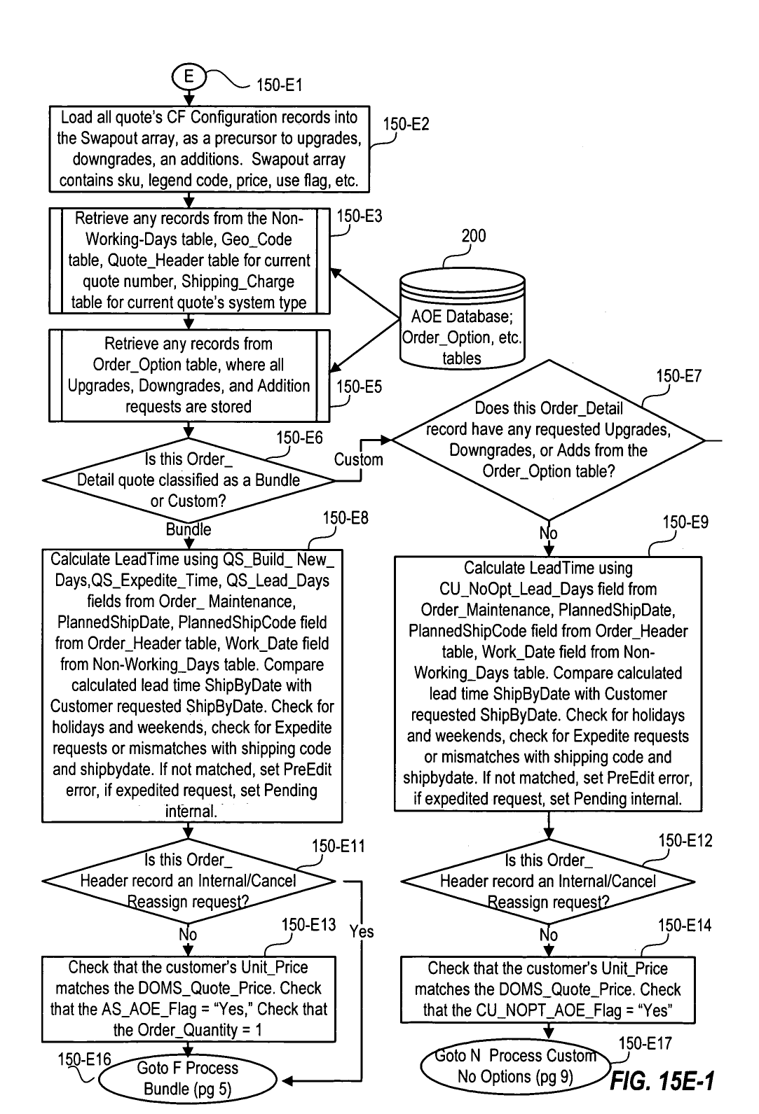

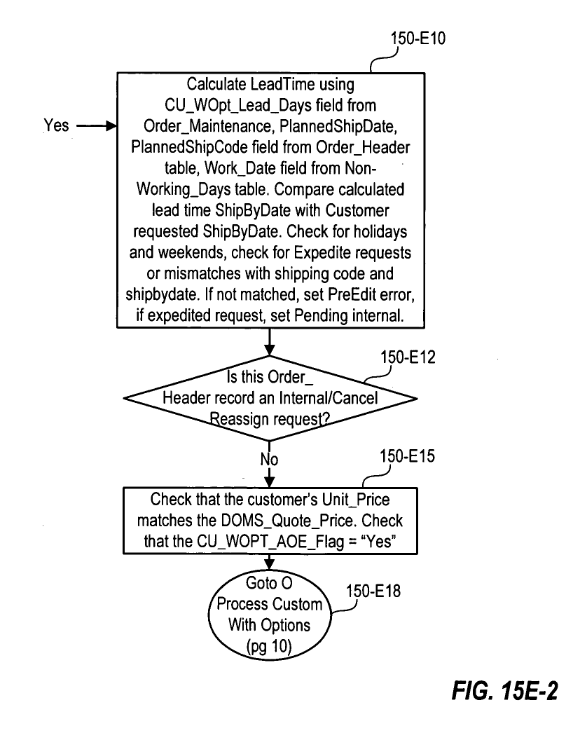

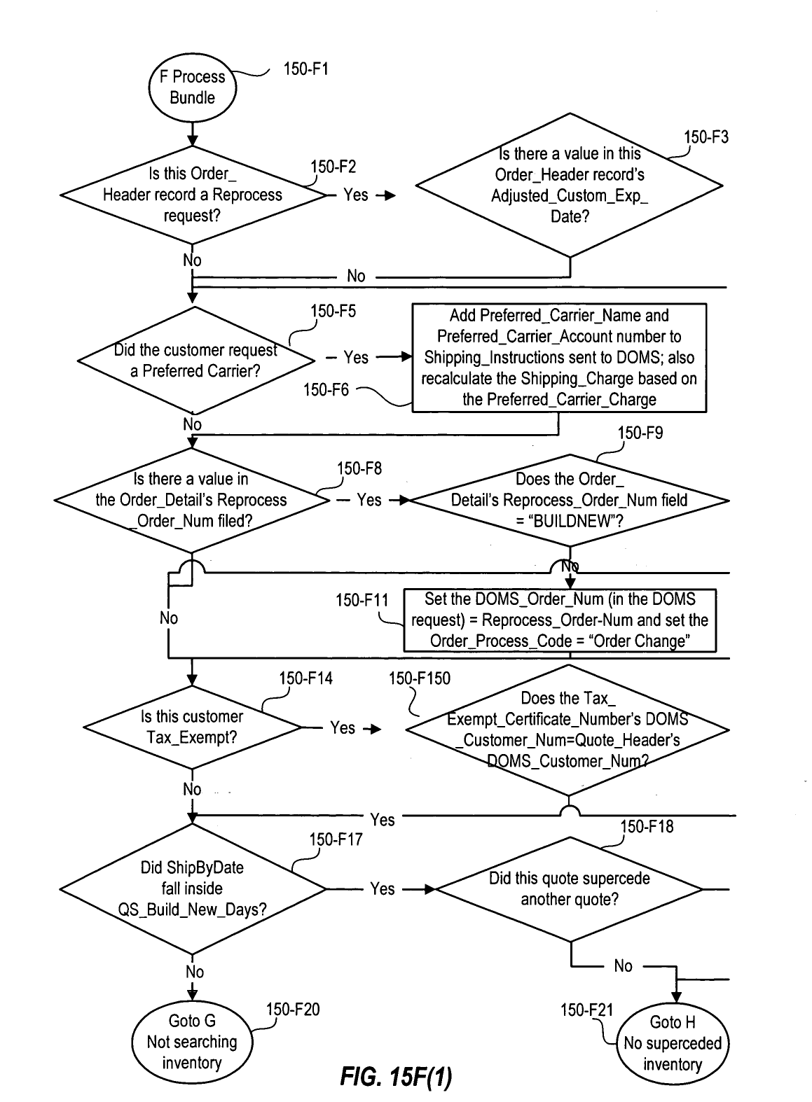

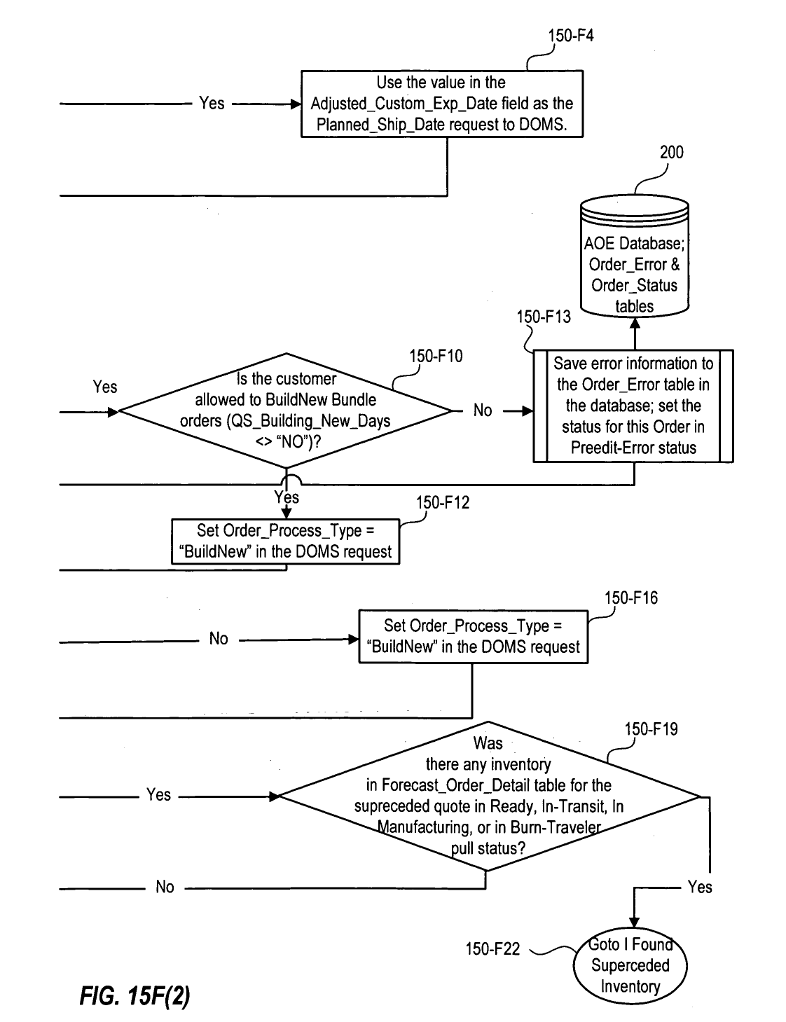

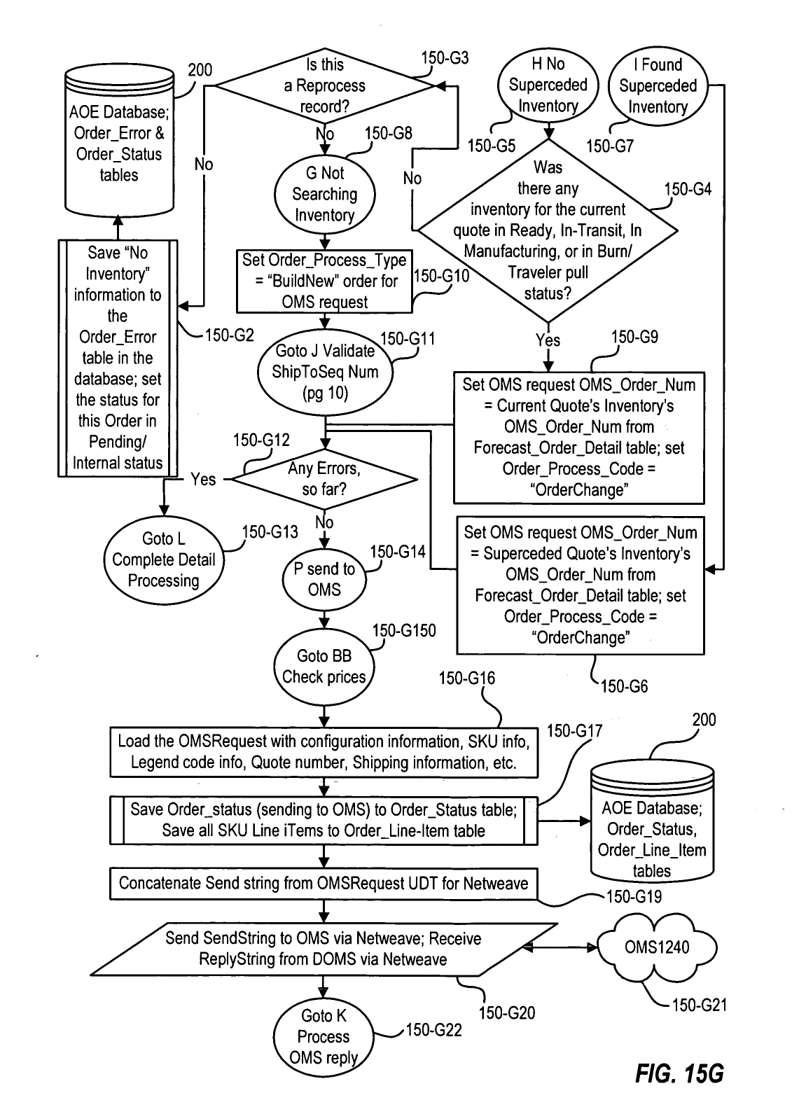

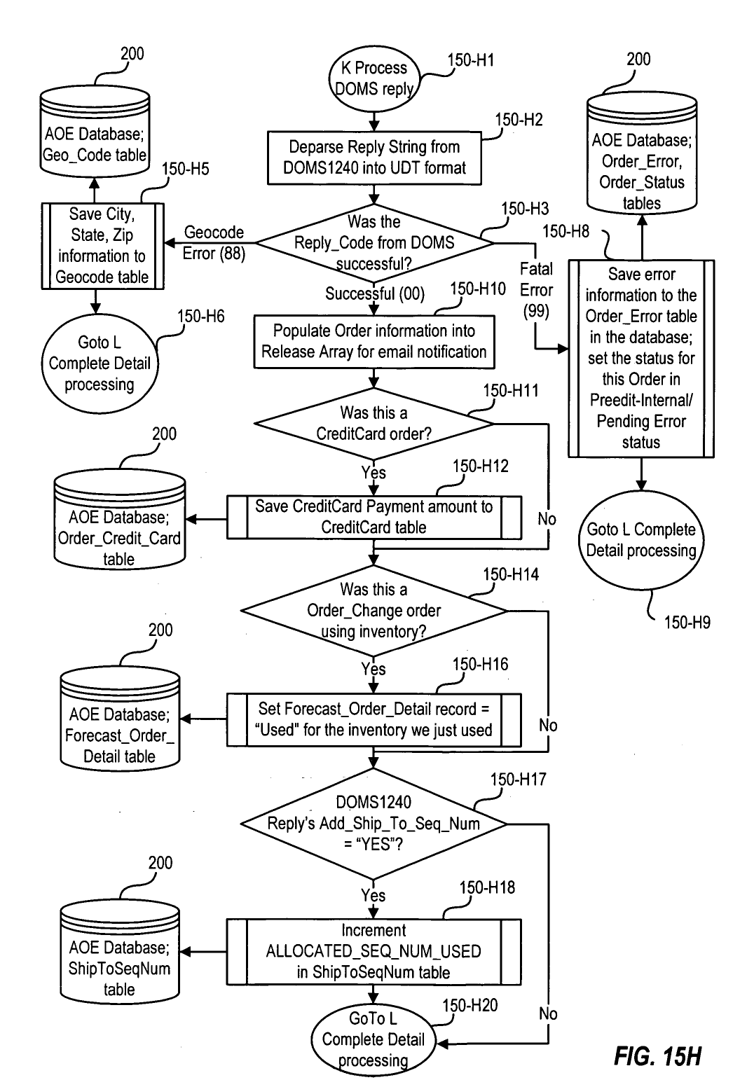

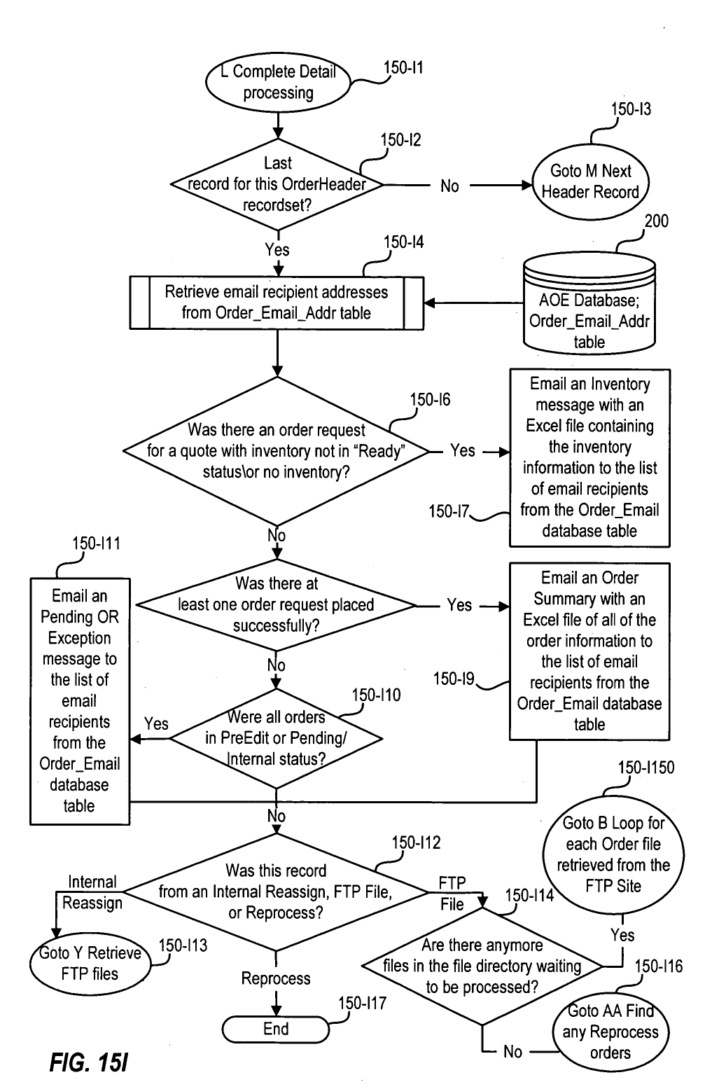

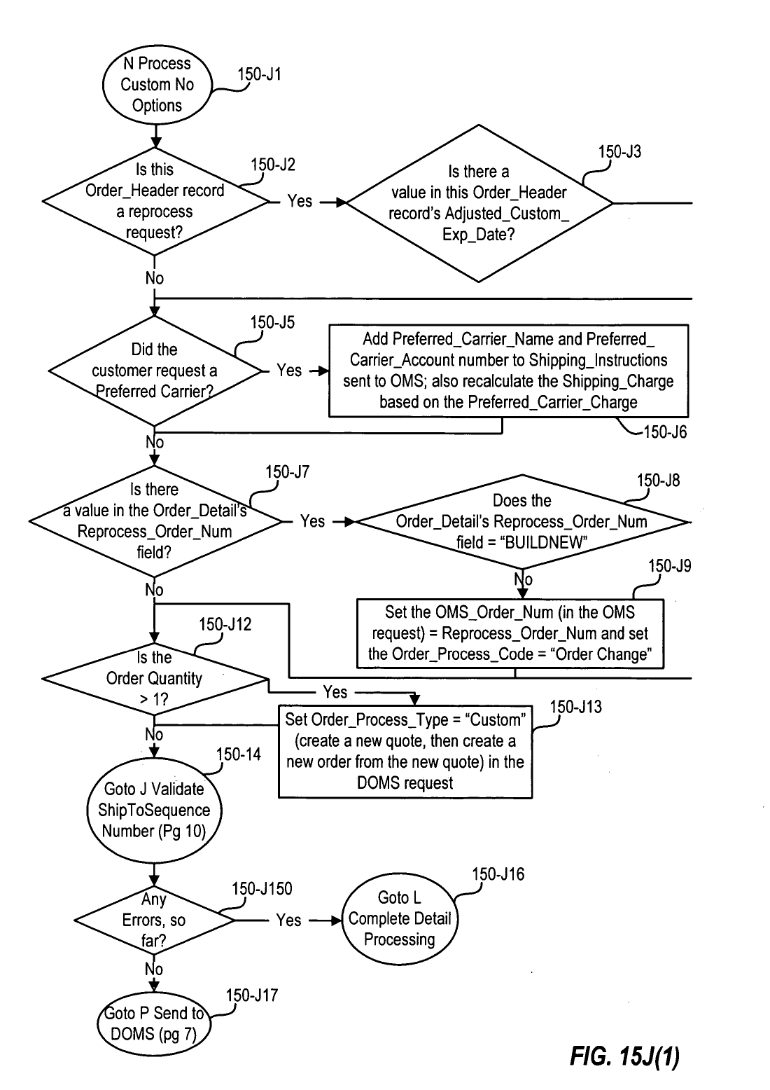

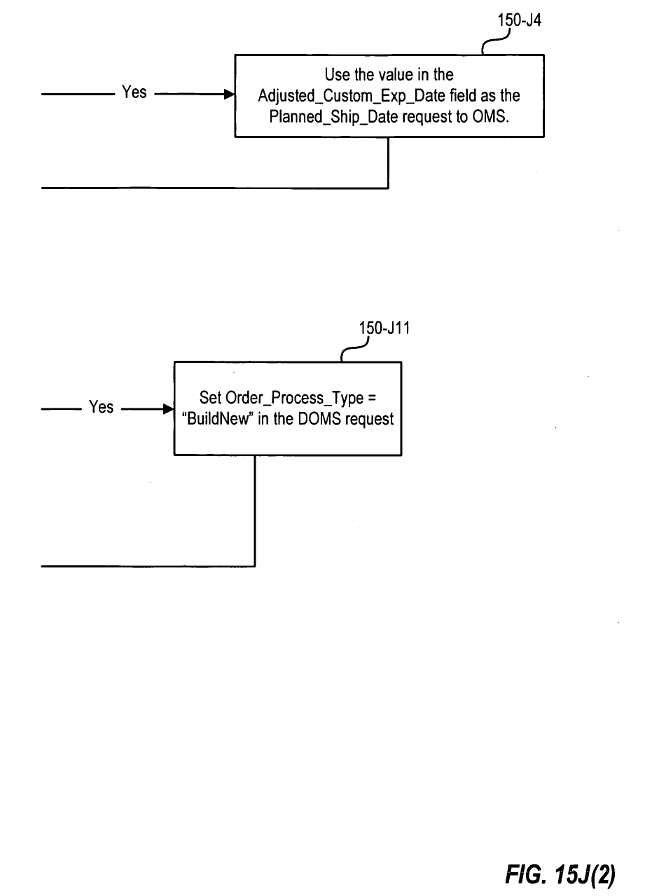

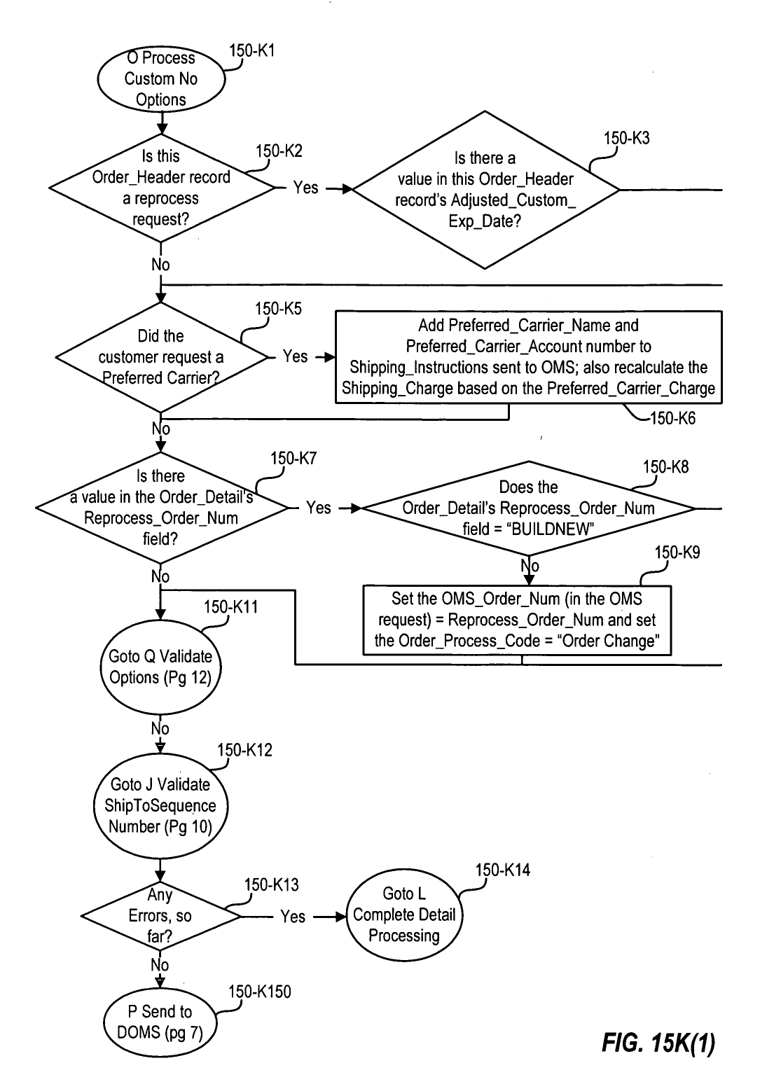

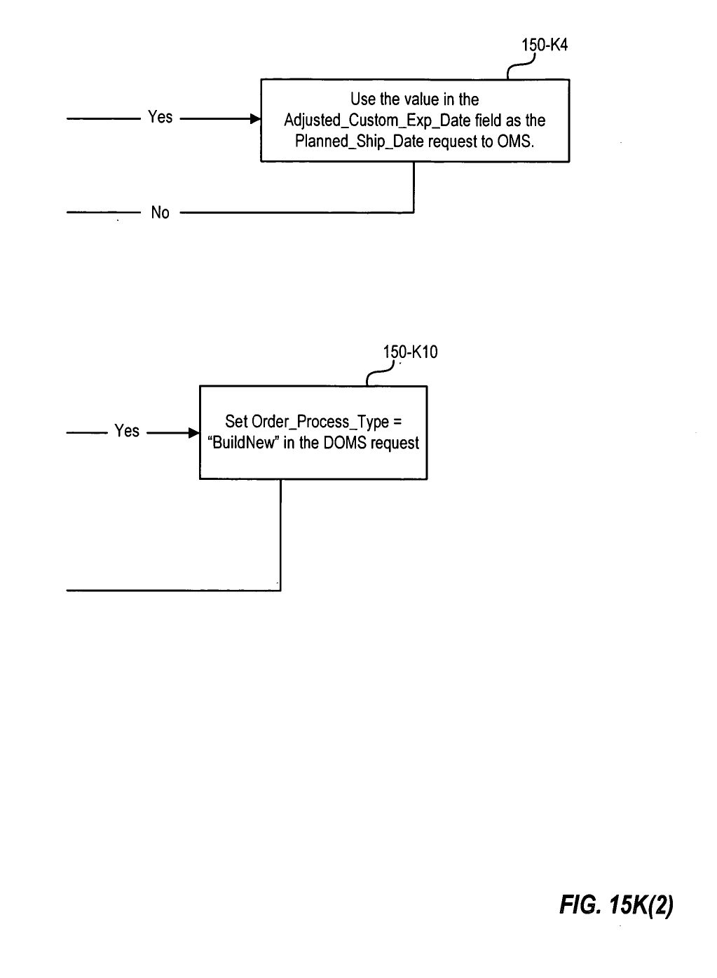

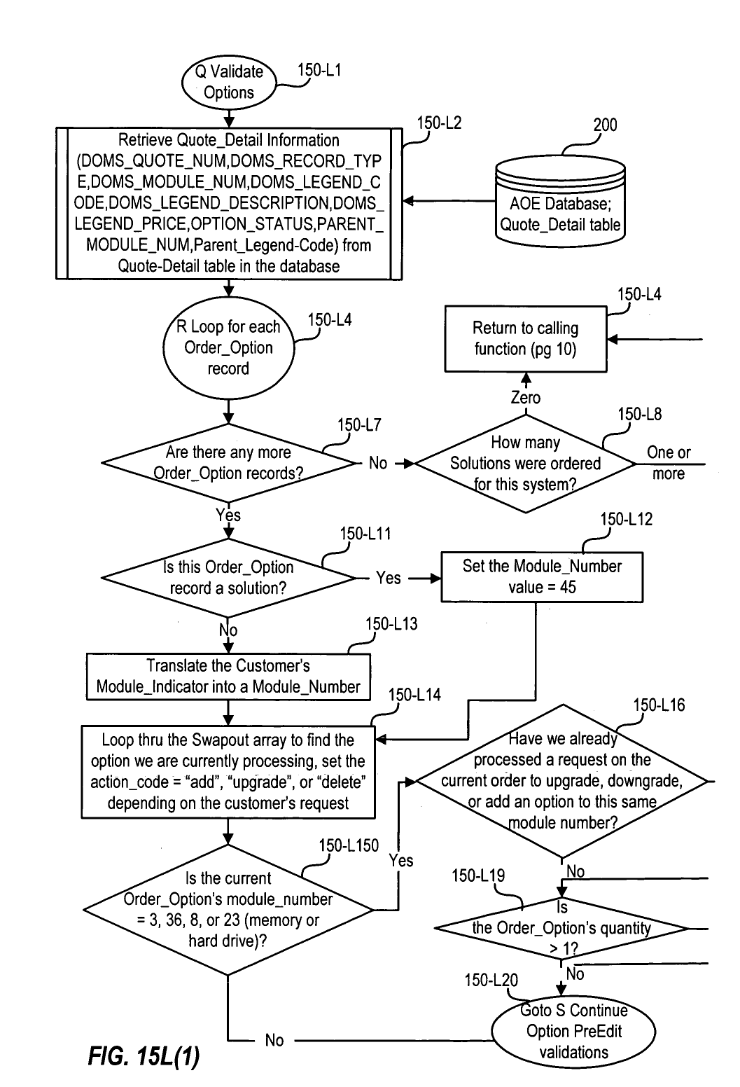

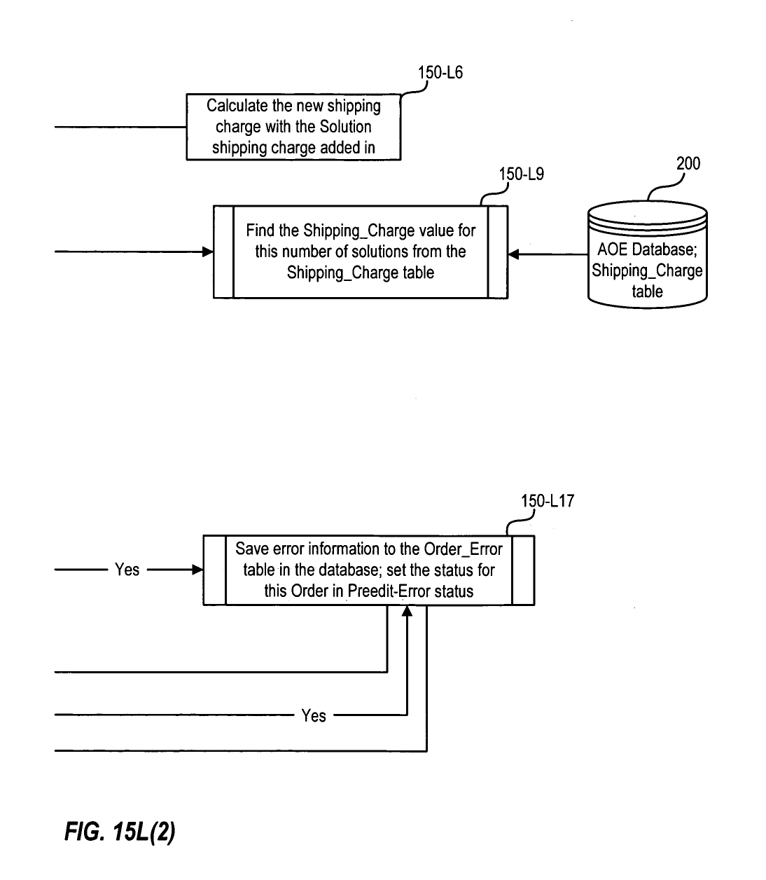

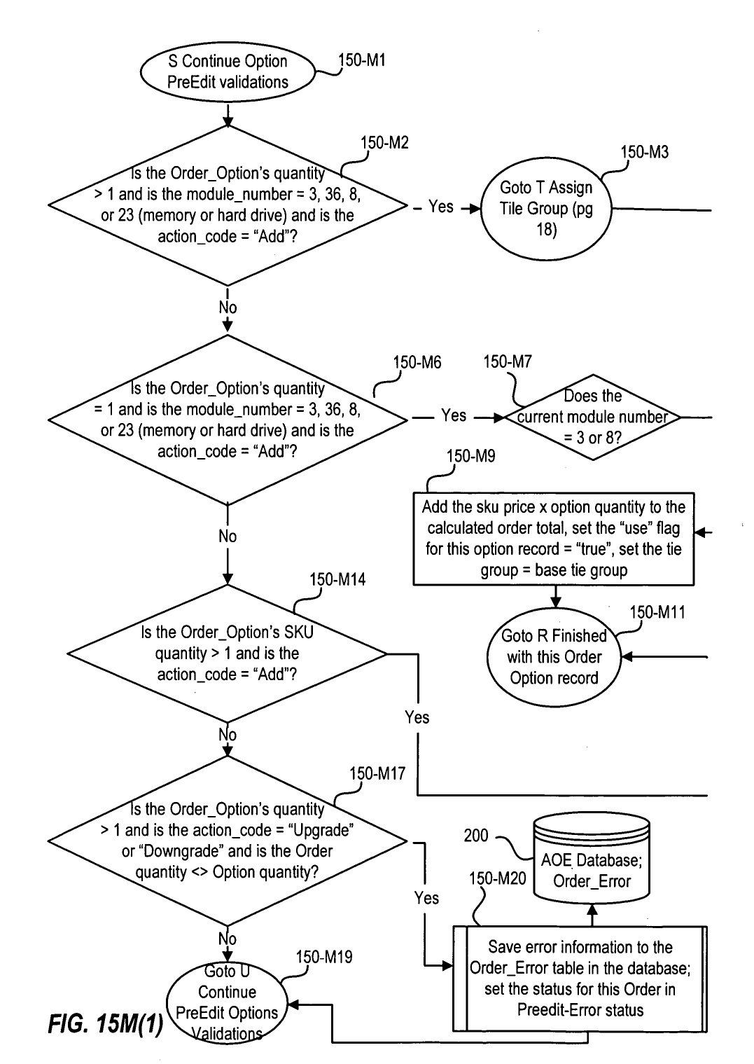

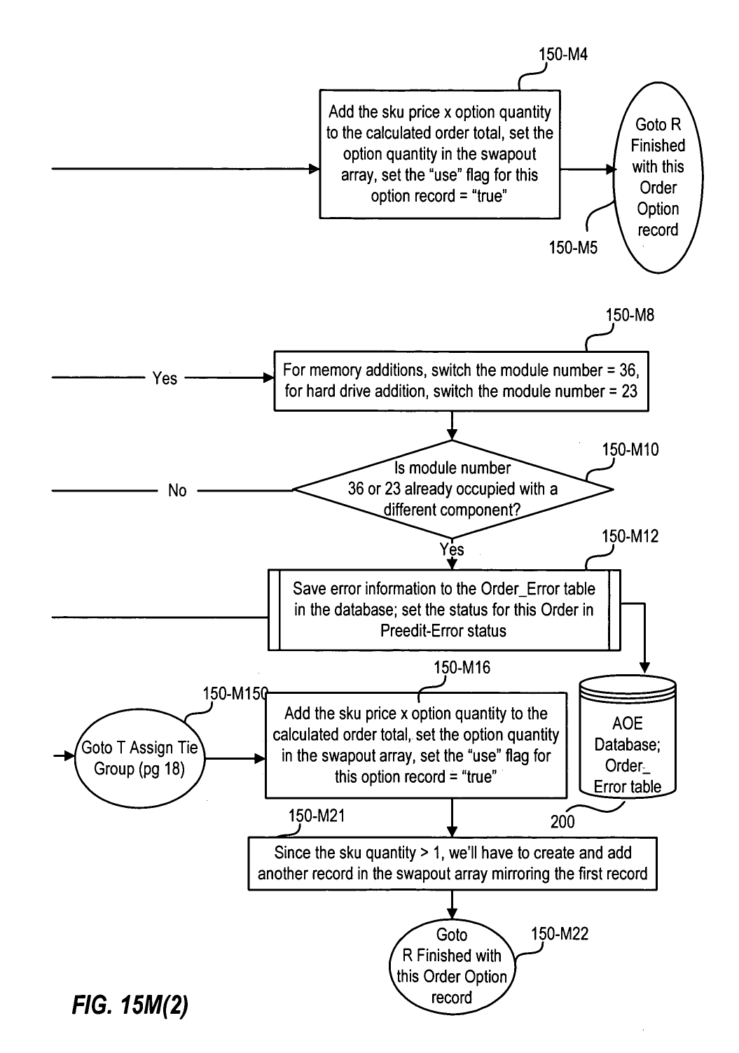

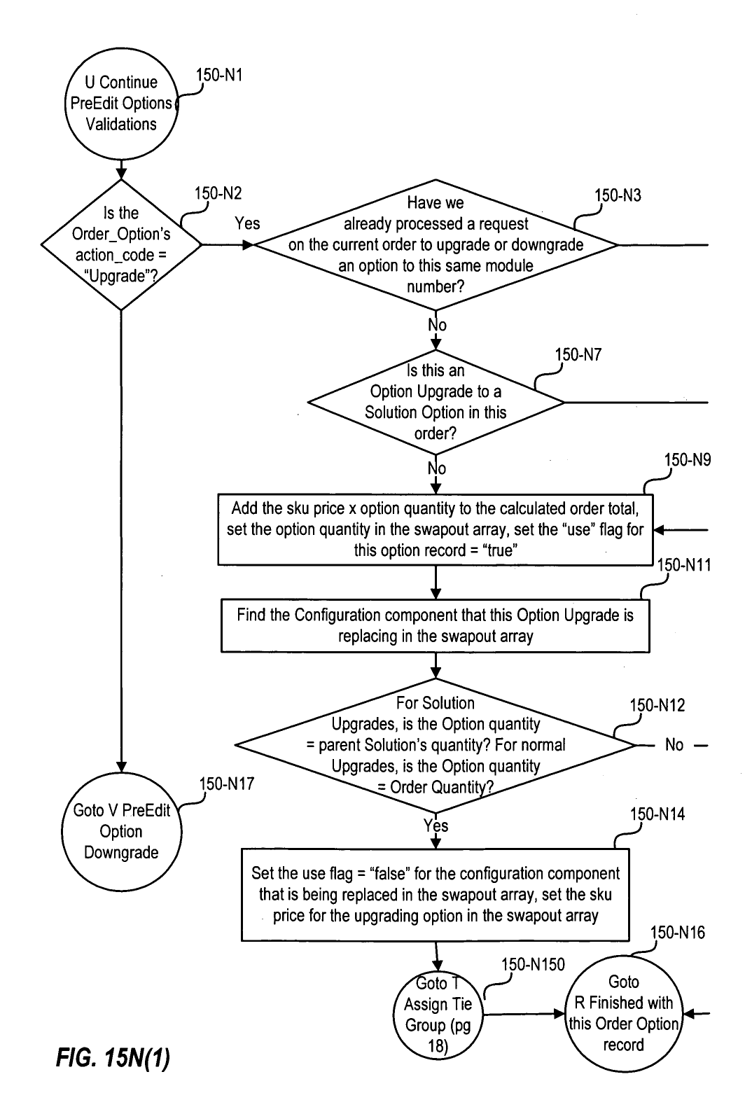

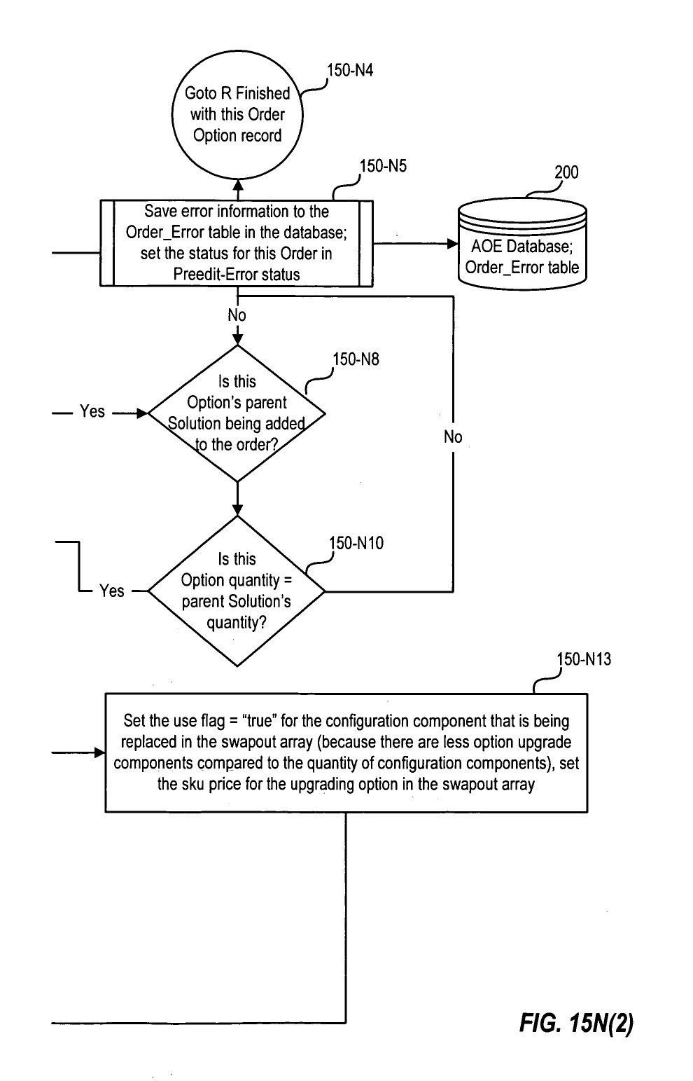

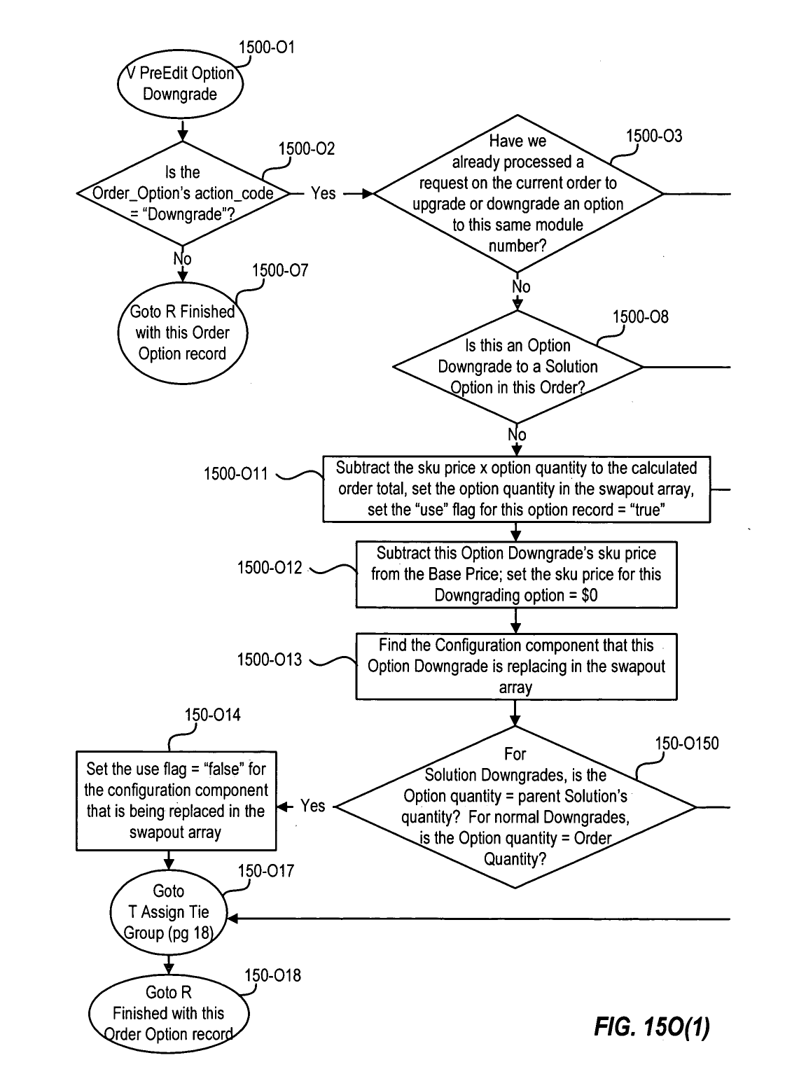

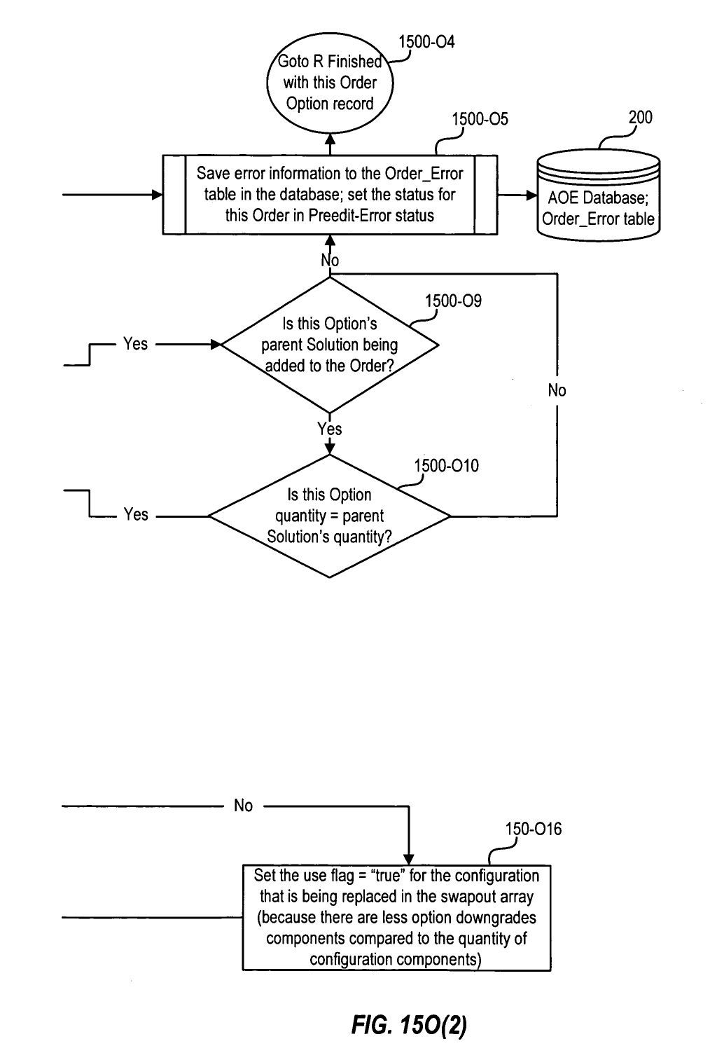

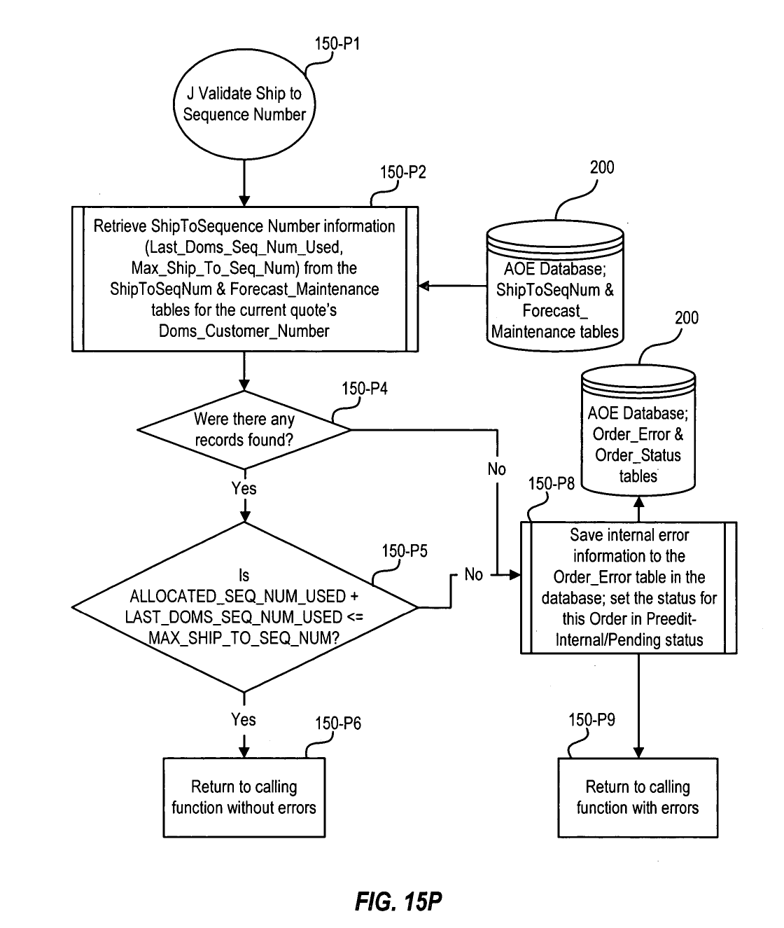

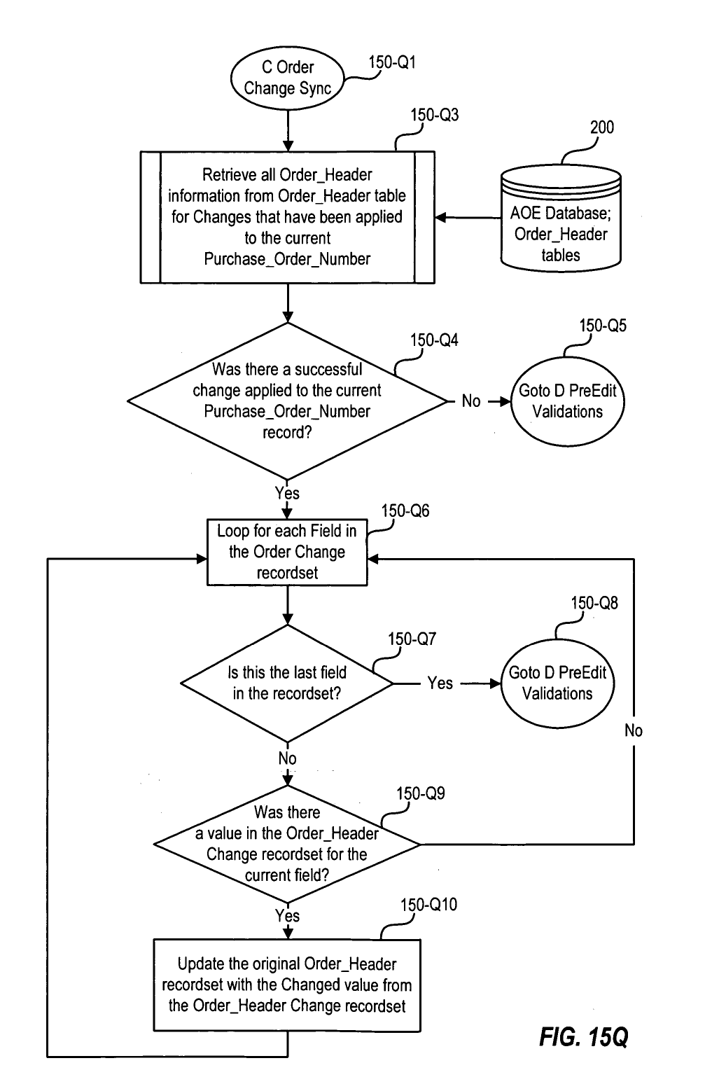

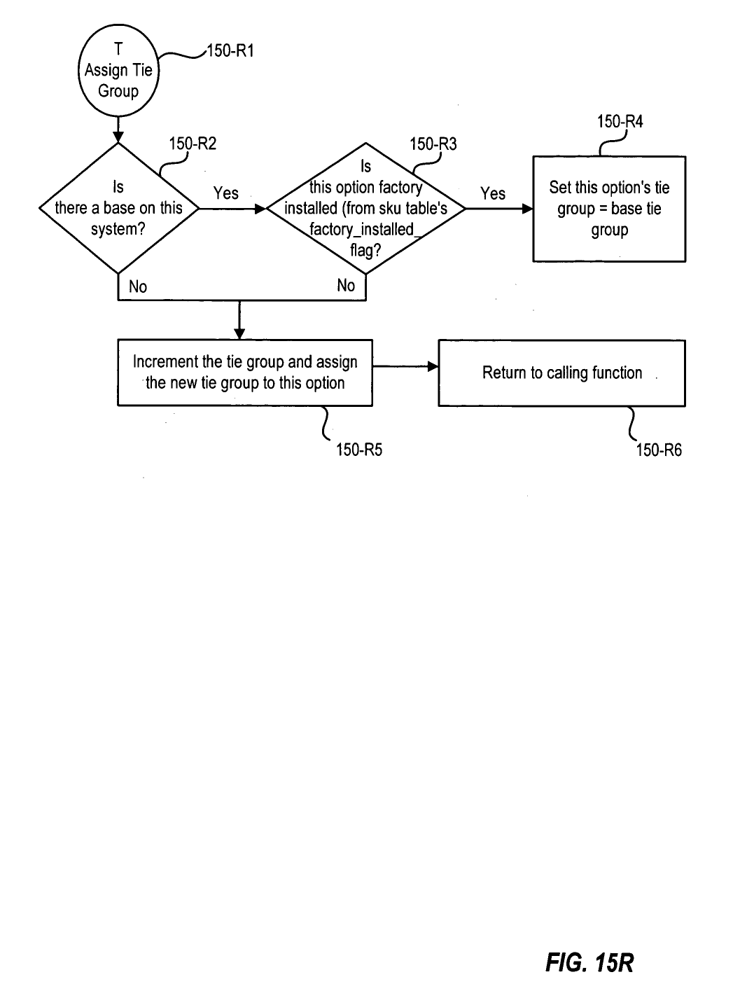

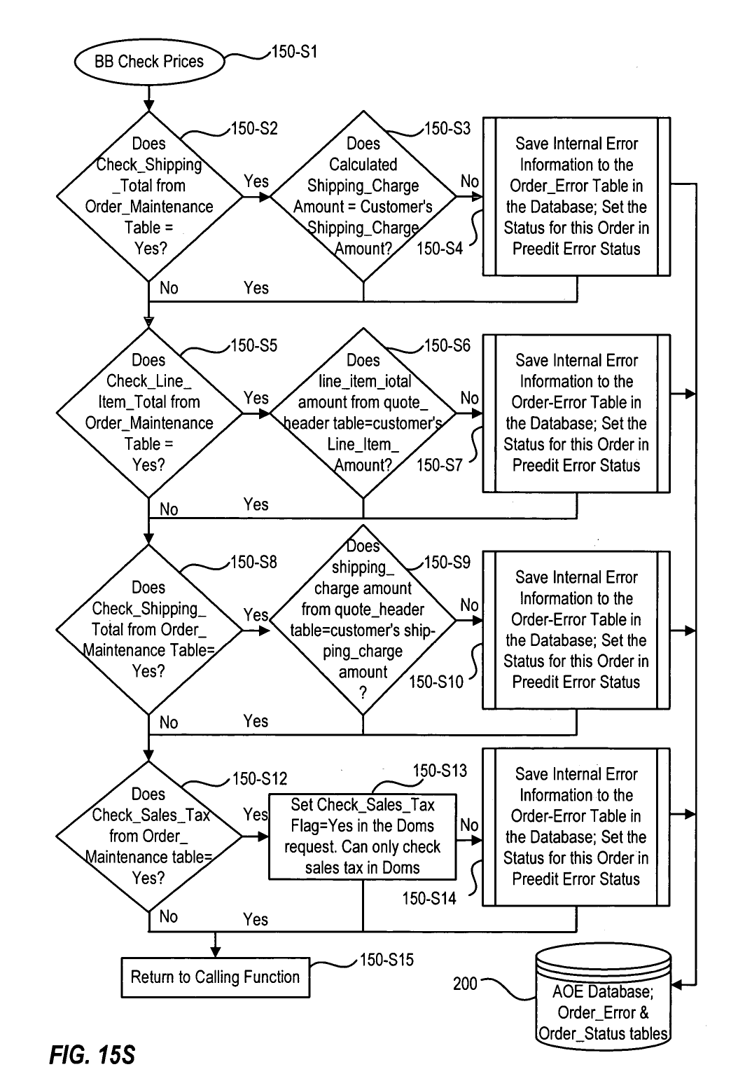

Referring to FIGS. 15A through 15S, the order processor batch program 14A-15 operates to open a database connection with the AoE database 200 in steps 150-A3 through 150-A7, and retrieves information from an FTP transport medium in step 150-A8, which optionally is another type of transport medium, such as TCP/IP or other appropriate medium. More particularly, referring to blocks 150-A14 through 150-B6 shown in FIG. 15B, a retrieval is accomplished with a loop that retrieves each file with an appropriate extension identifying the file as a order file. This loop retrieves any order files received from one or more customers.

In loop “B” shown in block 150-C1 shown in FIG. 15C, all the order data is inserted as received from the customer into AoE database 200 in block 150-C2. This is done to always have the original data available for audit requirements. The order processor 14A-15 also sorts the file by the planned ship date so that orders with a smaller lead time are allocated against stocking order inventory in contrast to orders that have a larger lead time. The order process begins in block 150-C7 wherein order header and order wrapper data is validated. An order header refers to representative data, typically at the “head” of an order that relates to more specific items in the entire order. Order wrapper data relates to the naming of the order file.

Further shown in FIG. 15C are blocks 150-C17 through 150-C18 referring to FIG. 15Q. FIG. 15Q shows a diagram that determines if there is an internal request by a computer user to perform a cancel of an order and a reassign of another stocking order to a purchase order. The reason for such is that new inventory may have been built and existing inventory may be available and preferred. For example, end of month inventory clearance policies may dictate using existing available inventory instead of building new systems. FIG. 15Q includes blocks 150-Q1 through 150-Q10 and provides logic exiting to pre-edit validations in FIG. 15D.

Block 150-D1, shown in FIG. 15D, preedit validations are done automatically against the data, until block 150-D16. The functions performed includes executing orders against header data and executing detailed functions. The pre-edits insure that the customer is following the pre-defined business rules. If the customer is not following the rules, the order processor 14A-15 rejects the order with the business rule broken therein denoted. If the order passes preedits successfully, the order request is processed in the OMS system. Accordingly preedits are handled automatically independent of human interaction.

The predits uses a recordset called an “order maintenance” recordset from AoE database 200 to check the validity of the Order Header information sent by the customer in order 338. The checks performed are shown below in Table 1:

TABLE 1
Transaction_Purpose_Code sent in the customer's order file matches the
ORDER_PURPOSE_CODE in the Order_Maintenance table in the
database using appropriate value.
Purchase_Order_Type sent in the customer's order file matches either
the Lease_Order_Value, Term_ORder_Value or
Credit_Card_Order_Value from the Order_Maintenance table
in the database customer payment that a customer can pay by.
Checks for duplicate PO numbers if the PO_Duplicate_Check_Flag is
set to YES in the Order_Maintenance table of the database. Do we check
for duplicate Pos for customer?.
Checks the lengths of the PO Number, if it is greater than 15, then it
generates a unique, adjusted PO Number, and appends the originally
requested PO Number to the Shipping_Instructions.
Compares the currency_code sent by the customer to the currency_code
in the Order_Maintenance table. Looking for appropriate currency..
If the customer sent a Preferred_Carrier name, it checks to see if the
customer is allowed to use Preferred carriers, and if there's a surcharge on
using a Preferred carrier. Determine if customer wants to use customer
specific carrier.
Check to make sure the customer sent a ShipTo First and Last Name in the
ST_Name field. Also, checks the ShipTo Additional Name field,
and ShipTo ContactName field. Required Data
Checks to make sure the customer sent a ShipTo Address Line 1. Checks
to make sure the ST_Zip is atleast 5 numeric digits, and makes
sure that the customer sent a value for the ShipTo CityTo City,
state, zip, and country code. Required Data.
Checks to make sure customer sent a value for the BillTo Name. ppends
BillToName and ShipToContactName to send as the ShipToCompany
name. Required Data.
Checks to make sure customer sent a value for the BillTo Address Line 1,
and Bill To City and state, zip, and country code. Required Data
If customer sent a Tax_Exempt Certificate number with the PO
request, the program checks in the Tax_Exempt_Certificate table in
the database to match the cerificate number and find the proper
DOMS_Customer_Number to use when ordering the PO. It also checks
to make sure the Jurisdiction_Level matches the address in the ShipTo
information requested by the customer, and if the Tax_Exempt_{—}
Certificate is still effective. Is customer permitted to order tax-exempt?.

Referring to TABLE 2, below, edits to the line items shown in order file 338 are accomplished as part of the pre-edit sequence described in flow blocks shown in FIG. 15D.

TABLE 2
If customer sent payment as a credit card, the program checks the
CREDIT_CARD_ORDER_FLAG in the Order_Maintenance table in
the database to make sure the customer is approved to order by Credit
Card. It also checks that there's a value for the Credit Card Number,
Expiration Date, and Credit Card Type (Visa, MC, Discover, AmEx).
The customer may split an order between up to 3 credit cards, so the
program checks to make sure that the Precentage of Payment for all cards
adds up to 100%. (CID value is a required field for American Express
cards only). Data validation
B) ClsPreEdit.PreEditDetail: First retrieves the order's quote information
from the quote tables in the database. Then, checks for a valid quote
status, invalid quote statuses are “Deleted”, “Exceptioned”,
“Exceptioned and Replaced”, “Exceptioned and Deleted”, and
“Replaced” in which the Replacing quote is already active. Also,
checks the “System Type”, “System Matrix Type”, and Shipping
charges. Customer requesting active configuration
C) ClsPreEdit.PreFditDetail: If this record is a Reprocessing Order, check
the Geo_Code table to see if there was a user selection for a particular
GeoCode. Here, it also retrieves a recordset of the Non-Working days for
this customer. It also retrieves a list of the options requested for this
system. Internal processing
D) ClsPreEdits (continued): The program checks the ShipByDate to make
sure it doesn't fall on a non-working day, also checks the Shipping_{—}
Service (Standard vs. Expedited) based on the ShipByDate. If the order
is a Reprocessing order, it checks to see if there was a user-entered
Adjusted ShipByDate. If there's an entry for Preferred Carrier, it adjusts
the Shipping_Instructions accordingly. It checks in the ReprocessOrder
Number field in the Order_Header table for a user-entered order
number. If there's an order number present, the program uses the order
number to place an order change. If ReprocessOrderNumber field has the
string “BUILDNEW”, it creates a new order from the quote. Next, the
program checks for the Tax_Exempt flag. If the customer requested
a non-tax order, the matching OMS_Customer Number must be sent with
the order request to OMS. Data validation
If the order is not an Order_Change, it validates the ShipToSeqNumber
for the order by retrieving the ShipToSeqNumber data from the Ship_{—}
Seqence_Number table in the database. It adds the ALLOCATED_{—}
SEQ_NUM_USED + LAST_OMS_SEQ_NUM_USED,
it that number is greater than the MAX_SHIP_TO_SEQ_NUM,
then we've run out of ShipToSequence numbers for that particular
DOMS_Customer_Number and the PO is placed in PreEdit-Internal
bucket for a business user to review (most likely the business user will
create a new OMS_Customer_Number.) Internal processing
Also, the program checks the Line_Item_Total if the Check_Line_{—}
Item_Total_Flag is set to YES. If the Line_Item_Totals don't
match, then the program puts the order into PreEdit-Error status and
returns the PO back to the customer. It also checks that the AoE_Flag
is set to YES, if not, itsets the PO in Error. Validating pricing
If the order is a Reprocessing order, the program also checks the
Adjusted_Custom_Exp_Date field in the Order_Header table in the
database. If there's a value in the Adjusted_Custom_Exp_Date field,
then the program sends the Adjusted date as the requested ShipByDate.
Internal processing

Referring now to FIG. 15E, a flow diagram illustrates the portion of the order processorl 4A-15 that calculates lead time for bundled systems, ensuring that contractual agreements are met in blocks 150-E8. In Block 150-E9 and 150-E10 orders for non-commodity products are examined calculate lead times to ensure that contractual agreements are met. The dates provided in the order file 338 are those given by the customer. These dates must be in accordance with pre-existing agreements. Shipment requests for non-working days defined as days that the manufacturer does not ship product or weekends are not permitted in an embodiment of the invention. In other embodiments a 24/7 request is permitted.

Blocks 150-E13 through 150-E15 provide that the customer provided pricing matches the manufacturer-calculated pricing on a per-configuration basis.

Blocks 150-E14 and 150-E15 relate to FIG. 15J and 15 K, wherein non-commodity configurations are evaluated to determine if optional components have been ordered. More particularly, FIG. 15J, including blocks 150-J1 through 150-J17 relates to processing of configurations without options. In one embodiment, no options refers to no upgrades or downgrades of components within a system configuration. FIG. 15K, includes blocks 150-K1 through 150-K15, and provides for processing a non-commodity product with options selected. Specifically, options are validated in block 150-K11. Block 25-K11 refers to FIG. 15L for validation of options.

Referring now to FIG. 15F, blocks 25-F1 through 25-F21 are shown. Blocks 150-F3 through 150-F4 determine whether a customer requested an expedited shipment. Bock 150-F5 relates to a preferred carrier of the customer and adds the data as part of the parameters of the order.

Referring to blocks 150-F8 through 150-F12, a process is shown that determines whether a customer order file 338 requests a commodity item that includes a ship date identifying a number of business days that is greater than the contractual number of days, the program creates a new order in the OMS system for an immediate build of a system instead of ordering a release of pre-built inventory. The blocks 150-F14 through 150-F16 relate to determining whether the order file 338 is tax exempt. Blocks 150-F17 through 150-F22 determine if there was any existing inventory from a prior month that has been superceded with a new catalog and new configuration with a new price and for which the customer is permitted to use the new price.

FIG. 15G provides blocks 150-G1 through 150-G22. The flow diagram illustrates in these blocks how the data is sent to OMS server 1240. Referring to block 150-G1 through 150-G8, a determination is made as to whether a reprocess occurred. More particularly, if an order failed and requires reprocessing, the OMS server 1240 will not release further inventory against the order due to the reprocess find in block 150-G3. Block 150-G8 prevents further inventory from being applied to the order. Block 150-G10 sets a process type to “build new” in the OMS server 1240 parameters. Block 150-G11 validates the ship to sequence number. The block 150-G11 validation refers to FIG. 15P. FIG. 25P includes blocks 150-P1 through 150-P9. The functionality shown includes in block 150-P2, obtaining a maximum ship to sequence number for maintaining the integrity of the OMS system.

Referring back to FIG. 15G, block 150-G13 refers to FIG. 151. FIG. 151 includes blocks 150-11 through 150-117 and provides for internal processing.

Referring FIG. 15G, block 150-G15, a check price process begins. The check price flow diagram is shown in FIG. 15S in blocks 150-S1 through 150-S15. More specifically, certain charges and pricing must be validated based on contractual agreements with customers. Typically, customers do not have a complex shipping and tax calculation tool that allows contractual shipping charges to be calculated. Accordingly, the flow logic shown calculates the charges on behalf of the customer with the manufacturers OMS system being the system of record. Sales tax can be calculated differently in a customers procurement system 371, therefore, the system of record will control the transaction. The line item total plus the shipping total plus the sales tax total gives the order total, therefore the order totals are incorrect if validation of shipping and sales tax are not correct. Thus, if the line item totals match, the order is processed and the order is not refused for shipping or tax discrepancies. The “real” dollar amount is communicated via order acknowledgement file 340 shown in FIG. 3A. Therefore, the customer may update their system to reflect the “real” order total. In some embodiments, there are no tax charges due to lease customers.

FIG. 15G, block 150 G-14 through block 150 G-21 provides for preparing and sending the validated data to OMS server 1240. Preparing the data includes stringing the data and order parameters together for transport. After sending data to OMS server 1240, a reply is received and further processing takes place as shown in FIG. 15G in block 150-G16. In block 150-G16 the request is loaded as shown in FIG. 15H. FIG. 15H includes blocks 150-H1 through 150-H20. The functionality shown includes determining in block 150-H3 whether the processing of the order was successful, and, if not, a reprocess or an error occurs. If successful, an update occurs in 150-H1 through 150-H19 of various AoE database 200 tables. The process completes with a call to detail processing in FIG. 151.

Referring to FIG. 15L, blocks 150-L1 through 150-L20 are shown. The flow diagram includes loops for each option record in block 150-L4, and processes a swap out array in block 150-L14, and sets the action code of the option to an “add” an “upgrade” or a “delete”. The option validation in FIG. 15L includes fail-safes procedures ensuring in block 150-L15 that illegal configurations of, for example, more than one operating system, or more than one body style in a automobile manufacturing system, or more than one memory module or hard drive are not ordered in incorrect quantities in block 150-L19.

The pre-edit flow diagram shown in FIG. 15L continues in FIG. 15M. Referring to FIG. 15M, blocks 150-M1 through 150-M22. The functionality of the figure includes determining whether an order includes an add component, and, if so, whether an OS tie group parameter must be incremented. The “tie-group” parameter is an OMS 1240 server parameter that is needed to generate a correct order. The flow diagram also determines if there an order includes an upgrade or a downgrade of a system. Referring to FIG. 15R, the assign tie group blocks 150-R1 through 150-R6 relate to whether an option requires incrementing. Options are tied to a chassis and certain predefined options are not. In block 150-R3, the flow diagram determines whether a component is factory installed or not. If it is, then the tie group is not incremented. If it is not factory installed the tie group is incremented. For example, a steering wheel is generally tied to an automobile, and a cell phone may not be.

Referring to FIG. 15N, including blocks 150-N1 through 150-N17. The functionality of FIG. 15N relates to determining whether a code relates to a upgrade. Block 150-N3 determines if the code relates to a upgrade component. Block 150-N7 determines if the code related to a upgrade of a solution. Block 150-N9 through block 150-N14 performs swap outs of components in a swap out array, and incremental pricing changes. Further included in FIG. 15N is option processing specifically looking for mini-systems, referred to as “solutions.” More specifically, a solution refers to a grouping of components that are provided together and referred to jointly as a “solution.” For example a “docking solution” includes a mouse, keyboard, monitor and a dock for use with a notebook computer. The customer will use one code to refer to the group of components instead of ordering separate items. Another example would be an “LS” package for an automobile, including wheel flares, CD player, ski rack, and global positioning system.

Specifically, blocks 150-N8 through 150-N15, provide for breaking down solutions into component parts for order processing. The tie-group parameter is incremented in block 150-N15, which refers to FIG. 15R, discussed above.

FIG. 15N further continues pre-editing orders including option downgrades in block 150-N17, which refers to FIG. 150.

Referring now to FIG. 150, including blocks 150-01 through 150-018, block 150-02 determines whether a code relates to a downgrade. Block 150-03 determines if the code relates to a downgrade component. Block 150-08 determines if the code related to a downgrade of a solution. Block 150-011 through block 150-014 performs swap outs of components in a swap out array, and incremental pricing changes.

Referring back to FIG. 4B, one embodiment of the manufacturing process depicts how configuration data is extracted seamlessly from a non-Windows environment database into a Window environment. FIG. 4B shows a non-Windows database, such as a UNIX or LINUX or other legacy server OMS server 410. The process interacts with OMS server 410 from a Windows environment or other user-friendly environment via an agent 420. As shown, quote requests 430 are received by agent 420 which responds with response 440. Agent 420 includes a library shown as MPATHLIB, which assists in the seamless interaction with the OMS server 410.

Referring back to FIG. 14B, OMS server 1240 is shown in further detail. OMS server 1240, according to one embodiment, is a Cobol program that runs on the OMS system. There are portions of the program developed to generate non-commodity, or commodity orders in the OMS system. Further, portions of the program manage the release of pre-built inventory stocking orders as part of a stocking order program within order processor 14A-15, by performing an order change on the pre-built order number, thereby allocating a real customer purchase order number, customer ship-to address information and customer specified shipping requirements. Further, the portions of the program control the return of the order and order change information in OMS server 1240 from the OMS system platform to a disparate computing platform shown as an Windows NT program order processor 14A-15.

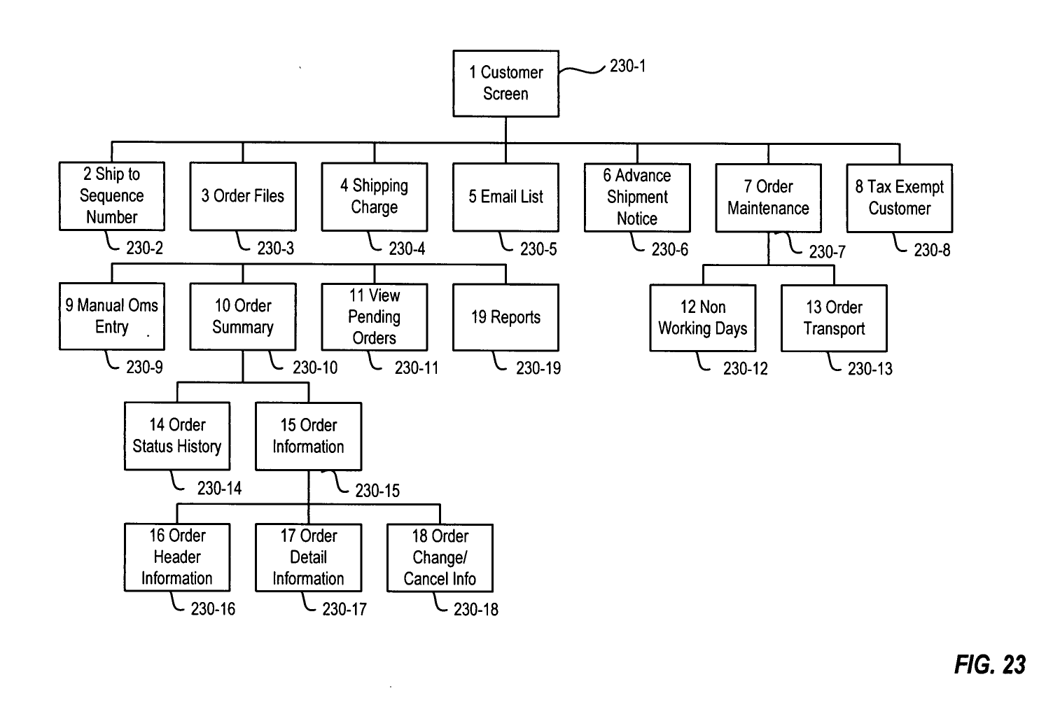

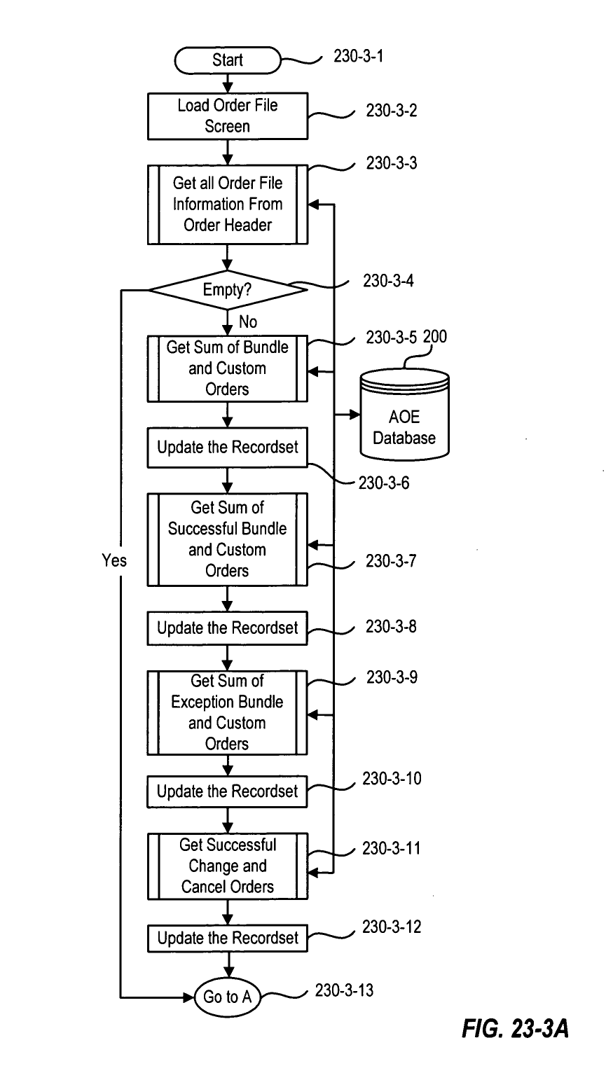

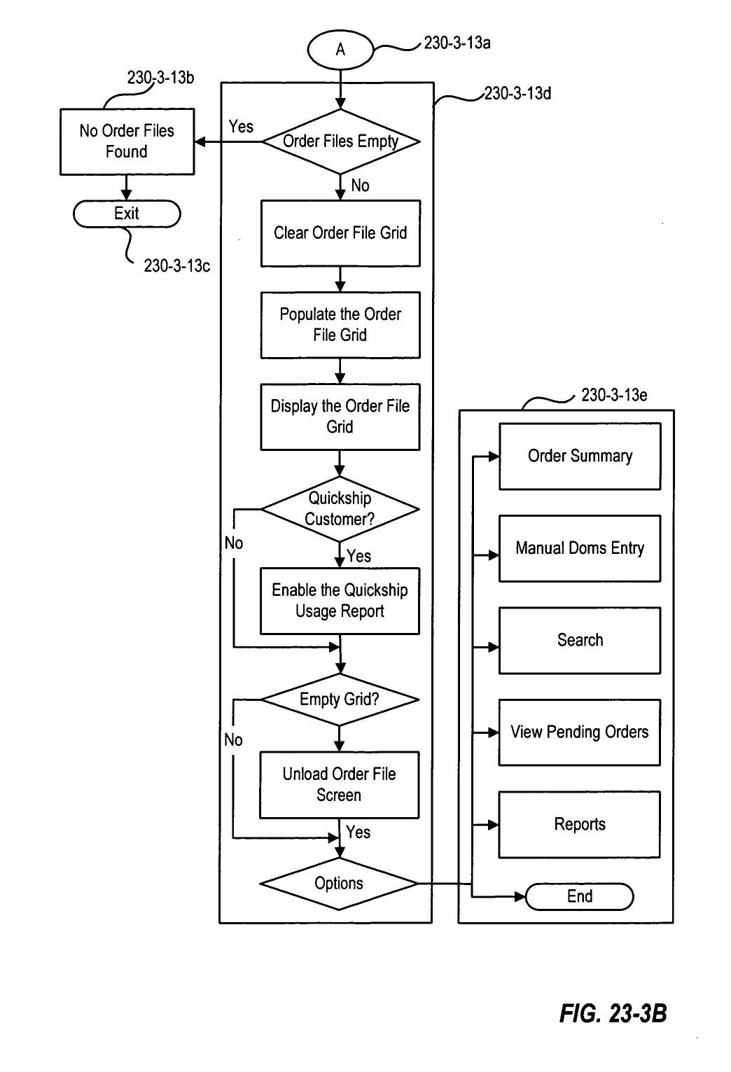

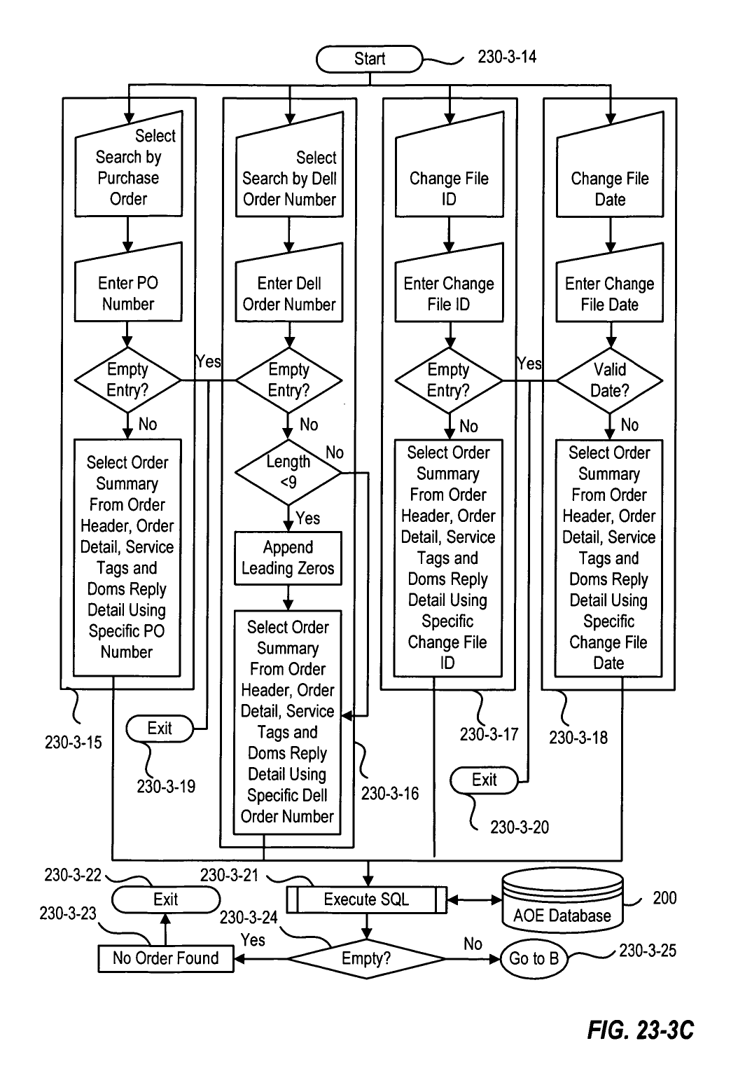

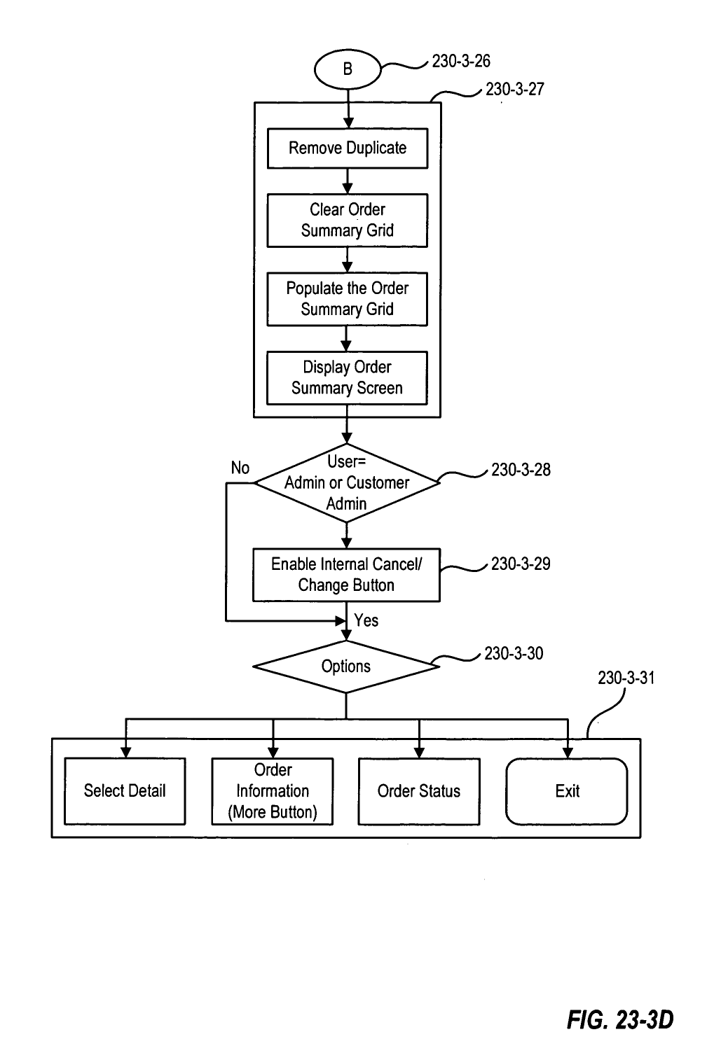

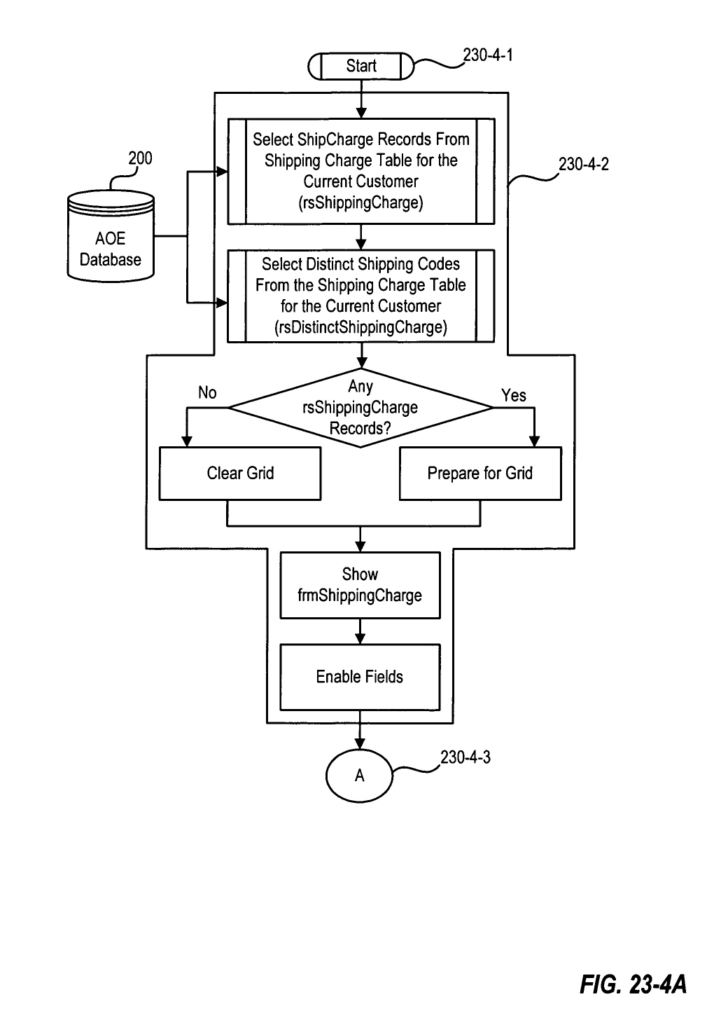

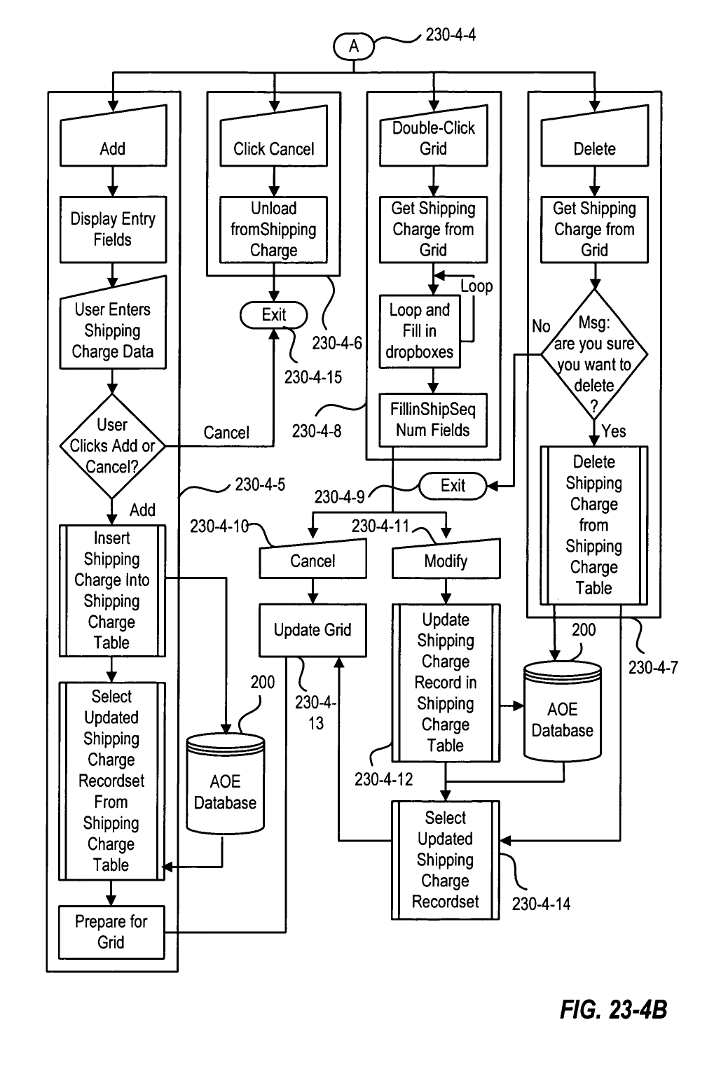

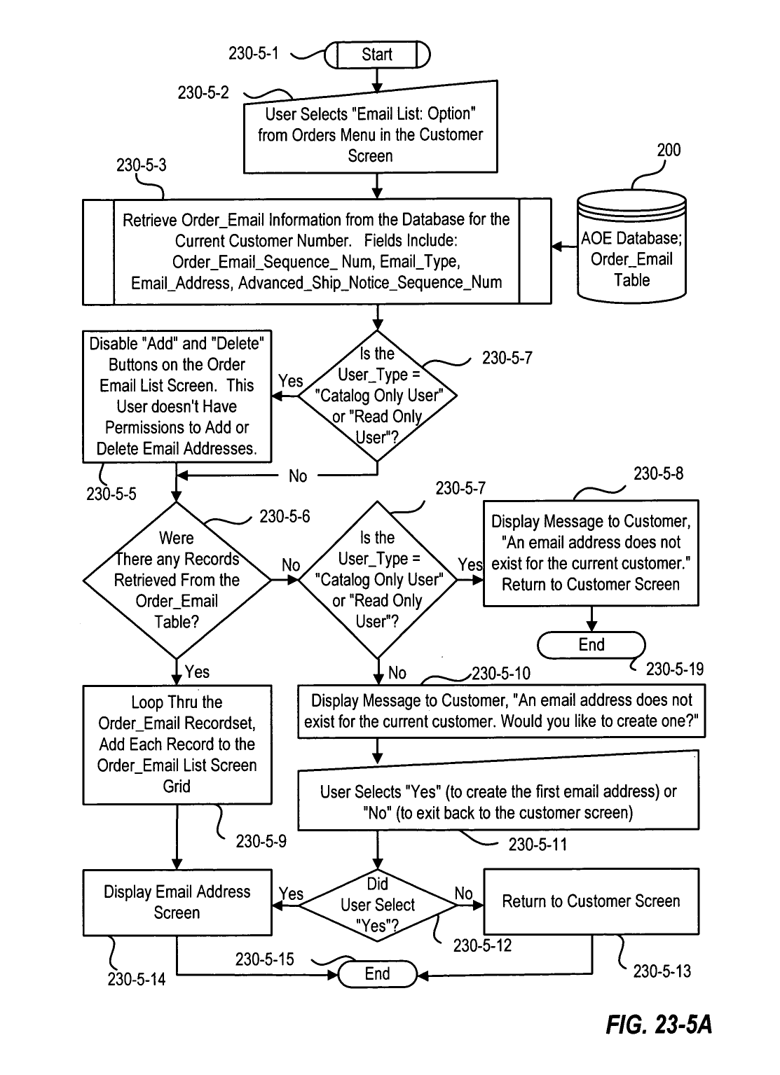

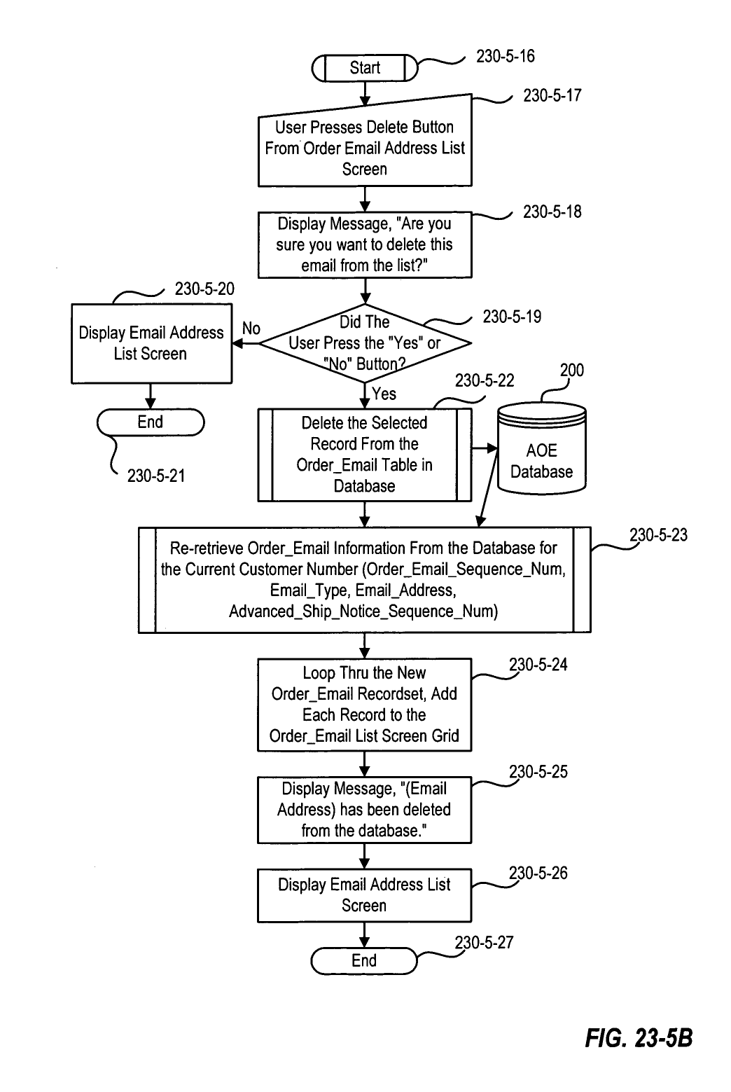

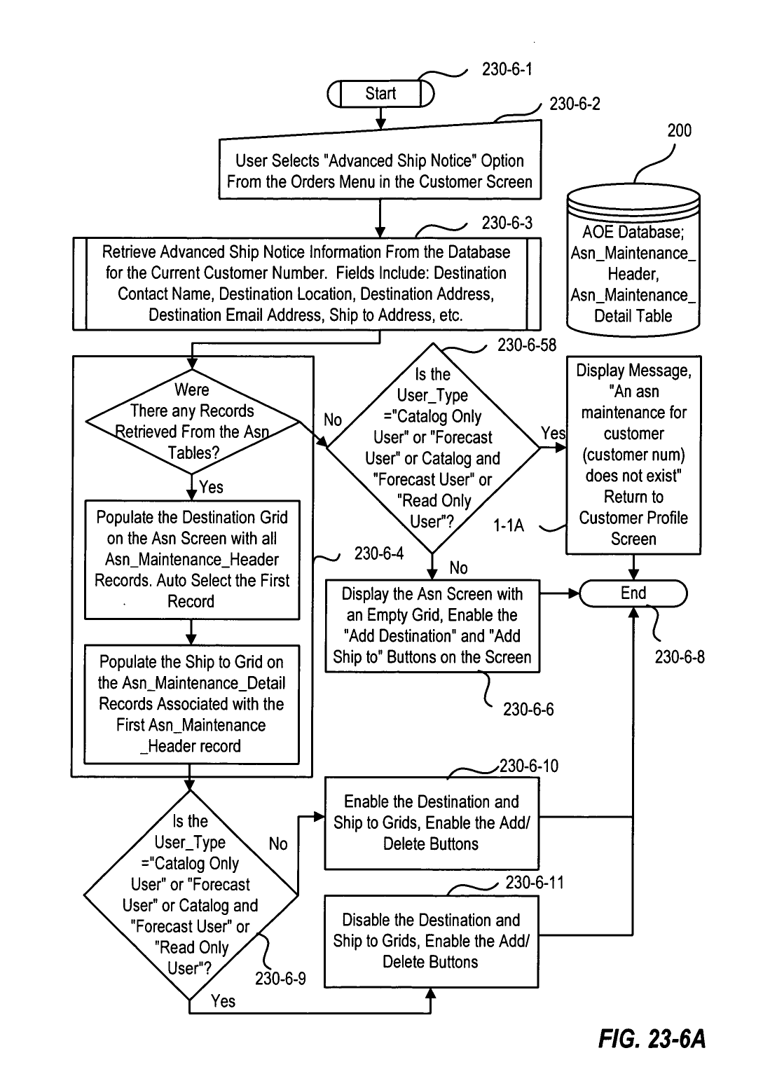

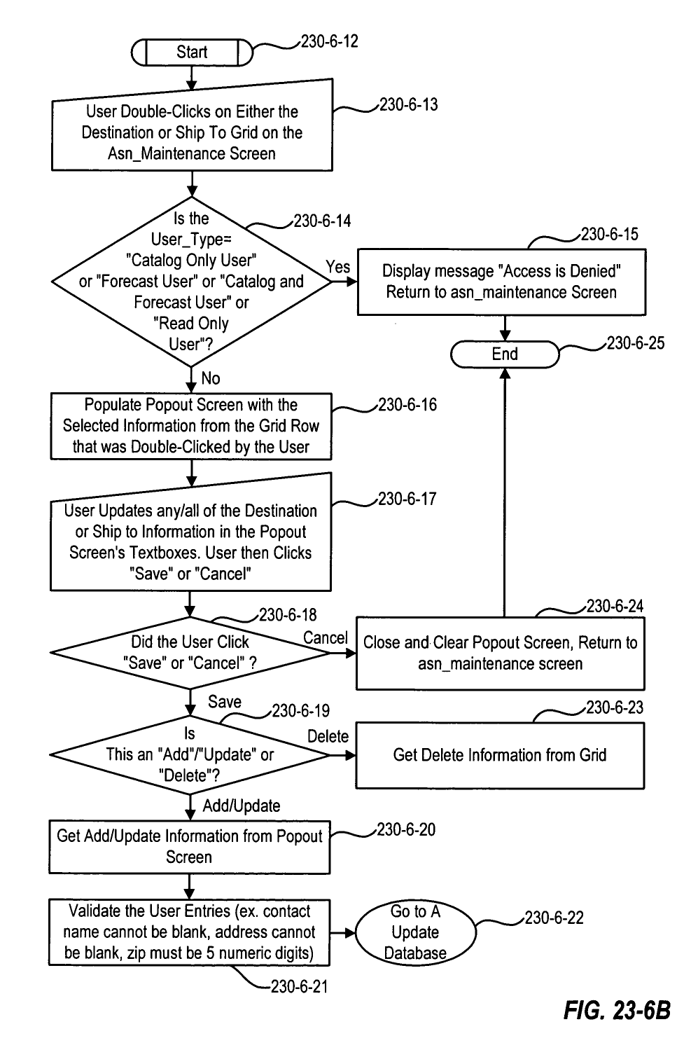

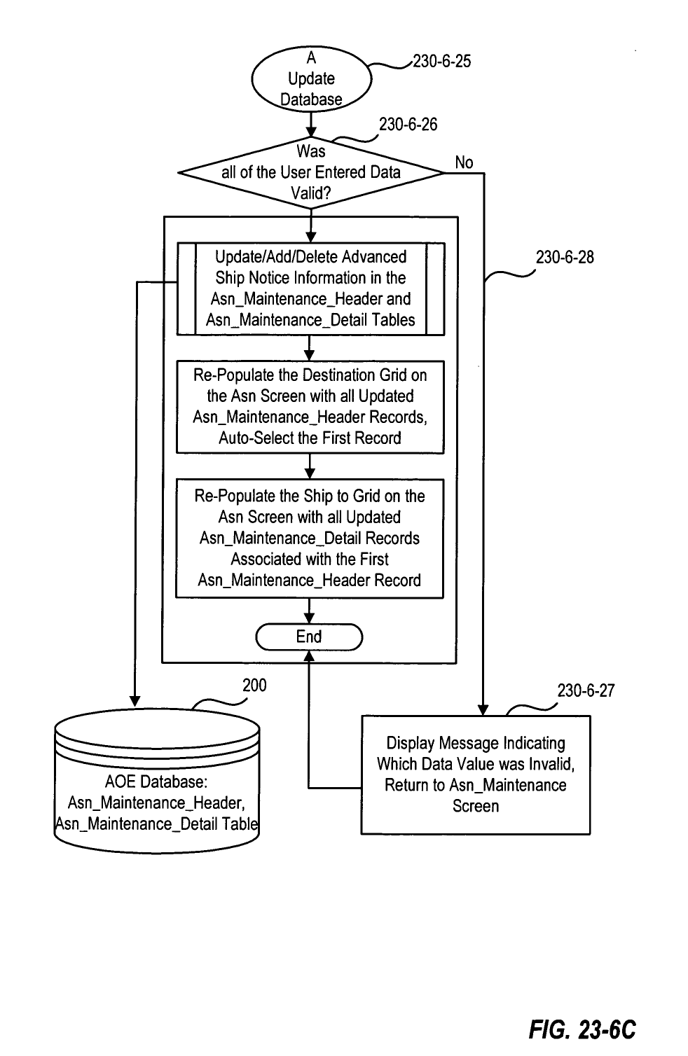

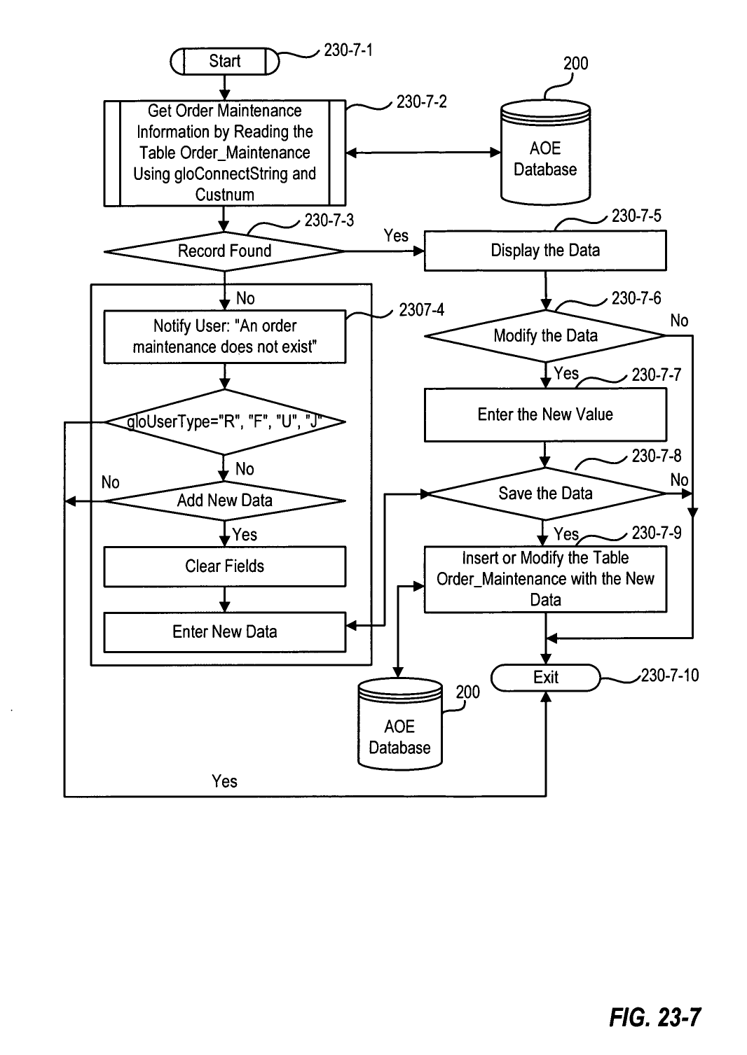

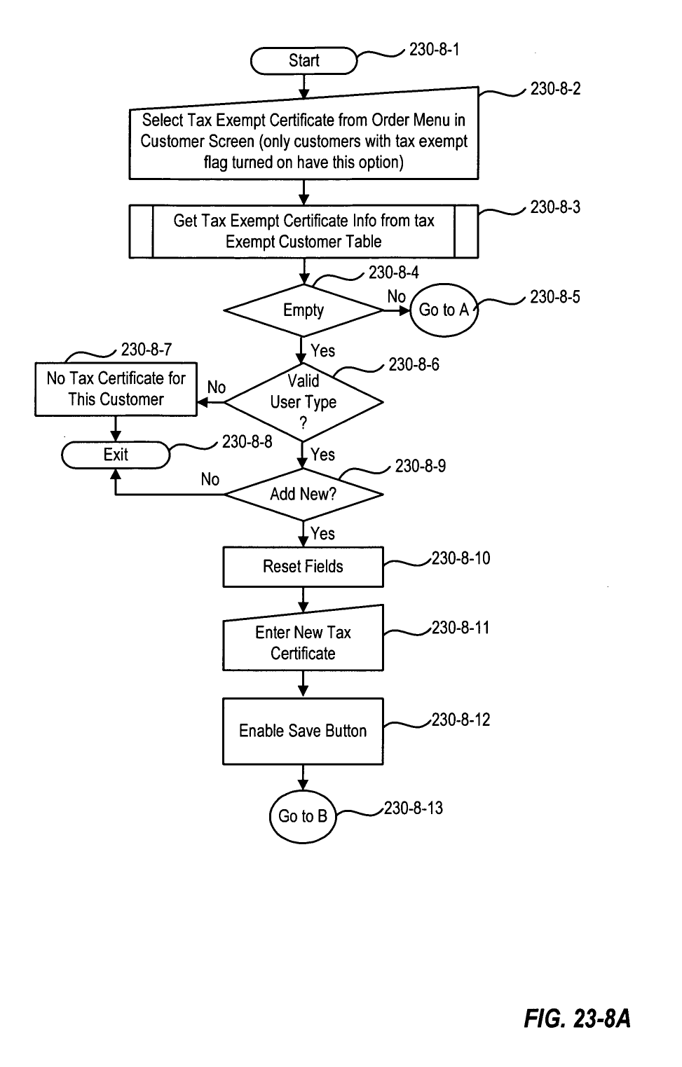

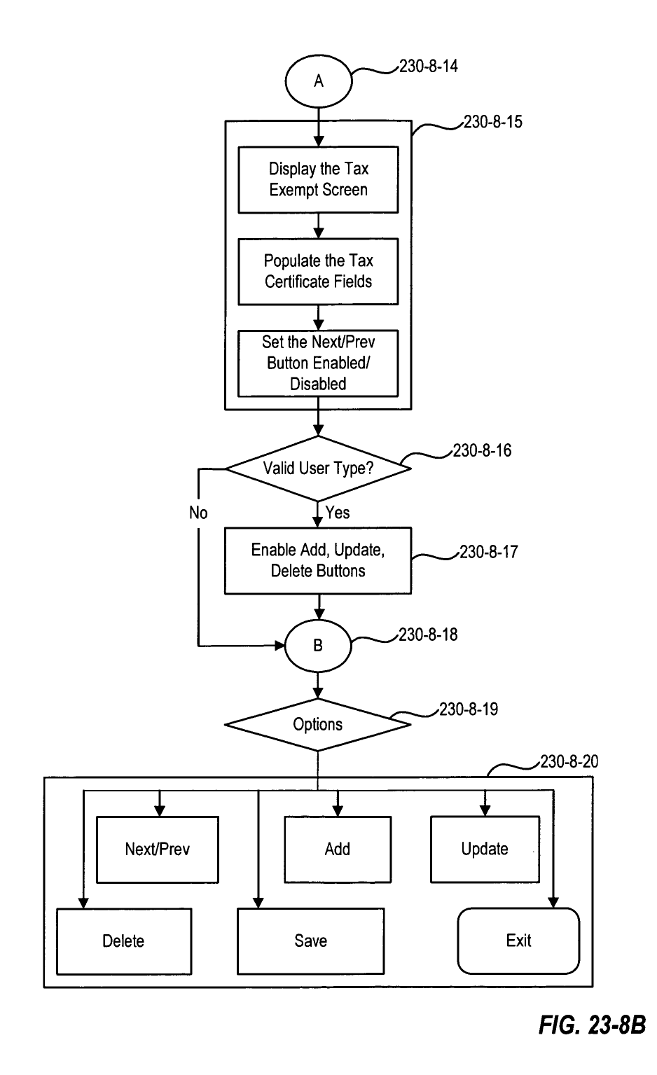

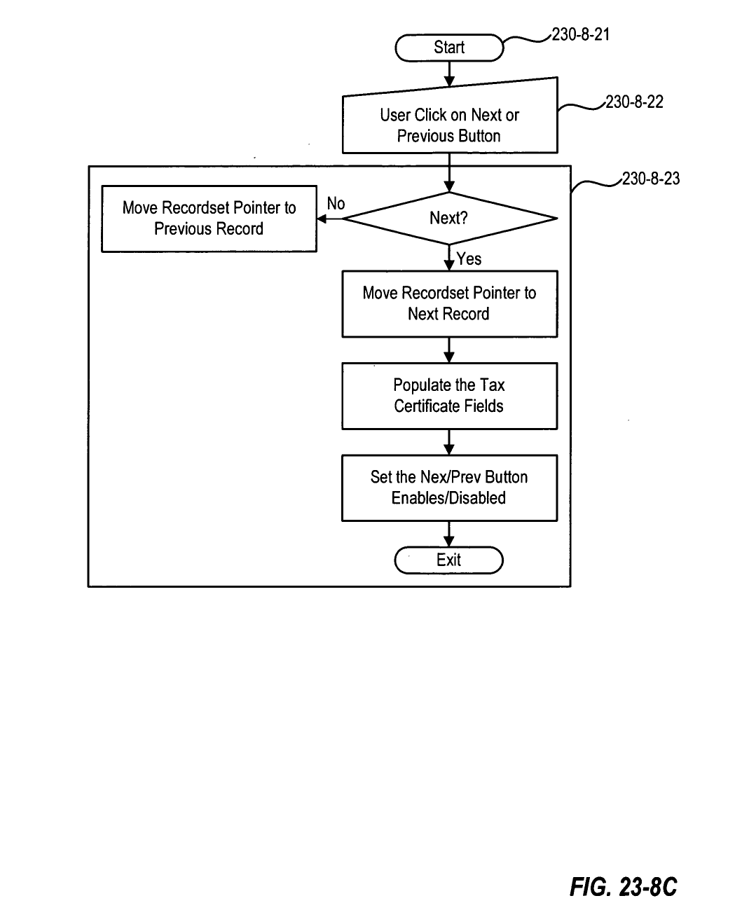

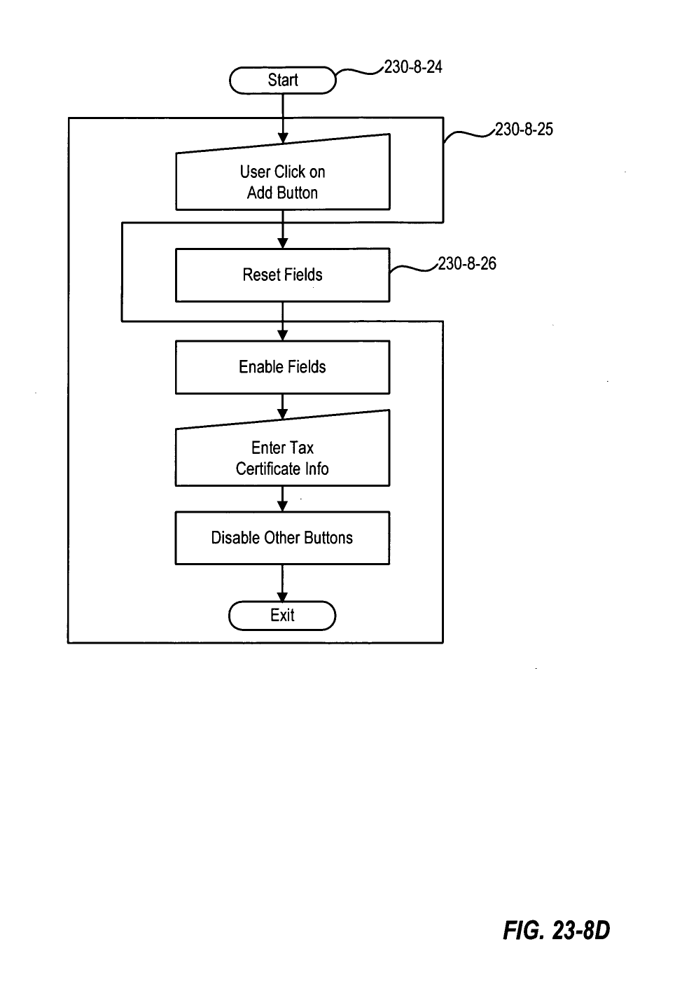

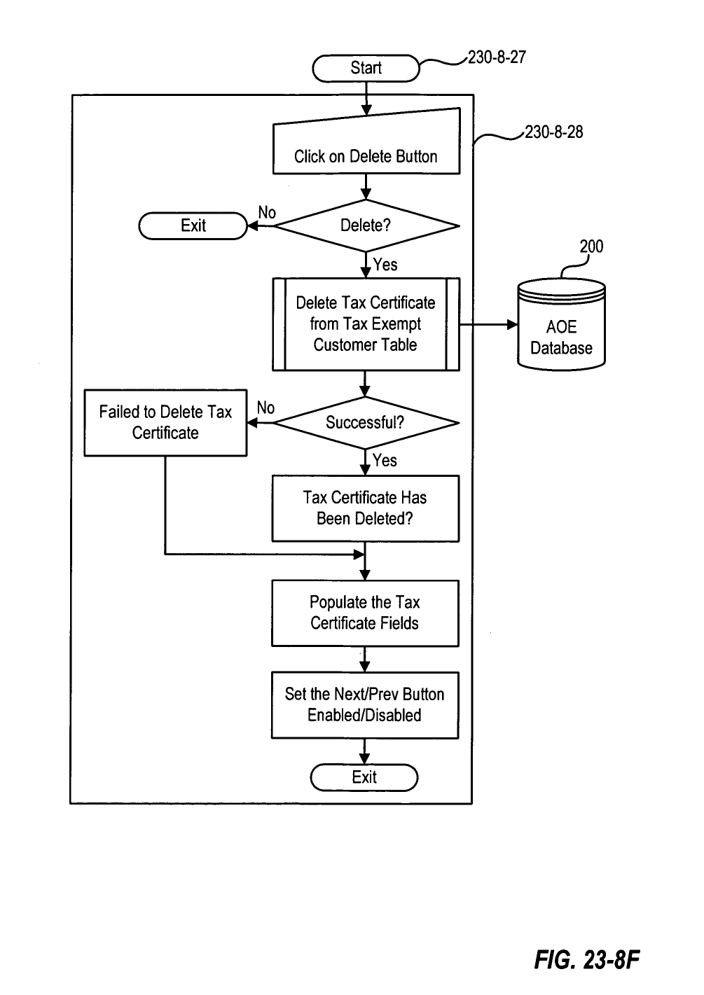

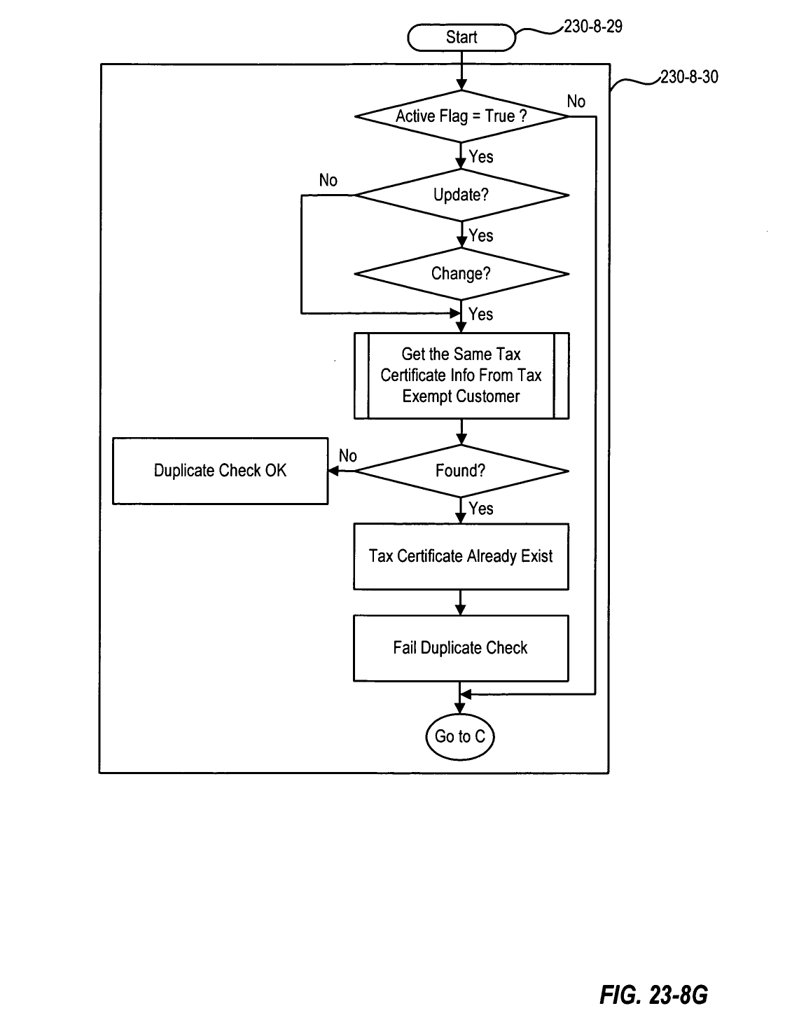

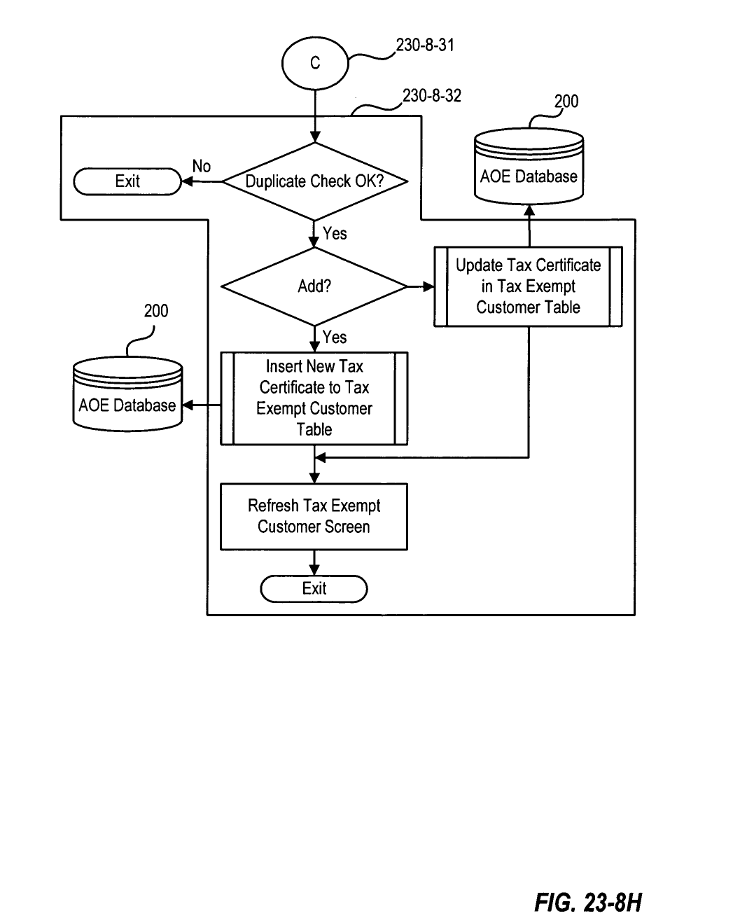

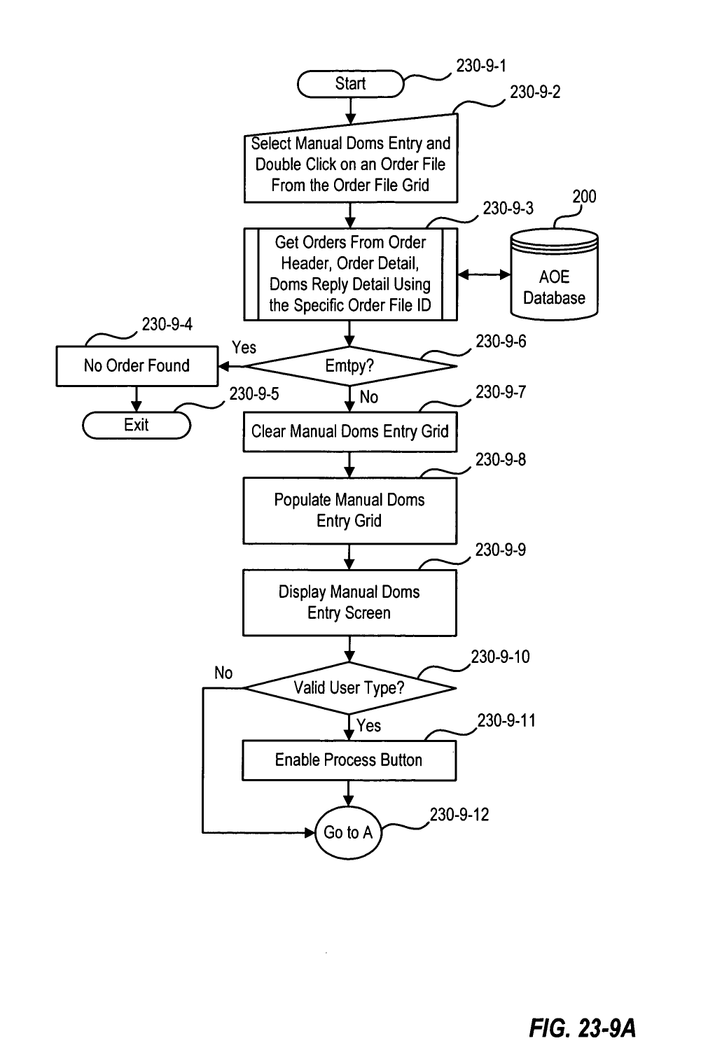

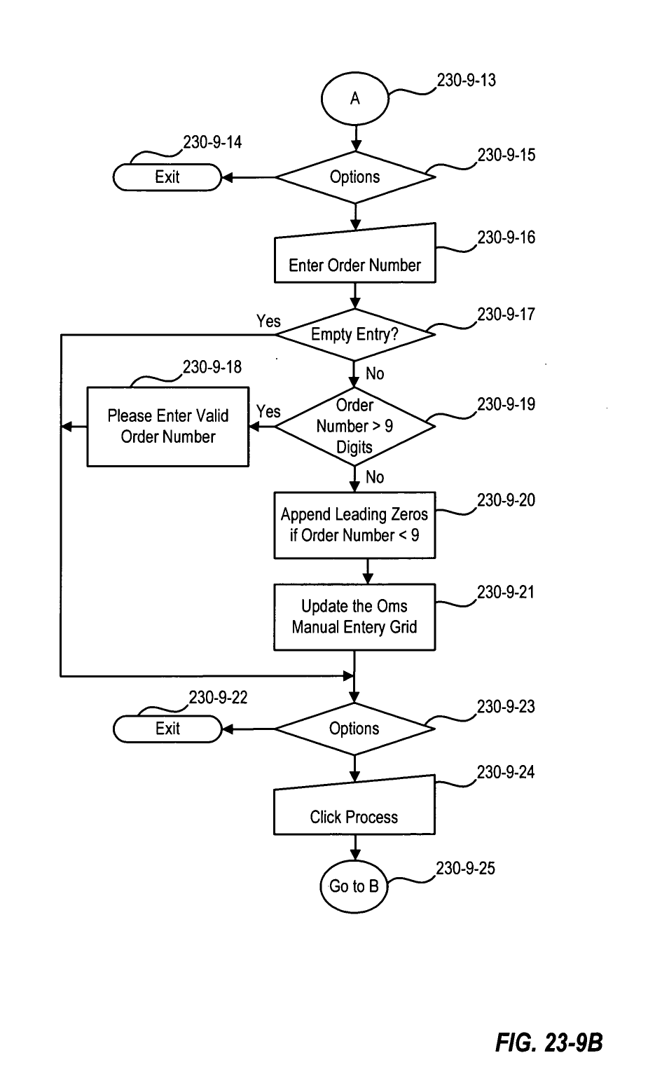

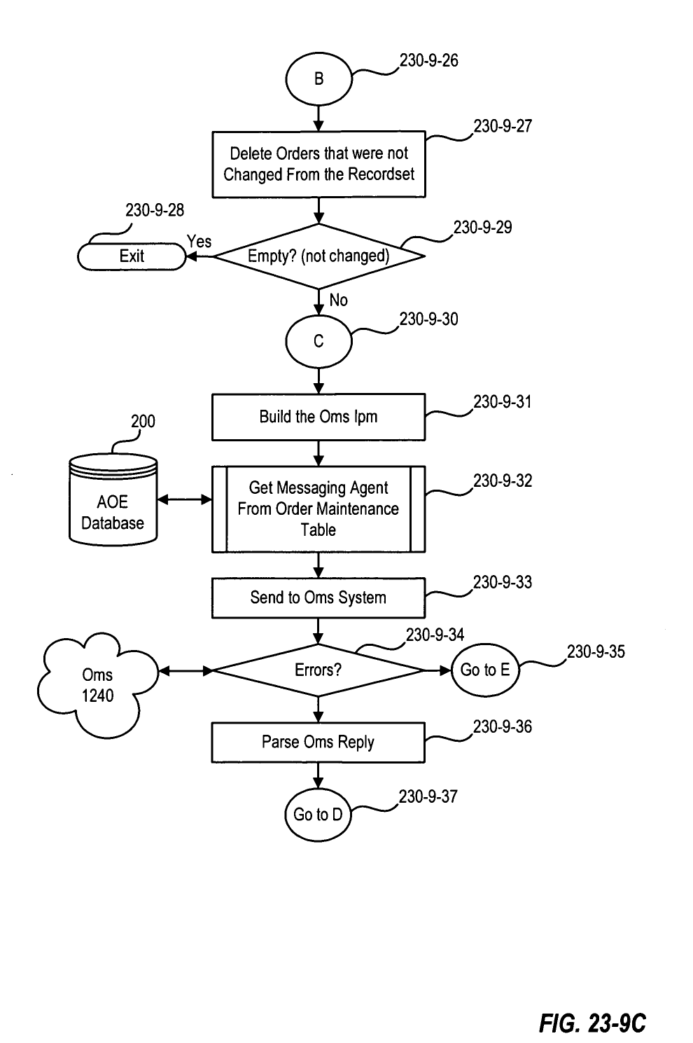

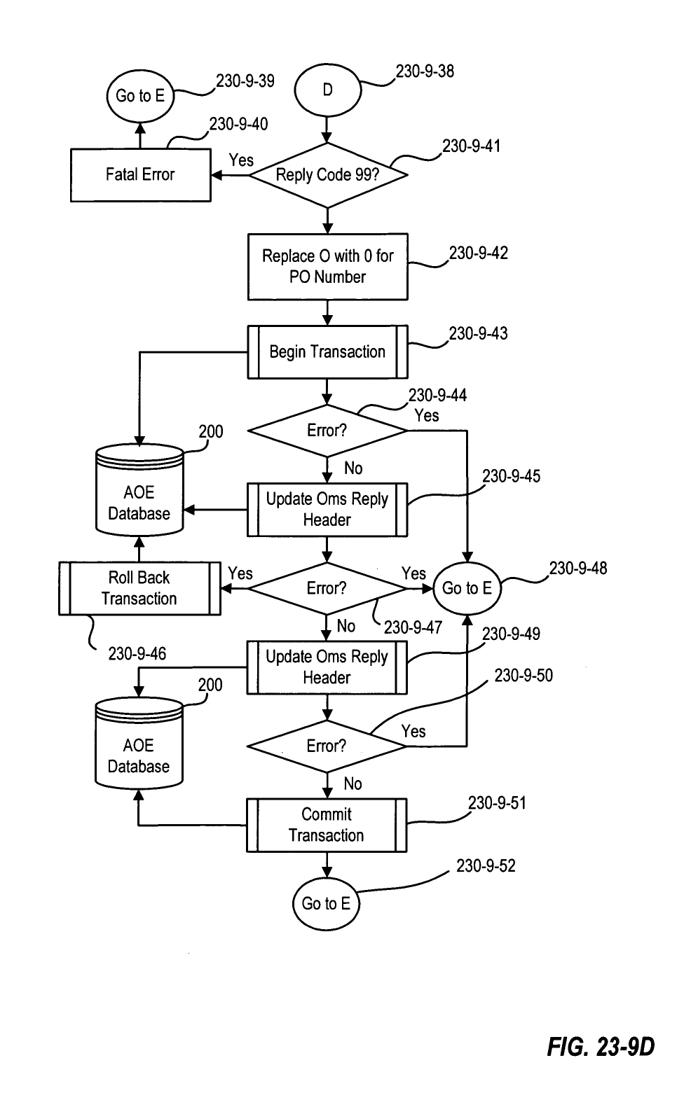

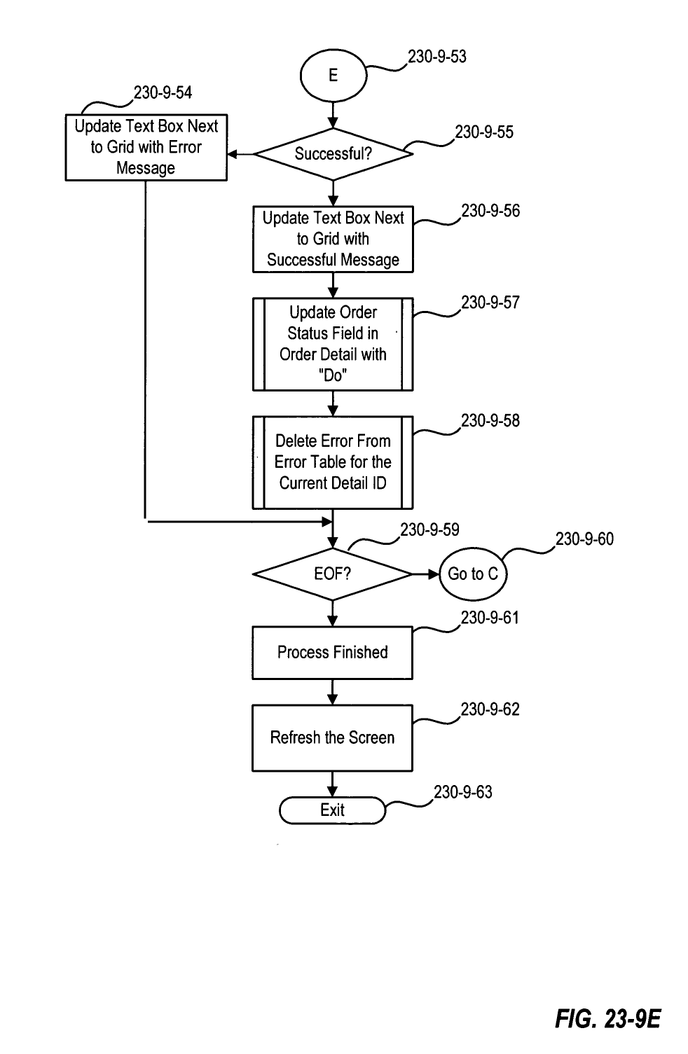

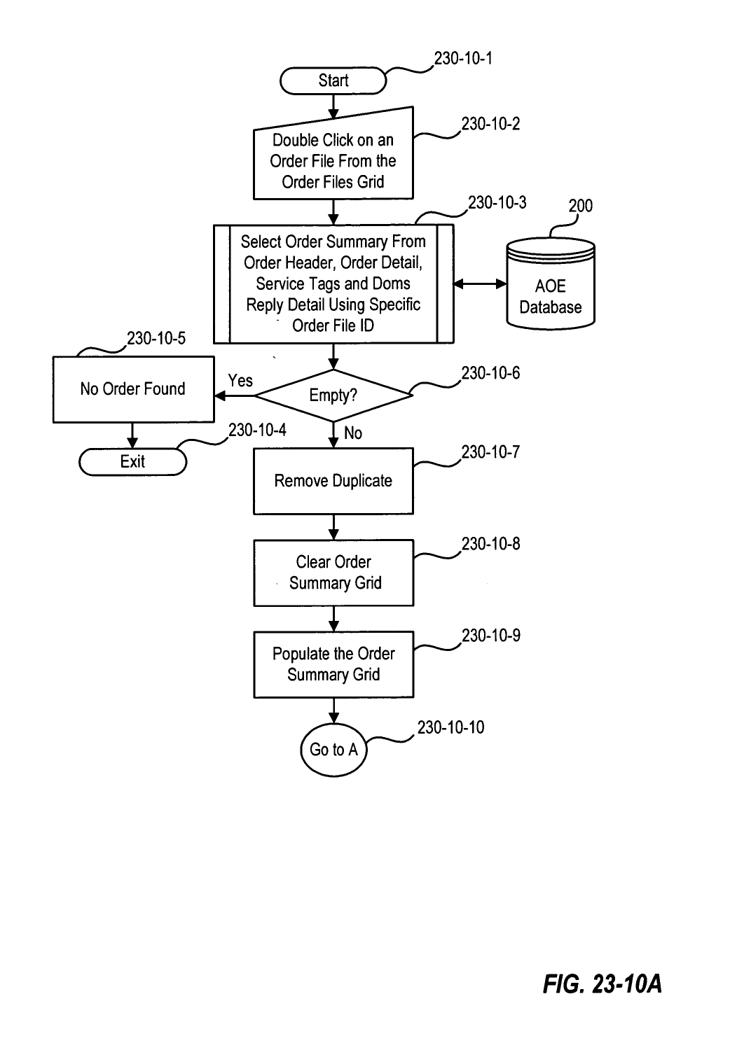

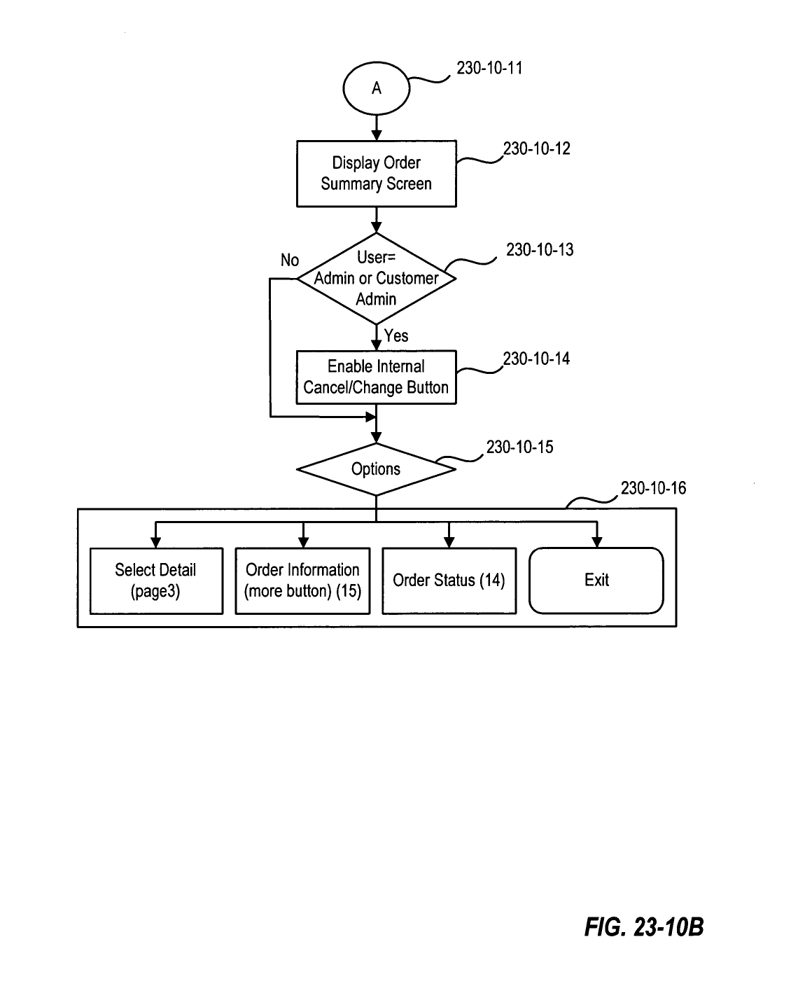

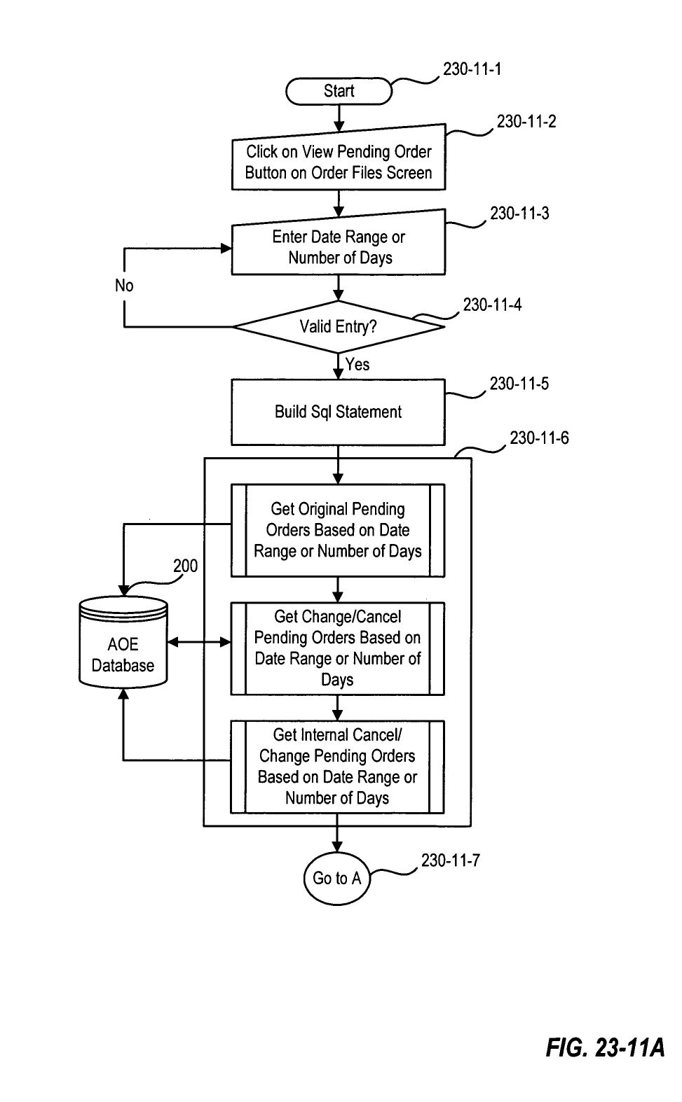

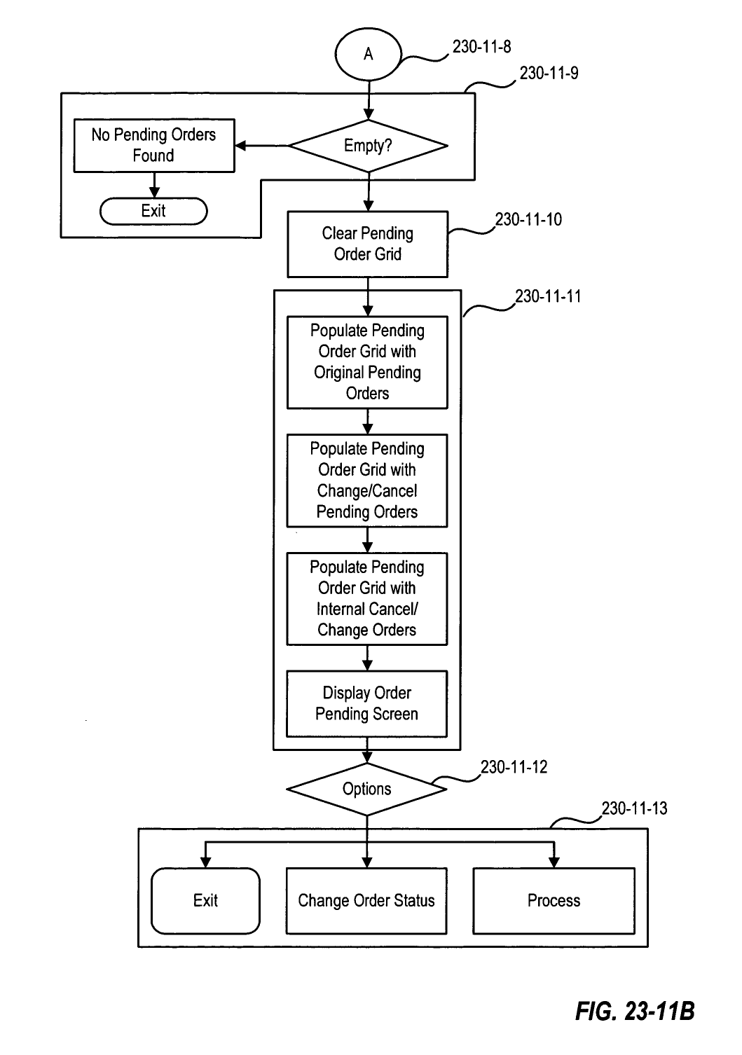

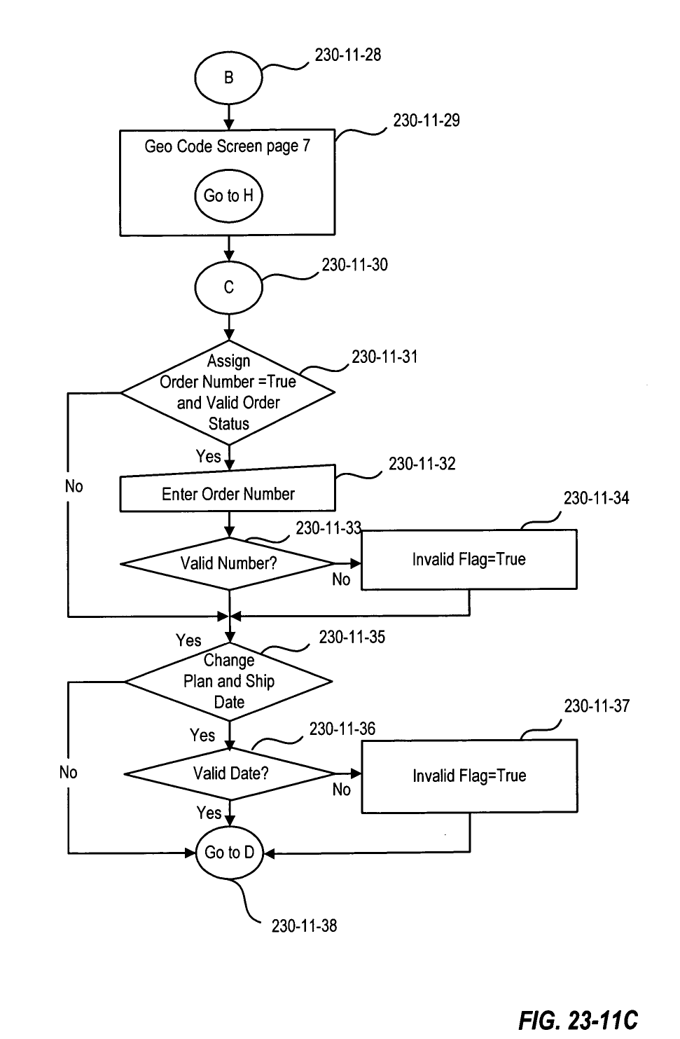

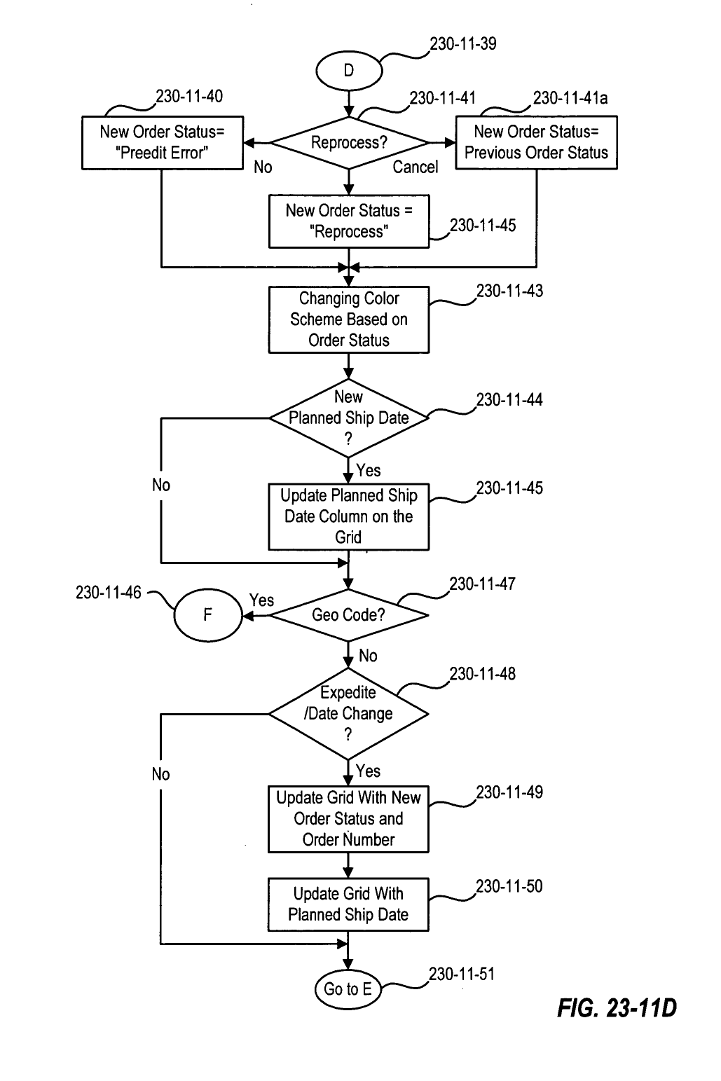

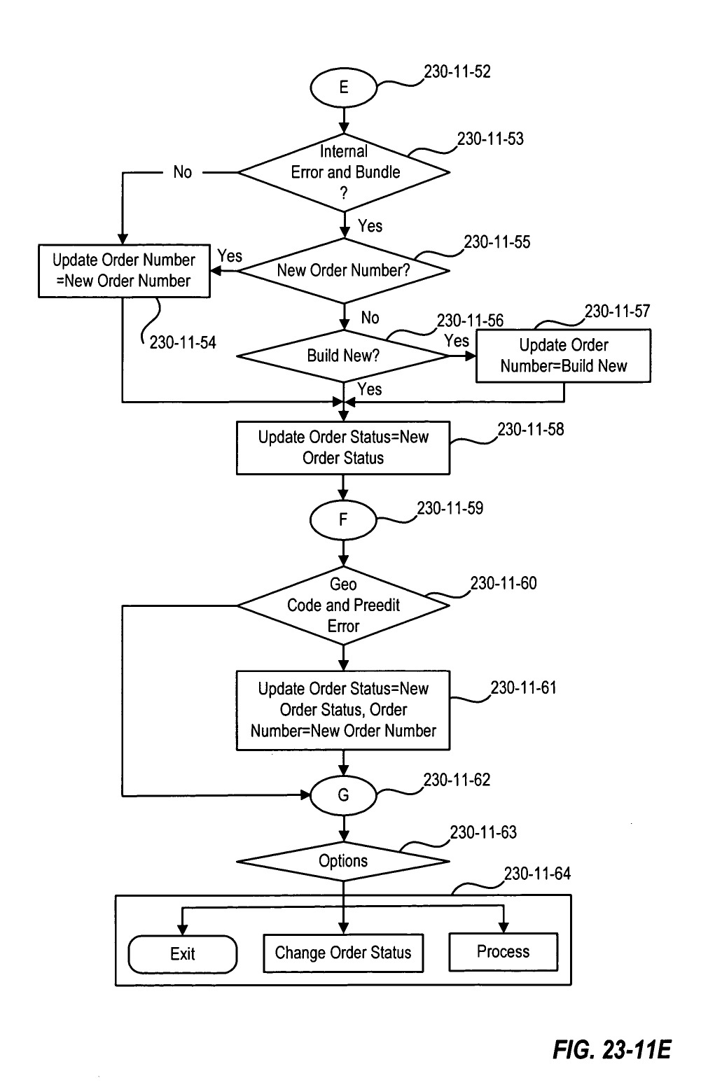

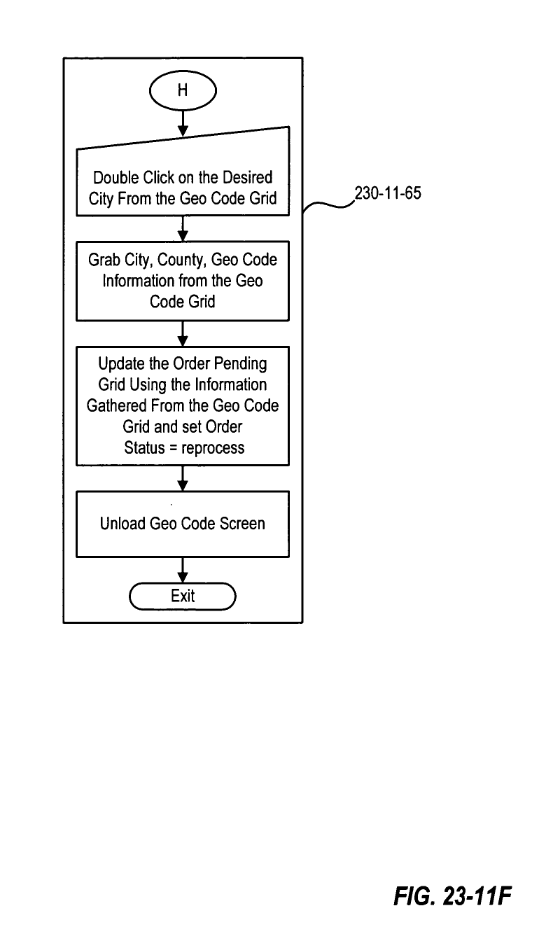

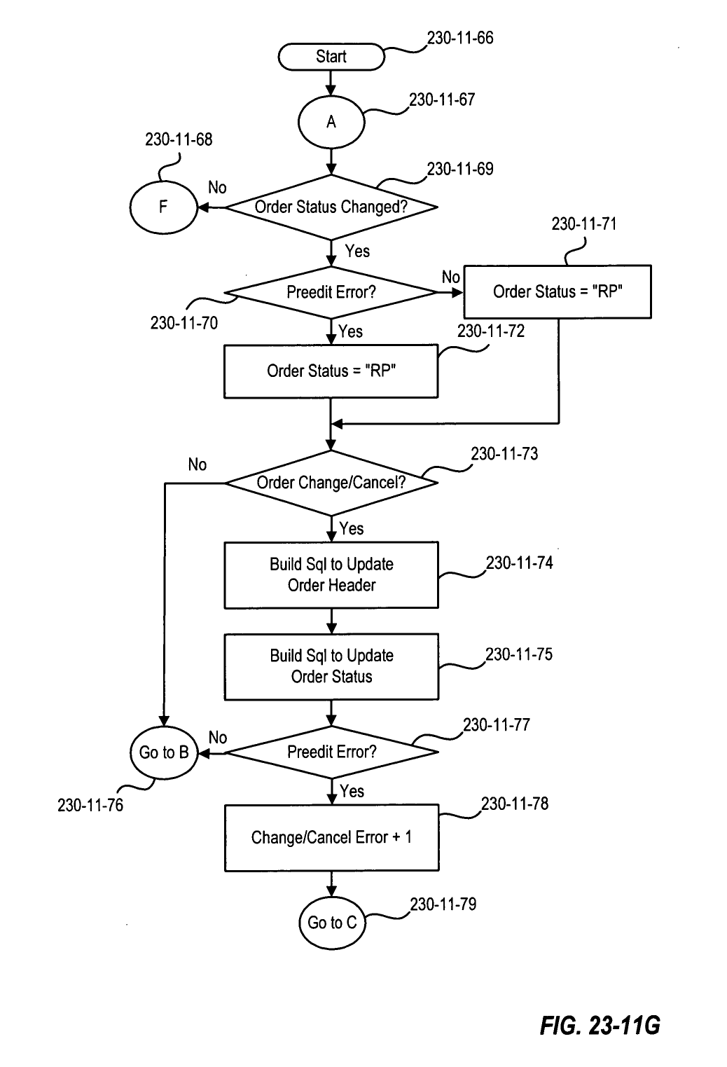

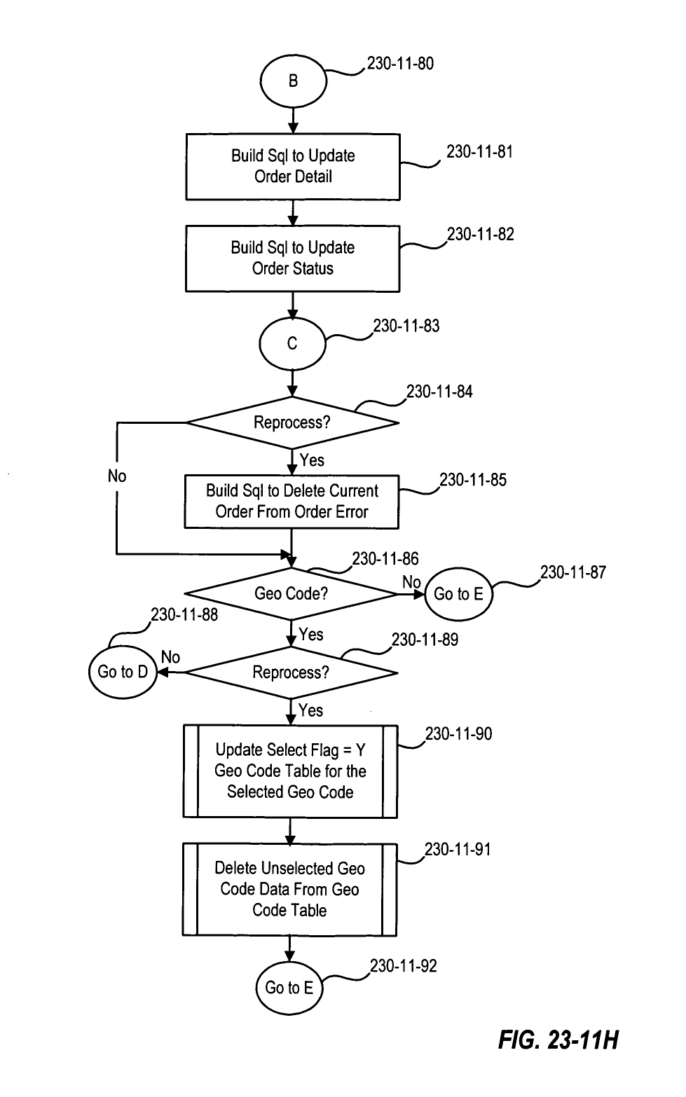

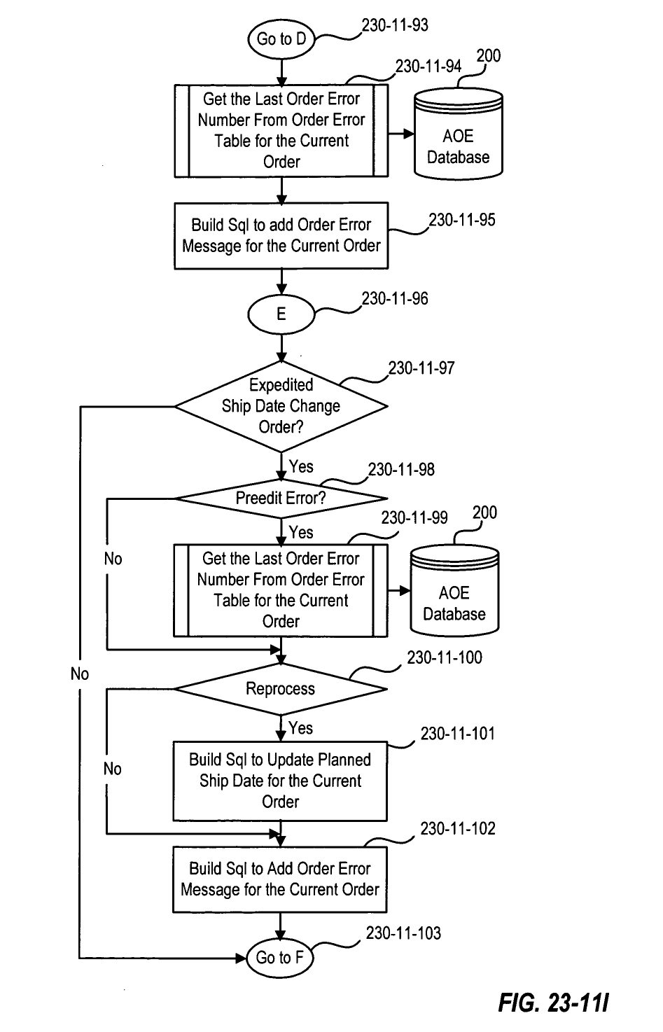

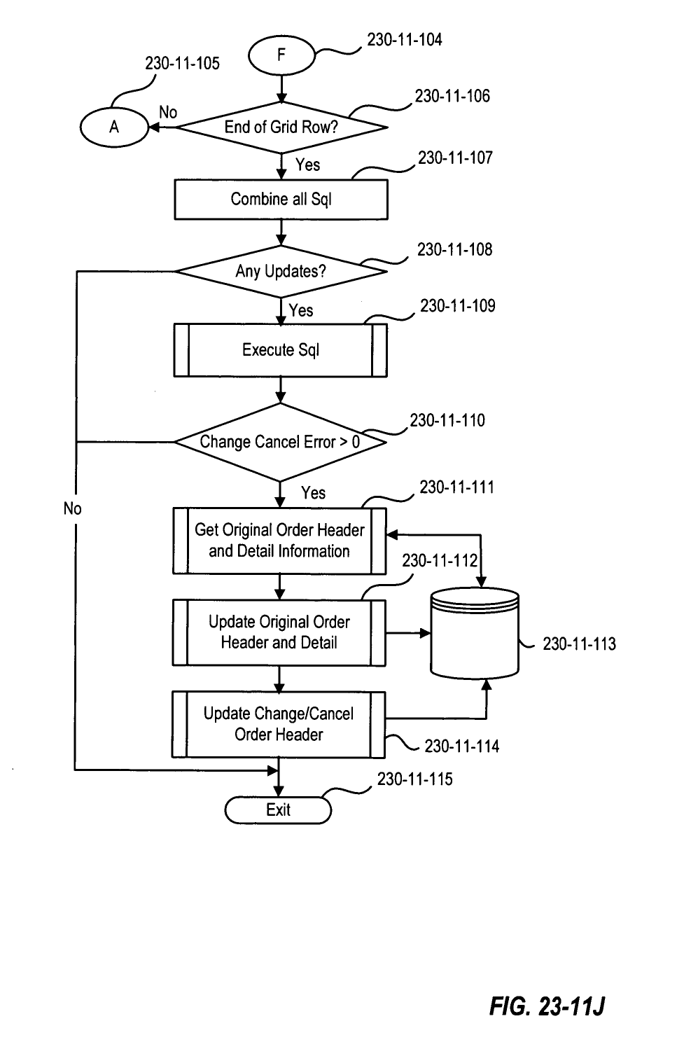

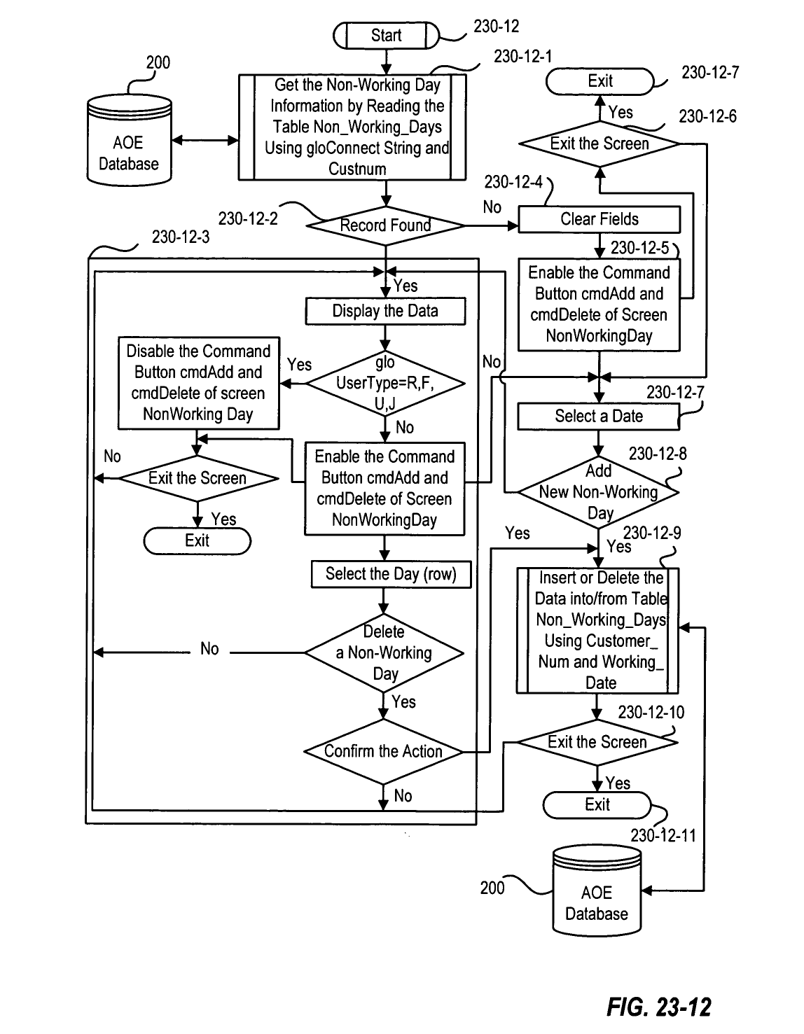

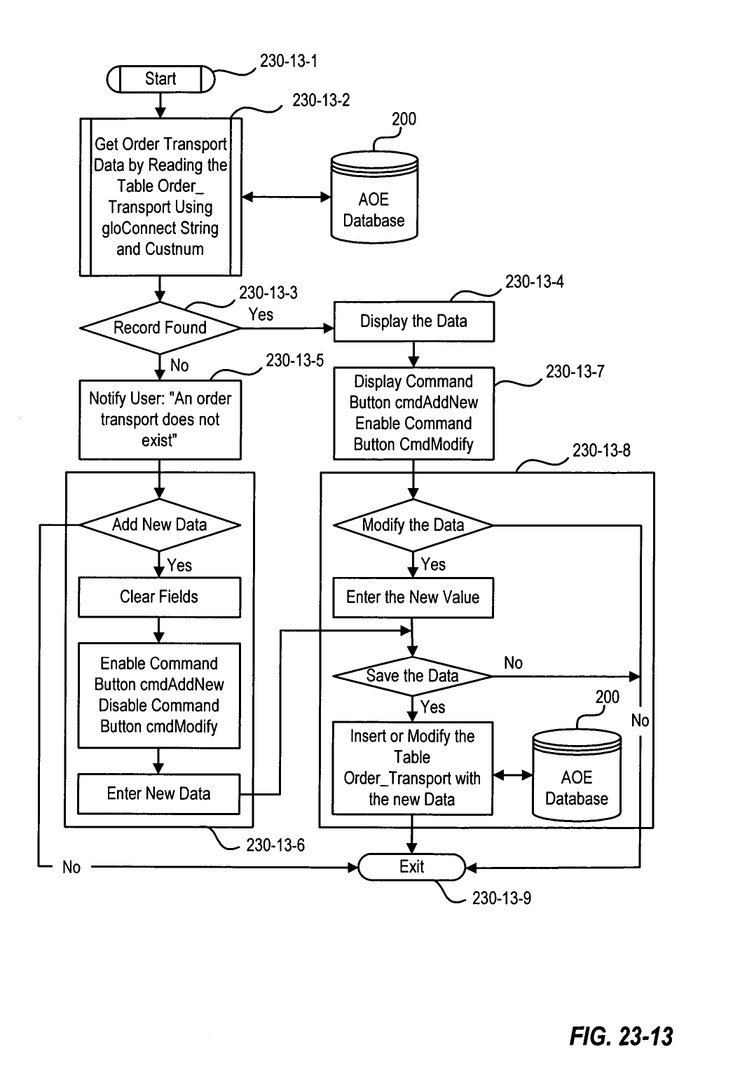

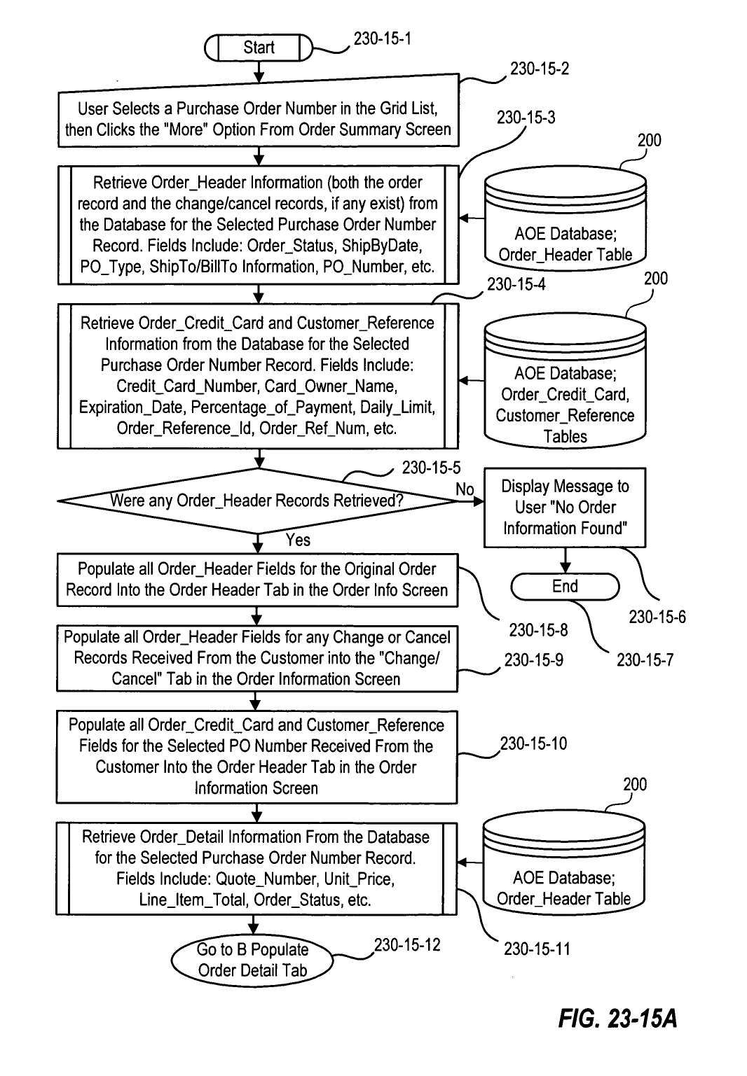

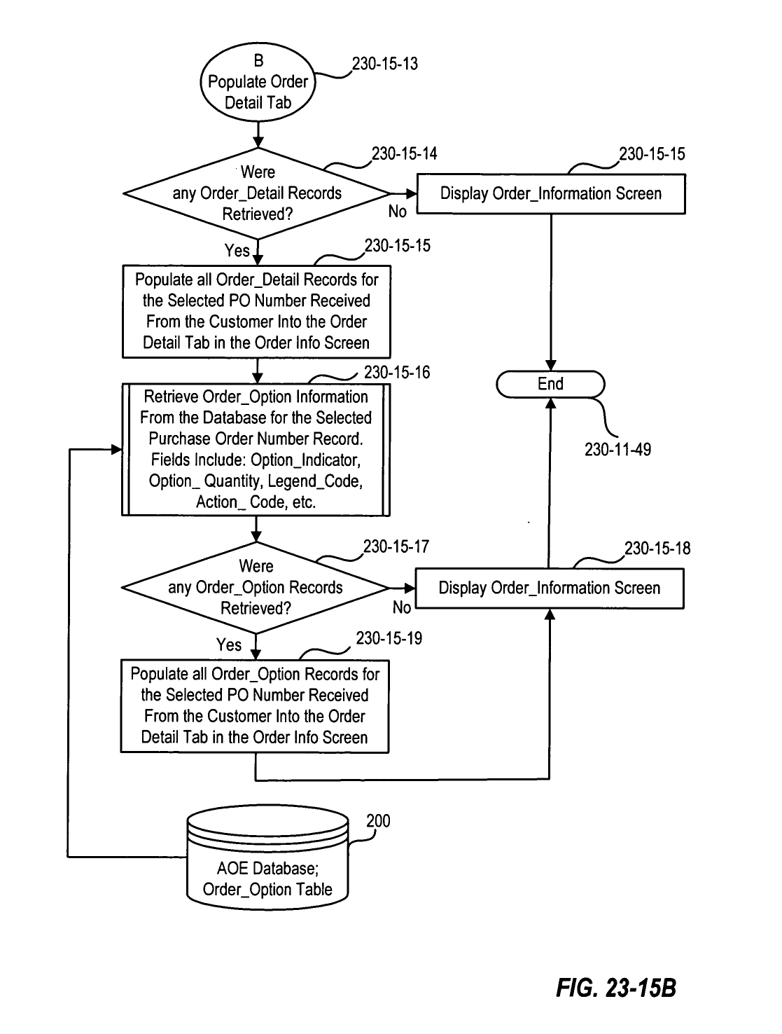

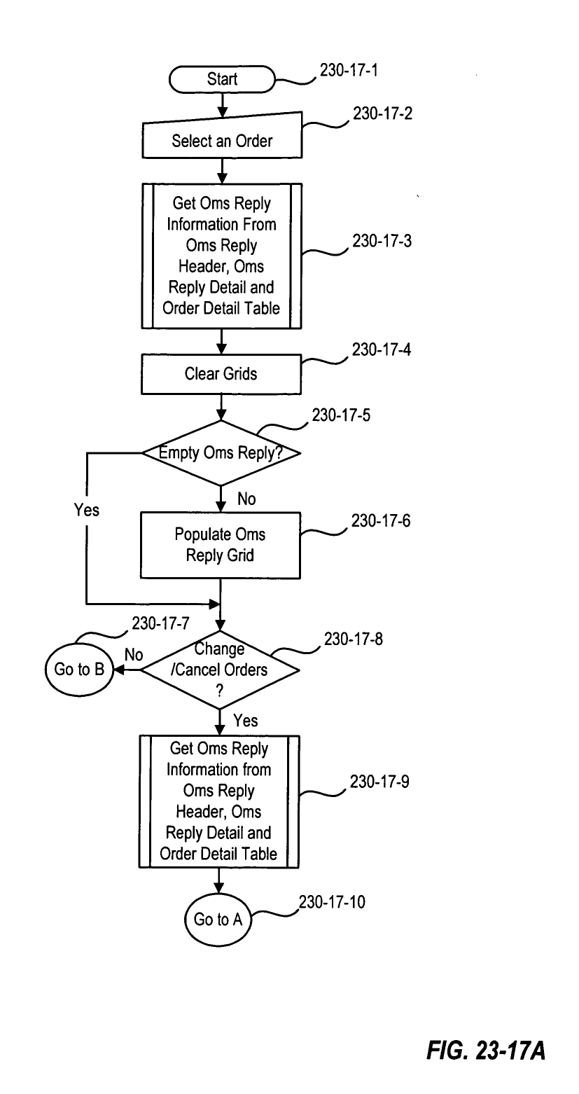

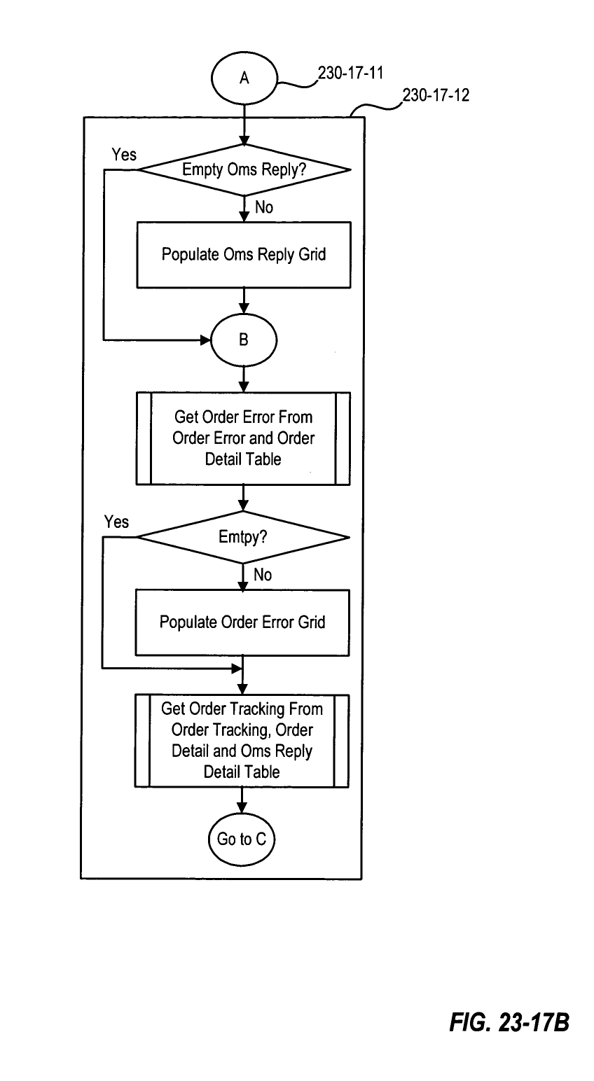

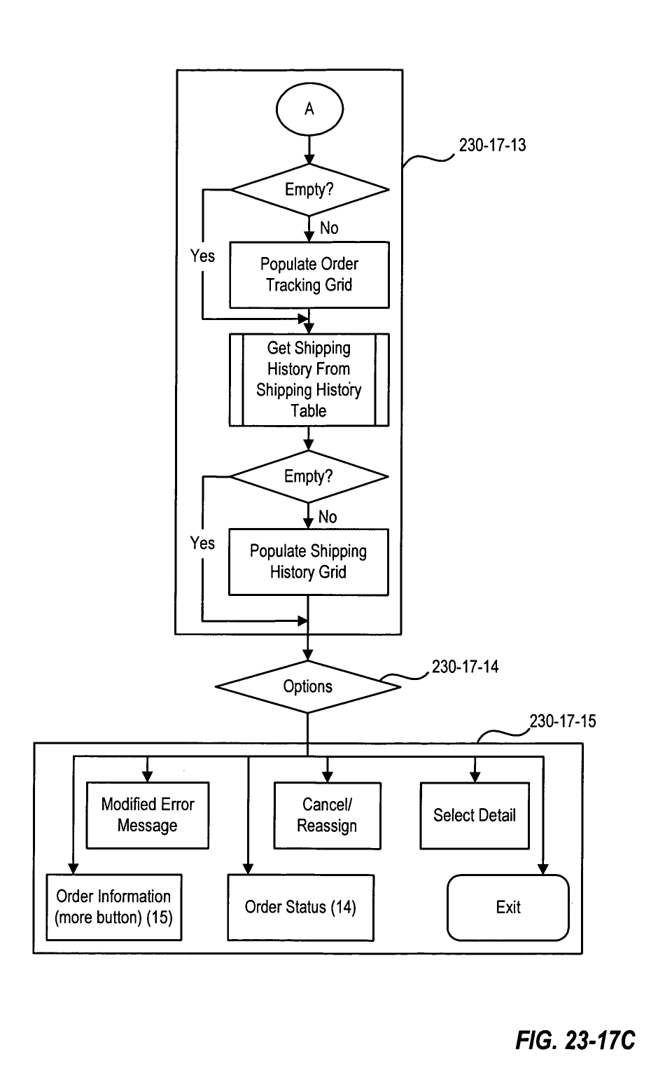

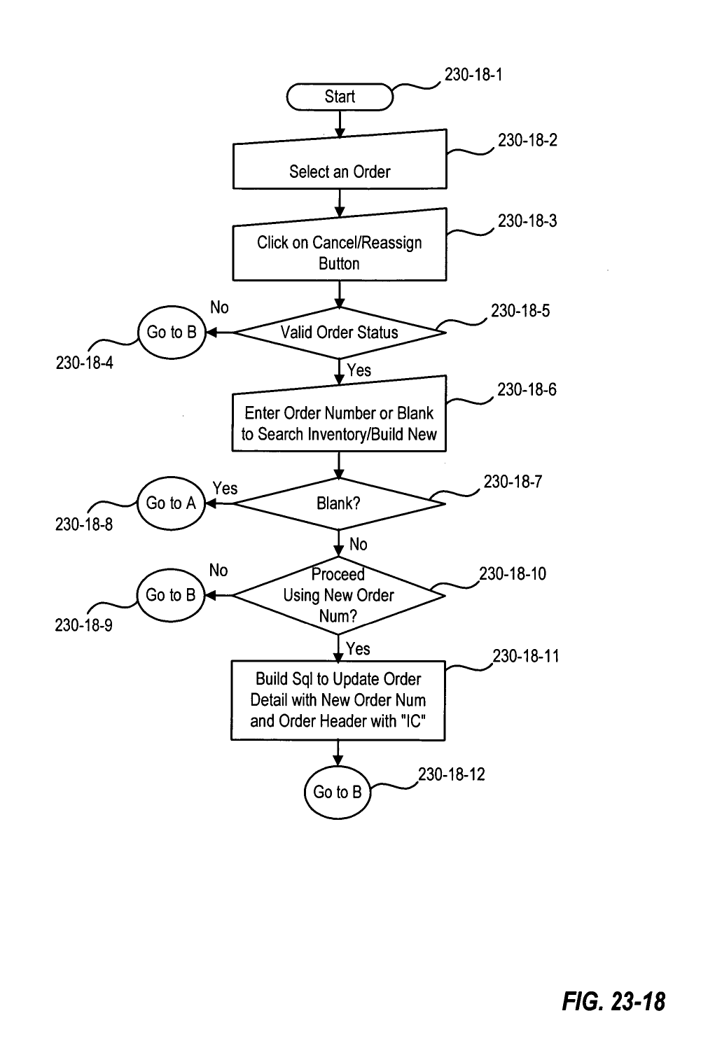

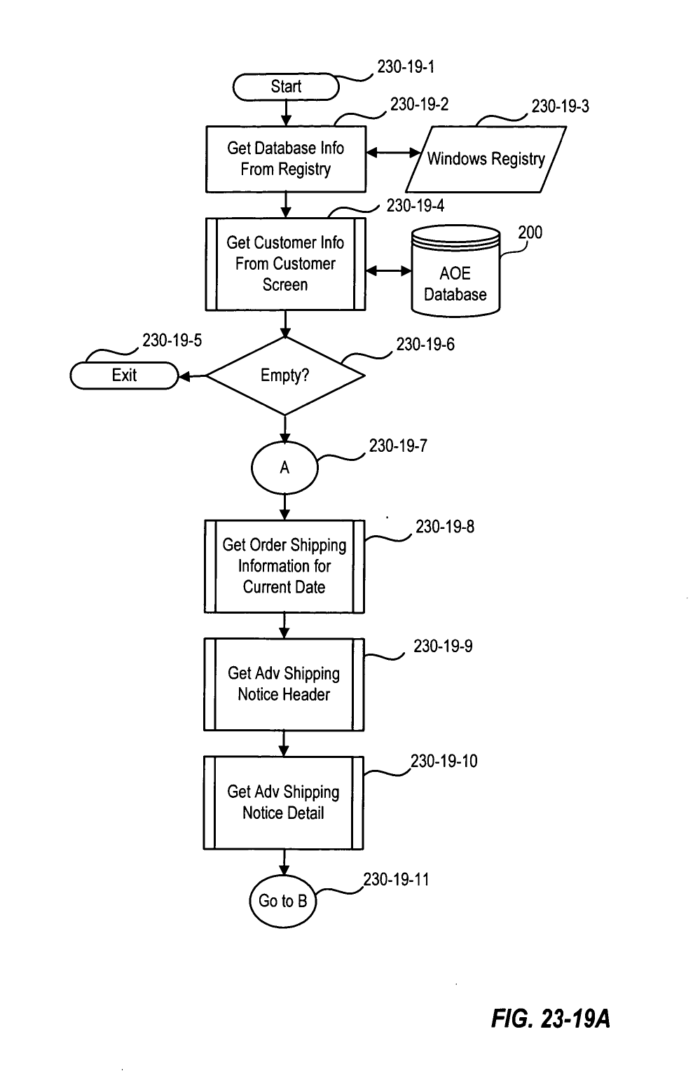

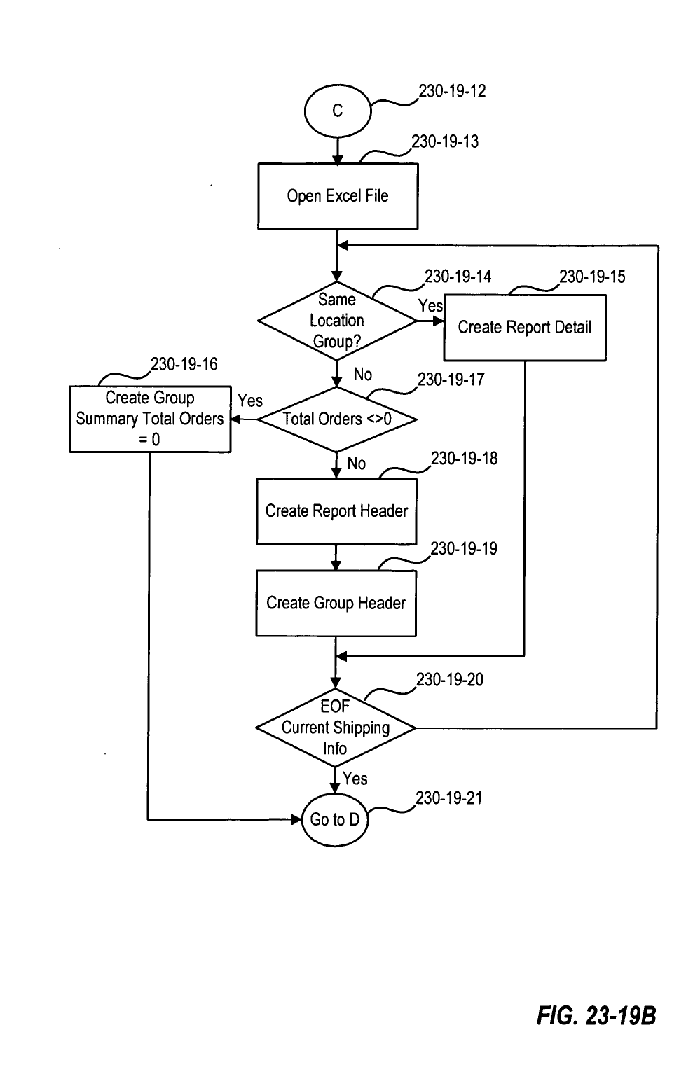

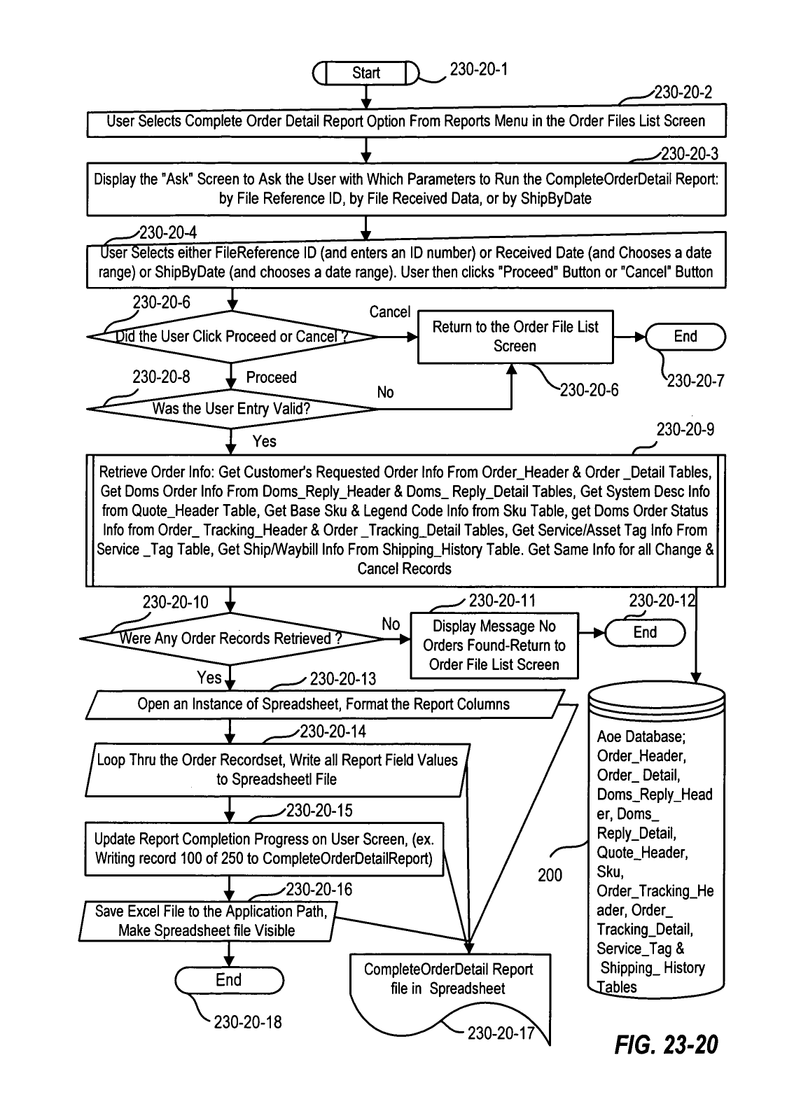

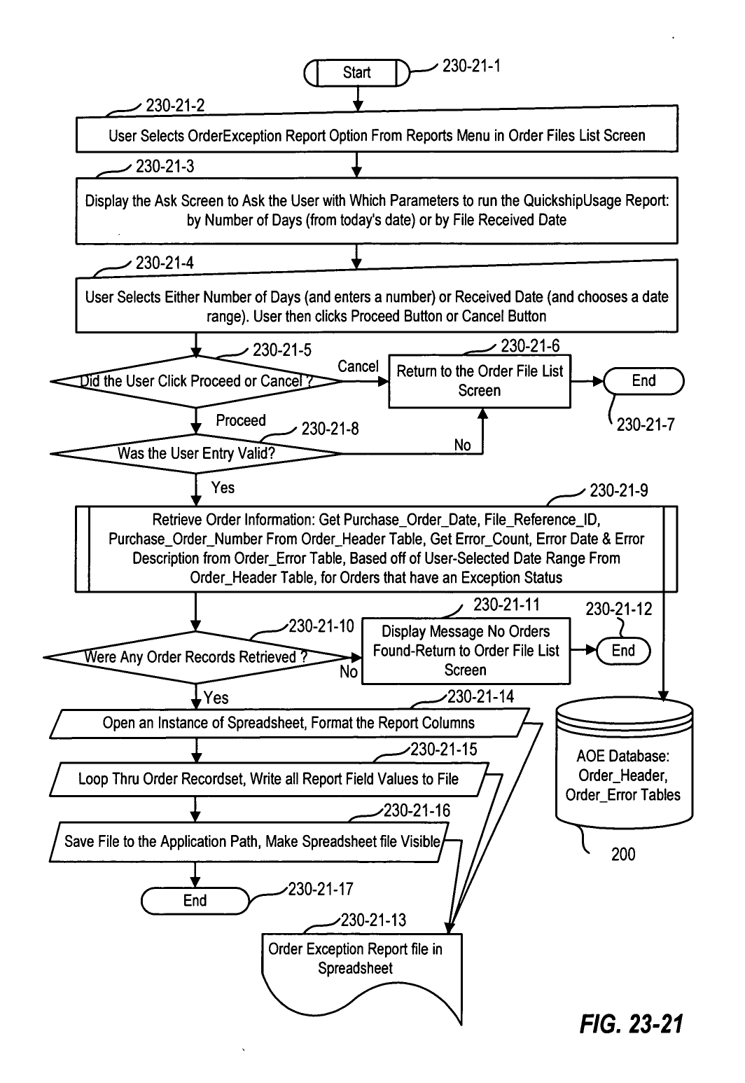

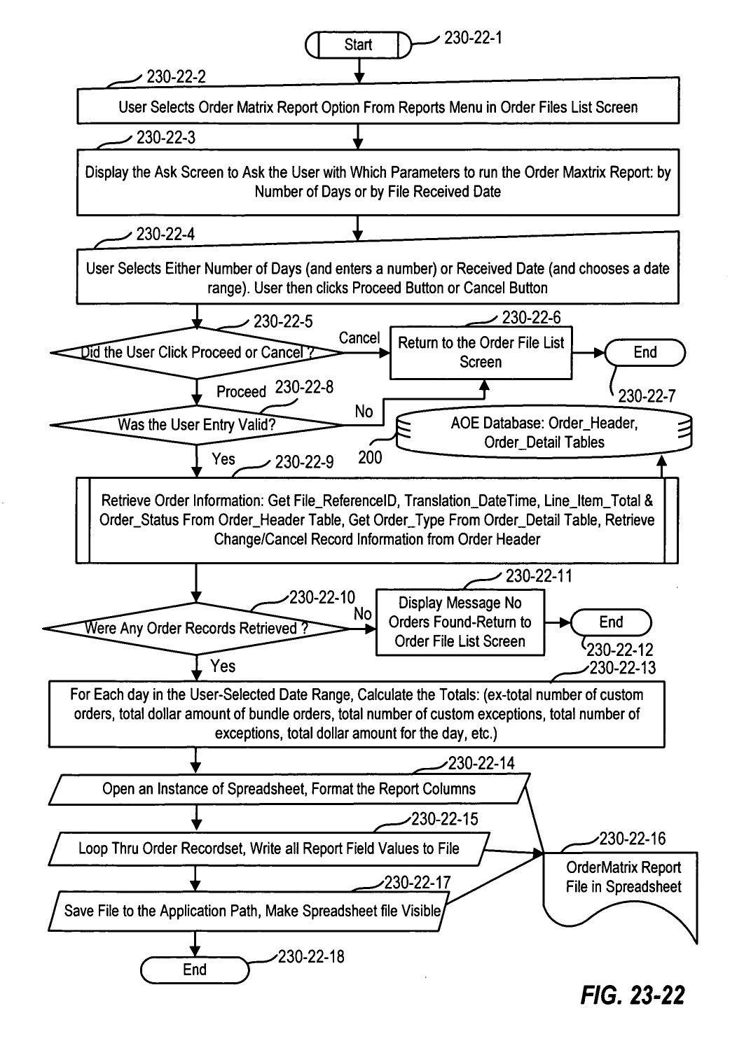

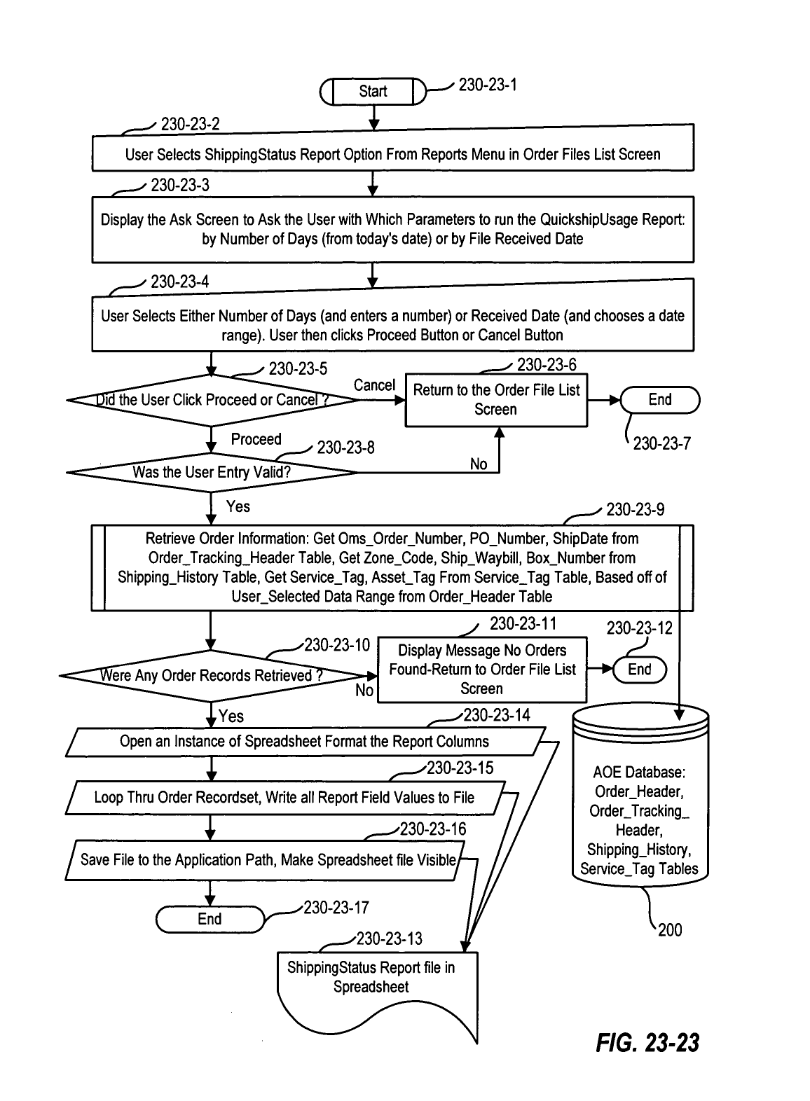

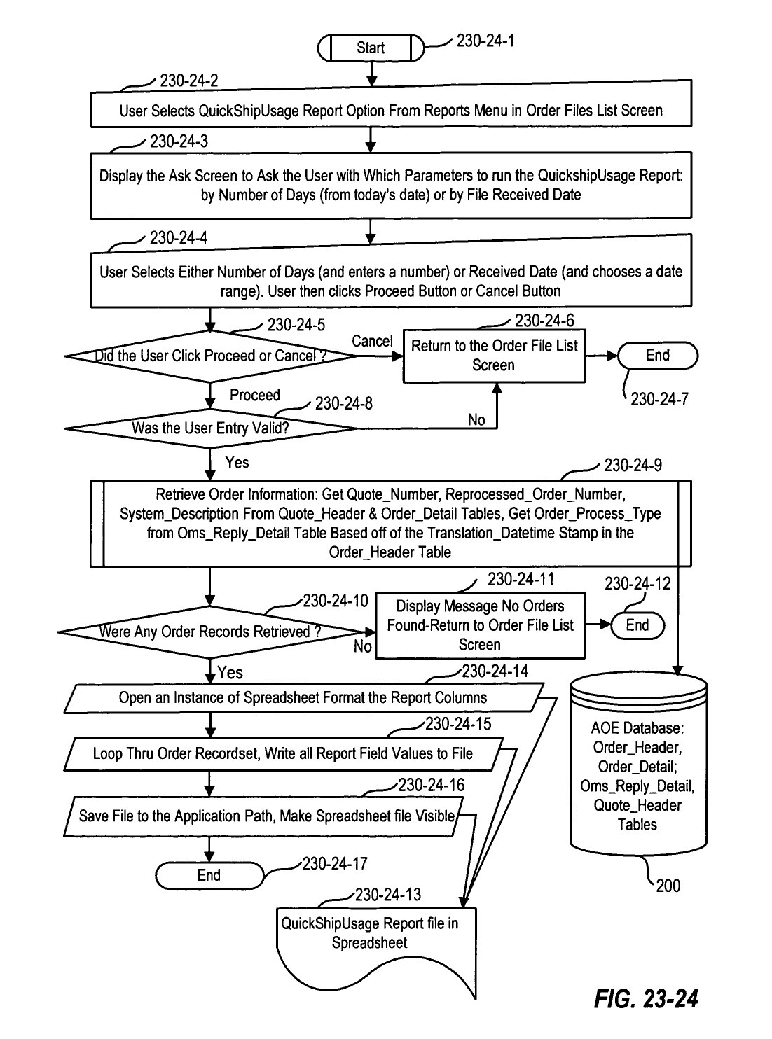

The order processor program 14A-15 communicates with OMS server 1240 and uses parameters from AoE GUI 402, the order maintenance module 230-7 shown in FIG. 23 and the data returned is stored in the AoE database 200. The information sent to OMS server 1240 includes a Quote number, identifying a configuration, and line item totals. These parameters include all the components of that configuration, and all SKUs and the price for each SKU. Further information includes any upgrade, downgrade, or additional components and their SKUs and SKU pricing to the base configuration. This information is necessary to generate an order in the OMS system. OMS server 1240 receives the request and processes the request as denoted by the Order Processor 14A-15 as it communicates the action OMS server 1240 is to take with the request.

Once the order has been processed by OMS server 1240, one of the order parameters sent from the Order Processor 14A-15 will convey whether OMS server 1240 should perform an auto release of the order in the OMS system. An auto release is work flow set in the OMS system that releases the order from a hold status. A hold status is the first status all orders are set to by default. After the release of the order, the OMS server 1240 transfers the order to a process status that begins the manufacturing process.

Another feature of OMS server 1240 is that it is used by a batch program, called Order Chg/Cancel Processor 14A-19. If a cancel request is issued from the Order Chg/Cancel Processor 14A-19, then OMS server 1240 will attempt to cancel the order as requested in the OMS system.

If the OMS system allows the order cancel, then a successful cancel status will be sent back to the Order Chg/Cancel Processor 14A-19. If the OMS system did not allow for the order cancel to happen, then a unsuccessful cancel status will be sent to the Order Chg/Cancel Processor. If a change request is issued from the Order Chg/Cancel Processor then Doms 1240 will attempt to update the order as requested. If OMS system allows the order update, then a successful change status will be sent back to the Order Chg/Cancel Processor 14A-19. If the OMS system did not allow for the order update to happen, then an unsuccessful change status will be sent to the Order Chg/Cancel Processor 14A-19. In all cases, the return status and additional data will be stored in the AoE database 200.

Another feature of this program includes the use by the Manual OMS Entry module 230-9 shown in FIG. 23. The functionality of manual OMS entry module is used when needed to pull Order information manually out of the OMS system, into the AoE database 200. The type of information received includes order number, line item pricing, shipping pricing, sales tax pricing, the order total, the purchase order number, and the ship-to information. There is a edit check to ensure that the manual order extract being requested by a computer user has been typed in correctly, such that it checks to ensure that the purchase order number, the OMS customer number, and the OMS order number matches. According to one embodiment, the order data from the OMS system is checked in module Manual OMS Entry 230-9 to ensure that the data matches the correct customer purchase order number in AoE database 200. The functionality of module 230-9 is most commonly used when implementing the AoE system, to perform a staggered implementation of the automatic order entry, wherein a manufacturer receives the order file 338 but does not want to automatically process it.

Order Process Translation

According to one embodiment of the invention, the order process includes a translation process similar to the process discussed above with reference to FIG. 6, includes placing data onto a disparate platform as part of the manufacturing process. Particularly, in many business environments, the ability to store data in an environment that is robust yet not as easily accessible is desired to maintain important data. Thus, according to one embodiment, an order translation process includes placing data from a user-friendly environment into a disparate platform with particular rules for the data and loading the data into the disparate platform.

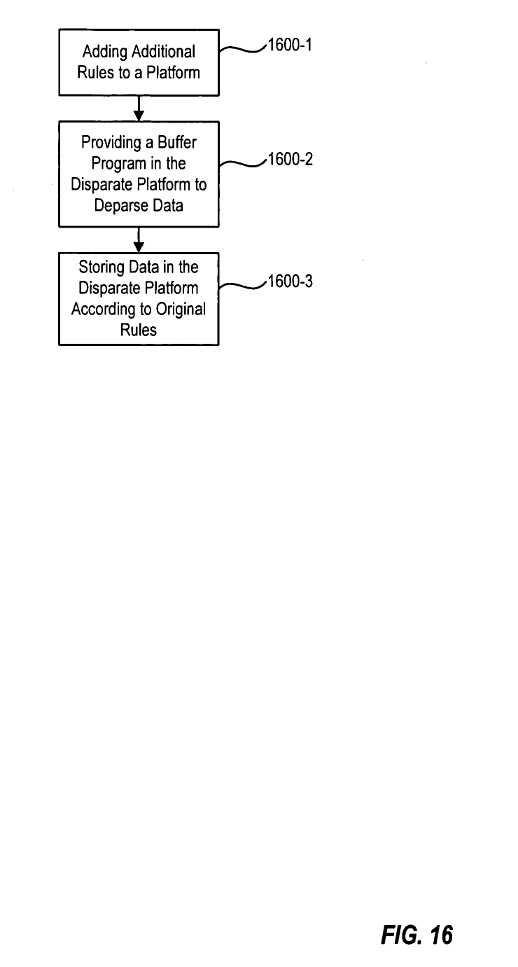

Referring to FIG. 16 a method for translating data between disparate platforms is provided. As shown, FIG. 16 includes blocks 1600-1 through 1600-3. In one embodiment, the data is in a legacy-type platform with rules associated with the data. The process begins with adding addition rules to a user-friendly platform to allow data from the platform to be placed into a disparate platform in block 1600-1. The process continues in block 1600-2 with integrating the data in the disparate platform by providing a buffer program to deparse the data received from the user-friendly platform. In block 1600-3, the disparate platform stores the data using the original rules of the platform.

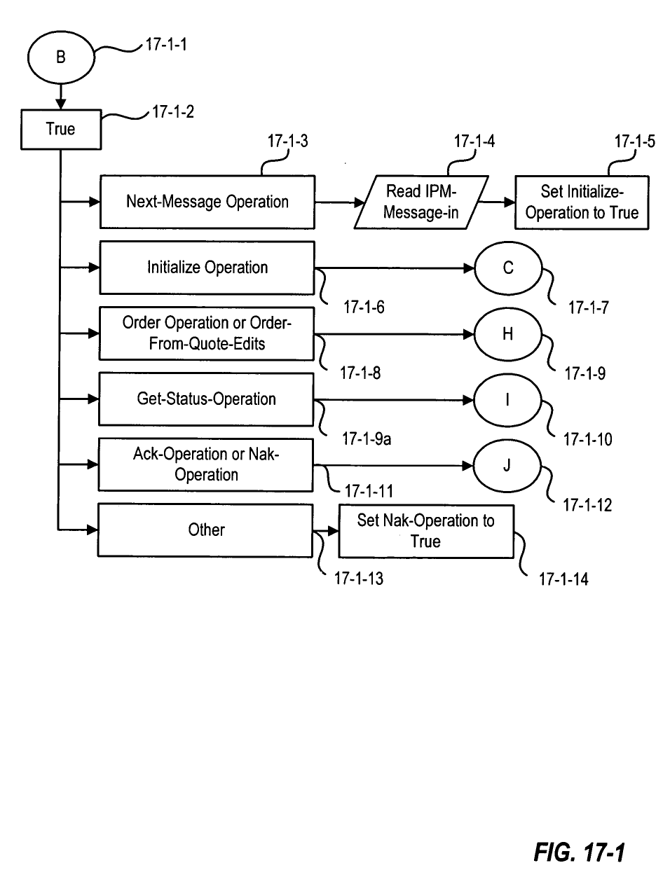

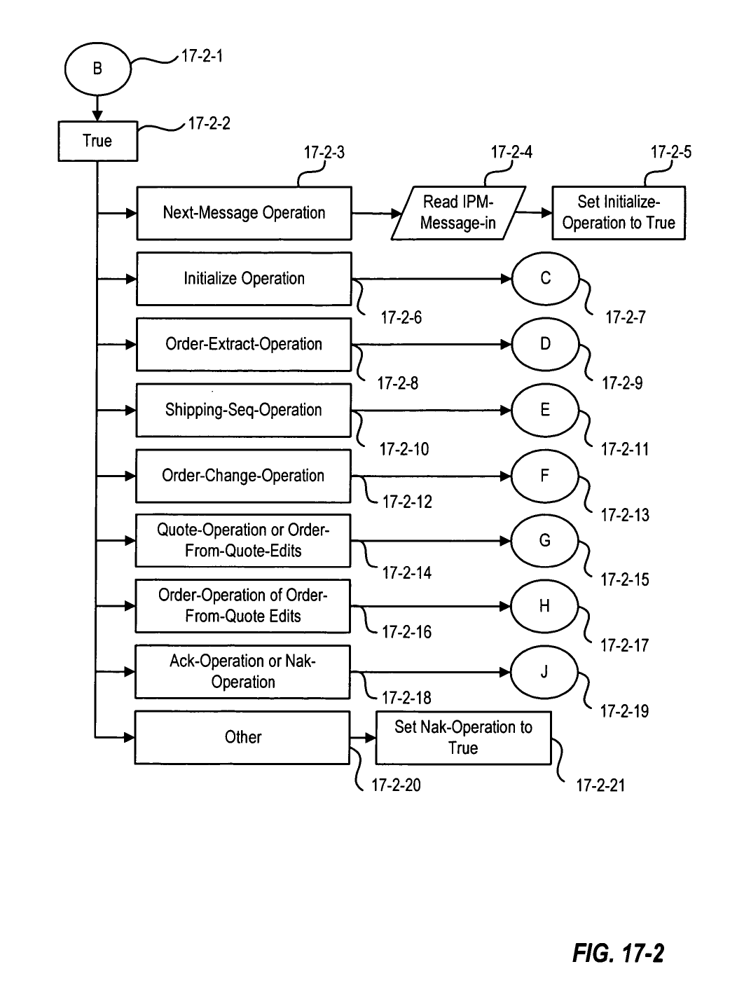

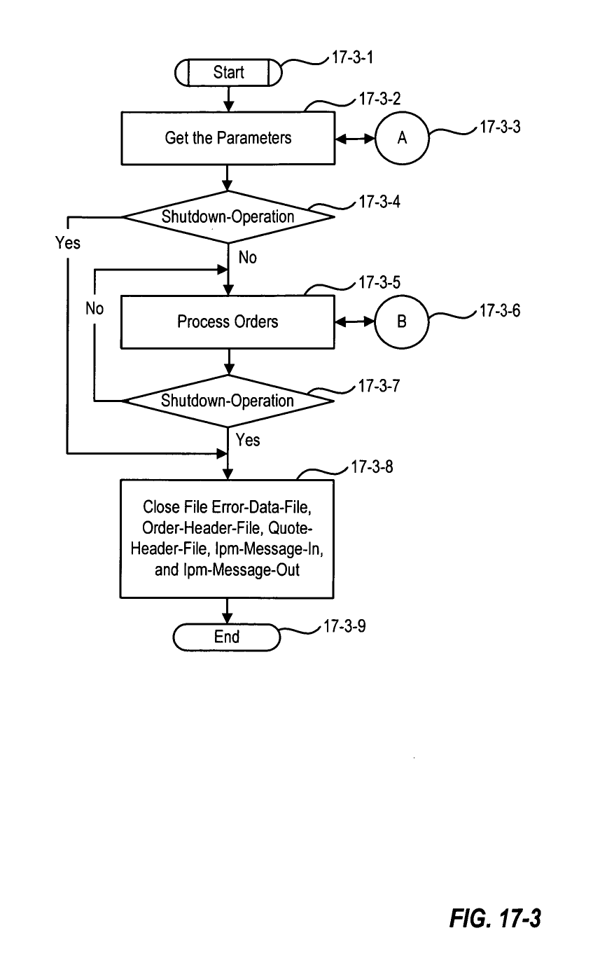

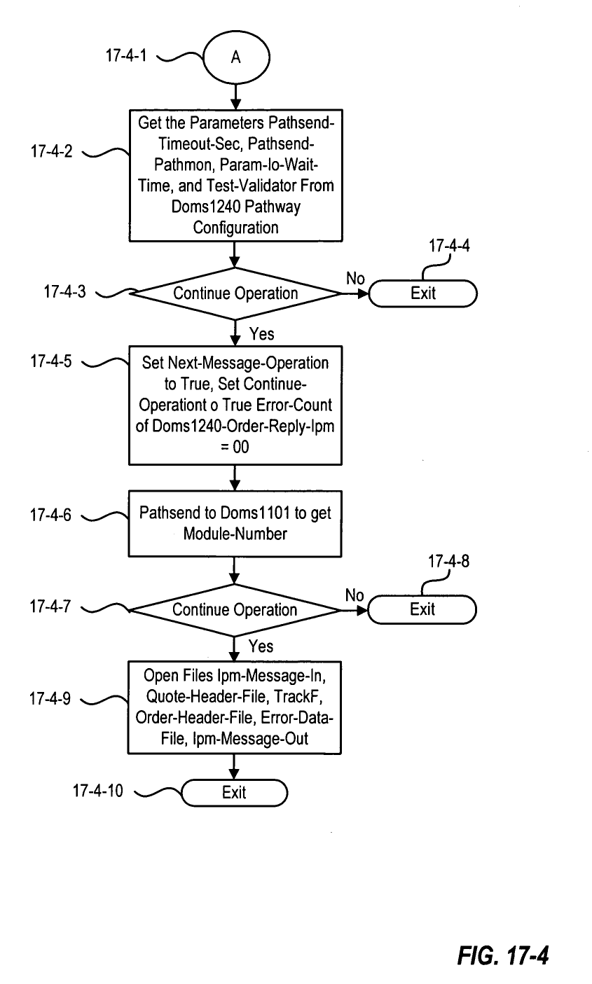

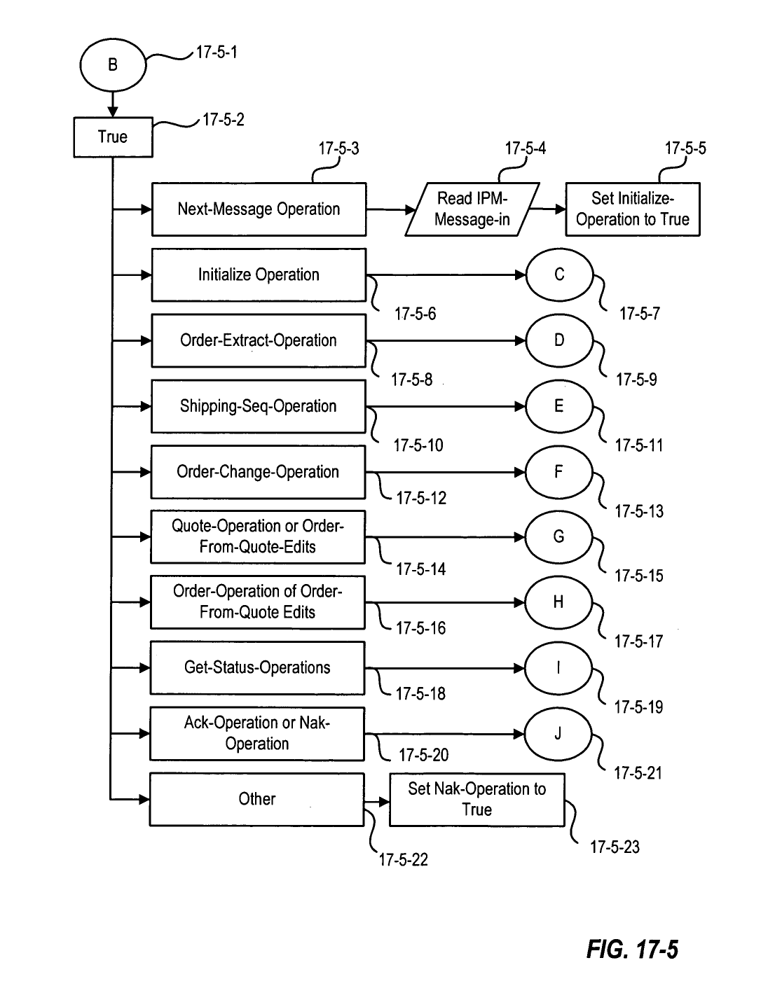

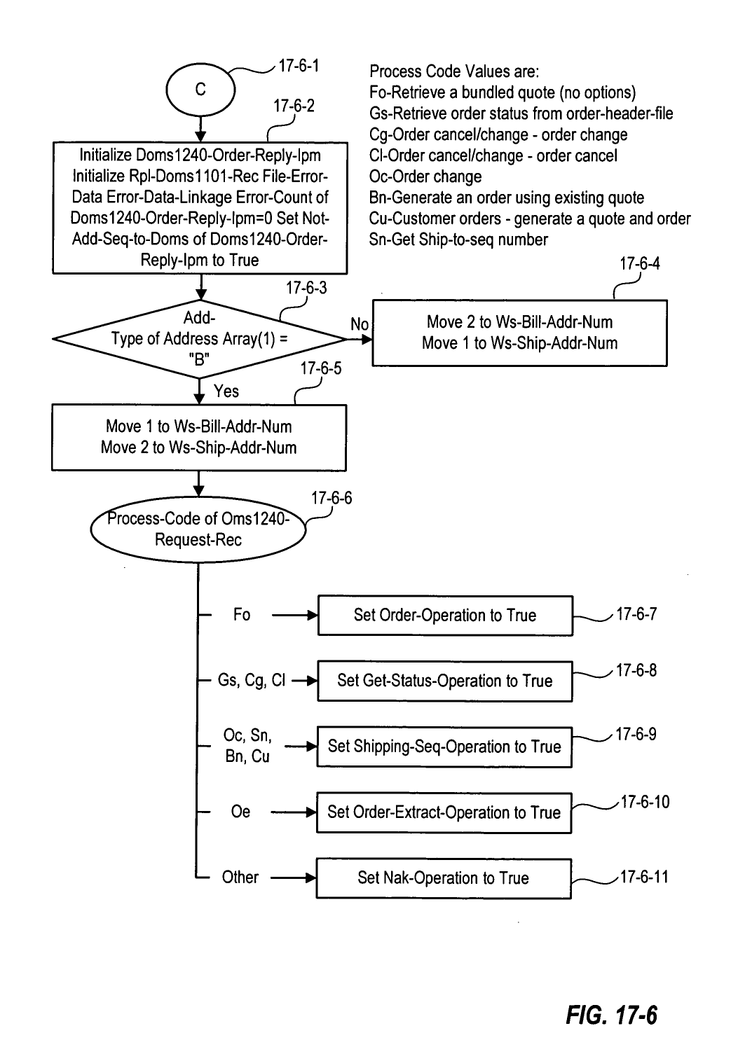

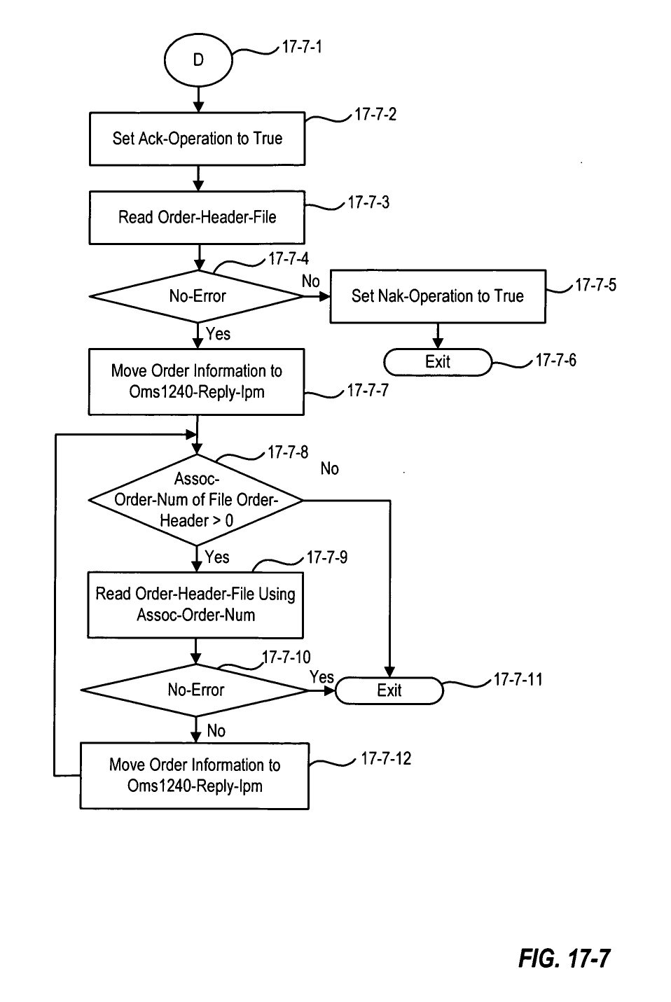

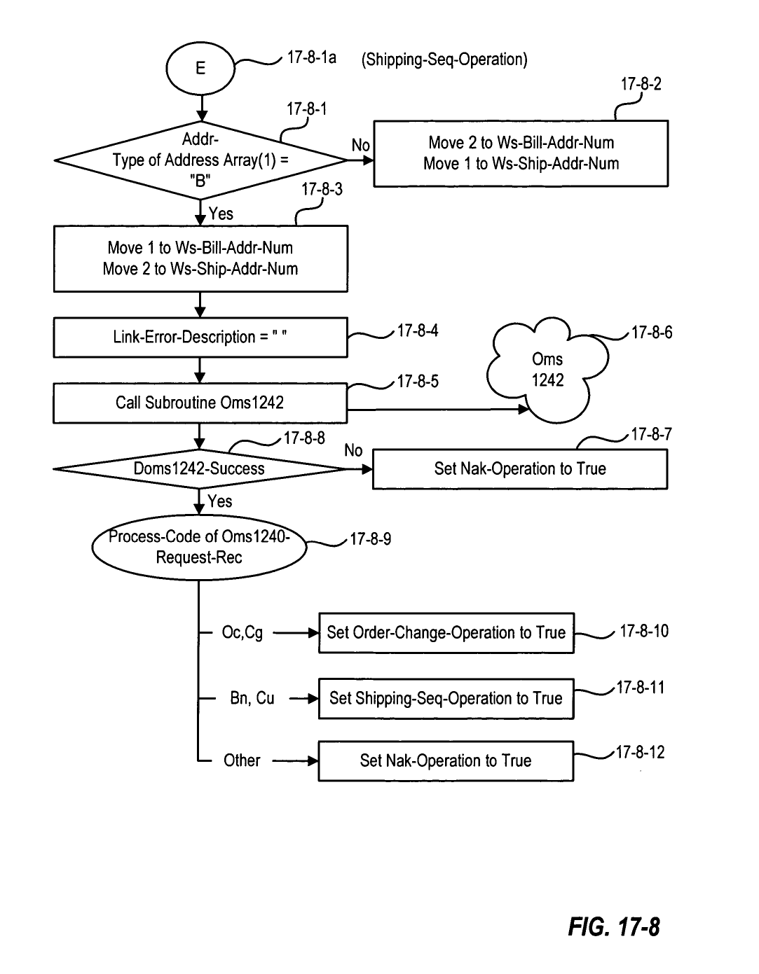

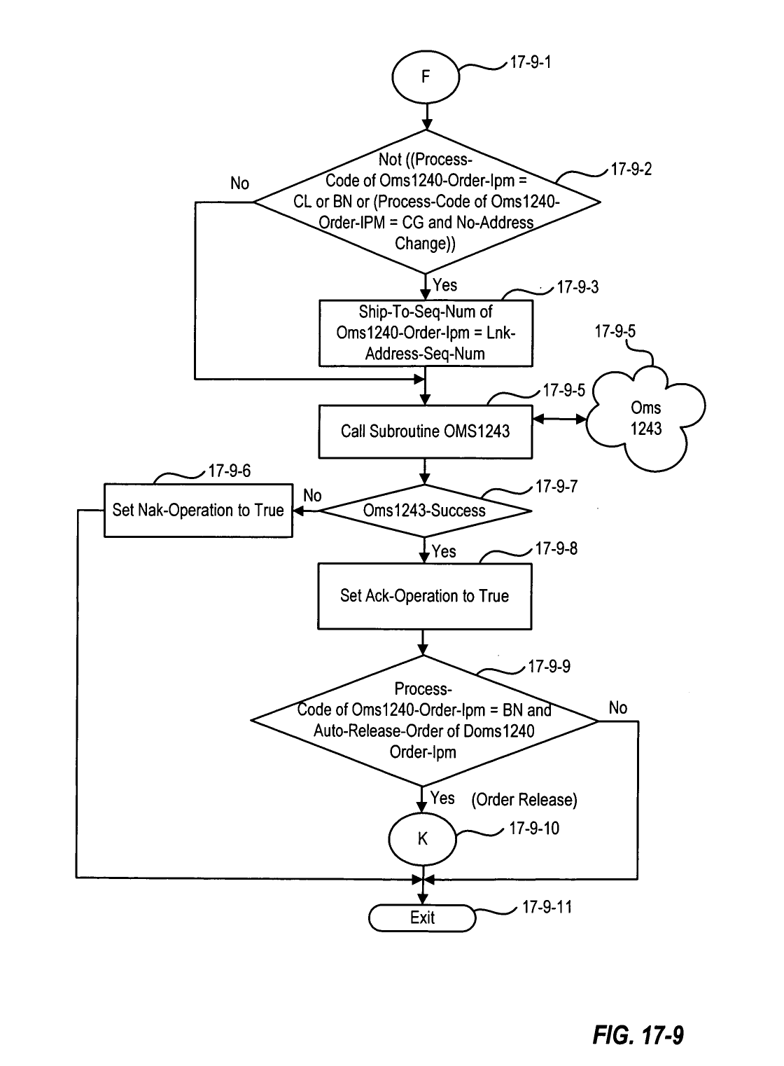

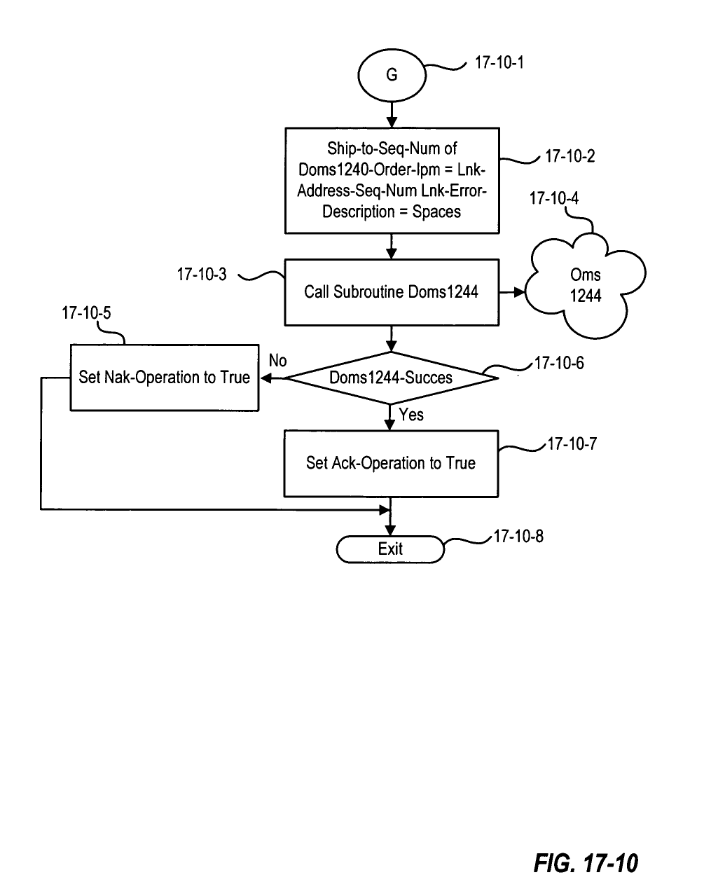

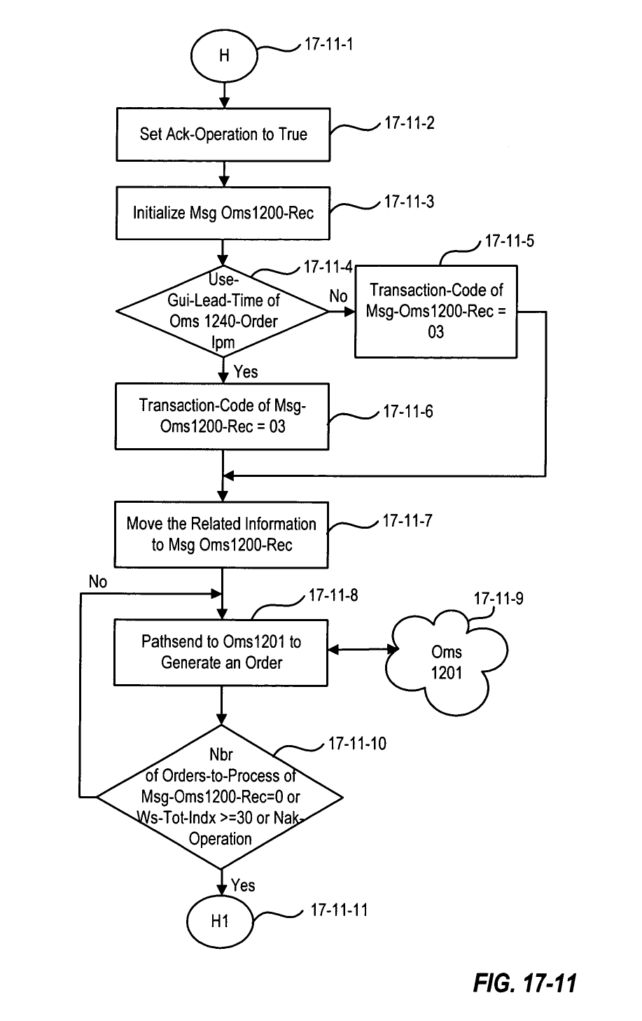

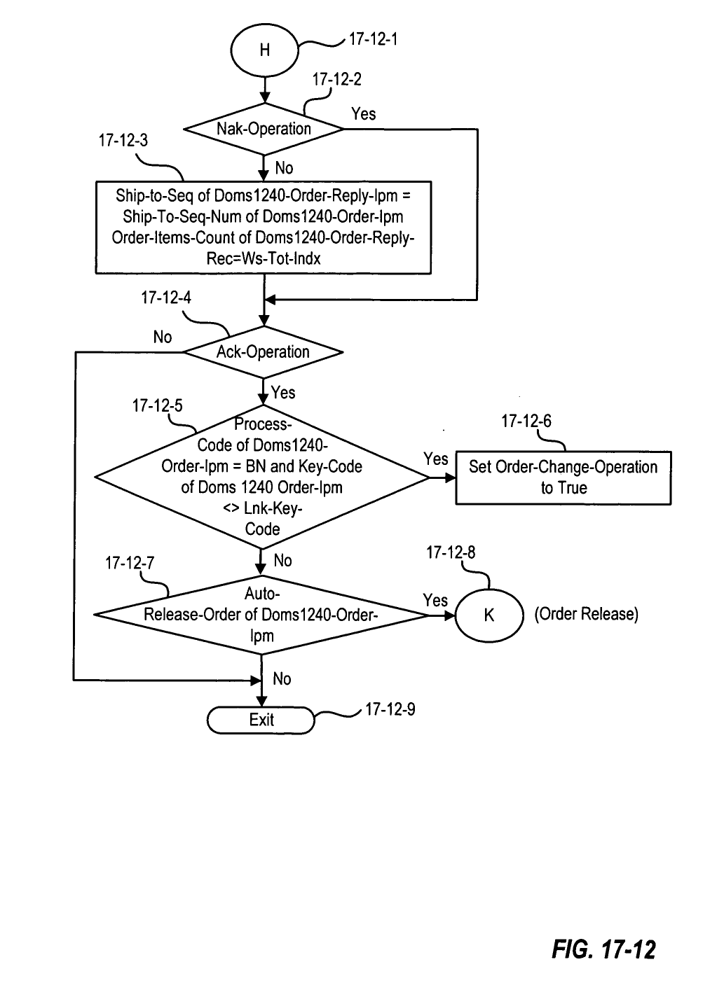

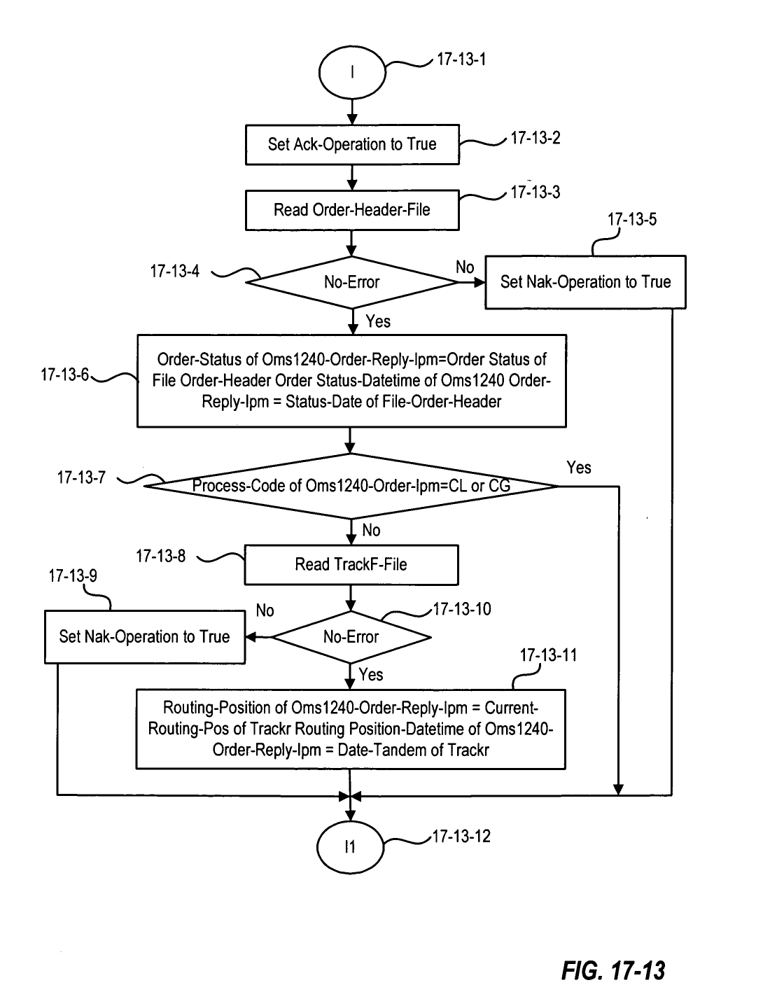

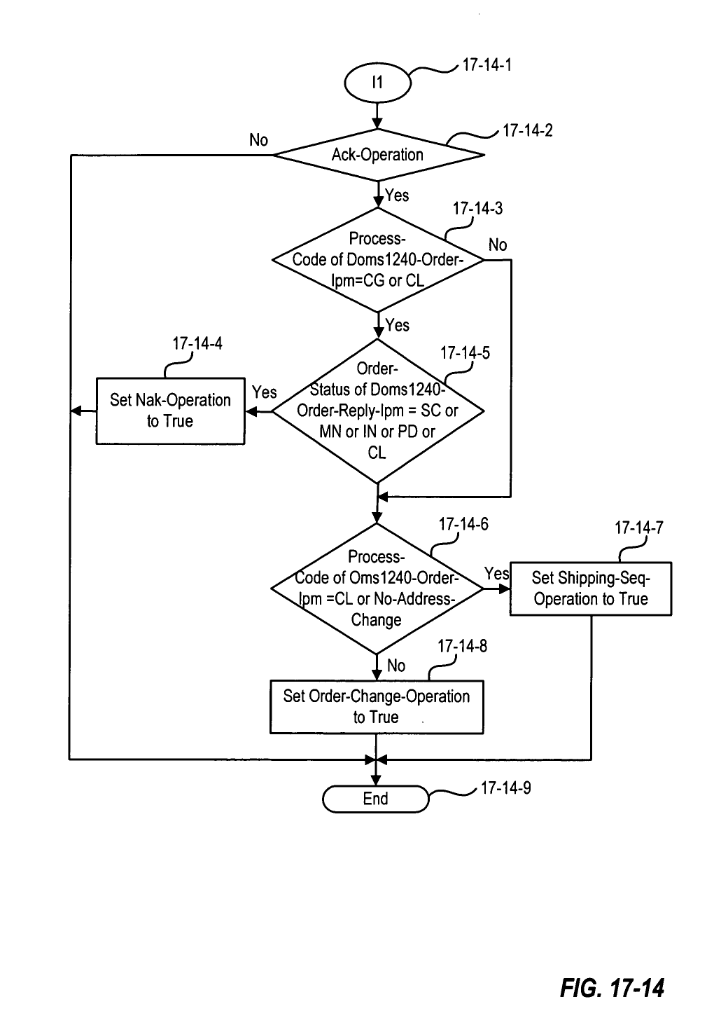

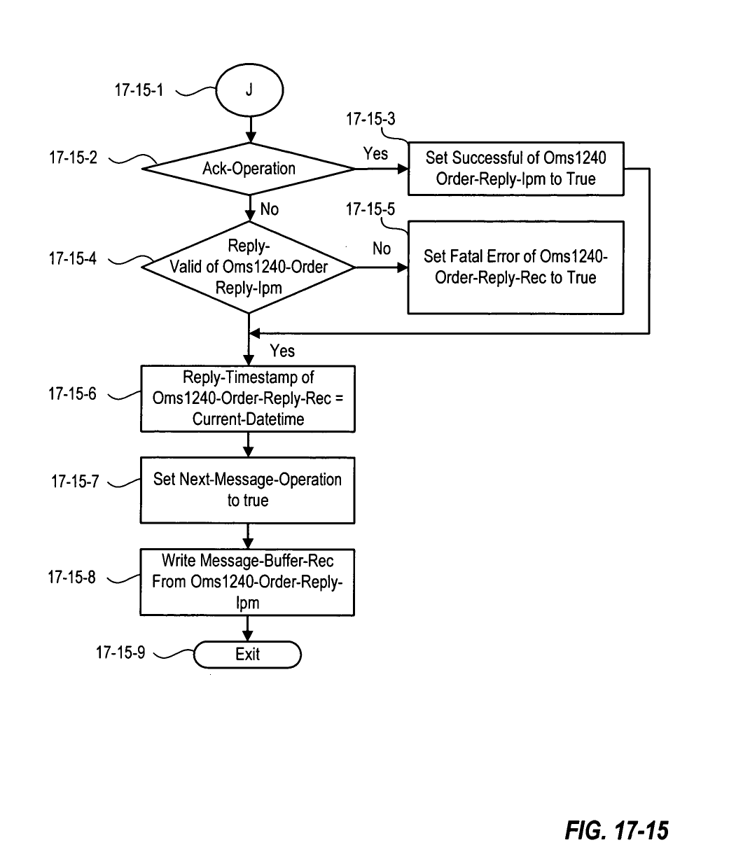

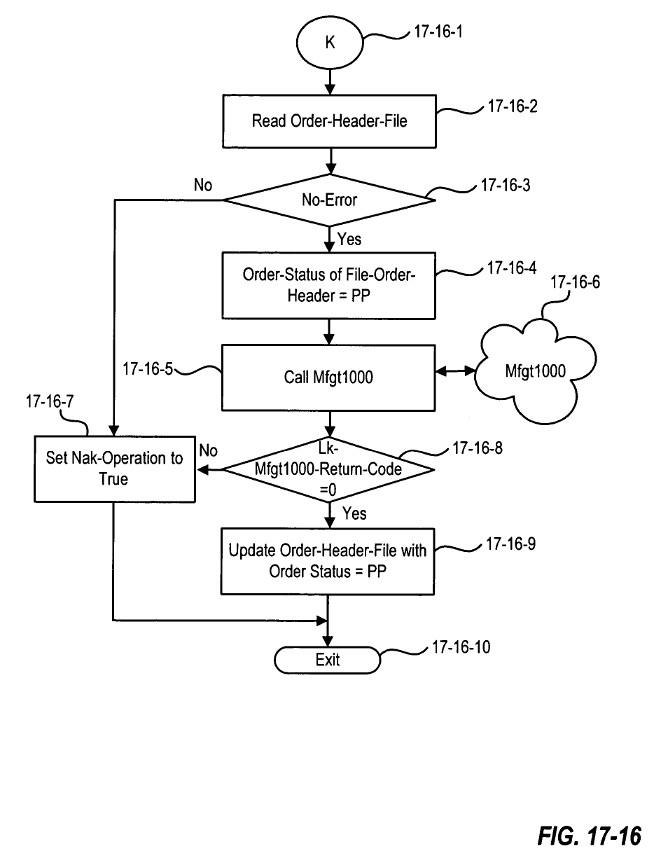

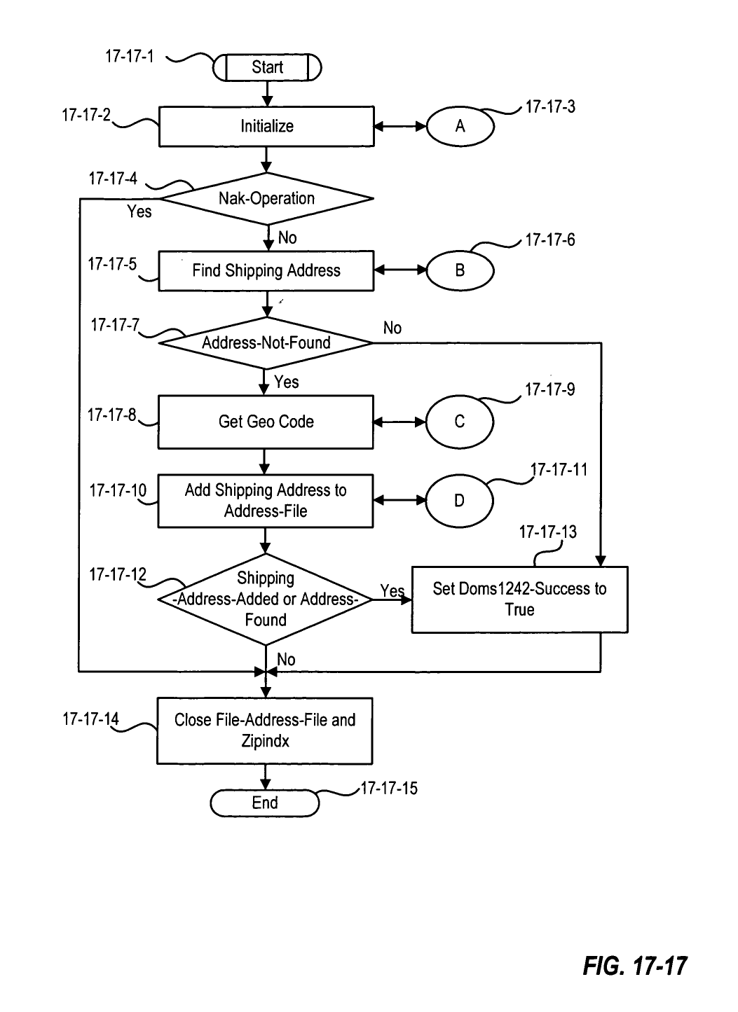

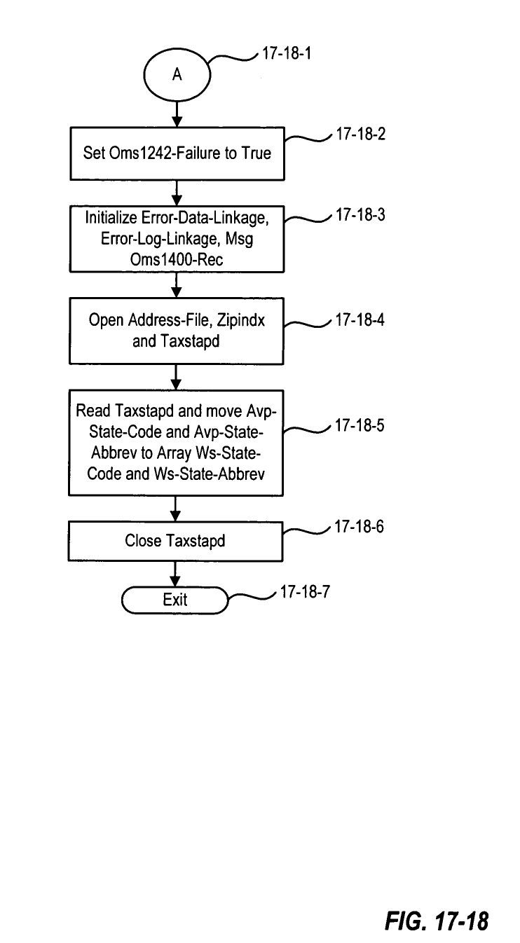

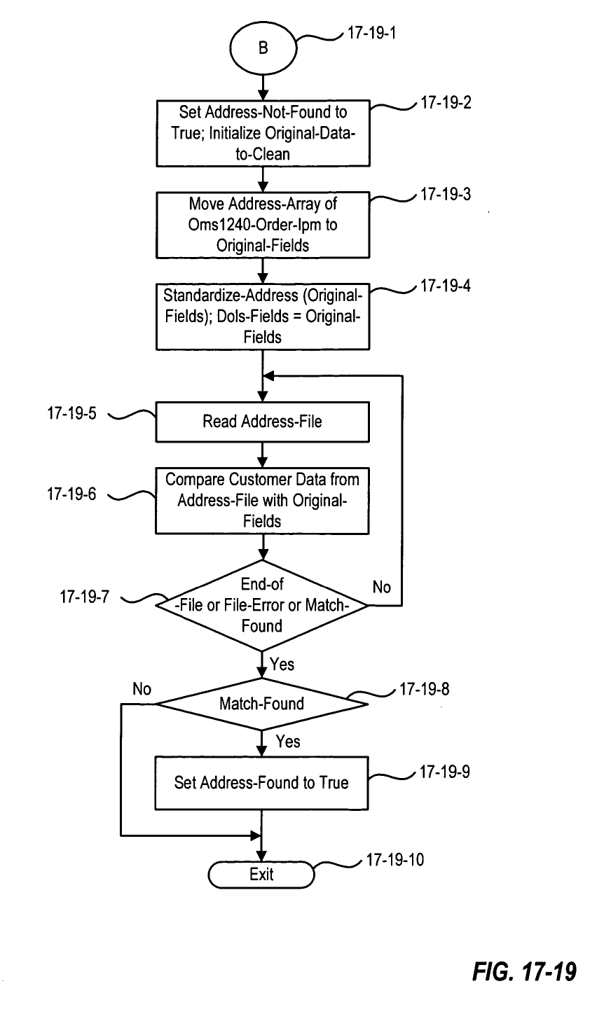

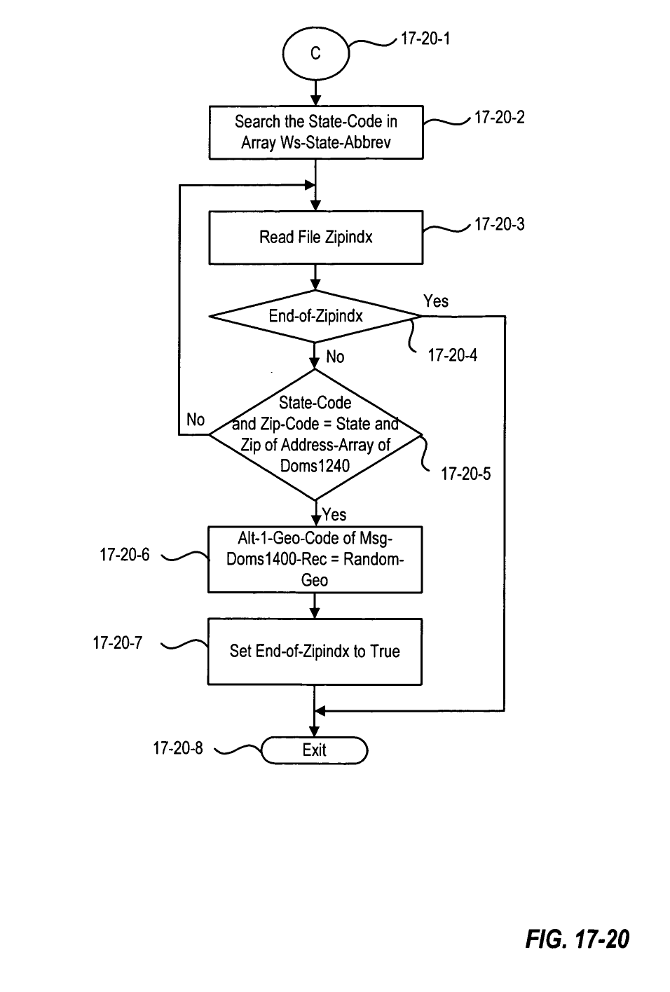

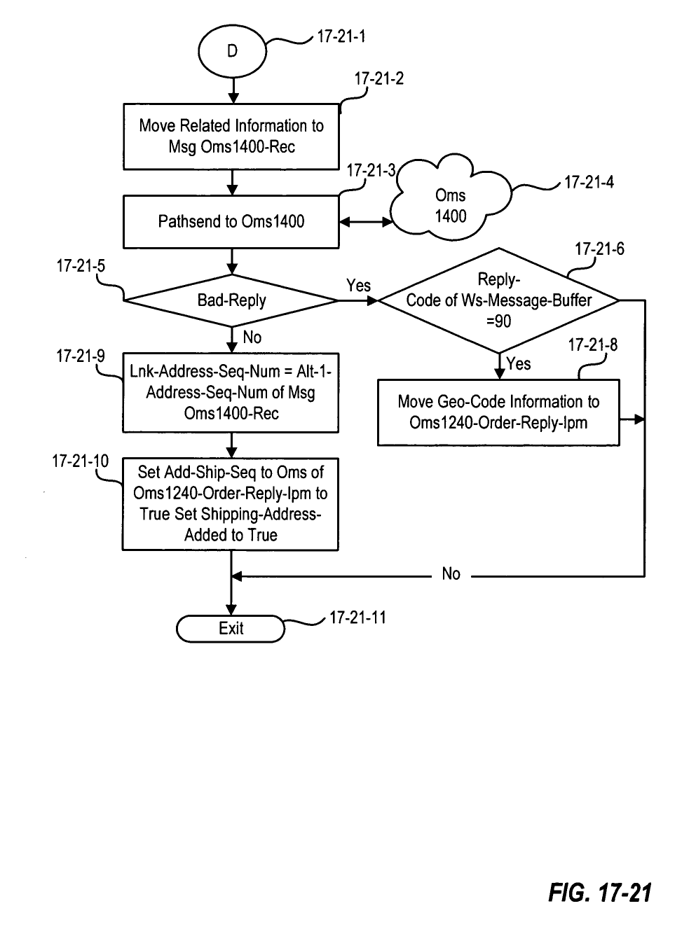

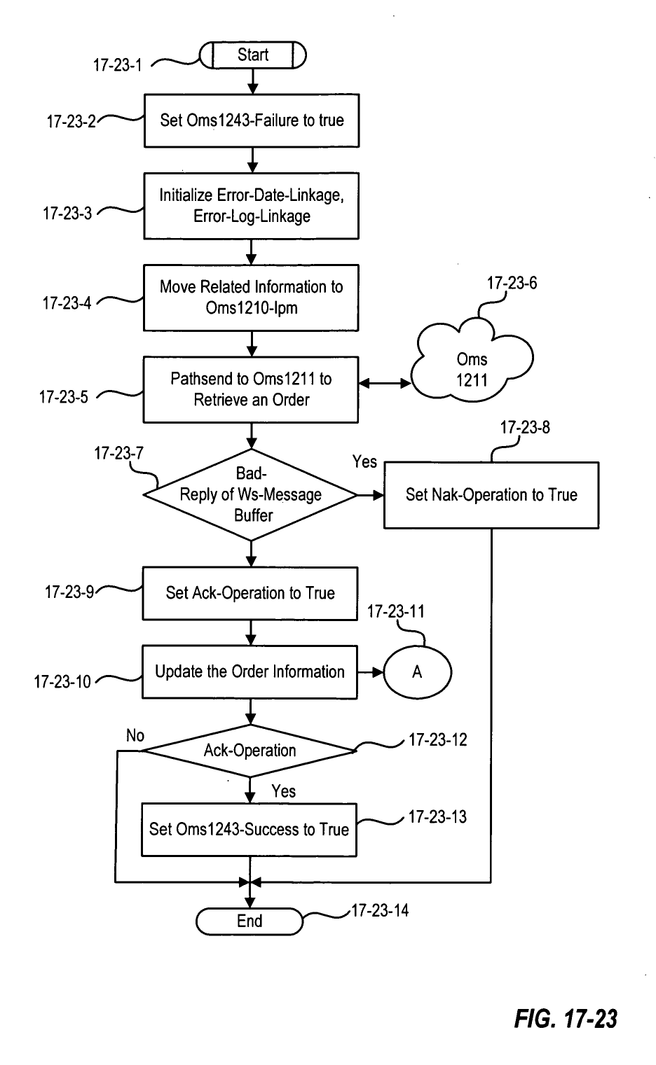

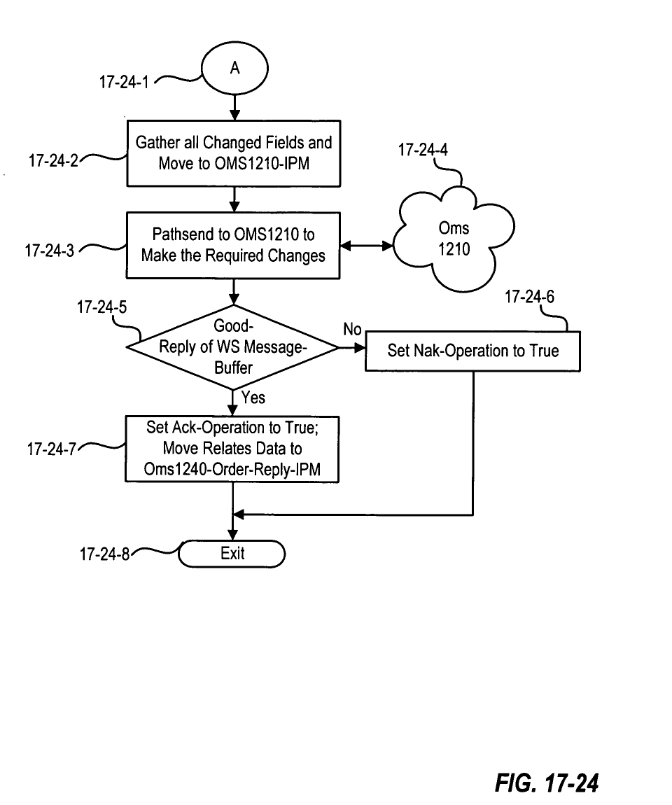

Referring now FIG. 17-1 through 17-24, the OMS server 1240 shown in FIG. 14B is described in flow diagrams. OMS server 1240 performs the function of translating order data from a Windows NT platform to a disparate platform. The main program is illustrated in flow diagram format on FIG. 17-3. Referring to block 17-3-6 in FIG. 17-3 block “B” is shown. The “B” process is shown in FIGS. 17-1, 17-2 and 17-5. FIG. 17-1 shows the “B” flow diagram for creating stocking orders in accordance with the inventory process described above. FIG. 17-1 includes blocks 17-1-1 through 17-1-14 and reads in requests for stocking orders in block 17-1-3, processes those request in block 17-1-9, determines the success, and exits at block 17-3-5 shown in FIG. 17-3. FIG. 17-2 includes blocks 17-2-1 through 17-2-21 and illustrates the “B” process taken for non-stocking order generation, order changes, order cancellations, and releases of stocking inventory by doing an order change. For example, in one embodiment, after a customer sends order file 338 shown in FIG. 3A, a customer optionally sends order changes or order cancellations in another file structure (not shown in FIG. 3A). FIG. 17-2 shows the flow diagram with functionality including receiving a request at block 17-2-3 that indicates whether the request is for a new order that is not a stocking order, a change to an order, a cancellation of an order. The flow diagram executes blocks 17-2-3 through 17-2-17 in sequence as required to execute the functionality.

FIG. 17-3 includes block 17-3-3 “A” to get parameters. Function “A” is shown in flow diagram in FIG. 17-4. Referring to FIG. 17-4, blocks 17-4-1 through 17-4-18 illustrate the function of retrieving data from the OMS system illustrated in FIG. 14B.

Referring to FIG. 17-5, all functionalities included in FIG. 17-1 and 17-2 are included for completeness in blocks 17-5-1 through 17-5-23. Only those required for a particular functionality are activated from the calling program shown in FIG. 17-3.

FIG. 17-6 illustrates blocks 17-6-1 through 17-6-10 in a flow diagram called from FIG. 17-2 “C” for initialization.

FIG. 17-7 illustrates the flow diagram called from FIG. 17-2 for extracting orders “D” from the OMS system. As shown FIG. 17-7 includes blocks 17-7-1 through 17-7-12. FIG. 17-8 illustrates the flow diagram called from FIG. 17-2 “E” for locating shipping addresses. More specifically, FIG. 17-8 includes blocks 17-8-1 through 17-8-12. Included in the module is a call to a subroutine OMS 1242 17-8-6. The OMS 1242 subroutine is shown in FIG. 14B wherein the subroutine is shown to interact with OMS system tables for tax data, zip code data, address data and other data.

FIG. 17-9 illustrates the flow diagram called from FIG. 17-2 for performing an order change “F.” FIG. 17-9 includes blocks 17-9-1 through 17-9-11. The flow diagram illustrates processing of change or cancellation of order. The flow diagram calls a subroutine OMS 1243 shown in FIG. 14B which updates purchase orders, shipping data and performs order cancellation.

FIG. 17-10 illustrates the flow diagram called from FIG. 17-2 “G” related to generating configurations. As shown, the flow diagram calls subroutine OMS 1244 in blocks 17-10-3 through 17-10-4. OMS 1244 is shown in FIG. 14B. The subroutine creates new quotes for custom non-commodity orders and uses a price override. The OMS 1244 subroutine calls sever OMS servers, and database tables.

FIG. 17-11 illustrates the flow diagram called from FIG. 17-2 “H” related to generating orders. More specifically, FIG. 17-11 includes blocks 17-11-1 through 17-11-11, which include interaction with the AOE GUI 402 shown in FIG. 14A to determine lead time required according customer agreements. The flow diagram continues on FIG. 17-12 with blocks 17-12-1 through 17-12-9 wherein codes of the order are processed and automatically set for release in blocks 17-12-7 and 17-12-8.

Referring to FIG. 17-13, a flow diagram called from FIG. 17-1 “I” is illustrated in blocs 17-13-1 through 17-14-9 in FIG. 17-14. The “I” flow diagram is called for a “get status” operation is used only for those orders that are stocking orders for inventory.

Referring to FIG. 17-15, a flow diagram called from FIG. 17-2 “J,” is shown in blocks 17-15-1 through 17-15-9. More particularly, the flow diagram illustrates an acknowledgment or a not-acknowledgment of orders from customers. If an order does not process correctly, a fatal error occurs, and if the process acknowledges correctly, a time stamp is given to the order in block 17-15-6.

Referring to FIG. 17-16, the processing of orders from customers continues with process “K” called from FIG. 17-9, block 17-9-10. The order is released for manufacture in blocks 17-16-1 through 17-16-10. Manufacturing is called in blocks 17-16-5 and 17-16-6.

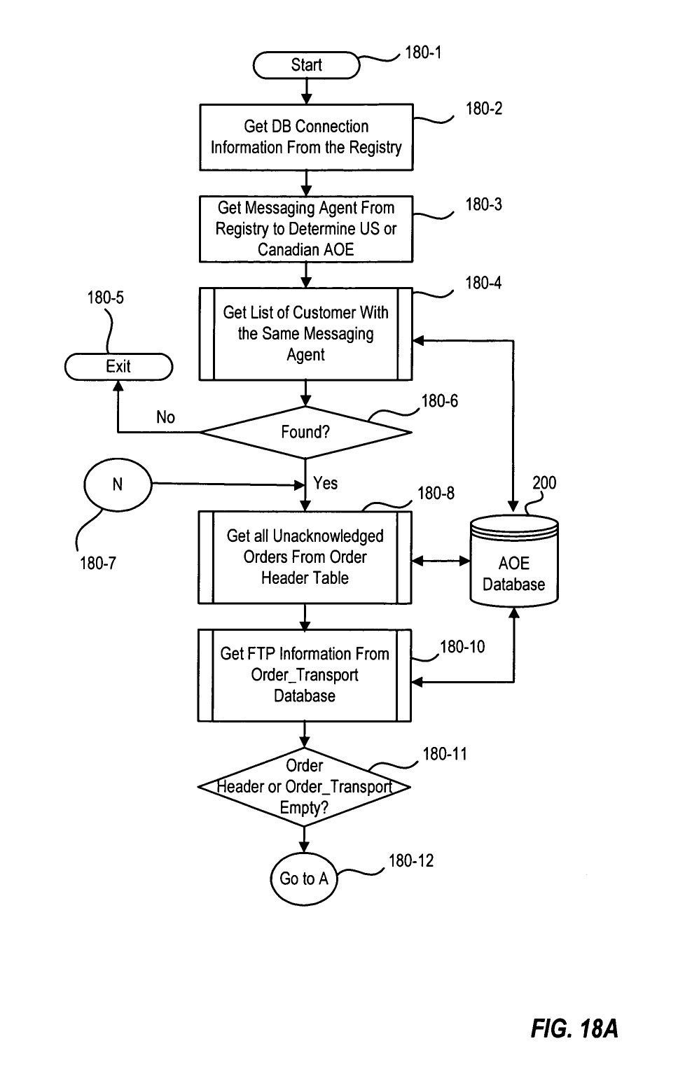

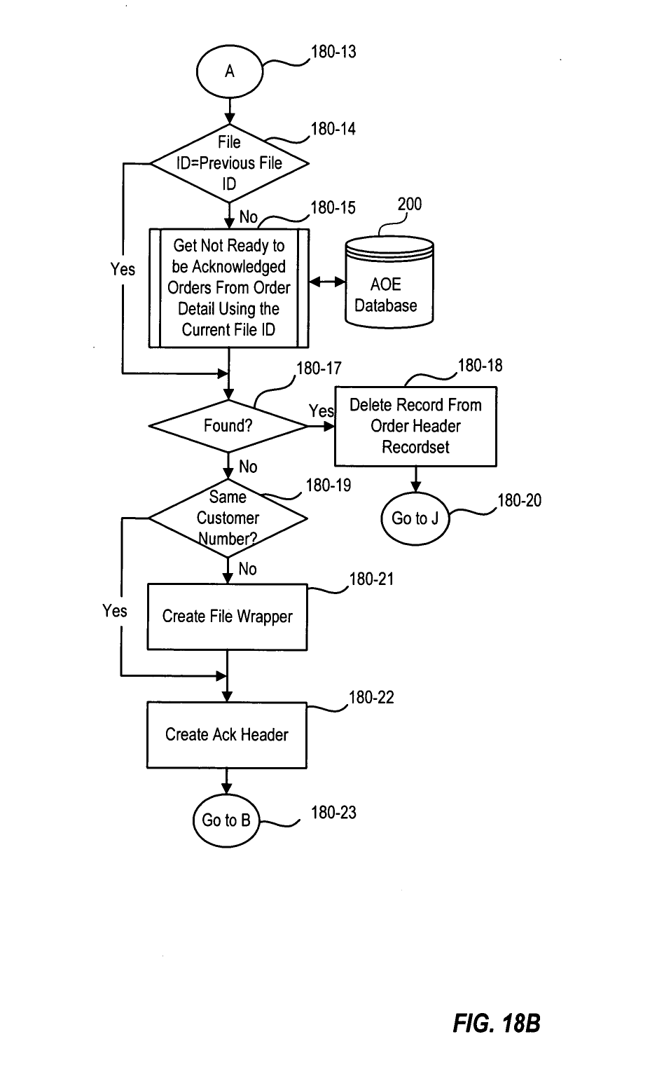

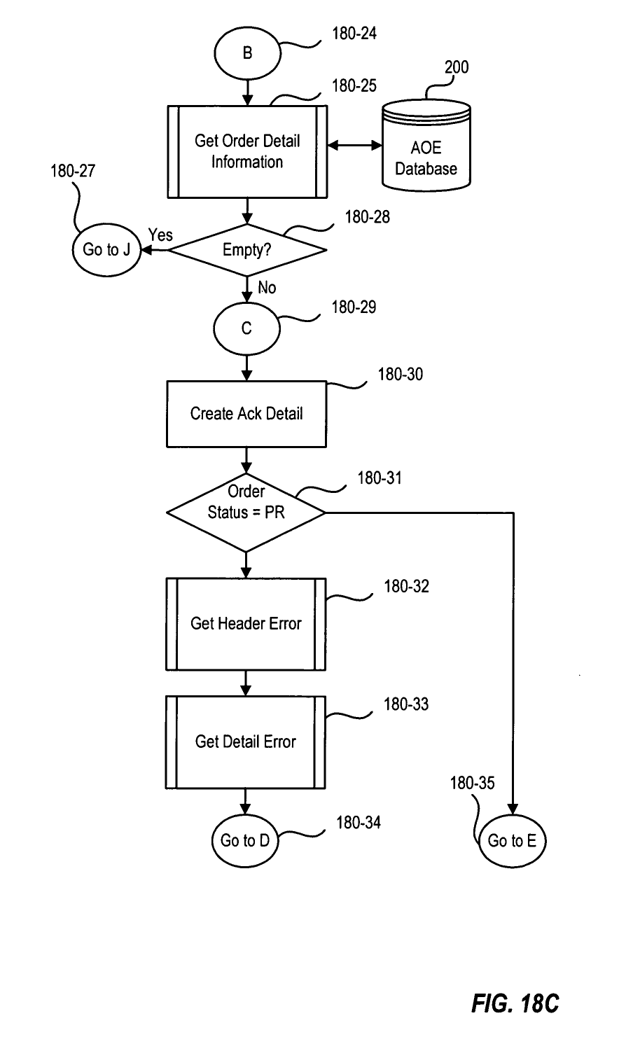

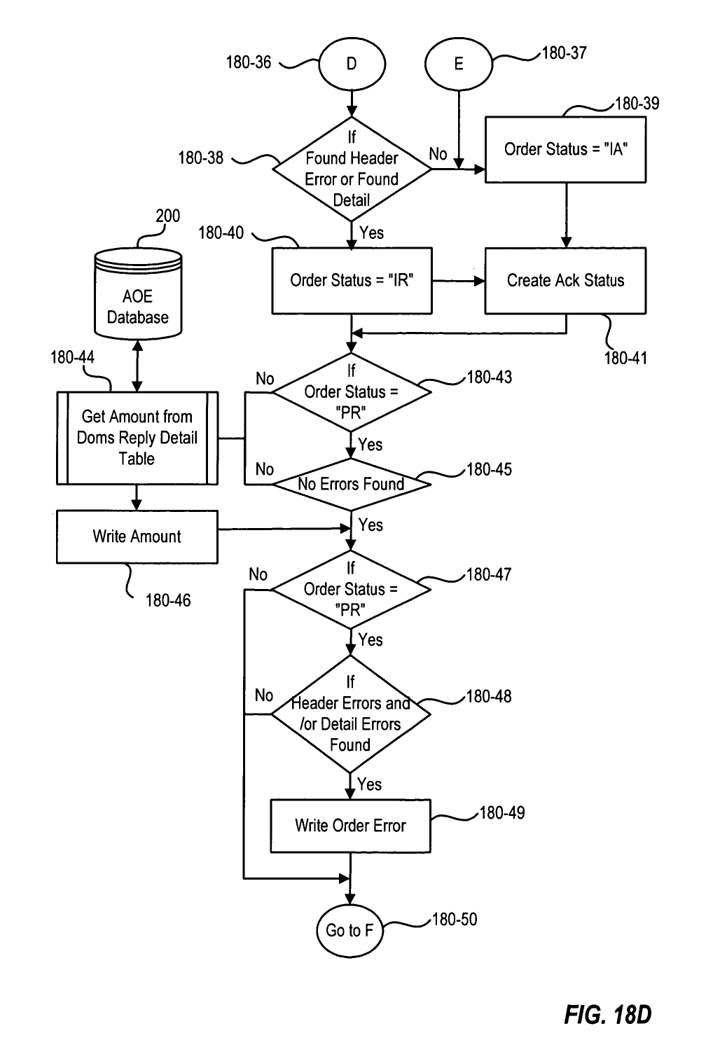

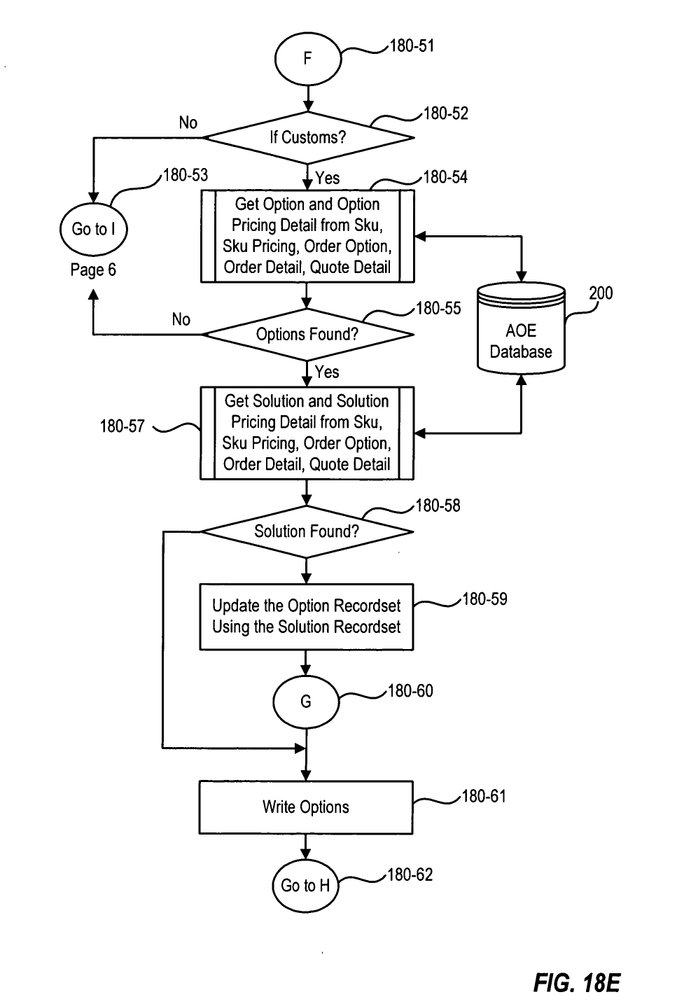

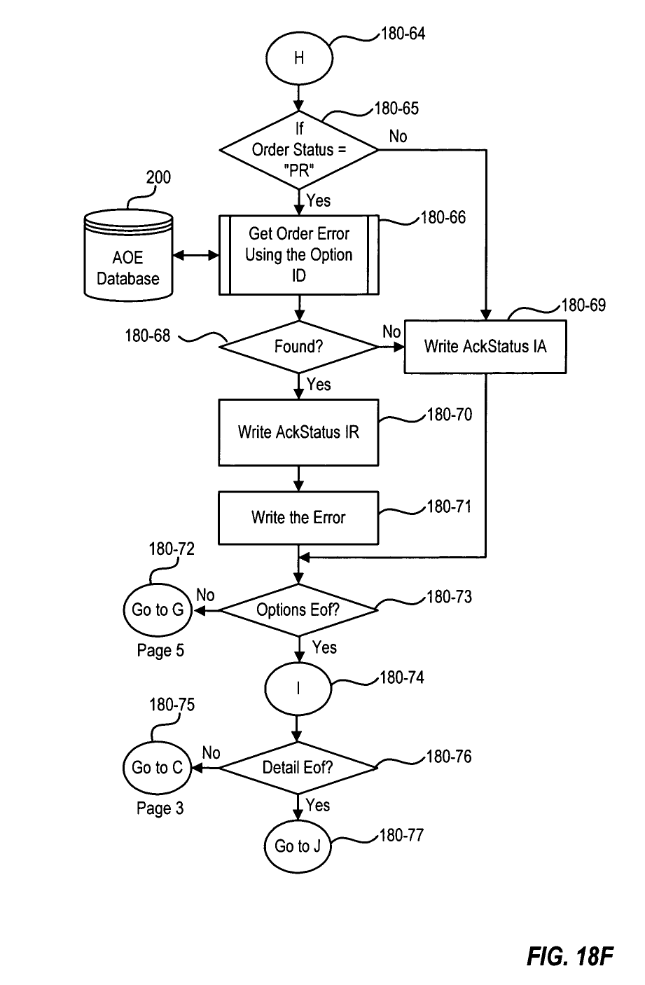

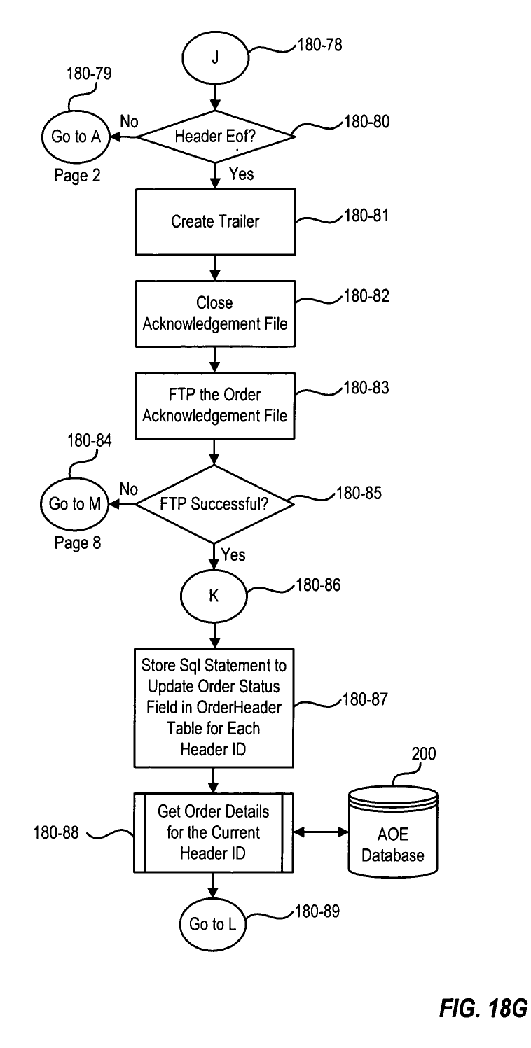

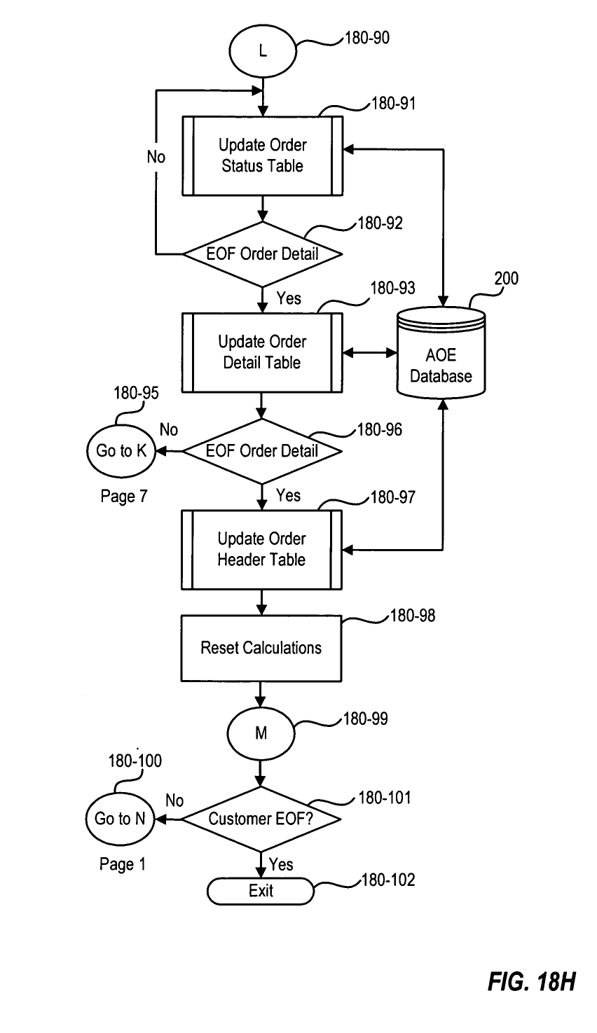

Referring to FIG. 17-17, blocks 17-17-1 through 17-17-15 provides a subroutine 1242 called from OMS server 1240 shown in FIG. 14B. The subroutine includes calls to flow diagrams for retrieving shipping data and initialization. More particularly, “A” relates to the flow diagram illustrated in FIG. 17-18 block 17-18-1 wherein files holding customer data are opened to retrieve data for addressing. “B” relates to block 17-19-1 in FIG. 17-19, including blocks 17-19-1 through 17-19-9, the flow diagram shown illustrates a subroutine for finding a customer shipping address by locating matches to customer data held in the OMS system. “C” relates to the flow diagram illustrated in FIG. 17-20, blocks 17-20-1 through 17-20-8 for locating further address information in databases in the OMS system. “D” relates to the flow diagram illustrated in FIG. 17-21, blocks 17-21-1 through 17-21-10, related to adding a shipping address to an address file for a customer.

Referring now to FIG. 17-23, a flow diagram for subroutine OMS 1243 shown in FIG. 14B is shown in detail. FIG. 17-23-1 includes blocks 17-23-1 through 17-23-14. The program includes processing of update data and cancellation data of orders. The program is called from Order Change/Cancel Processor 14 A-19 shown in FIG. 14A. Block 17-23-11 “A” continues the flow diagram by relating to FIG. 17-24, wherein the program continues and interacts with OMS system by making changes in accordance with order cancellation/change requests made by customers.

Order Process Batch Programs

Referring now to FIG. 18A through 18H, the batch program shown as order acknowledgement 14A-8 is shown in flow diagram form. FIG. 18A-18H includes blocks 180-1 through 180-102 inclusive. Referring back to FIG. 3A, order acknowledgment program 14A-18 acknowledges in an acknowledgement file 340 an order file 338 received from a customer server 254. The order file 338 may include many orders for either commodity or non-commodity products, and the acknowledgement file 340 will acknowledges the processing results from the manufacturers OMS system. According to one embodiment, the acknowledgment file includes acknowledgments for an entire order file 338. This enables a customer to efficiently determine exceptions for orders that did not process properly as well as confirm orders that processed properly. The data received by customer server 254 in the acknowledgment file 340 includes the customer purchase order number, the OMS order numbers assigned to the purchase order number, all pricing, including order total, line item total, shipping total, and tax total. If an error is included in the file, a reason is provided for every error if the attempt to process the order was unsuccessful. This allows the customer's procurement system 371 to correct all errors for an order prior to re-submitting the order.

Referring back to FIG. 14A, the order process includes an order acknowledgment batch file 14A-18 shown in FIG. 18A through FIG. 18H. The order acknowledgment batch program 14A-18 extracts orders processed by the order processor 14A-15 via database 200. The extraction of the orders is shown in blocks 180-1 through 180-25 shown in FIG. 18A through 18C. The order acknowledgment batch program produces a file 340 that is transmitted via communication medium 250 to the customer or to a location for pickup by a customer.

The acknowledgment file 340 includes in FIG. 18C, code that discriminates between commodity and non-commodity products, by separately acknowledging components within a non-commodity configuration. For example, a custom configuration for a product might include a monitor downgrade, hard drive upgrade, an add of speakers, and a keyboard upgrade to a bilingual keyboard. If the order was successful or unsuccessful, each component will be acknowledged to display which component, if any was separately rejected. For example, if the bilingual keyboard was improperly ordered with an improper action code, the acknowledgment file 340 will so indicate, and indicate a successful component process for all components but the bilingual keyboard. Further, for the bilingual keyboard, an explanation of the error will be provided in the acknowledgment file. The portions of the flow diagram in FIGS. 18C through 18D, blocks 180-33 through 180-49 indicate the “get detail error” modules for accomplishing the functions described.

The acknowledgment file 340 further includes details retrieved from AOE database 200 as shown in FIGS. 18E through 18H, blocks 180-51 through 180-102.

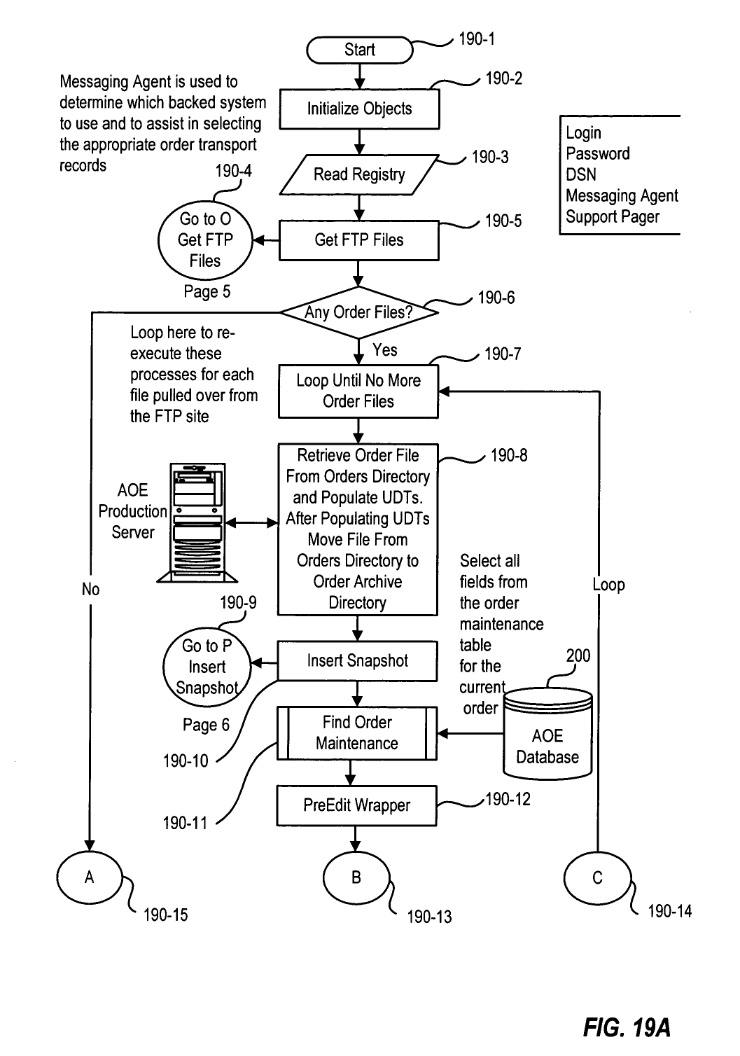

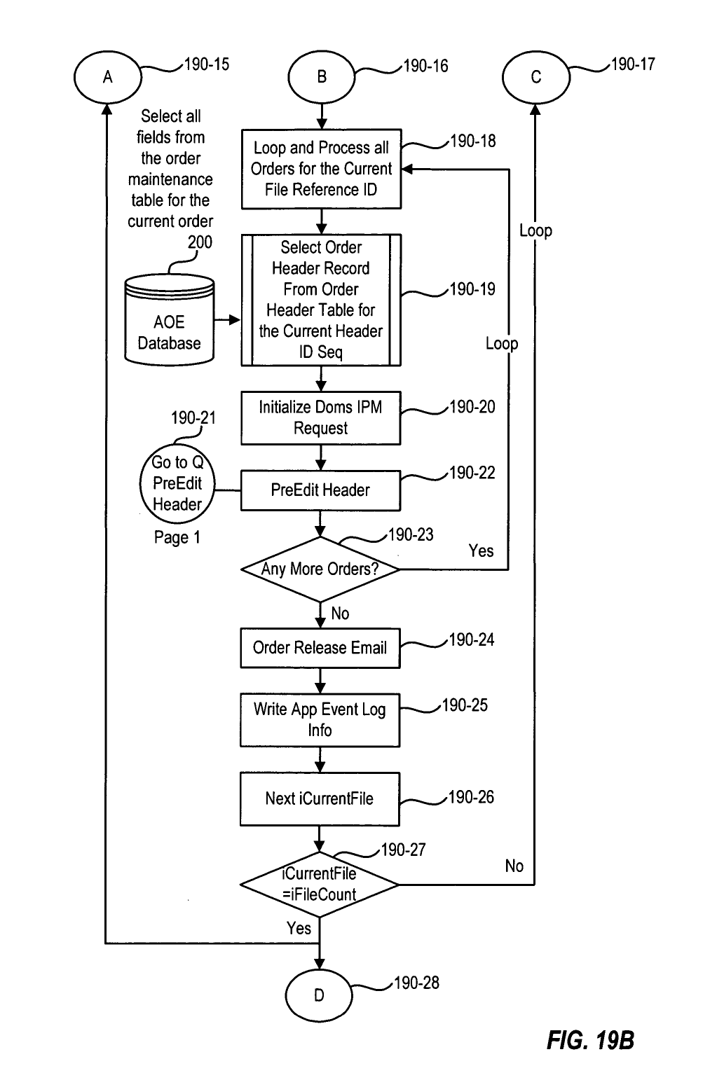

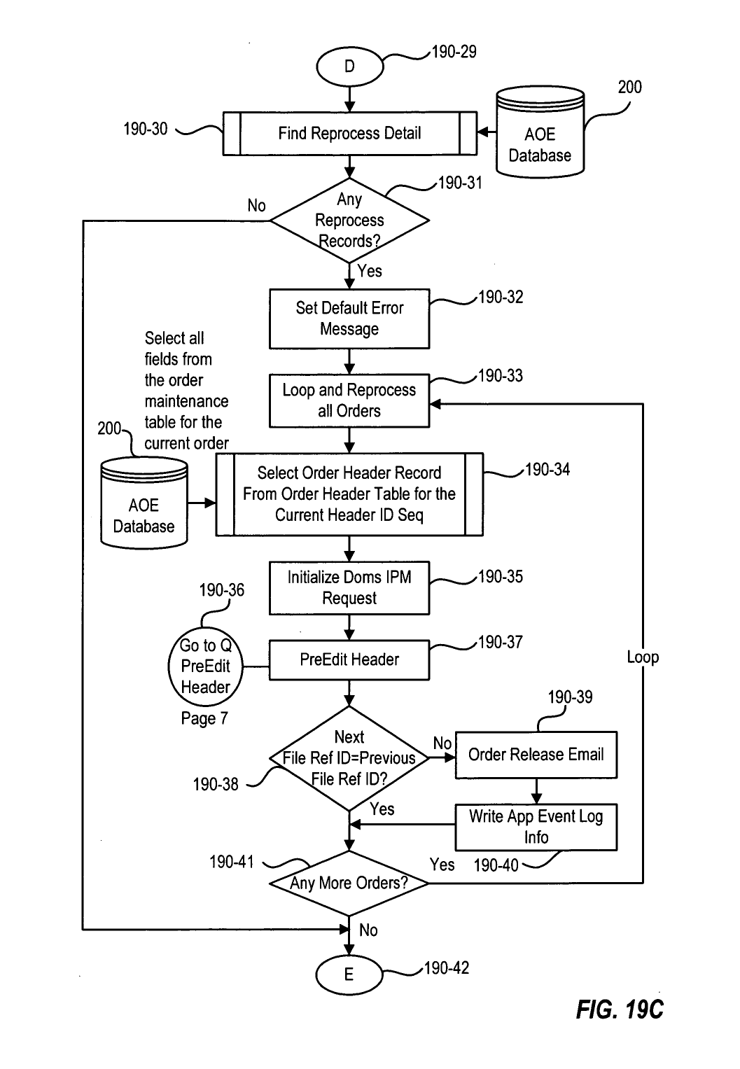

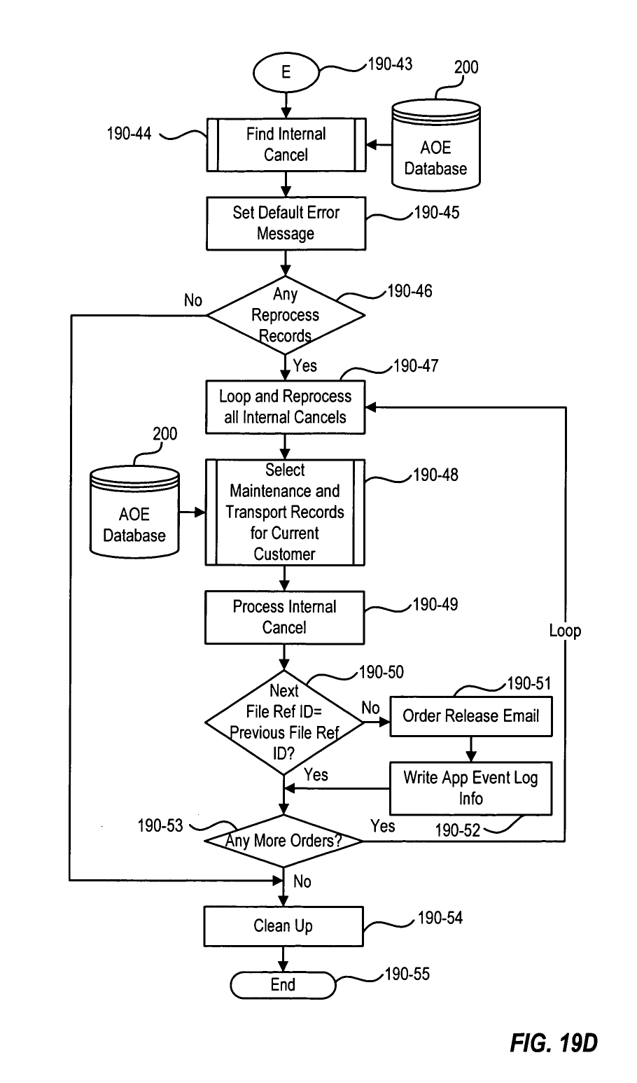

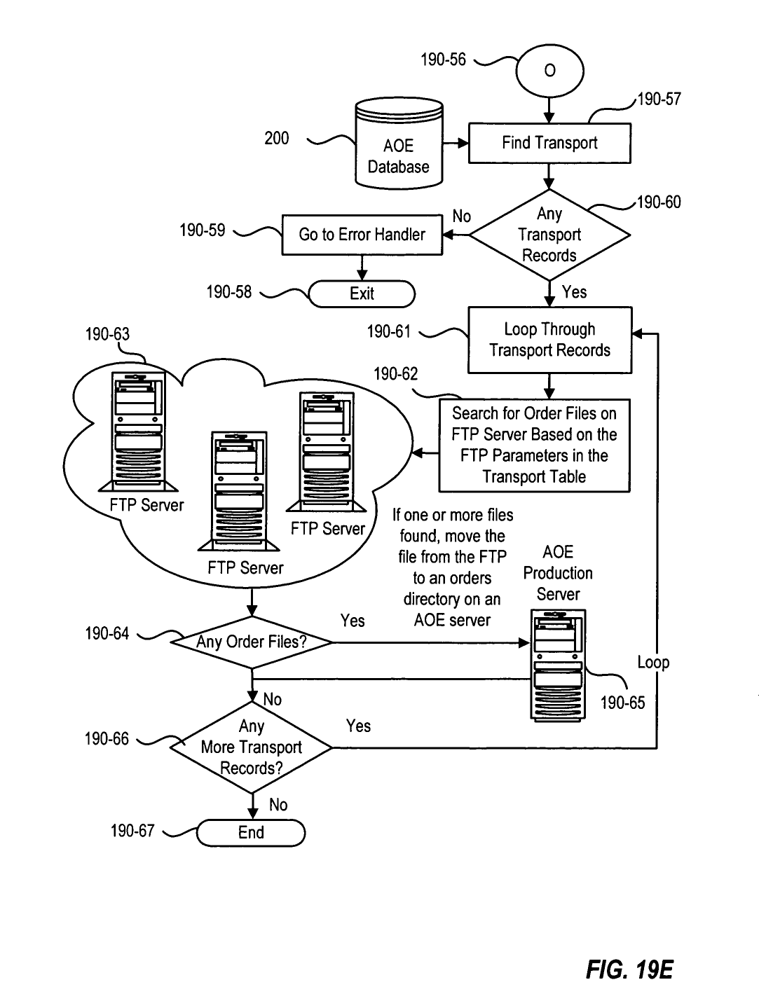

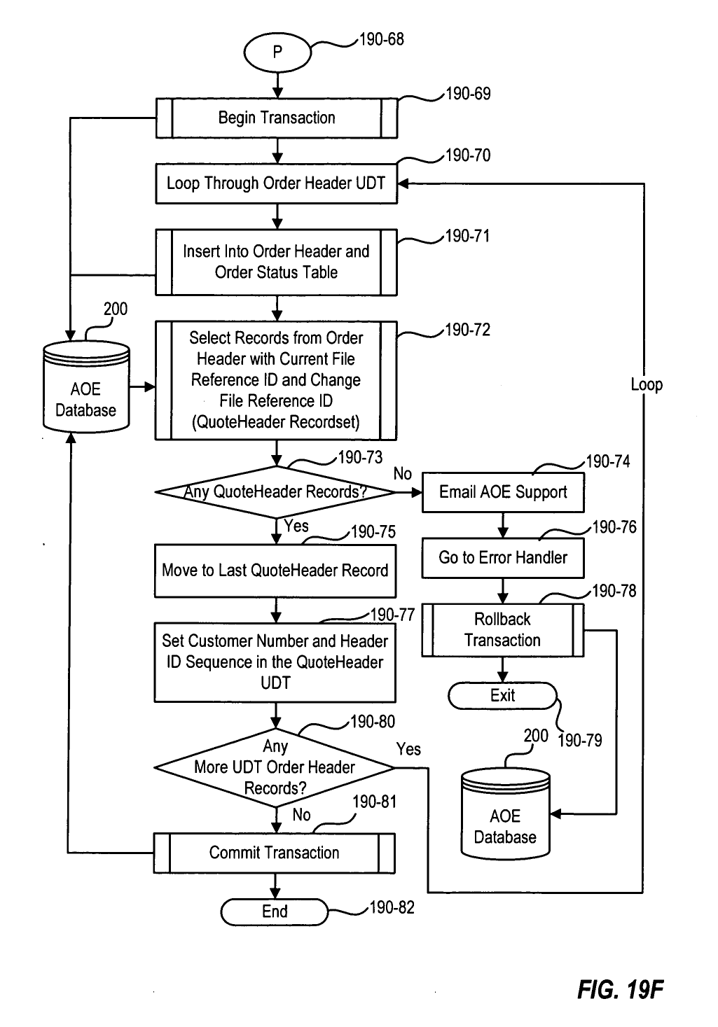

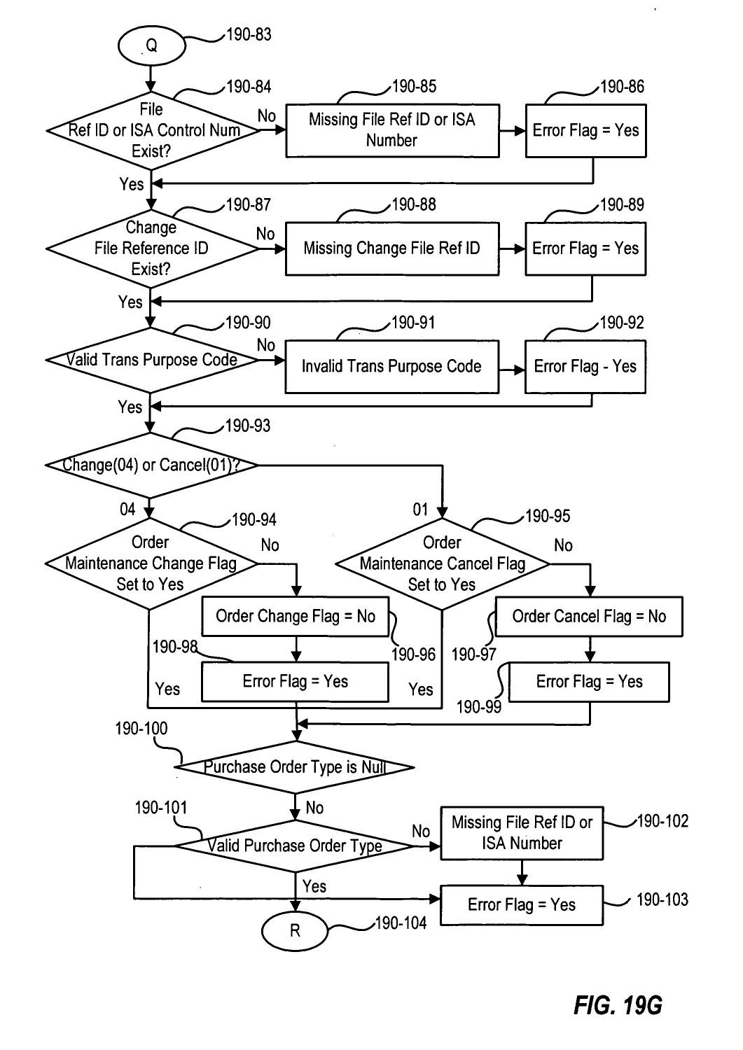

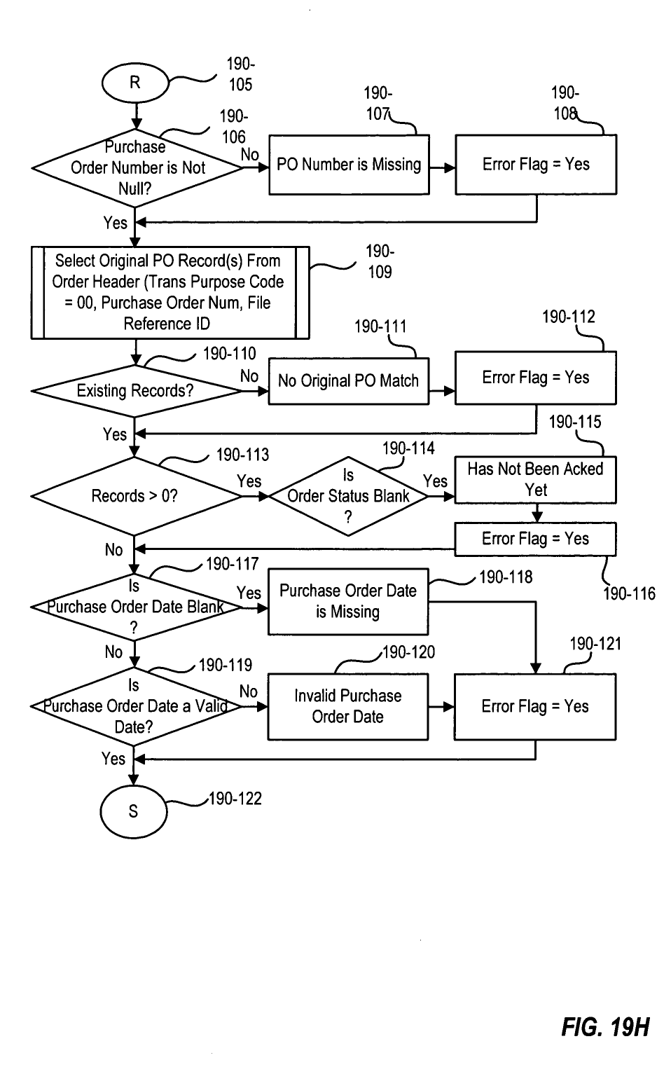

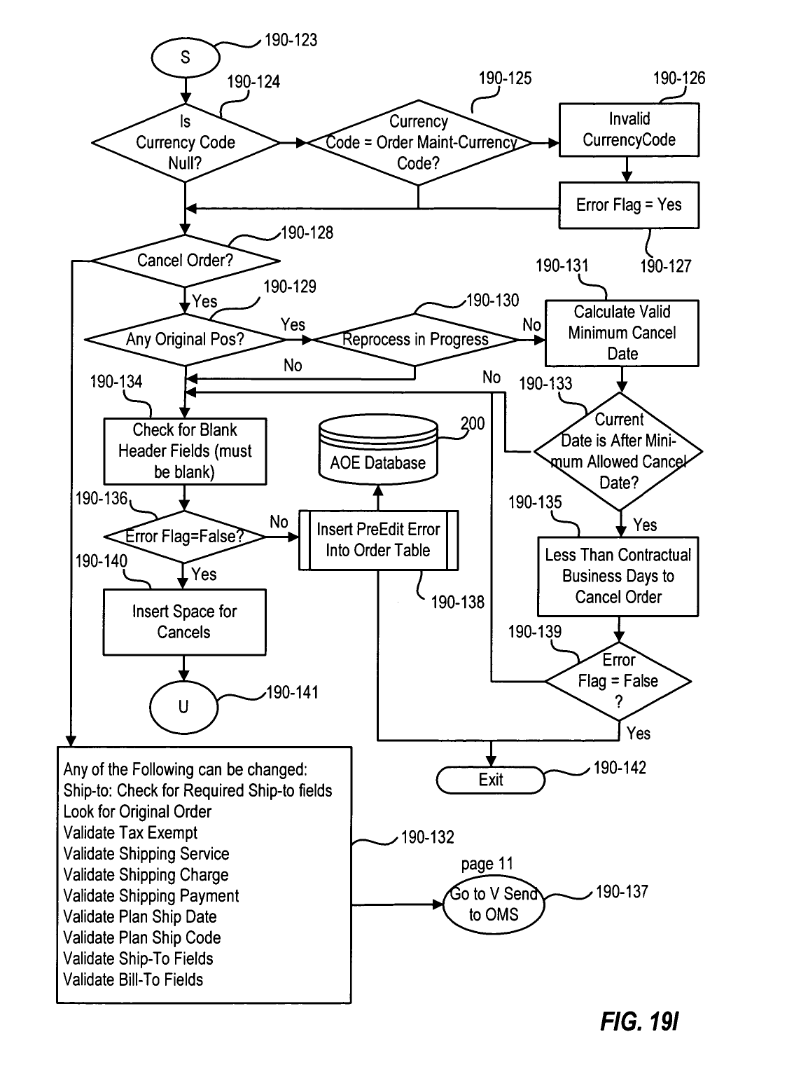

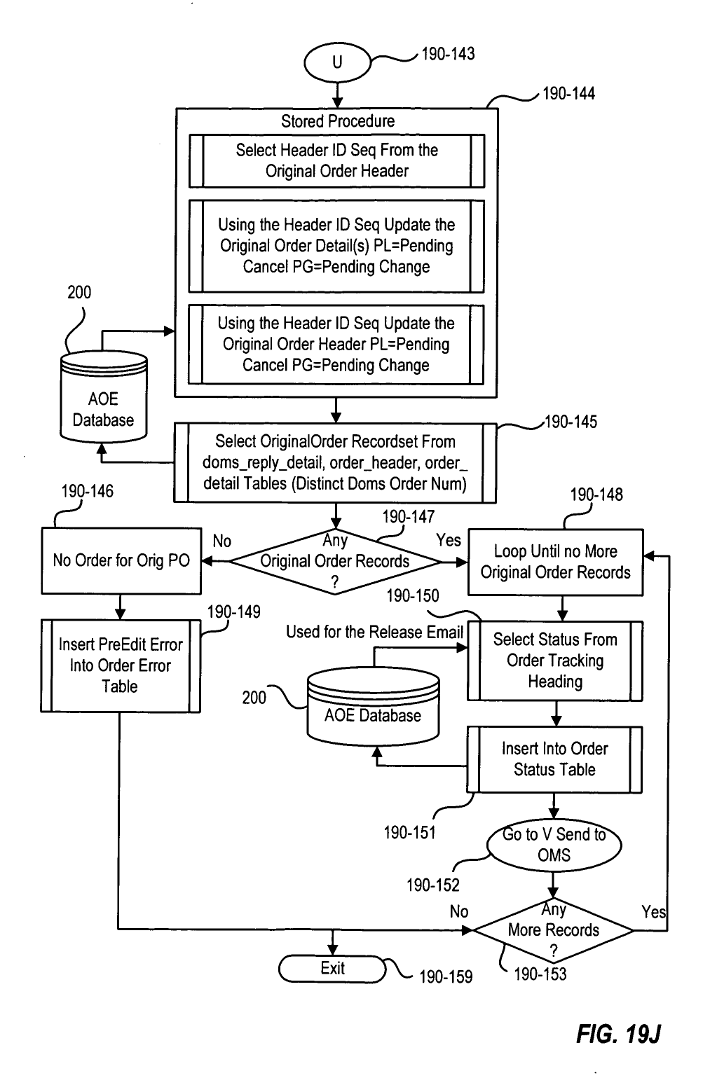

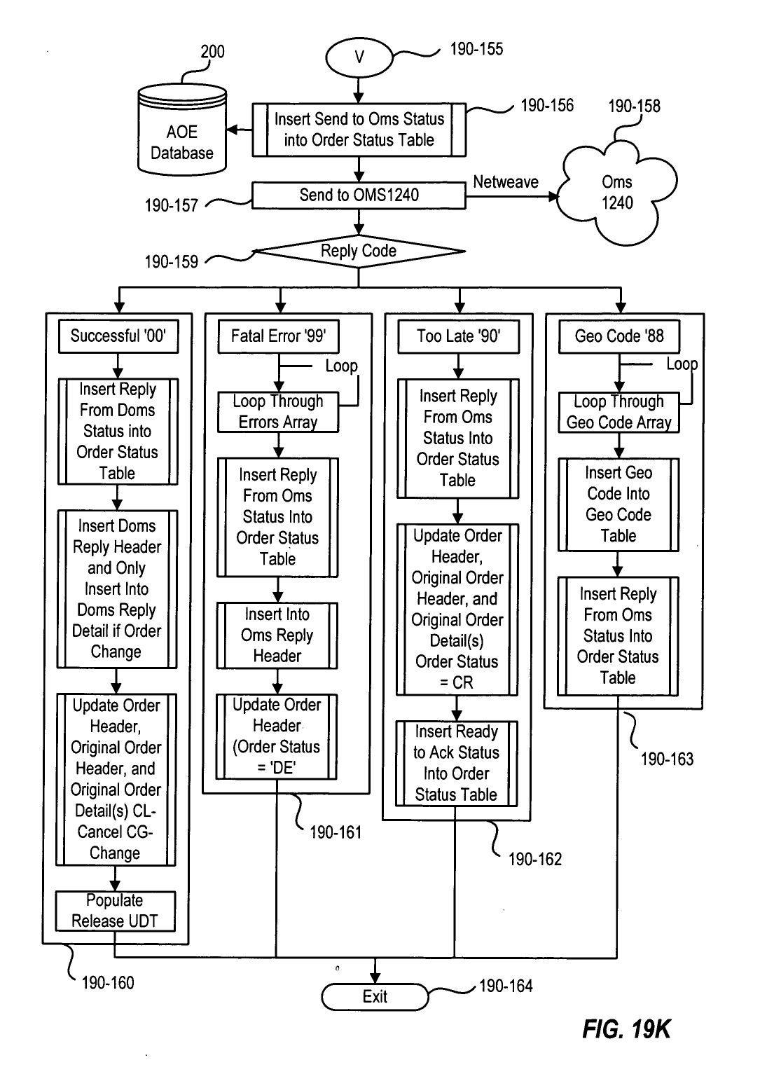

Referring to FIG. 19A through FIG. 19K, the order change/cancel processor 14A-19 is shown in flow diagram format. FIGS. 19A through 19K includes blocks 190-1 through 190-164. Order change/cancel processor is a batch program written in Visual Basic or another appropriate software program.

The order cancel/change processor batch program 14A-19 retrieves information from an FTP transport medium which optionally is another type of transport medium, such as TCP/IP or other appropriate medium in blocks 190-4 through 190-5. The retrieval is shown in detail in FIG. 19E, blocks 190-56 through 190-67. The order cancel/change processor 14A-19 further operates to open a database connection with the AoE database 200 in blocks 190-8 through 190-11.

Block 190-9 provides for taking a “snapshot” of the order cancel/change data as received from a customer in its original format. This block is shown in flow diagram form in FIG. 19F in blocks 190-68 through 190-82.

Referring to FIG. 19B, block, 190-21 “pre-edit header” refers to FIG. 19G, blocks 190-83 through 190-164. The pre-edit header validates data in an order cancel/change file received from a customer in blocks 190-84 through block 190-90. In blocks 190-93 through 190-99, the program determines whether a cancel or a change is being requested and whether either a cancel or a change is permitted for a customer. For example, contractual agreements with particular customers may prohibit order cancellations and/or order changes.

Referring to FIG. 19H, blocks 190-105 through 190-122 provide flow diagrams showing how the order cancel/change processor 14A-19 locates OMS system order data assigned to a customer using the customer-generated purchase order number. Block 190-115 provides for searching to insure that an order acknowledgment 340 shown in FIG. 3A took place prior to permitting a customer to cancel or change an order.

Referring to FIG. 191, blocks 190-123 through 190-141 are shown in flow diagram form. The flow diagrams show in blocks 190-128 whether the request is a cancel or a change request. If the file requests a change, block 190-132 provides parameters that are permitted to be changed. The items shown include order header data, such as ship to address, shipping service, planned ship date, and bill to information. If a customer requests that only those items are to be changed, the request is then forwarded to the OMS system via block 190-137.

For cancellation requests for orders, FIG. 191 and 19J, blocks 190-129 through 190-154 inclusive shows a flow diagram that checks as to whether there are any pending actions to be completed on the order prior to issuing the order cancel. In FIG. 19J, block 190-152 processes the request for cancellation to the OMS server 1240. A pending action is referred to as a “reprocess” action. If there is no such reprocessing pending, block 190-131 provides a check to insure that the customer gave appropriate lead time for the cancellation request. For example, a contractual agreement might indicate that a customer must provide one business day notice before cancellation of an order. Thus, if a cancellation request is made within one business day of a shipping date, the cancellation request is refused.

Referring to FIG. 19K, the flow diagram for sending cancellation and change requests to OMS server 1240 is shown in further detail in blocks 190-155 through 190-164. In 190-156 the status of AoE database 200 is updated with a new status prior to sending the request to OMS server 1240 in block 190-157. Block 190-159 provides the return status reply code. Blocks 190-160 provide that if the action was successful, the AoE database 200 is so notified. Blocks 190-161 provide that if a fatal error occurs, the AoE database 200 error status will be updated. Blocks 190-162 provide that a late reply code occurred and the AoE database 200 will be updated as to the error status. Blocks 190-163 provide that there is additional information that a computer user will need to take, then the status code is updated in the AoE database 200.

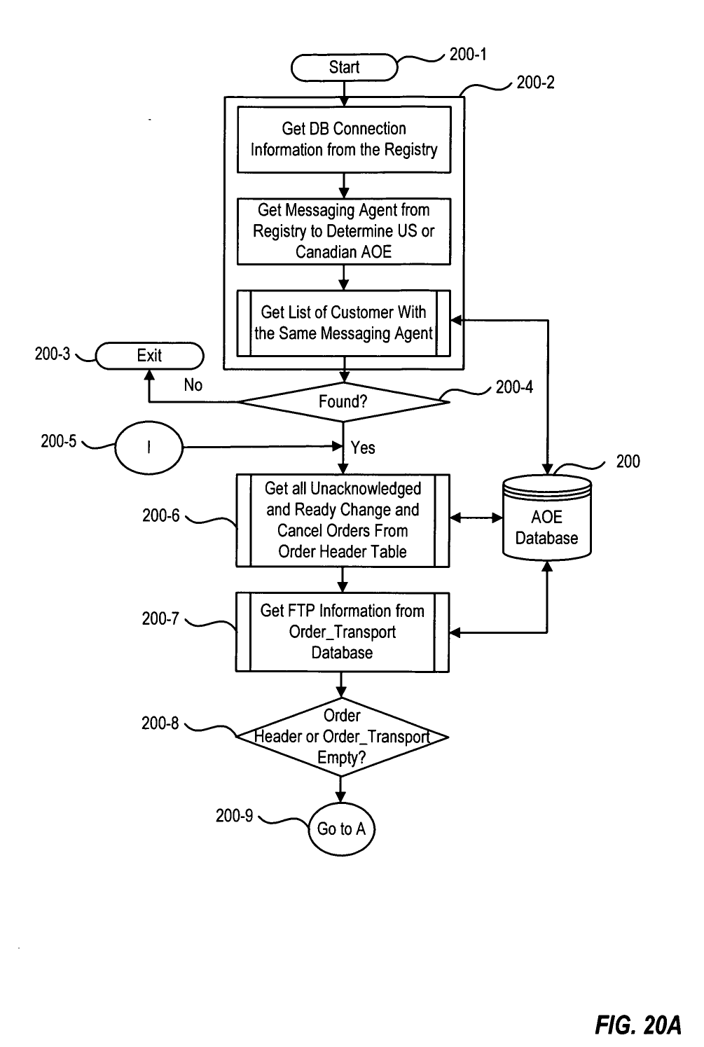

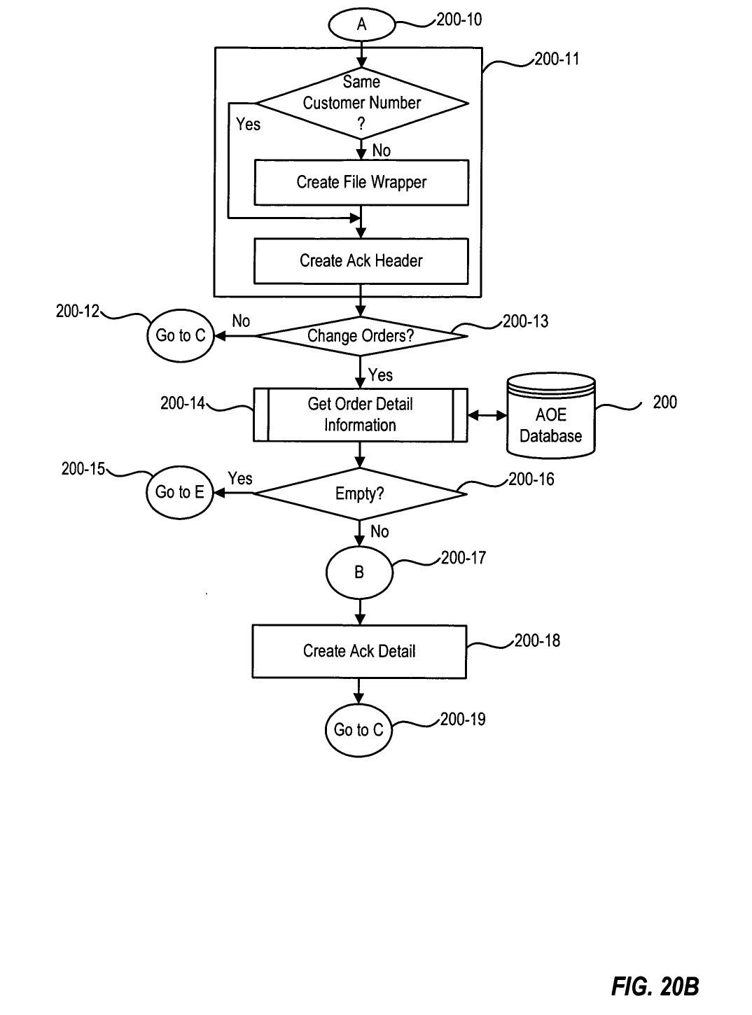

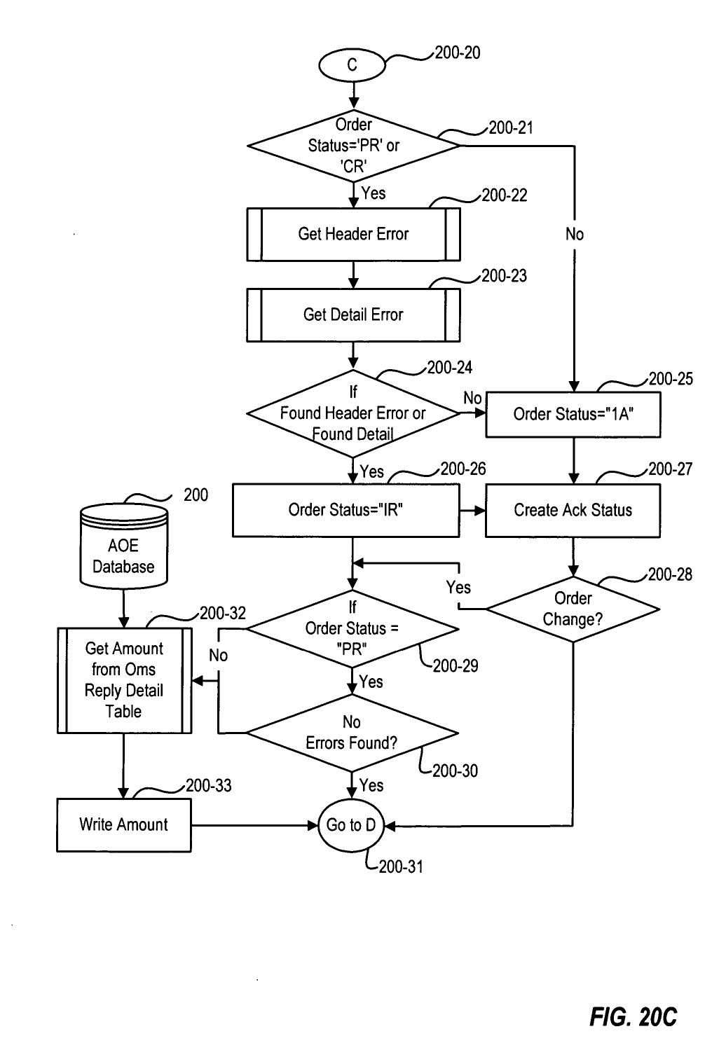

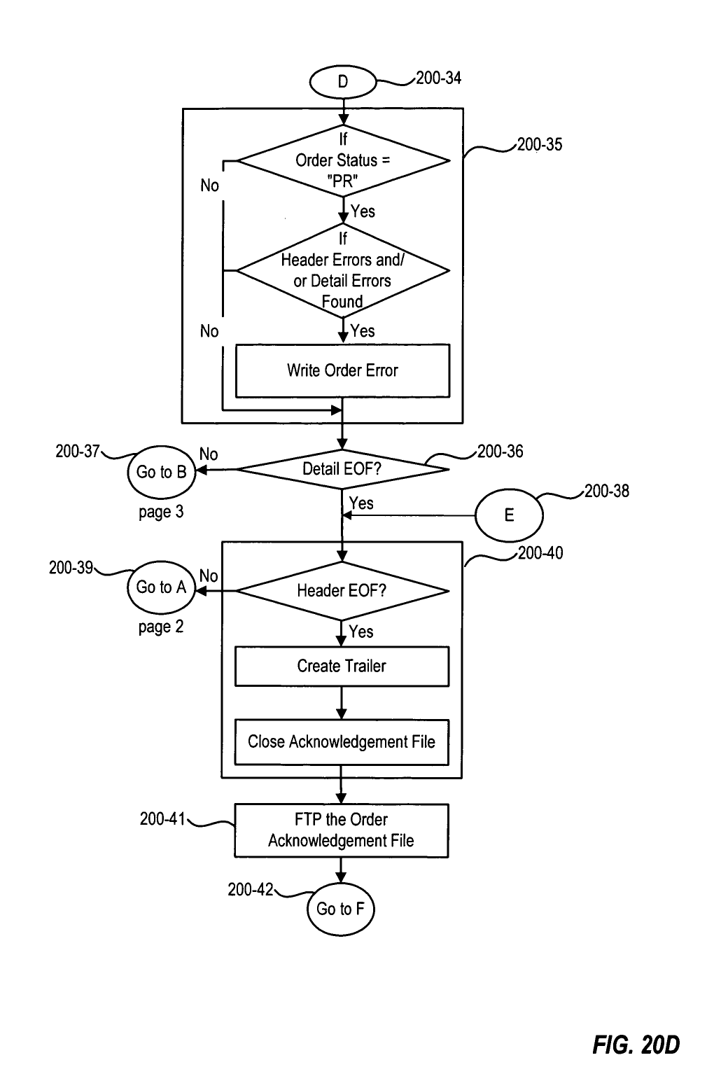

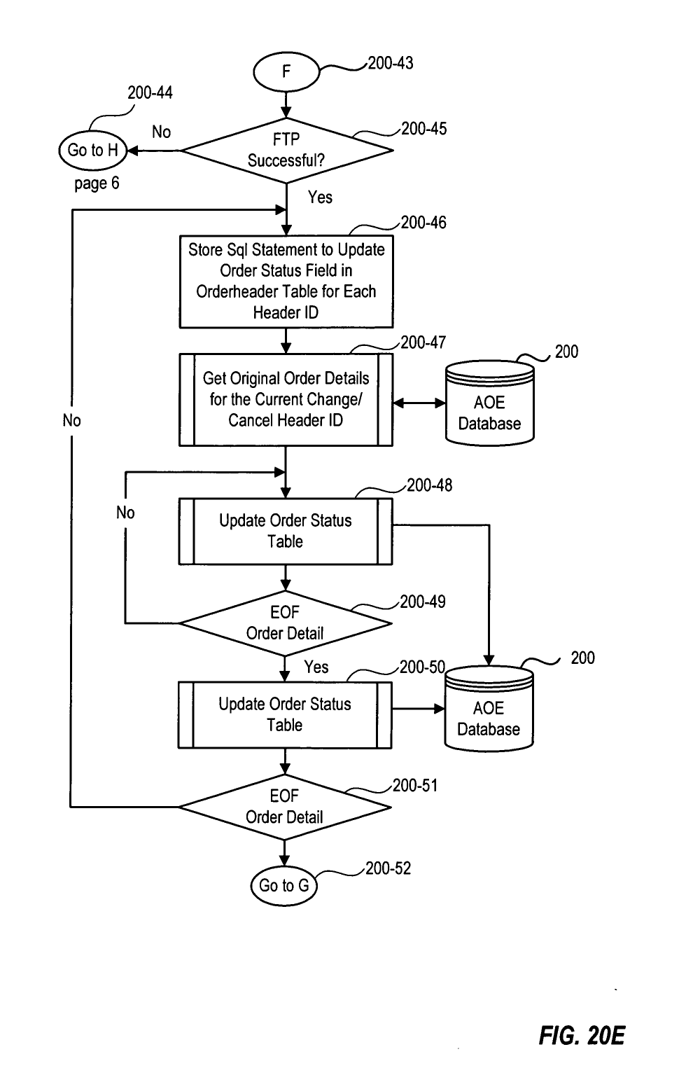

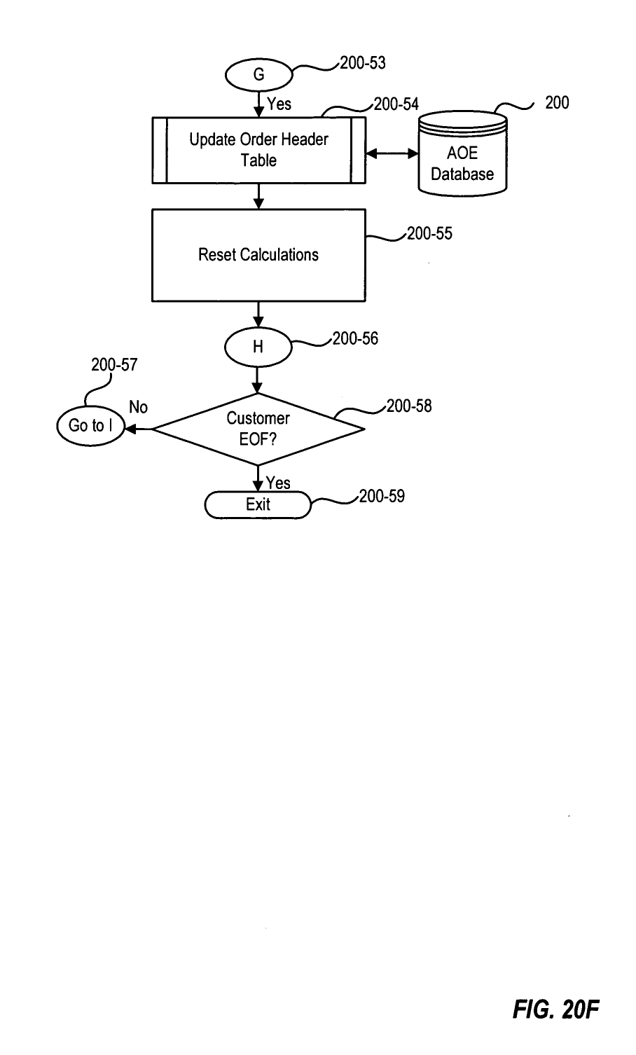

Referring now to FIGS. 20A through 20F, flow diagrams for Order Change/Cancel Acknowledgment 14A-20, shown in FIG. 14A, is shown in further detail. FIGS. 20A through 20 F include blocks 200-1 through 200-59. As shown, the flow diagrams provide for a response to a customer's change or cancel order requests. The order cancel and change acknowledgement program 14A-20 obtains all order records in the AoE database 200 that have been processed by the Order Change Processor 14A-19, whether successful or unsuccessful. The program 14A-20 creates an order cancel change acknowledgement file that contains the original purchase order number provided by the customer, any pricing changes related to an order change request, successful and unsuccessful indications such as error messages, OMS order numbers, and the like. The customer then loads the order cancel and change acknowledgement file into their procurement system 371 shown in FIG. 3B to relate back to their cancel or change order requests.

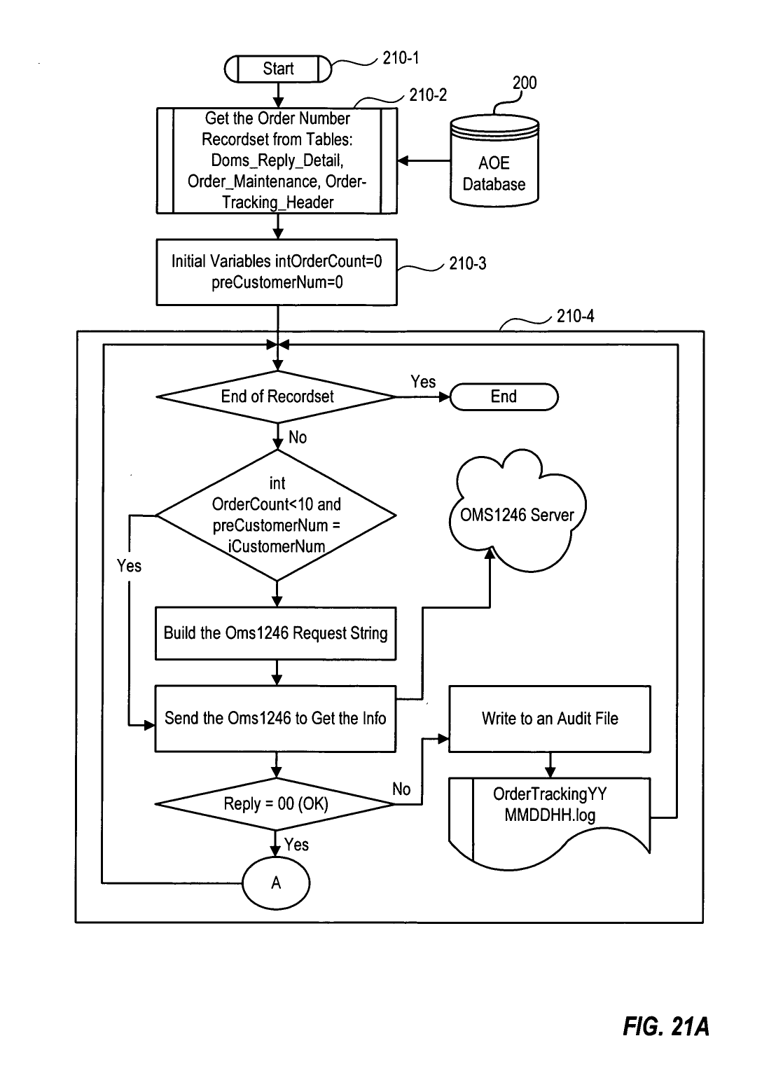

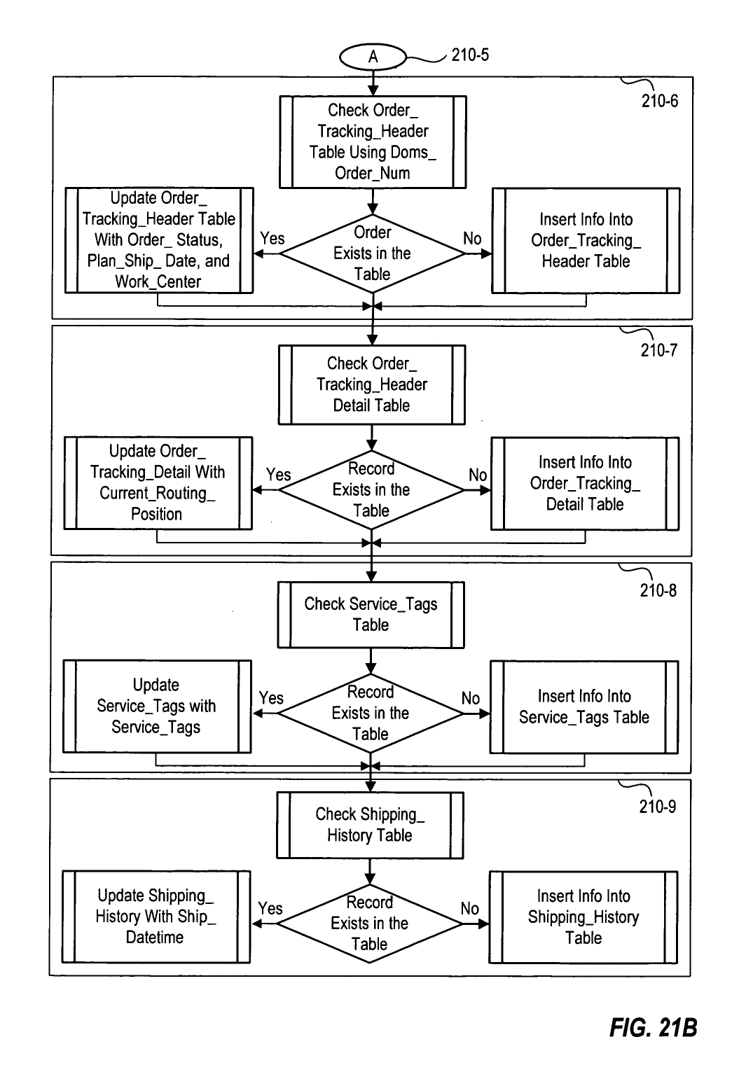

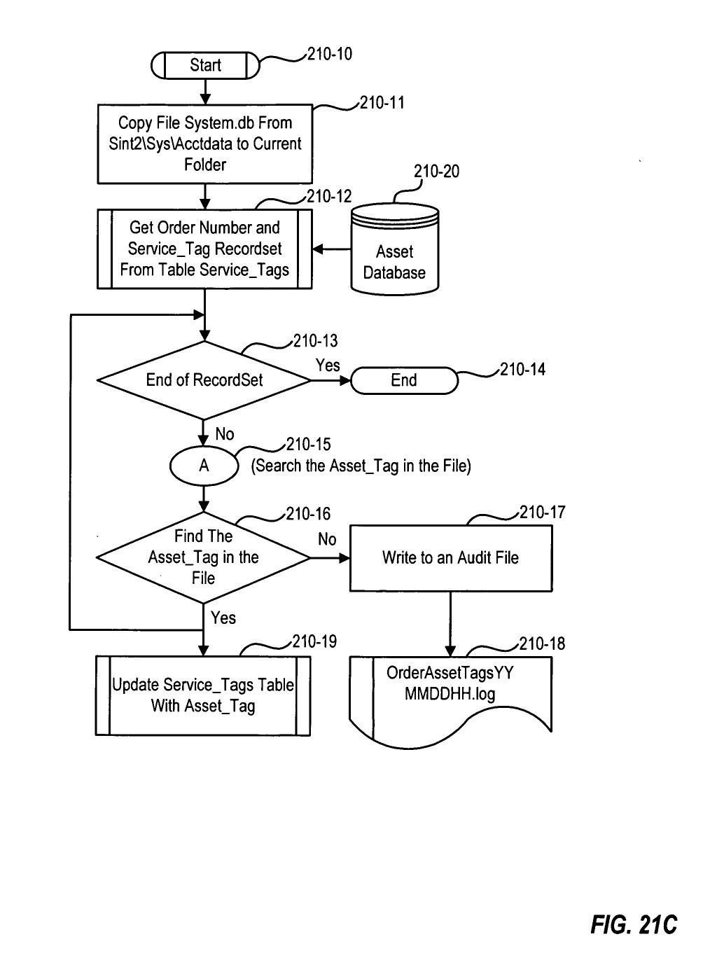

Referring to FIGS. 21A, 21B and 21C, Order Tracking program 14A-21 in FIG. 14A, is shown in flow diagram form. The order tracking program enables tracking of non-commodity products as well as commodity products. The tracking program shown in FIG. 21A, blocks 210-2 through 210-4 retrieves all open orders from the AoE database 200, performs a send to OMS server 1246, and information obtained includes OMS system status (cancelled, on hold, build process, shipped, invoiced, paid). Further information obtained includes box number of the product shipped, shipping waybill numbers, shipping carrier, shipping weight per box, and the exact date and time of shipment. Referring to FIG. 21B, blocks 210-5 through 210-9, determines what new information is required for update in the AoE database 200.

Referring to FIG. 21C, the Asset Tag program 14A-22 is shown in flow diagram form. According to an embodiment, an “asset tag” is a unique identifier for each system or component. Asset tags can be customer specific, including numbering schemes for labels and the like for configurations and/or components of a configuration that customers can use for asset management within their company. The asset tags are placed within a configuration or physically placed on a product. Unlike a service tag used for a manufacturer to track or identify uniquely a system, the asset tags for a customer are generated by a manufacturer on behalf of a customer. Further, asset tags depend on customer agreements as to which components or configurations require asset tags. Asset tag program 14A-22 is, in one embodiment, a batch program that obtains manufacturing assigned customer specific asset tags from asset database 210-20 shown in FIG. 14A.

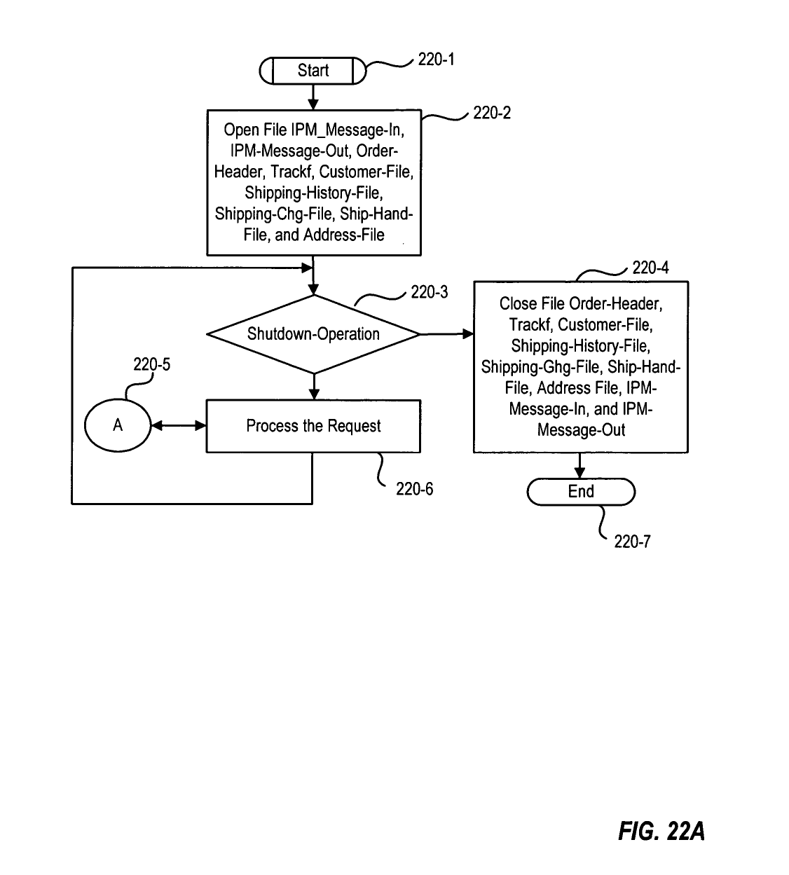

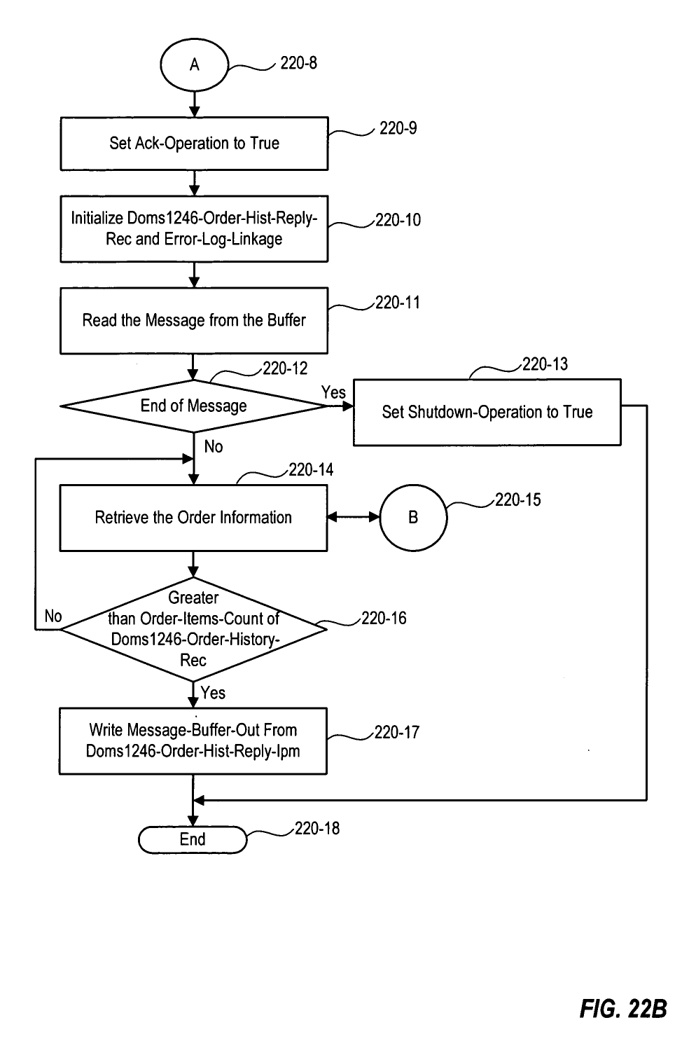

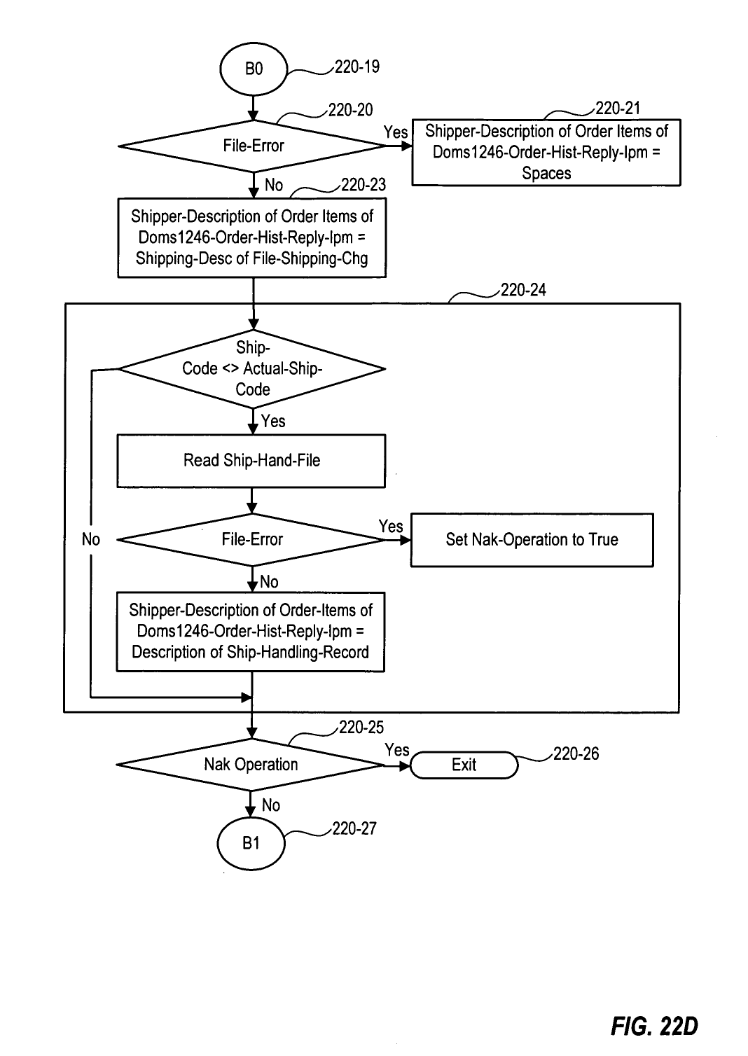

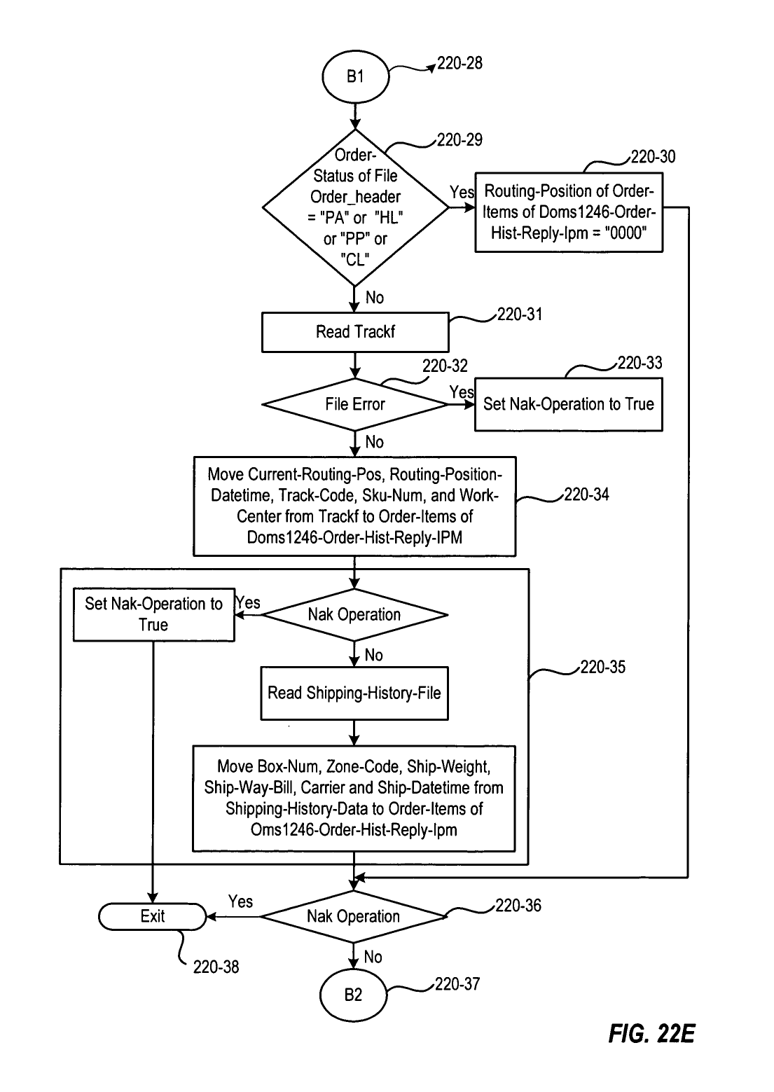

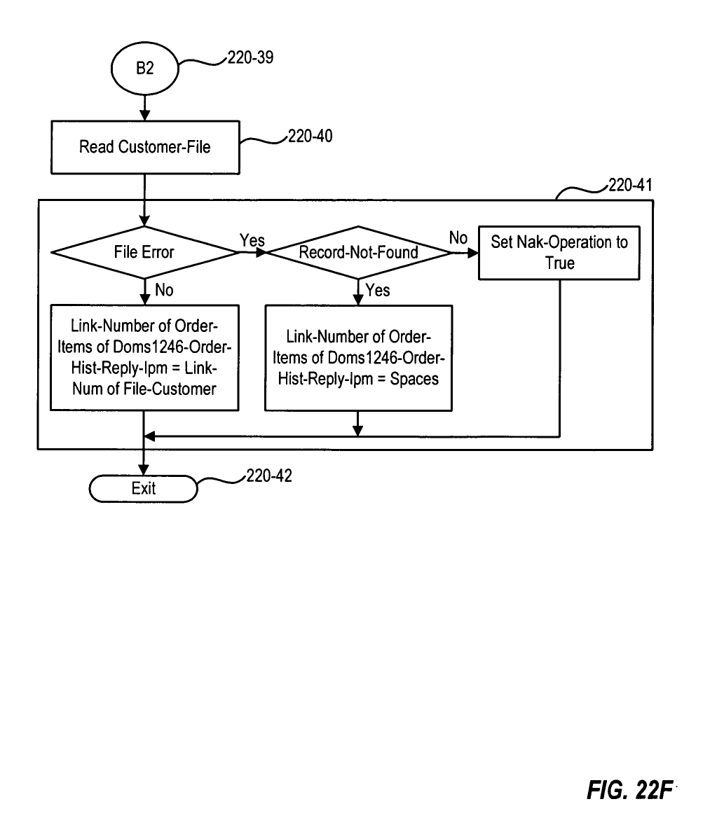

Referring to FIG. 14C, OMS server 1246 is shown as coupled to Order Tracking program 14A-21 in FIG. 14A. OMS server 1246 is a program outlined in flow diagram form in FIGS. 22A through 22 F in blocks 220-1 through 220-42. In one embodiment, OMS server 1246 is a Cobol program that runs on a mainframe type computer, and resides with in the OMS system. The program 14A-21 obtains information for each order after an order is created or completed in the OMS system in blocks 220-1 through 220-42. The information obtained includes multiple OMS order statuses including the date and time of each status, the manufacturing service tag, payment code, payment amount, purchase order number, work center information (chassis type) and shipping information which consists of: the actual shipped date of the order, the ship-to information, the actual shipping charge, the shipping carrier, all waybill numbers and box numbers for each waybill, the shipping status for each waybill and the date and time, and the shipping weight of each box.

Order Entry GUI

Referring back to FIG. 14A, AoE GUI 402 is shown. The order process includes software modules in AoE GUI 402. The outline of the AoE GUI 402 are shown in FIG. 23. As shown in FIG. 23, blocks 230-1 through 230-18 identify software modules that relate to different screens presented in the GUI. The diagram shows which screens pull up other screens. For example, order files screen 230-3 allows a computer user to pull up screen 230-9, 230-10, 230-11 or 230-19.

Referring to FIG. 23-3A, a flow diagram for Order Files software module shown in FIG. 23 block 230-3 is shown. The Order Files module includes blocks 230-3-1 through 230-3-31. The flow diagrams illustrates code that resides in the AOE GUI 402 shown in FIG. 14A. The code enables computer users to view an entire history of customer requested purchase order data and change/cancel data in a file for in several files. The code includes a check of computer user permissions and includes the ability to run reports, view and process pending orders, view total dollar amounts, order count totals and purchase order details.

Referring to FIG. 23-4A and 23-4B, flow diagrams illustrate the code for the Shipping Charge software module shown as block 230-4 in FIG. 23. The Shipping Charge module includes blocks 230-4-1 through 230-4-15. The module enables computer users to add, delete and update shipping charge data. The AOE GUI 402 permits the data to be displayed on a screen including Shipping Service, configuration type, system type, system matrix type, shipping charge cost, services descriptions, and the like. The data is used by the Order Processor program 14A-15 shown in FIG. 14A to locate correct shipping charge data for an order.

Referring to FIG. 23-5A and FIG. 23-5B, flow diagrams illustrate the code for the Email List software module shown in block 230-5 in FIG. 23. FIG. 23-5 A and 23-5B include blocks 230-1 through 230-5-27. The module enables a computer user to add and delete email addresses for recipients of notices related to stocking orders, order release notifications, order exception notifications, inventory notifications, change and cancel notifications and certain error notifications. Computer users with appropriate permissions may add or delete email addresses.

Referring to FIG. 23-6A through 23-6C, flow diagrams illustrate the code for the Advance Shipment Notice software module shown in block 230-6 in FIG. 23. FIGS. 23-6A through 23-6C include blocks 230-6-1 through 230-6-28. The functionality shown in the flow diagrams enables a computer user to add, delete and update advanced ship notice recipient data. The data includes destination, contact names, destination location, address, email address and ship to addresses. After a permissions check, a computer user can update fields in the screen present.

Referring to FIG. 23-7, a flow diagram illustrating the code for the Order Maintenance software module shown in FIG. 23 is shown in blocks 230-7-1 through 230-7-10. The functionality of the software module includes enabling a computer user to update customer profile data. The data is displayed on the screen to give lead times, shipping charge values, check line item total, check shipping total, check sales tax total, keycode data, expedited orders and the like. The Order Processor 14A-15 and the Order Change and Cancel Processor 14A-19 shown in FIG. 14A use the data to validate the customer data and to place orders in the AoE system. If the computer user has appropriate permissions the fields can be updated in the screen displayed.

Referring to FIG. 23-8A through FIG. 23-8H, flow diagrams illustrate the code for the Tax Exempt Customer software module shown as block 230-8 in FIG. 23. The flow diagrams include blocks 230-8-1 through 230-8-32. The screens presented by the flow diagrams allow a computer user to view and update tax exempt customer data. The fields that can be viewed include the tax exempt certificate number, the customer number, city state, jurisdiction and effective dates for the tax exemption.

Referring to FIG. 23-9A to FIG. 23-9E a manual order entry module for block 230-9 shown in FIG. 23 is shown in flow diagram form. The flow diagram includes blocks 230-9-1 through 230-9-63. The flow diagram produces a screen residing in the AoE GUI 402, and is accessible from the Order Files module 230-3 shown in FIG. 23. It enables the computer users to obtain order number information from the OMS system. In one embodiment, a computer user with the correct permissions can enter an order number that relates to a customer purchase order number. The computer user can then in order to remedy a problem that cannot be solved through the normal batch ordering process. This functionality accepts in the user's order number, makes a trip to DOMS to find the Order Total, sales tax, etc, in order to update the AOE database, and Acknowledge to the customer.

The functionality of manual OMS entry module is used when needed to pull Order information manually out of the OMS system, into the AoE database 200. The manual OMS entry module performs an edit check to ensure that the manual order extract being requested by a computer user has been typed in correctly, such that it checks to ensure that the purchase order number, the OMS customer number, and the OMS order number matches. According to one embodiment, the order data from the OMS system is checked in module Manual OMS Entry 230-9 to ensure that the data matches the correct customer purchase order number in AoE database 200. The functionality of module 230-9 is most commonly used when implementing the AoE system, to perform a staggered implementation of the automatic order entry, wherein a manufacturer receives the order file 338 but does not want to automatically process it.

Referring to FIGS. 23-10A and 23-10B, flow diagrams illustrate the code for software module Order Summary shown in block 230-10. The flow diagrams include blocks 230-10-1 through 230-10-16. The functionality of the code is to enable a computer user to view all customer requested purchase order data and change/cancel data. The data displayed includes purchase order number, quote number, order status, planned ship date, service tag number, asset tag data, manufacturer order number, status and shipping data including waybill, zone code and other shipping data. Any error data received during the processing of the order can also be displayed. The computer user can also perform an internal cancellation or reassignment of an order. Further detailed header data and other details of an order can be viewed.

Referring to FIG. 23-11A through 23-11J, flow diagrams illustrate the View Pending Order software module 230-11 shown in FIG. 23. The flow diagrams include blocks 230-11-1 through 230-11-115. The functionality of the flow diagrams includes enabling a computer user to view orders, process orders and reject orders that are in a pending status. A pending status occurs when an order is held up for certain reasons. For example, a customer's request purchase order can be pending if an expedited request requires approvals.

Referring to FIG. 23-12, a flow diagram illustrates the Non-Working Day module 230-12 shown in FIG. 23. The flow diagram includes blocks 230-12-1 through 230-12-11. The functionality includes determining which days, according to customer agreements, are non-working days, and displaying whether a shipment request was made for a delivery on a non-working day.

Referring to FIG. 23-13, a flow diagram illustrates the Order Transport software module shown in FIG. 23, block 230-13. The flow diagram includes blocks 230-13-1 through 230-13-9. As shown, the software module displays order transport data.

Referring now to FIG. 23-15A and 23-15B, flow diagrams illustrate the Order Information software module shown in block 230-15 in FIG. 23. The flow diagrams include blocks 230-15-1 through 230-15-19. The functionality shown in the flow diagrams includes enabling computer users to view customer purchase order data included header data such as ship by dates and ship to values. Further data that can be viewed includes order detail data including options ordered, quote number, unit prices, order quantity and whether or not a customer has requested a cancel or change of an order.

Referring to FIG. 23-17 A through 23-17C, flow diagrams illustrate the Order Detail Information software module shown as block 230-17 shown in FIG. 23. The flow diagrams are operable when a computer user chooses a purchase order number in the Order Summary screen shown as 230-10 in FIG. 23. The software module populates requested order data including shipping data, error data and status data as requested by a computer user.

Referring to FIG. 23-18, a flow diagram illustrates the Order change/Cancel Information software module 230-18 shown in FIG. 23. The functionality of the code enables a computer user to cancel an order placed in AoE system and reassign a different order number to a purchase order number of a customer. For example, a computer user uses this functionality when a particular order is not far enough in the build process to meet contractual shipping dates. An internal cancel and reassignment can reassign a predetermined order number to the purchase order to allow the program to search for inventory or build a new order.

Referring to FIG. 23-19A, 23-19B, 23-20, 23-21, 23-22, 23-23 and 23-24, flow diagrams illustrate the reports flow diagrams shown in block 230-19 of FIG. 23. FIG. 23-19A and 23-19B show the flow diagrams for creating an advance shipment notice report, the notice report is created with a batch program and communicates shipping data to the customer. The application reads shipping data such as waybill, box count zone code, carrier name and shipping date from an AOE system table. In an exemplary embodiment, the batch program is scheduled to run periodically to automatically update customers of the status of their orders.

Referring to FIG. 23-20, a complete order detail report flow diagram is shown included blocks 230-20-1 through 230-20-18. The functionality of the flow diagram is to enable a computer user to create a spreadsheet report based on a customers order file identification, a file received date or a ship-by date. The report lists all orders and changes and cancels requested by a customer. The report lists a plurality of fields including purchase order number, sales tax, shipping charges, order total, ship-by date, shipping information configuration description, order quantity, SKU numbers, asset tags and service tags.

FIG. 23-21 provides a flow diagram for creating an order exception report. The figure includes blocks 230-21-1 through 230-21-17. The functionality of the report includes enabling computer users to track order errors caused by invalid data received by a customer. The report lists purchase order data, error count, error data and error descriptions.

FIG. 23-22 provides a flow diagram for creating an order matrix report. The blocks included are 230-22-1 through 230-22-18. The functionality enables computer users to create a spreadsheet based on the customer's number of days since sending an order file or a file received date. The report is a summary of categorized dollar amounts and order counts on a date basis. The report lists all orders and cancels and changes requested by a customer. The fields included in the report are file received date, total dollar amount for non-commodity orders, total number of order processed, total exceptions, total number of customer orders that were cancelled or changed, total number of bundled orders, total number of bundle orders that were processed, total number of exception bundle orders, and the like.

FIG. 23-23 provides a flow diagram for creating a shipping status report. The flow diagram includes blocks 230-25-1 through 230-25-17. The flow diagram enables a computer user to create a spreadsheet report that assists in tracking order shipping data.

FIG. 23-24 provides a flow diagram for creating an inventory report. The code presents a spreadsheet that tracks inventory usage for bundled products and configurations. The report includes a count of the number of systems that were built new due to lack of inventory.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1-30. (canceled)

31. A method for a manufacturer to automate a catalog process, the method comprising:
creating a catalog of configurable products including at least one of non-commodity products and services; and
presenting a data file, the data file including the catalog, the presenting via a communication medium to a purchaser, the data file including
manipulable parameters that enable configuration of a non-commodity product or service, the manipulable parameters including upgrades, downgrades and swapping of components; and,
non-manipulable parameters that contribute to the configuration of a non-commodity product or service, the non-manipulable parameters including parent components, orphan components, child components, configuration components and optional components.

32. The method of claim 31 wherein the purchaser includes at least one of a customer, a third party acting on behalf of the customer and a supplier.

33. The method of claim 31 wherein the manufacturer includes a third party acting on behalf of the manufacturer.

34. The method of claim 31 wherein the data file allows the purchaser to configure the products independent of a third party provided configuration tool.

35. The method of claim 31 wherein the presenting includes transmitting the data file to the customer.

36. The method of claim 31 wherein the presenting includes hosting the data file on a world wide web interface.

37. The method of claim 31 wherein the data file is configured to be incorporated into a procurement system, the data file providing a catalog of configurable components.

38. The method of claim 37 wherein the data file includes business rules in a structured data format.

39. The method of claim 38 wherein the business rules include rules for manipulating data including functional rules and configuration rules for integrating the data file into the procurement system.

40. The method of claim 31 wherein the data file includes data shared by the manufacturer and a host of the data file.

41. The method of claim 31 wherein the data file provides data shared by a purchaser's procurement system and a seller's invoicing system.

42. The method of claim 31 wherein the data file is an (Electronic Data Interchange) EDI format.

43. The method of claim 31 wherein the electronic data file is transmitted to the purchaser using an SGML format.

44. The method of claim 31 wherein the electronic data file is in a proprietary file format.

45. The method of claim 31 wherein the data file is periodically updated by the manufacturer to indicate pricing changes and production transactions.

46. A method for a manufacturer to automate a catalog process, the method comprising:
creating a catalog of configurable products including at least one of non-commodity products and services; and
presenting a data file, the data file including the catalog, the presenting via a communication medium to a purchaser, the data file including
a configuration identifier, a price of the configuration, a type of component identifier, the type of component include custom or bundled, upgrades, downgrades, an additions permitted with pricing component, work flow data identifying add configurations, discontinue configuration, replace configuration, effective date, and a discontinue date.

47. The method of claim 41 wherein the data file includes pricing according to predetermined agreements with the manufacturer and the host.

48. The method of claim 41 wherein the data file includes at least one of factory-installed components, non-factory-installed components, and subsystem configurations.

49. The method of claim 41 wherein the data file includes a core configuration including:
commodity and non-commodity default services; and
customer-specific integration components.

50. The method of claim 44 wherein the customer-specific integration components include customer specific software and menus, images, customer asset tag labels, and security cables.

51. The method of claim 44 wherein the customer-specific integration components include at least one of transportation industry options and transportation services.

52. The method of claim 43 wherein the factory installed, non-factory installed, customer kit and solution data includes the associated Stock Keeping Units (SKUs), including a third parties or a manufacturer generated SKUs and pricing.

53. The method of claim 41 fuirther comprising:
receiving an acknowledgment file approving configurations within the data file.

54. The method of claim 48 wherein the acknowledgment file includes acknowledging each parameter of configurable products, including components, pricing, services as acceptable and not acceptable.

55. The method of claim 41 wherein the data file provides data shared by a purchaser's procurement system and a seller's invoicing system.

56. The method of claim 41 wherein the data file is an (Electronic Data Interchange) EDI format.

57. The method of claim 41 wherein the electronic data file is transmitted to the purchaser using an SGML format.

58. The method of claim 41 wherein the electronic data file is in a proprietary file format.

59. The method of claim 41 wherein the data file is periodically updated by the manufacturer to indicate pricing changes and production transactions.

60. A method for a manufacturer to automate a catalog process, the method comprising:
creating a catalog of configurable products including at least one of non-commodity products and services; and
presenting a data file, the data file including the catalog, the presenting via a communication medium to a purchaser; and,
transmitting an action code within the data file denoting product configurations requiring replacement in a procurement system, the action code permitting a purchaser receiving the data file to update open orders in the procurement system prior to delivery of an order without manual interaction.

61. The method of claim 50 wherein the data file provides data shared by a purchaser's procurement system and a seller's invoicing system.

62. The method of claim 50 wherein the data file is an (Electronic Data Interchange) EDI format.

63. The method of claim 50 wherein the electronic data file is transmitted to the purchaser using an SGML format

64. The method of claim 50 wherein the electronic data file is in a proprietary file format.

65. The method of claim 50 wherein the data file is periodically updated by the manufacturer to indicate pricing changes and production transactions.

66. A method for a manufacturer to automate a catalog process, the method comprising:
creating a catalog of configurable products including at least one of non-commodity products and services;
presenting a data file, the data file including-the catalog, the presenting-via a communication medium to a purchaser, the data file including
configuration parameters, the configuration parameters including a configuration identifier, a price of a configuration, a type of component identifier, an additions permitted with pricing parameter, work flow data identifying add configurations, discontinue configuration, replace configuration, effective date, and a discontinue date;
manipulable parameters that enable configuration of a non-commodity product or service, the manipulable parameters including upgrades, downgrades and swapping of components; and,
non-manipulable parameters that contribute to the configuration of a non-commodity product or service, the non-manipulable parameters including parent components, orphan components, child components, configuration components and optional components; and,
transmitting an action code within the data file denoting product configurations requiring replacement in a procurement system, the action code permitting a purchaser receiving the data file to update open orders in the procurement system prior to delivery of an order without manual interaction.

67. The method of claim 66 wherein the data file provides data shared by a purchaser's procurement system and a seller's invoicing system.

68. The method of claim 66 wherein the data file is an (Electronic Data Interchange) EDI format.

69. The method of claim 66 wherein the electronic data file is transmitted to the purchaser using an SGML format.

70. The method of claim 66 wherein the electronic data file is in a proprietary file format.

71. The method of claim 66 wherein the data file is periodically updated by the manufacturer to indicate pricing changes and production transactions.
